(19) United States
(12) Patent Application Publication
(10) Pub. No.: US 2026/0172243 A1
(43) Pub. Date: Jun. 18, 2026

(54) Data Sovereignty Assurance for Artificial Intelligence (AI) Models

(71) Applicant: Istari Digital, Inc., Charleston, SC (US)

(72) Inventors: William Roper, JR., Charleston, SC (US); Christopher Lee Benson, Arlington, VA (US); Sriram Krishnan, Cambridge, MA (US); Danne Lauren Stayskal, Eastsound, WA (US)

(21) Appl. No.: 19/533,579

(22) Filed: Feb. 9, 2026

Related U.S. Application Data
(63) Continuation of application No. PCT/US24/58547, filed on Dec. 4, 2024.
(60) Provisional application No. 63/606,030, filed on Dec. 4, 2023.
(60) Provisional application No. 63/721,250, filed on Nov. 15, 2024.

(51) Int. Cl. H04L 9/08; G06N 3/084

(52) U.S. Cl. CPC H04L 9/0861; G06N 3/084

(57) ABSTRACT

Deploying neural networks that use unique data sources generated by enterprises as training or input data has significant potential to unlock novel insights and domain-specific AI capabilities. However, data owners are often hesitant to share their proprietary and valuable datasets with third parties for training neural networks, even though doing so could provide significant benefits. Similarly, neural network owners are reluctant to expose their confidential weights and biases, which represent critical intellectual property. The proposed solution is based on both data and neural network parameters being transformed into a secure mathematical space, enabling collaborative training and deployment of neural networks without exposing sensitive information. The solution proposed here resolves data and neural network model privacy issues by allowing data owners and neural network owners to work together securely, ensuring that neither party's assets are compromised, while still enabling effective collaboration.

### REFERENCE TO RELATED APPLICATIONS

If an Application Data Sheet (“ADS”) or PCT Request Form (“Request”) has been filed on the filing date of this application, it is incorporated by reference herein. Any applications claimed on the ADS or Request for priority under 35 U.S.C. §§ 119, 120, 121, or 365(c), and any and all parent, grandparent, great-grandparent, etc., applications of such applications, are also incorporated by reference, including any priority claims made in those applications and any material incorporated by reference, to the extent such subject matter is not inconsistent herewith.

Furthermore, this application is related to the U.S. patent applications listed below, which are incorporated by reference in their entireties herein, as if fully set forth herein:
U.S. provisional patent application No. 63/650,498 (Docket No. IST-05.001P), filed on May 22, 2024, entitled “Fyber: Distributed Digital Threading Platform for Trusted Data Sources,” describes distributed digital threading for trusted data sources.
PCT application No. PCT/US24/49149 (Docket No. IST-02.006PCT), filed on Sep. 28, 2024 entitled “Artificial Intelligence (AI) Assisted End-to-End Workflow Integration for Software Development in Digital Model Platforms,” describes artificial intelligence (AI)-assisted approaches to integrate discrete workflows for software development within digital software platforms.
PCT application No. PCT/US24/44938 (Docket No. IST-03.006PCT), filed on Sep. 1, 2024 entitled “Multimodal Digital Document Interfaces for Dynamic and Collaborative Reviews,” describes interface enhancement for digital software platforms.
PCT application No. PCT/US24/42768 (Docket No. IST-02.004PCT), filed on Aug. 16, 2024, entitled “Artificial Intelligence (AI) Assisted Automation of Testing in Software Environments,” describes workflow enhancement for digital software platforms.
PCT application No. PCT/US24/40624 (Docket No. IST-03.003PCT), filed on Aug. 1, 2024, entitled “Machine Learning Engine for Workflow Enhancement in Digital Workflows,” describes workflow enhancement for digital software platforms.
PCT application No. PCT/US24/40468 (Docket No. IST-03.004PCT), filed on Jul. 31, 2024, entitled “Multimodal User Interfaces for Interacting with Digital Model Files,” describes multimodal user interfaces for digital software platforms.
PCT application No. PCT/US24/38878 (Docket No. IST-03.002PCT), filed on Jul. 19, 2024, entitled “Generative Artificial Intelligence (AI) for Digital Workflows,” describes efficient AI-assisted script generation methods that preserve customer data sovereignty.
PCT application No. PCT/US24/35885 (Docket No. IST-02.002PCT), filed on Jun. 27, 2024, entitled “Artificial Intelligence (AI) Assisted Integration of New Digital Model Types and Tools into Integrated Digital Model Platform,” describes the enhancement of model splicer technology through AI-assistance.
PCT application No. PCT/US24/27912 (Docket No. IST-02.003PCT), filed on May 5, 2024, entitled “Secure and Scalable Sharing of Digital Engineering Documents,” describes secure and scalable document splicing technology.
PCT application No. PCT/US24/27898 (Docket No. IST-03.001PCT), filed on May 4, 2024, entitled “Digital Twin Enhancement using External Feedback within Integrated Digital Model Platform,” describes digital and physical twin management and the integration of external feedback within a DE platform.
PCT application No. PCT/US24/19297 (Docket No. IST-01.002PCT), filed on Mar. 10, 2024, entitled “Software-Code-Defined Digital Threads in Digital Engineering Systems with Artificial Intelligence (AI) Assistance,” describes AI-assisted digital threads for digital engineering platforms.
PCT application No. PCT/US24/18278 (Docket No. IST-02.001PCT), filed on Mar. 3, 2024, entitled “Secure and Scalable Model Splicing of Digital Engineering Models for Software-Code-Defined Digital Threads,” describes model splicing for digital engineering platforms.
PCT application No. PCT/US24/14030 (Docket No. IST-01.001PCT), filed on Feb. 1, 2024, entitled “Artificial Intelligence (AI) Assisted Digital Documentation for Digital Engineering,” describes AI-assisted documentation for digital engineering platforms.
U.S. provisional patent application No. 63/442,659 (Docket No. IST-01.001P), filed on Feb. 1, 2023, entitled “AI-Assisted Digital Documentation for Digital Engineering with Supporting Systems and Methods,” describes AI-assistance tools for digital engineering (DE), including modeling and simulation applications, and the certification of digitally engineered products.
U.S. provisional patent application No. 63/451,545 (Docket No. IST-01.002P), filed on Mar. 10, 2023, entitled “Digital Threads in Digital Engineering Systems, and Supporting AI-Assisted Digital Thread Generation,” describes model splicer and digital threading technology.
U.S. provisional patent application No. 63/451,577 (Docket No. IST-02.001P1), filed on Mar. 11, 2023, entitled “Model Splicer and Microservice Architecture for Digital Engineering,” describes model splicer technology.
U.S. provisional patent application No. 63/462,988 (Docket No. IST-02.001P2), filed on Apr. 29, 2023, also entitled “Model Splicer and Microservice Architecture for Digital Engineering,” describes model splicer technology.
U.S. provisional patent application No. 63/511,583 (Docket No. IST-02.002P), filed on Jun. 30, 2023, entitled “AI-Assisted Model Splicer Generation for Digital Engineering,” describes model splicer technology with AI-assistance.
U.S. provisional patent application No. 63/516,624 (Docket No. IST-02.003P), filed on Jul. 31, 2023, entitled “Document and Model Splicing for Digital Engineering,” describes document splicer technology.
U.S. provisional patent application No. 63/520,643 (Docket No. IST-02.004P), filed on Aug. 20, 2023, entitled “Artificial Intelligence (AI)-Assisted Automation of Testing in a Software Environment,” describes software testing with AI-assistance.
U.S. provisional patent application No. 63/590,420 (Docket No. IST-02.005P), filed on Oct. 14, 2023, entitled “Commenting and Collaboration Capability within Digital Engineering Platform,” describes collaborative capabilities.
U.S. provisional patent application No. 63/586,384 (Docket No. IST-02.006P), filed on Sep. 28, 2023, entitled “Artificial Intelligence (AI)-Assisted Streamlined Model Splice Generation, Unit Testing, and Documentation,” describes streamlined model splicing, testing and documentation with AI-assistance.
U.S. provisional patent application No. 63/470,870 (Docket No. IST-03.001P), filed on Jun. 3, 2023, entitled “Digital Twin and Physical Twin Management with Integrated External Feedback within a Digital Engineering Platform,” describes digital and physical twin management and the integration of external feedback within a DE platform.
U.S. provisional patent application No. 63/515,071 (Docket No. IST-03.002P), filed on Jul. 21, 2023, entitled “Generative Artificial Intelligence (AI) for Digital Engineering,” describes an AI-enabled digital engineering task fulfillment process within a DE software platform.
U.S. provisional patent application No. 63/517,136 (Docket No. IST-03.003P), filed on Aug. 2, 2023, entitled “Machine Learning Engine for Workflow Enhancement in Digital Engineering,” describes a machine learning engine for model splicing and DE script generation.
U.S. provisional patent application No. 63/516,891 (Docket No. IST-03.004P), filed on Aug. 1, 2023, entitled “Multimodal User Interfaces for Digital Engineering,” describes multimodal user interfaces for DE systems.
U.S. provisional patent application No. 63/580,384 (Docket No. IST-03.006P), filed on Sep. 3, 2023, entitled “Multimodal Digital Engineering Document Interfaces for Certification and Security Reviews,” describes multimodal user interfaces for certification and security reviews.
U.S. provisional patent application No. 63/613,556 (Docket No. IST-03.008P), filed on Dec. 21, 2023, entitled “Alternative Tool Selection and Optimization in an Integrated Digital Engineering Platform,” describes tool selection and optimization.
U.S. provisional patent application No. 63/584,165 (Docket No. IST-03.010P), filed on Sep. 20, 2023, entitled “Methods and Systems for Improving Workflows in Digital Engineering,” describes workflow optimization in a DE platform.
U.S. provisional patent application No. 63/590,456 (Docket No. IST-04.001P), filed on Oct. 15, 2023, entitled “Data Sovereignty Assurance for Artificial Intelligence (AI) Models,” relates to data sovereignty assurance during AI model training and evaluation.
U.S. provisional patent application No. 63/606,030 (Docket No. IST-04.001P2), filed on Dec. 4, 2023, also entitled “Data Sovereignty Assurance for Artificial Intelligence (AI) Models,” further details data sovereignty assurances during AI model training and evaluation.
U.S. provisional patent application No. 63/419,051, filed on Oct. 25, 2022, entitled “Interconnected Digital Engineering and Certification Ecosystem.”
U.S. non-provisional patent application Ser. No. 17/973,142 (Docket No. 54332-0057001) filed on Oct. 25, 2022, entitled “Interconnected Digital Engineering and Certification Ecosystem.”
U.S. non-provisional patent application Ser. No. 18/383,635 (Docket No. 54332-0059001), filed on Oct. 25, 2023, entitled “Interconnected Digital Engineering and Certification Ecosystem.”
U.S. provisional patent application No. 63/489,401, filed on Mar. 9, 2023, entitled “Security Architecture for Interconnected Digital Engineering and Certification Ecosystem.”

### NOTICE OF COPYRIGHTS AND TRADEDRESS

A portion of the disclosure of this patent document contains material which is subject to copyright protection. This patent document may show and/or describe matter which is or may become tradedress of the owner. The copyright and tradedress owner has no objection to the facsimile reproduction by anyone of the patent disclosure as it appears in the U.S. Patent and Trademark Office files or records, but otherwise reserves all copyright and tradedress rights whatsoever.

ISTARI DIGITAL is a trademark name carrying embodiments of the present invention, and hence, the aforementioned trademark name may be interchangeably used in the specification and drawings to refer to the products/process offered by embodiments of the present invention. The terms ISTARI and ISTARI DIGITAL may be used in this specification to describe the present invention, as well as the company providing said invention.

### FIELD OF THE INVENTION

This disclosure relates to the training and evaluation of artificial intelligence (AI) models, and more specifically to data sovereignty assurance during AI model training and evaluation.

### BACKGROUND OF THE INVENTION

The statements in the background of the invention are provided to assist with understanding the invention and its applications and uses, and may not constitute prior art.

Data collection and sharing have become pivotal in industry and research, particularly in data-intensive applications such as artificial intelligence, machine learning, and big data analytics. The vast amounts of data generated daily drive innovation, enhance decision-making, and enhance the delivery of products and services. Particularly in the field of artificial intelligence (AI), data sharing is of paramount relevance, as machine learning models require large datasets for training to ensure accuracy and reliability.

Data breaches, data leaks, hacking, and associated exposure of sensitive information, are fueling growing security and privacy concerns associated with data sharing. For example, recent data breaches at major credit reporting agencies and social networks have compromised the financial and personal data of hundreds of millions of users around the world, fueling concerns about the security of customer data. Furthermore, neural networks can fall victim to model inversion attacks, which reconstruct private/untransformed input data from model outputs. Such attacks can expose sensitive information of users and organizations, raising security concerns. The recent leaking of the proprietary weights of a tech industry leader's large scale language model compounds those fears.

In sensitive contexts such as the aerospace industry, medical organizations, government institutions and contractors, and so on, the potential implications of data breaches are significantly larger. Such security and privacy issues may lead to the increased reluctance of data owners to share their data, and to the enactment of laws restricting the movement of data. The consequent restrictions on data sharing may hinder information system operations, innovation, limit the development of data-intensive applications, and potentially slow down progress in various fields of industry and research.

Data sovereignty in its widest sense refers to the principle that digital information generated by an enterprise or an individual remains under the control of the data owner throughout the data life cycle. More specifically, with respect to data used in the training of neural networks and other AI models, data sovereignty refers to the principle that the data owner should maintain control over access to their data even when shared with third parties that are allowed to use it for training, or when the trained neural network is deployed. For example, the data owner should be protected against accidental exposure or intentional extraction of their training data through manipulation of the neural network, or even through mere access to it. Equally, such a data sovereignty safeguard may be expected by neural network model owners who want to share the model functions without explicitly sharing its architecture or parameters.

The increasing demand for data sharing in data-intensive applications is creating a tension between the risks and benefits of data sharing. Therefore, in view of the aforementioned difficulties, it would be an advancement in the state of the art to provide methods and systems enabling data sharing that is compliant with data sovereignty principles, particularly for AI training purposes.

It is against this background that various embodiments of the present invention were developed.

### BRIEF SUMMARY OF THE INVENTION

This summary of the invention provides a broad overview of the invention, its application, and uses, and is not intended to limit the scope of the present invention, which will be apparent from the detailed description when read in conjunction with the drawings.

Deploying neural networks that use unique data sources generated by enterprises as training or input data has significant potential to unlock novel insights and domain-specific AI capabilities. Consequently, data owners and neural network owners often wish to collaborate to train new AI models, or to apply AI to their individual applications. However, current data security frameworks are insufficient to address growing concerns about confidentiality and misuse. Traditional training processes require access to both the internal parameters of the neural networks and the source data, and create a barrier due to competing concerns over data secrecy. Existing solutions typically rely on assurances from AI model providers to not retain input data beyond a fixed period (e.g., 30 days), or on deploying pre-trained models within isolated enterprise environments. Both approaches fall short of enabling secure and flexible collaboration.

In light of this, data owners are often hesitant to share their proprietary and valuable datasets with third parties for training neural networks, even though doing so could provide significant benefits. Similarly, neural network owners are reluctant to expose their confidential weights and biases, which represent critical intellectual property.

Accordingly, we propose systems and methods where both data and neural network parameters are transformed into a secure mathematical space, enabling collaborative training and deployment of neural networks without exposing sensitive information. The systems and methods proposed here resolve data and model privacy issues by allowing data owners and neural network owners to work together securely, ensuring that neither party's assets are compromised, while still enabling effective collaboration.

Broadly, the present invention relates to methods and systems for training and evaluating neural networks while preserving data sovereignty. The method may be applied by a single party or multiple parties seeking to keep their data and/or neural network private from one another.

The methods and systems herein present two parties, a neural network (NN) owner having a private NN, and a data owner having private data to be used for a NN operation such as evaluation, training, fine-tuning, as context data, etc. To enhance the privacy of both the NN and the data, the methods and systems described herein include mathematical transformations from a true mathematical space (the untransformed space) to a transformed mathematical space (the transformed space) where NN operations may be carried out.

Various embodiments of the present invention are discussed in detail herein. In particular, the so-called Embodiment 1 and Embodiment 2 differ in the mathematical operations that are used to describe the process required to carry out privacy measures. Two major sub-embodiments are also discussed:

In a “shared data” sub-embodiment of the invention, the data owner shares a transformed representation of their data with the NN owner, and the NN owner carries out the NN operation in the transformed space. The NN operation in the transformed space is equivalent to an identical NN operation using the untransformed data on the untransformed NN in the true space. In other words, equivalence denotes that the transformation preserves corresponding neural network operations performed in an untransformed space, up to a predetermined error threshold, as discussed below. Despite this equivalence, the methods and systems described herein ensure that the NN owner has no ability to access the data owner's private data before or after the operation.

In a “shared NN” sub-embodiment of the invention, the NN owner shares a transformed representation of their NN with the data owner, and the data owner carries out the NN operation in the transformed space. The NN operation in the transformed space is equivalent to an identical NN operation using the untransformed data on the untransformed NN in the true space. In other words, equivalence denotes that the transformation preserves corresponding neural network operations performed in an untransformed space, up to a predetermined error threshold, as discussed below. Despite this equivalence, the methods and systems described herein ensure that the data owner—in this case—has no ability to access the NN's private NN parameters before or after the operation.

More specifically, in a “shared data” sub-embodiment of the invention, the data and NN owners agree on some setup compatibility information (known as transformation setup data, in some embodiment) that includes, for example, dimensionality data (see, for example, the transformation setup data discussed below). The data owner then creates a “data owner private transformation key” configured to transform data from the true space to the transformed space. The data owner private transformation key is kept confidential by the data owner and is not shared with the NN owner. The data owner then transforms their data using the data owner private transformation key and sends the transformed data to the NN owner, along with a shared transformation key required for the NN owner to transform their private NN from the true space to the transformed space. An activation function and a transformation operator required for the NN owner to carry out NN operations in the transformed space are also sent to the NN owner, as discussed herein. In some embodiments, a transformed activation function is shared as floating point coefficients of a series expansion computation, where the transformed activation function is able to act on affine transformations of the hidden layer inputs and the floating point coefficients are computed using the data owner private transformation key. The NN owner then transforms the NN (i.e., the NN weights and biases) using the setup information and the shared transformation key received from the data owner. The NN owner then carries out the NN operation in the transformed space using the transformed data and the transformed NN.

In the case of an evaluation, a training, or a fine-tuning operation, the NN owner propagates the transformed data through the transformed NN. In the case of an evaluation, a forward propagation is carried out, and the NN owner obtains transformed output data in the transformed space. Importantly, since the NN owner does not have access to the data owner private transformation key, the NN owner cannot access the transformed data received from the data owner or the transformed output obtained from the forward propagation operation in the transformed space. Hence, the NN owner sends the transformed output data to the data owner. The data owner may now use its data owner private transformation key to reverse the transformation it originally carried out on its untransformed data. This reversal from the transformed space to the true space is called a “de-transformation”, and yields an untransformed output from the NN operation.

In the case of a training or fine-tuning operation, a backpropagation is carried out, whereby the transformed data received from the data owner is used to train the transformed NN. The methods detailed herein describe sub-embodiments where the data owner may prevent access to any data point in the training data. Ultimately, the NN owner ends up with a trained, transformed NN in the transformed space. Since the data owner's private transformation key is required to generate transformed inputs, transformed training data, and untransformed outputs, the NN owner has no ability to make use of the trained transformed NN for evaluation, training, fine-tuning, etc., except for the specific data owner involved. The NN owner can, however, de-transform the trained NN itself, to yield a trained untransformed NN, using the setup compatibility information and the shared transformation key sent by the data owner. Exemplary steps during the de-transform steps involve reverse order of transformation operations such as logarithms to reverse exponentiations, reversing row permutations or removing expansions that use an identity matrix. The trained untransformed NN can be used for a subsequent evaluation, training or fine-tuning etc. operation with a different data owner.

Remarkably, the shared transformation key sent to the NN owner is designed to enable the NN owner to transform and de-transform the private NN. However, it cannot be used to transform and de-transform the data owner's untransformed data, nor the transformed output of the transformed NN, without the data owner private transformation key. The shared transformation key only consists of random matrix terms that contribute to expansions of the transformed input data and the transformed hidden layer input data. The shared transformation key does not include the untransformed input data. Furthermore, the methods and systems described herein ensure that any data shared with the NN owner, such as the setup information and the shared transformation key, cannot be used by the NN owner to infer the data owner transformation key. The shared transformation key typically involves the product of two random matrices, that constitute two different private transformation keys known to the data owner and thus make it harder for NN owner to infer the data owner transformation keys.

These factors highlight how the various embodiments presented preserve data sovereignty while allowing for training machine learning and AI models.

Similarly, in a “shared NN” sub-embodiment of the invention, the data and NN owners agree on some setup information that includes, for example, dimensionality data (see, for example, the transformation setup data discussed below). The NN owner then creates a “NN owner private transformation key” configured to transform the private NN from the true space to the transformed space. The NN owner private transformation key is kept confidential by the NN owner and is not shared with the data owner.

The NN owner then transforms their NN using the NN owner private transformation key and sends the transformed NN (i.e., the transformed NN weights and biases) to the data owner. An activation function and a transformation operator required for the data owner to carry out NN operations in the transformed space are also sent to the data owner, as discussed herein. In some embodiments, a transformed activation function is shared as floating point coefficients of a series expansion computation, where the transformed activation function is able to act on affine transformations of the hidden layer inputs and the floating point coefficients are computed using the NN owner private transformation key. The data owner then transforms their data using the setup information received from the NN owner, to generate transformed data in the transformed space.

The data owner then carries out the NN operation in the transformed space using the transformed data and the transformed NN. In the case of an evaluation, a training, or a fine-tuning operation, the data owner propagates the transformed data through the transformed NN using the activation function and the transformation operator. In the case of an evaluation, a forward propagation is carried out, and the data owner obtains transformed output data in the transformed space.

Importantly, since the data owner does not have access to the NN owner private transformation key, the data owner cannot access the transformed NN received from the NN owner. Specifically, the data owner cannot access the original NN in its true space, nor can they access the transformed NN in a way that reveals the NN owner's model internals. Furthermore, since the data owner does not have access to the NN owner private transformation key, the data owner also cannot de-transform data, including the transformed output of the transformed NN.

The methods disclosed herein provide the data owner to lock the transformed output of the transformed NN in the transformed spec, in a way that enables the NN owner to de-transform it back to the true space while it is still locked. This renders the de-transformed output data, still locked in the true space, inaccessible to the NN owner. Once sent by the NN owner back to the data owner, the methods disclosed herein enable the latter to unlock the de-transformed output in the true space.

In the case of a training or fine-tuning operation, a backpropagation is carried out, whereby the transformed NN received from the NN owner is trained using the transformed data. The methods detailed herein describe sub-embodiments where the data owner may prevent any data point in the training data to be used to train the transformed NN. Ultimately, the data owner ends up with a trained, transformed NN in the transformed space. Such a trained NN may be returned to the NN owner for de-transformation to the true space.

Since the NN owner private transformation key is required to transform or de-transform the NN, the data owner has no ability to access the private NN parameters. The data owner can, however, through collaboration with the NN owner as described above, transform and de-transform input and output data.

Since the private key is required to access the untransformed NN or the untransformed outputs, the data owner has no ability, however, to access or use the private NN in the true space.

Remarkably, the information sent to the data owner is designed to enable the data owner to transform and de-transform data. However, it cannot be used to transform and de-transform the NN, without the NN owner private transformation key. Furthermore, the methods and systems described herein ensure that any data shared with the data owner, such as the setup information, cannot be used by the data owner to infer the NN owner transformation key.

Most operations described herein are represented as matrix operations. As discussed below, specific choices of matrix groups may improve computational efficiency.

### SUMMARY OF VARIOUS ASPECTS OF THE INVENTION

Various methods, processes, and non-transitory storage media storing program code for a privacy-preserving process for utilizing a neural network (NN) between a data owner having private untransformed data and a NN owner having a private NN are all within the scope of the present invention.

### Method Aspect: Shared Data—Data Owner

A first aspect, or one embodiment of the present invention, is a computer-implemented method for neural network (NN) propagation, through a NN owned by a NN owner, of confidential data owned by a data owner.

The method may include generating a data owner private transformation key, where the data owner private transformation key is kept confidential by the data owner. The method may also include transforming the confidential data from a true space into transformed data in a transformed space using the data owner private transformation key. The method may also include generating a shared transformation key, where the shared transformation key is necessary for the NN owner to propagate the transformed data through a transformed NN in the transformed space. Finally, The method may also include transmitting, to the NN owner, the transformed data and the shared transformation key.

In some embodiments, the confidential data may include input data for forward propagation through the NN. The method may also include receiving, from the NN owner, a transformed output in the transformed space, where the transformed output was generated by forward-propagating the input data through the transformed NN. The method may also include de-transforming the transformed output using the data owner private transformation key, to generate de-transformed output data in the true space, where the de-transformed output data is equivalent to a true space output generated by forward-propagating the input data through the NN in the true space.

In some embodiments, the method may further include exchanging, with the NN owner, transformation setup data, where the transformation setup data is based at least on pre-agreed upon dimensionality data, where the transformation setup data provides information required for neural network operations in the transformed space, and where neural network operations performed in the transformed space are transformed operations that preserve corresponding neural network operations performed in the true space up to a predetermined error threshold.

In some embodiments, the method may further include sending, to the NN owner, a transformation operator based at least on the transformation setup data, where the transformation operator is configured to perform transformed NN operations in the transformed space.

In some embodiments, the method may further include exchanging, with the NN owner, an activation function, where the activation function is based at least on the transformation setup data, and where the activation function is required to perform transformed NN operations in the transformed space.

In some embodiments, the transformation setup data may include a class of cost functions required to perform transformed NN operations in the transformed space, and the method may further include generating a cost function based on the class of cost functions of the transformation setup data.

In some embodiments, the method may further include initiating a secure connection between the data owner and the NN owner.

### Method Aspect: Shared Data—NN Owner

A second aspect, or another embodiment of the present invention, is a computer-implemented method for neural network (NN) propagation, through a NN owned by a NN owner, of confidential data owned by a data owner.

The method may include receiving, from the data owner, transformed data in a transformed space, where the transformed data corresponds to the confidential data in a true space. The method may also include receiving, from the data owner, a shared transformation key necessary for the NN owner to propagate the transformed data through a transformed NN in the transformed space. The method may also include transforming a true NN from a true space into the transformed NN in the transformed space using information within the shared transformation key. Finally, the method may also include propagating the transformed data through the transformed NN in the transformed space, where the NN owner cannot access a transformed output in the transformed space generated by propagating the transformed data through the transformed NN.

In some embodiments, the confidential data may include true input data for forward propagation through the NN, the transformed data may include transformed input data, and propagating the transformed data through the transformed NN may include forward-propagating the transformed input data through the transformed NN to generate the transformed output in the transformed space. The method may further include sending, to the data owner, the transformed output in the transformed space.

In some embodiments, the confidential data may include true training data and true target data for training the NN, the transformed data may include transformed training data and transformed target data for training the transformed NN, and propagating the transformed data through the transformed NN may include backpropagating one or more data points of the transformed training data and the transformed target data through the transformed NN in the transformed space, to generate one or more transformed error gradients in the transformed space. The method may further include training the NN using the one or more transformed error gradients in the transformed space to generate a transformed trained NN. Finally, the method may further include de-transforming the transformed NN by reversing the transforming of the true NN using information within the shared transformation key received from the data owner, to generate a trained NN in the true space.

Features described with respect to the first aspect apply equally to the second aspect.

### Method Aspect: Shared NN—Data Owner

A third aspect, or another embodiment of the present invention, is a computer-implemented method for neural network (NN) propagation, through a NN owned by a NN owner, of confidential data owned by a data owner.

The method may include receiving, from the NN owner, a transformed NN in a transformed space, where the transformed NN corresponds to a true NN in a true space. The method may also include transforming the confidential data from a true space into transformed data in the transformed space. Finally, the method may also include propagating the transformed data through the transformed NN in the transformed space, where the data owner cannot access a transformed output in the transformed space generated by propagating the transformed data through the transformed NN.

In some embodiments, the confidential data may include true input data for forward propagation through the NN, the transformed data may include transformed input data, and propagating the transformed data through the transformed NN may include forward-propagating the transformed input data through the transformed NN to generate the transformed output in the transformed space. The method may further include generating a data owner private output transformation key, where the data owner private output transformation key is kept confidential by the data owner. The method may also include locking, using the data owner private output transformation key, the transformed output, to generate a locked transformed output, where a de-transformation of the locked transformed output from the transformed space to the true space preserves the locking in the true space and does not prevent a subsequent unlocking in the true space. The method may also include transmitting, to the NN owner, the locked transformed output. The method may also include receiving, from the NN owner, a locked de-transformed output. Finally, the method may also include unlocking the locked de-transformed output, using the data owner private output transformation key, to generate a de-transformed output data, where the de-transformed output data is equivalent to a true space output generated by forward-propagating the true input data through the NN in the true space.

In some embodiments, the confidential data may include true training data and true target data for training the NN, the transformed data may include transformed training data and transformed target data for training the transformed NN, and propagating the transformed data through the transformed NN may include backpropagating one or more data points of the transformed training data and the transformed target data through the transformed NN in the transformed space, to generate one or more transformed error gradients in the transformed space. The method may further include training the transformed NN using the one or more transformed error gradients in the transformed space to generate a trained transformed NN, where the data owner cannot de-transform the transformed NN or access a transformed output of the trained transformed NN in the transformed space without a NN owner private transformation key. Finally, the method may further include transmitting the trained transformed NN to the NN owner.

Features described with respect to the previously presented aspects apply equally to the third aspect.

### Method Aspect: Shared NN—NN Owner

A fourth aspect, or another embodiment of the present invention, is a computer-implemented method for neural network (NN) propagation, through a NN owned by a NN owner, of confidential data owned by a data owner. The method may include generating a NN owner private transformation key, where the NN owner private transformation key is kept confidential by the NN owner. The method may also include transforming a true NN from a true space, using the NN owner private transformation key, to generate a transformed NN in a transformed space. Finally, the method may also include transmitting, to the data owner, the transformed NN.

In some embodiments, the confidential data may include true input data for forward propagation through the NN. The method may further include receiving, from the data owner, a locked transformed output of the transformed NN in the transformed space. The method may also include de-transforming, using the NN owner private transformation key, the locked transformed output, to generate a locked de-transformed output in the true space, where the NN owner cannot access the locked de-transformed output without a data owner private output transformation key. Finally, the method may also include transmitting, to the data owner, the locked de-transformed output.

In some embodiments, the confidential data may include true training data and true target data for training the NN, and the true training data and true target data were transformed by the data owner, to generate transformed training data and transformed target data. The method may further include receiving, from the data owner, a trained transformed NN, where the trained transformed NN was trained by the data owner in the transformed space using the transformed training data and transformed target data, and where the NN owner has no access to the transformed training data and the transformed target data used for training the trained transformed NN. Finally, the method may also include de-transforming the trained transformed NN using the NN owner private transformation key, to generate a trained NN in the true space.

Features described with respect to the previously presented aspects apply equally to the fourth aspect.

### Storage Media Aspect: Shared Data—Data Owner

A fifth aspect, or another embodiment of the present invention, is one or more non-transitory physical storage media storing program code. The program code may be executable by a hardware processor. The hardware processor when executing the program code may cause the hardware processor to execute a computer-implemented privacy-preserving process for utilizing a neural network (NN) between a data owner having untransformed data and a NN owner having a private NN.

The program code may include code to initiate a secure connection between the data owner and the NN owner. The program code may also include code to exchange, with the NN owner, transformation compatibility data, where the transformation compatibility data is based at least on pre-agreed upon dimensionality data, where the transformation compatibility data provides information required for neural network operations in a transformed space, and where neural network operations performed in the transformed space are transformed operations that preserve corresponding neural network operations performed in an untransformed space up to a predetermined error threshold. The program code may also include code to exchange, with the NN owner, an activation function, where the activation function is based at least on the transformation compatibility data. The program code may also include code to generate a data owner private transformation key based at least on the transformation compatibility data, where the data owner private transformation key is configured to transform the untransformed data from the untransformed space into transformed data in the transformed space, and where the data owner private transformation key is kept confidential by the data owner. The program code may also include code to transform the untransformed data utilizing at least the data owner private transformation key to generate the transformed data in the transformed space. The program code may also include code to generate a shared transformation key, where the shared transformation key is necessary for the NN owner to propagate the transformed data through the transformed NN in the transformed space. Finally, the program code may also include code to send, to the NN owner, the transformed data and the shared transformation key necessary for the NN owner to propagate the transformed data through the transformed NN in the transformed space.

In some embodiments, the transformed data is generated using the transformation compatibility data and the data owner private transformation key.

In some embodiments, the shared transformation key may include shared hidden layer transformation data generated based at least on the transformation compatibility data and the data owner private transformation key.

In some embodiments, the data owner private transformation key may include a set of random matrices, and where at least one individual data entry within the set of random matrices is a non-zero entry generated by the data owner using a random number generator.

In some embodiments, the untransformed data is untransformed input data for forward propagation through the transformed NN, where the transformed data is transformed input data. The program code may further include code to receive, from the NN owner, transformed output data, where the transformed output data may include output from a transformed NN in the transformed space in response at least to the transformed input data. Finally, the program code may also include code to generate a de-transformed output in the untransformed space from the transformed output data by de-transforming the untransformed data using the data owner private transformation key.

In some embodiments, the program code may include code to send, to the NN owner, a transformation operator based at least on the transformation compatibility data, where the transformation operator is configured to perform transformed NN operations in the transformed space.

In some embodiments, the transformed NN may have been transformed using the transformation compatibility data, the activation function, the shared transformation key, and the transformation operator.

In some embodiments, the activation function is a transformed activation function. The program code may further include code to generate the transformed activation function from an untransformed activation function through a series expansion using the transformation compatibility data and the data owner private transformation key.

In some embodiments, the transformation compatibility data may include one or more multivariate terms within the transformed activation function to define a transformation of the untransformed activation function.

In some embodiments, a noise component is embedded within the transformed activation function by adding it to the untransformed activation function prior to the series expansion.

In some embodiments, the noise component is a bounded differentiable noise function.

In some embodiments, the transformation compatibility data may include at least dimensions of the untransformed data, a location of a bias vector within the private NN, one or more dimensions of the private NN, a class of activation functions, and an error transformation key.

In some embodiments, transforming the untransformed data to generate the transformed data may include one or more of a matrix expansion, a matrix right-multiplication, and a matrix exponentiation.

In some embodiments, transforming the untransformed data to generate the transformed data may include expanding an untransformed data matrix using an expansion matrix associated with the data owner private transformation key to generate an expanded untransformed data matrix, right-multiplying the expanded untransformed data matrix using a multiplication matrix associated with the data owner private transformation key to generate a multiplied untransformed data matrix, and exponentiating the multiplied untransformed data matrix using an exponentiation matrix associated with the data owner private transformation key to generate a transformed data matrix.

In some embodiments, the exponentiating the multiplied untransformed data matrix uses an element-wise matrix exponentiation.

In some embodiments, the exponentiating the multiplied untransformed data matrix uses a row-column matrix-wise matrix exponentiation.

In some embodiments, the transformation compatibility data may include a class of cost functions.

In some embodiments, the program code may further include code to generate a cost function based on the class of cost functions of the transformation compatibility data.

In some embodiments, the untransformed data may include target data and a training data set, and the transformed data may include a transformed target data and a transformed training data set. The program code may further include code to transform the cost function through a series expansion using the transformation compatibility data and the data owner private transformation key. The program code may also include code to generate a transformed cost function. Finally, the program code may also include code to send, to the NN owner, the transformed cost function.

In some embodiments, the program code may further include code to identify, through an exchange with the NN owner, at least one locked data point of the transformed target data and the transformed training data set. The program code may also include code to receive, from the NN owner, a locked gradient associated with the at least one locked data point. The program code may also include code to generate a partially unlocked gradient from the locked gradient, using at least the data owner private transformation key. Finally, program code may also include code to send, to the NN owner, the partially unlocked gradient to enable the unlocking of the gradient associated with the at least one locked data point for backpropagation.

Features described with respect to the previously presented aspects apply equally to the fifth aspect.

### Storage Media Aspect: Shared NN—NN Owner

A sixth aspect, or another embodiment of the present invention, is one or more non-transitory physical storage media storing program code. The program code may be executable by a hardware processor. The hardware processor when executing the program code may cause the hardware processor to execute a computer-implemented privacy-preserving process for utilizing a neural network (NN) between a data owner having untransformed data and a NN owner having a private NN.

The program code may include code to initiate a secure connection between the data owner and the NN owner. The program code may also include code to exchange, with the data owner, transformation compatibility data, where the transformation compatibility data is based at least on pre-agreed upon dimensionality data, where the transformation compatibility data provides information required for neural network operations in a transformed space, and where neural network operations performed in the transformed space are transformed operations that preserve corresponding neural network operations performed in an untransformed space up to a predetermined error threshold. The program code may also include code to exchange, with the data owner, an activation function, where the activation function is based at least on the transformation compatibility data. The program code may also include code to receive, from the data owner, transformed data and a shared transformation key necessary for the NN owner to propagate the transformed data through a transformed NN in the transformed space. Finally, the program code may also include code to transform the private NN using the transformation compatibility data to generate a transformed NN.

In some embodiments, the program code may include code to receive, from the data owner, a transformation operator based at least on the transformation compatibility data, where the transformation operator is configured to perform transformed NN operations in the transformed space.

In some embodiments, the transformed NN may have been transformed using the transformation compatibility data, the activation function, the shared transformation key, and the transformation operator.

In some embodiments, the activation function is a transformed activation function generated from an untransformed activation function through a series expansion using the transformation compatibility data and a private transformation key generated by the data owner.

In some embodiments, the transformation compatibility data may include one or more multivariate terms within the transformed activation function to define a transformation of the untransformed activation function.

In some embodiments, the transformed data is transformed input data for forward propagation through the transformed NN. The program code may further include code to generate transformed output data from the transformed input data using the transformed NN, the shared transformation key and the transformation operator, where the transformed output data may include output from a transformed NN in the transformed space in response at least to the transformed input data. Finally, the program code may also include code to send, to the data owner, the transformed output data.

In some embodiments, the transformation compatibility data may include at least dimensions of the untransformed data, a location of a bias vector within the private NN, one or more dimensions of the private NN, a class of activation functions, and an error transformation key.

In some embodiments, the program code may further include code to verify, upon receiving the transformation compatibility data and the transformation operator, that the transformation operator is consistent with the dimensions of the untransformed data included within the transformation compatibility data.

In some embodiments, transforming the private NN may include generating an expanded weights and biases matrix through a matrix expansion, where the matrix expansion may include expanding an untransformed weights and biases matrix associated with the private NN using the dimensions of the untransformed data from the transformation compatibility data.

In some embodiments, transforming the private NN may further include generating transformed weights and biases through a matrix permutation and a matrix multiplication of the expanded weights and biases matrix, where the matrix permutation may include a rearrangement of rows of a matrix according to a specific permutation sequence, and where the matrix multiplication is one of term-wise multiplication and row-column matrix multiplication.

In some embodiments, the transformed data may include transformed target data and a transformed training data set. The program code may further include code to receive, from the data owner, a transformed cost function required to train the transformed NN in the transformed space.

In some embodiments, the program code may further include code to perform backpropagation through the transformed NN using a plurality of data points of the transformed target data and the transformed training data set, the transformed cost function, the shared transformation key, and the transformation operator, to generate a plurality of error terms in the transformed space corresponding to the plurality of data points. The program code may also include code to generate a plurality of unlocked gradients using the plurality of error terms, where the plurality of unlocked gradients are unlocked based on a generation of a private transformation key by the data owner. The program code may also include code to update the transformed weights and biases using the plurality of unlocked gradients. Finally, the program code may also include code to generate a trained transformed NN using the updated transformed weights and biases.

In some embodiments, the program code may further include code to identify, through an exchange with the data owner, at least one locked data point of the transformed target data and the transformed training data set. The program code may also include code to perform backpropagation through the transformed NN using the at least one locked data point, the transformed cost function, the shared transformation key, and the transformation operator, to generate at least one error term corresponding to the at least one locked data point in the transformed space. The program code may also include code to generate at least one locked gradient based on the at least one error term, where the at least one locked gradient is locked based on a generation of a private transformation key by the data owner. The program code may also include code to send, to the data owner, the at least one locked gradient associated with the at least one locked data point. The program code may also include code to receive, from the data owner, at least one partially unlocked gradient associated with the at least one locked data point. The program code may also include code to generate at least one unlocked gradient from the at least one locked gradient using at least the error transformation key. The program code may also include code to update the transformed weights and biases using the at least one unlocked gradient. Finally, the program code may also include code to generate a trained transformed NN using the updated transformed weights and biases.

In some embodiments, the transformed NN may be generated by the NN owner within a NN agent exclave accessible from a data owner's network, where the NN agent exclave is a secure data storage configured to host the transformed NN and accessible on a permissioned-basis for data exchange.

In some embodiments, the program code to transform the private NN may include program code to securely transmit session-specific configuration information of the transformed NN to the NN agent exclave using a dedicated secure connection.

In some embodiments, the session-specific configuration information of the transformed NN may include one of a NN model architecture, a NN hyperparameter, and a NN data schema.

In some embodiments, the program code may include code to generate a de-transformed weights and biases matrix by reversing the matrix expansion, the matrix permutation, and/or a matrix exponentiation performed during the transforming of the private NN, and using at least the transformation compatibility data. Finally, the program code may also include code to generate a de-transformed trained NN in the untransformed space based on the de-transformed weights and biases matrix.

In some embodiments, the program code may include code to initiate a new secure connection between a new data owner and the NN owner. The program code may also include code to receive, from the new data owner, new transformation compatibility data, where the new transformation compatibility data provides information required for neural network operations in a new transformed space. The program code may also include code to receive, from the new data owner, a new activation function, where the new activation function is based at least on the new transformation compatibility data. The program code may also include code to receive, from the new data owner, new transformed data and a new shared transformation key necessary for the NN owner to propagate the new transformed data through a new transformed trained NN in the new transformed space. Finally, the program code may also include code to transform the de-transformed trained NN from the untransformed space to the new transformed space using the new transformation compatibility data to generate the new transformed trained NN.

Features described with respect to the previously presented aspects apply equally to the sixth aspect.

### Storage Media Aspect: Shared NN—NN Owner

A seventh aspect, or another embodiment of the present invention, is one or more non-transitory physical storage media storing program code. The program code may be executable by a hardware processor. The hardware processor when executing the program code may cause the hardware processor to execute a computer-implemented privacy-preserving process for utilizing a neural network (NN) between a data owner having untransformed data and a NN owner having a private NN.

The program code may include code to initiate a secure connection between the NN owner and the data owner. The program code may also include code to exchange, with the data owner, transformation compatibility data, where the transformation compatibility data is based at least on pre-agreed upon dimensionality data, where the transformation compatibility data provides information required for neural network operations in a transformed space, and where neural network operations performed in the transformed space are transformed operations that preserve corresponding neural network operations performed in an untransformed space up to a predetermined error threshold. The program code may also include code to exchange, with the data owner, an activation function, where the activation function is based at least on the transformation compatibility data. The program code may also include code to generate a NN owner private transformation key based at least on the transformation compatibility data, where the NN owner private transformation key is configured to transform the untransformed NN from the untransformed space into a transformed NN in the transformed space, and where the NN owner private transformation key is kept confidential by the NN owner. The program code may also include code to transform the private NN utilizing the transformation compatibility data and the NN owner private transformation key to generate the transformed NN in the transformed space. Finally, the program code may also include code to send, to the data owner, the transformed NN.

In some embodiments, the NN owner private transformation key may include a set of random matrices, where at least one individual data entry within the set of random matrices is a non-zero entry generated by the data owner using a random number generator.

In some embodiments, the activation function may be a transformed activation function. The program code may further include code to generate the transformed activation function from an untransformed activation function through a series expansion using the transformation compatibility data and the NN owner private transformation key.

In some embodiments, the transformed NN may include transformed weights and biases generated through one or more transformation steps using the transformation compatibility data, where the one or more transformation steps include one of a matrix expansion, a matrix multiplication, and a matrix exponentiation.

In some embodiments, the program code may include code to send, to the data owner, a transformation operator based at least on the transformation compatibility data, where the transformation operator is configured to perform transformed NN operations in the transformed space.

Features described with respect to the previously presented aspects apply equally to the seventh aspect.

### Storage Media Aspect: Shared NN—Data Owner

An eighth aspect, or another embodiment of the present invention, is one or more non-transitory physical storage media storing program code. The program code may be executable by a hardware processor. The hardware processor when executing the program code may cause the hardware processor to execute a computer-implemented privacy-preserving process for utilizing a neural network (NN) between a data owner having untransformed data and a NN owner having a private NN.

The program code may include code to initiate a secure connection between the data owner and the NN owner. The program code may also include code to exchange, with the NN owner, transformation compatibility data, where the transformation compatibility data is based at least on pre-agreed upon dimensionality data, where the transformation compatibility data provides information required for neural network operations in a transformed space, and where neural network operations performed in the transformed space are transformed operations that preserve corresponding neural network operations performed in an untransformed space up to a predetermined error threshold. The program code may also include code to exchange, with the NN owner, an activation function, where the activation function is based at least on the transformation compatibility data. Finally, the program code may also include code to receive, from the NN owner, a transformed NN, where the transformed NN was generated in the transformed space by transforming the private NN from the untransformed space using the transformation compatibility data and a NN owner private transformation key generated by the NN owner.

In some embodiments, the activation function is a transformed activation function generated by the NN owner.

In some embodiments, the program code may include code to receive, from the NN owner, a transformation operator based at least on the transformation compatibility data, where the transformation operator is configured to perform transformed NN operations in the transformed space.

In some embodiments, the untransformed data is untransformed input data for forward propagation through the transformed NN. The program code may further include code to transform the untransformed input data by applying a set of matrix operations using the transformation compatibility data, to generate transformed input data in the transformed space. The program code may also include code to generate transformed output data from the transformed input data using the transformed NN, the activation function, and the transformation operator, where the transformed output data may include output from the transformed NN in the transformed space in response at least to the transformed input data. The program code may also include code to generate locked transformed output data from the transformed output data using a private output transformation key. The program code may also include code to send the locked transformed output data to the NN owner. The program code may also include code to receive, from the NN owner, locked untransformed output data, where the locked untransformed output data was generated by the NN owner from the locked transformed output data by reversing the transforming of the untransformed input data using the NN owner private transformation key. Finally, the program code may also include code to generate untransformed output data in the untransformed space from the locked untransformed output data using the private output transformation key.

In some embodiments, the set of matrix operations may include generating an expanded untransformed input data matrix through a matrix expansion, where the matrix expansion may include expanding an untransformed input data matrix using one or more dimensions of the private NN from the transformation compatibility data.

In some embodiments, the set of matrix operations may further include generating the transformed output data through a matrix permutation and a matrix multiplication of the expanded untransformed input data matrix, where a matrix permutation may include a rearrangement of columns of a matrix according to a specific permutation sequence, and where a matrix multiplication generates a product matrix, a product vector, or a product scalar, by multiplying elements of a first matrix with elements of a second matrix in a specific pattern.

Features described with respect to the previously presented aspects apply equally to the eighth aspect.

### Other Aspects of the Invention

In another aspect or embodiment of the present invention, a non-transitory, computer-readable storage medium is provided, the non-transitory, computer-readable storage medium storing executable instructions which when executed by a processor, causes the processor to perform a process for utilizing a neural network (NN) between a data owner having private untransformed data and a NN owner having a private NN in a privacy-preserving manner, including the aforementioned steps.

In yet another aspect or embodiment of the present invention, a computer program product is provided. The computer program may be used for a privacy-preserving process for utilizing a neural network (NN) between a data owner having private untransformed data and a NN owner having a private NN, and may include a computer-readable storage medium having program instructions, or program code, embodied therewith, the program instructions executable by a processor to cause the processor to perform the aforementioned steps.

In yet another aspect or embodiment of the present invention, a system for utilizing a neural network (NN) between a data owner having private untransformed data and a NN owner having a private NN in a privacy-preserving manner is provided, the system including a memory that stores computer-executable components, and a hardware processor, operably coupled to the memory, and that executes the computer-executable components stored in the memory, where the computer-executable components may include components communicatively coupled with the processor that execute the aforementioned steps.

In yet another aspect or embodiment of the present invention, a system for utilizing a neural network (NN) between a data owner having private untransformed data and a NN owner having a private NN in a privacy-preserving manner is provided, the system including a user device having a processor, a display, a first memory; a server including a second memory and a data repository; a communications link between said user device and said server; and a plurality of computer codes embodied on said first and second memory of said user device and said server, said plurality of computer codes which when executed causes said server and said user device to execute a process including the steps described herein.

In yet another aspect or embodiment of the present invention, a computerized server is provided, including at least one processor, memory, and a plurality of computer codes embodied on said memory, said plurality of computer codes which when executed causes said processor to execute a process including the steps described herein. Other aspects and embodiments of the present invention include the methods, processes, and algorithms including the steps described herein, and also include the processes and modes of operation of the systems and servers described herein.

In yet another aspect or embodiment of the present invention, an edge computerized system is provided, the edge computerized system running on a physical system or physical twin with either access to, or dedicated, processing, memory, computer code stored on a non-transitory computer-readable storage medium of the physical system or physical twin, and a plurality of sensor data being measured on said physical system or physical twin, the computer code causing the processor to perform the aforementioned steps.

Features which are described in the context of separate aspects and/or embodiments of the invention may be used together and/or be interchangeable wherever possible. Similarly, where features are, for brevity, described in the context of a single embodiment, those features may also be provided separately or in any suitable sub-combination. Features described in connection with the non-transitory physical storage medium or media may have corresponding features definable and/or combinable with respect to the system and/or method and/or computer product, or vice versa, and these embodiments are specifically envisaged.

Yet other aspects and embodiments of the present invention will become apparent from the detailed description of the invention when read in conjunction with the attached drawings.

### BRIEF DESCRIPTION OF THE DRAWINGS

The accompanying drawings, which are incorporated in and constitute part of this specification, illustrate embodiments of the invention and together with the description, serve to explain the principles of the disclosed embodiments. For clarity, simplicity, and flexibility, not all elements, components, or specifications are defined in all drawings. Not all drawings corresponding to specific steps or embodiments of the present invention are drawn to scale. Emphasis is instead placed on illustration of the nature, function, and product of the method and devices described herein.

Embodiments of the present invention described herein are exemplary, and not restrictive. Embodiments will now be described, by way of examples, with reference to the accompanying drawings, in which:

### Overview: Embodiments of the Invention

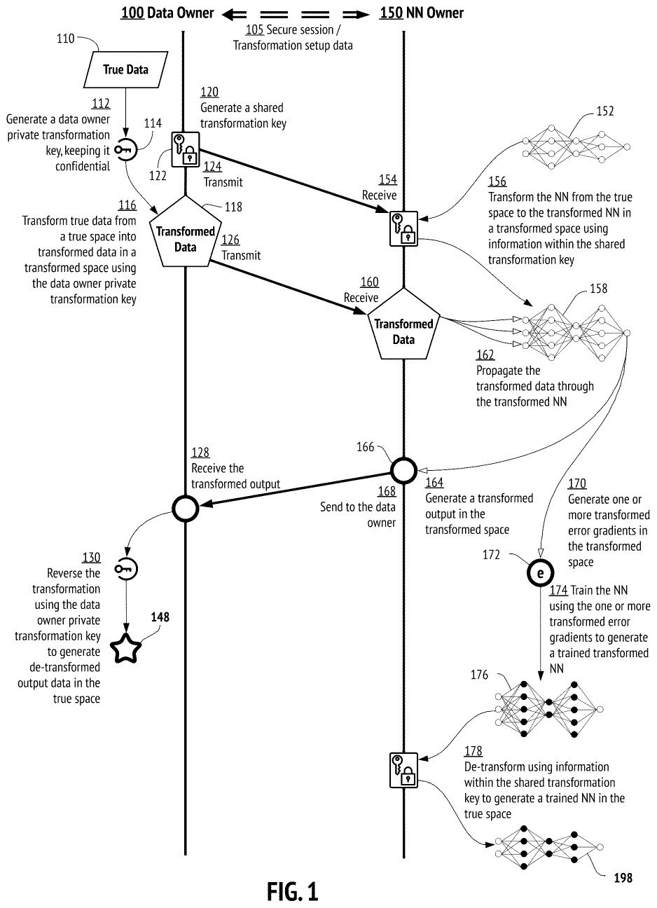

FIG. 1 illustrates a data sovereignty assurance process in a shared data scenario, in accordance with some embodiments of the present invention.

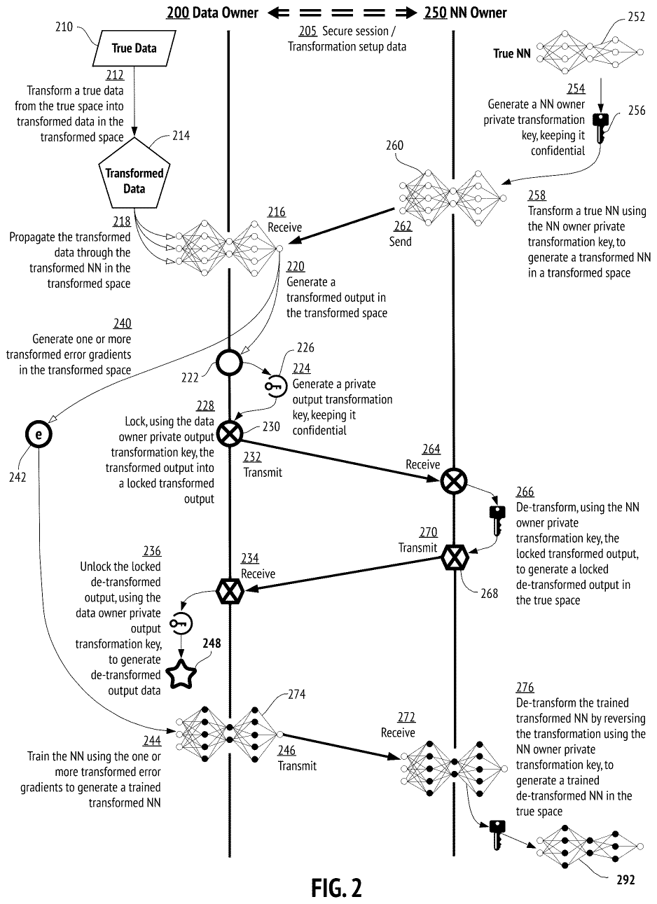

FIG. 2 further illustrates a data sovereignty assurance process in a shared neural network (NN) scenario, in accordance with some embodiments of the present invention.

### Introduction to the Interconnected Digital Model Platform (IDMP)

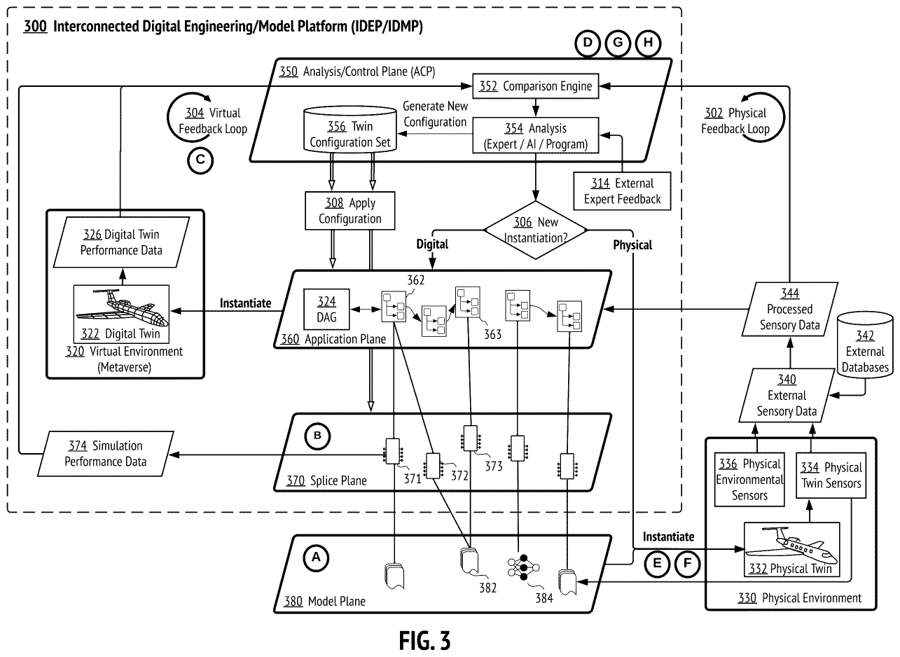

FIG. 3 shows an exemplary interconnected digital model platform (IDMP) architecture, in accordance with some embodiments of the present invention.

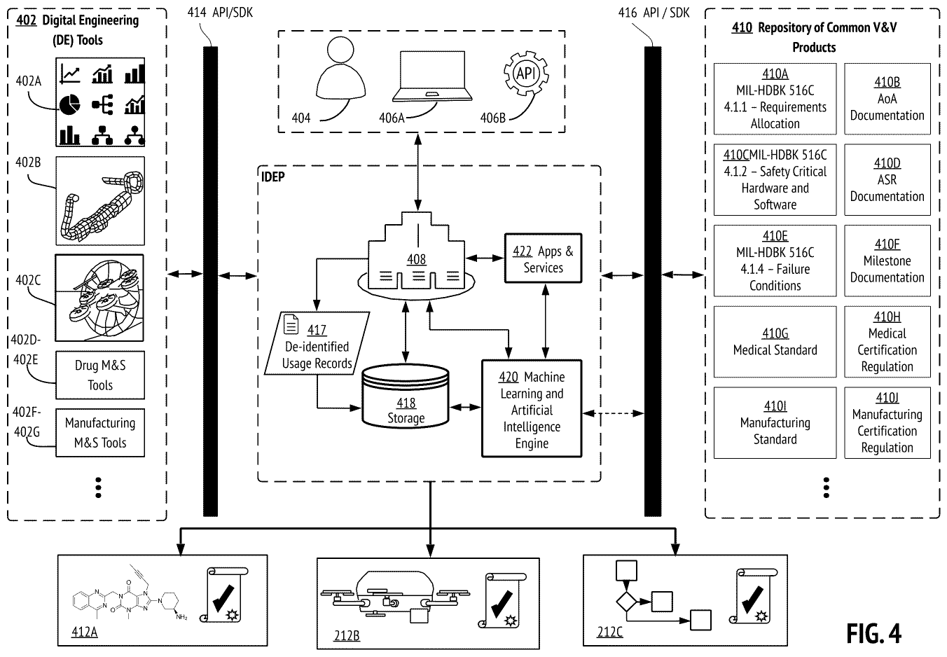

FIG. 4 shows an exemplary implementation of an IDEP as an interconnected digital engineering (DE) and certification ecosystem, and exemplary digitally certified products, in accordance with some embodiments of the present invention.

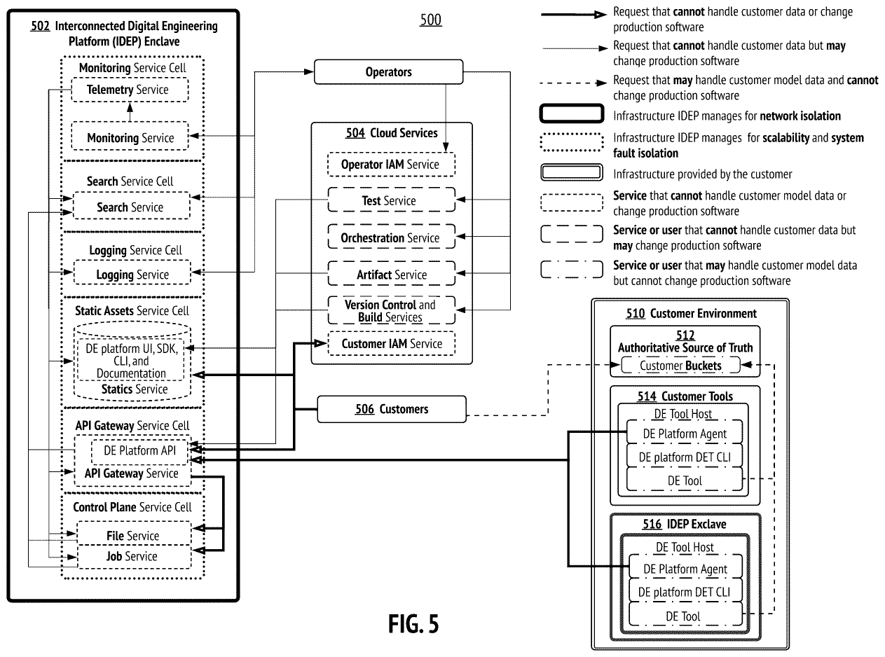

FIG. 5 shows another exemplary implementation of the IDEP illustrating its offered services and features, in accordance with some embodiments of the present invention.

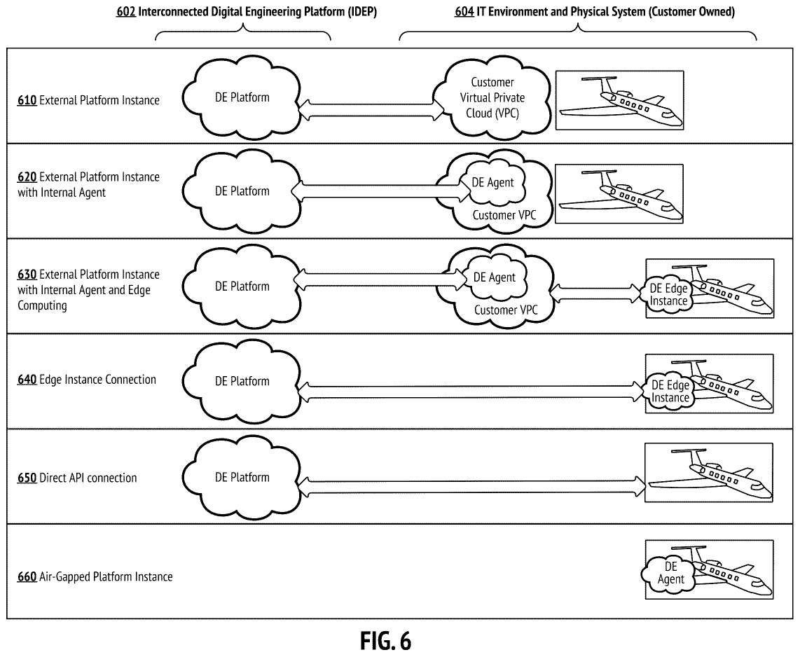

FIG. 6 shows potential scenarios for instantiating an IDEP in connection to a customer's physical system and IT environment, in accordance with some embodiments of the present invention.

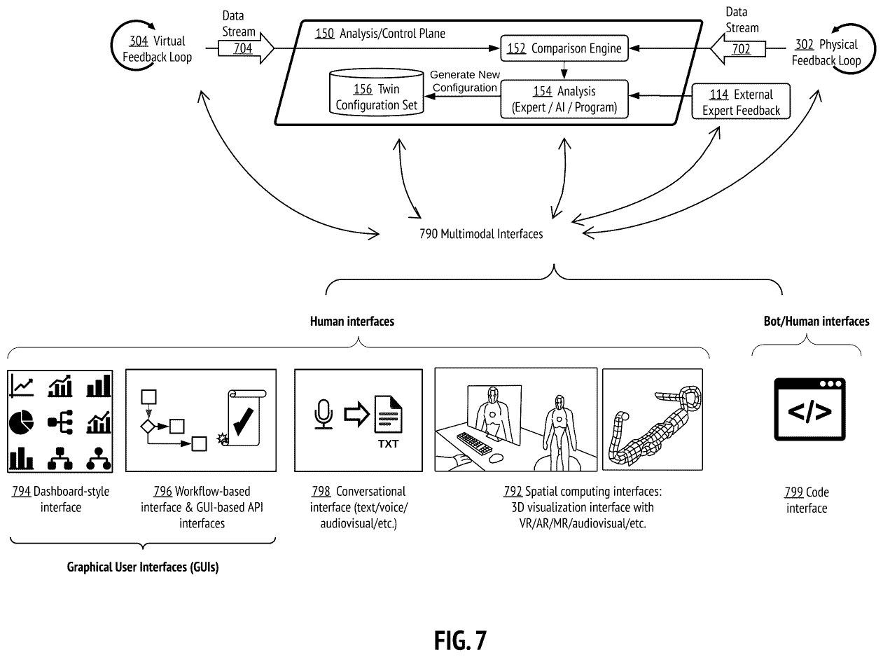

FIG. 7 shows exemplary multimodal interface designs for integration of feedback in am IDEP, in accordance with some embodiments of the present invention.

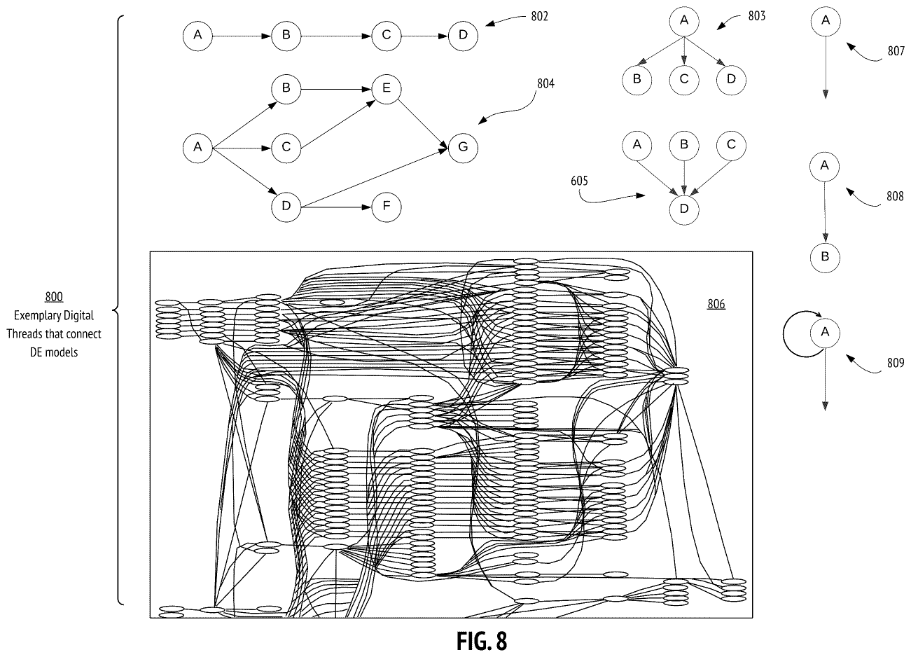

FIG. 8 is a schematic diagram comparing exemplary digital threads that connect DE models, in accordance with some embodiments of the present invention.

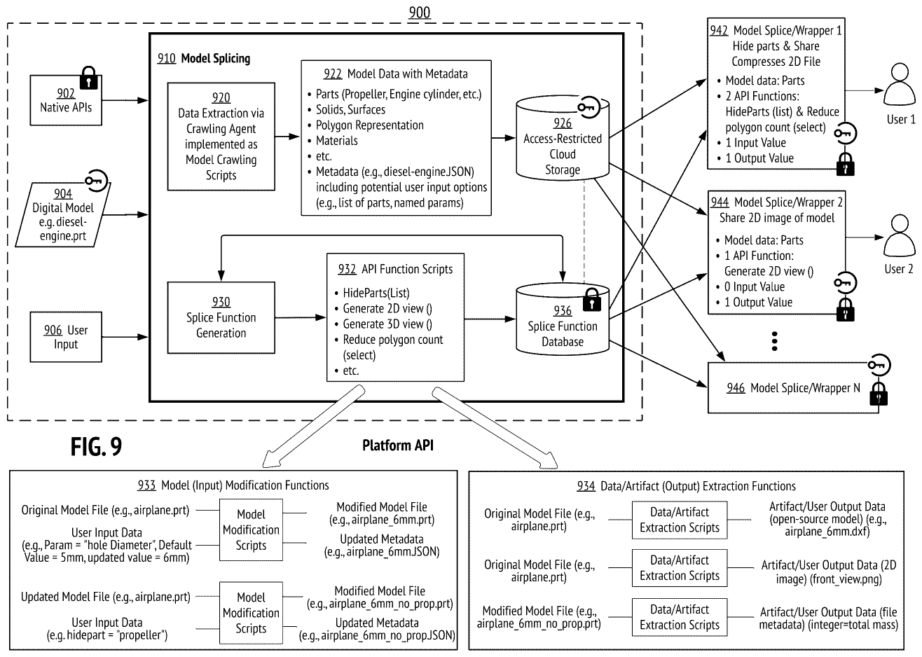

FIG. 9 is a schematic showing an exemplary DE model splicing setup, in accordance with some embodiments of the present invention.

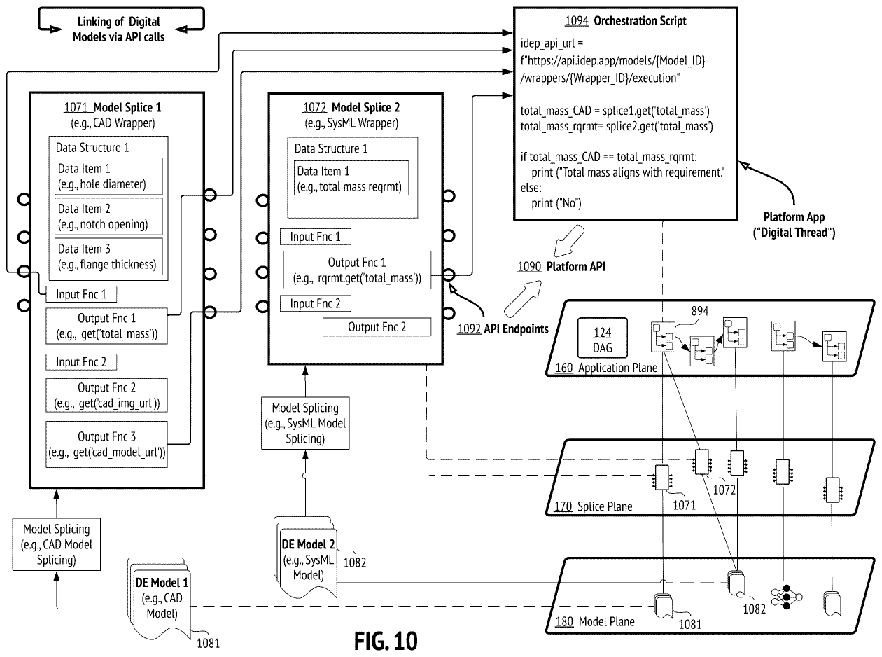

FIG. 10 is a schematic showing digital threading of DE models via model splicing, in accordance with some embodiments of the present invention.

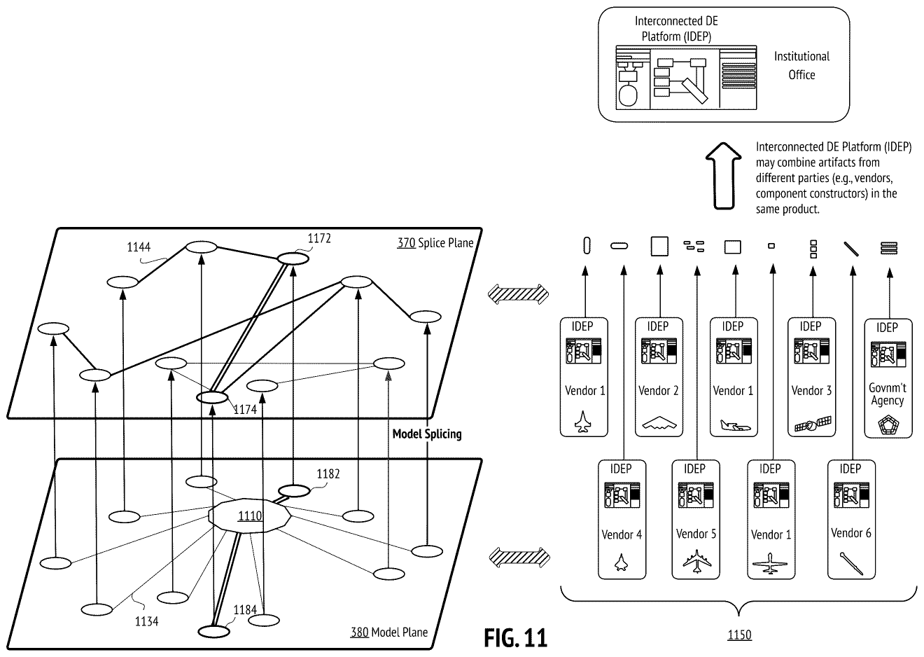

FIG. 11 is a schematic illustrating the linking of DE model splices in a splice plane and comparing digital threading with and without model splicing, in accordance with some embodiments of the present invention.

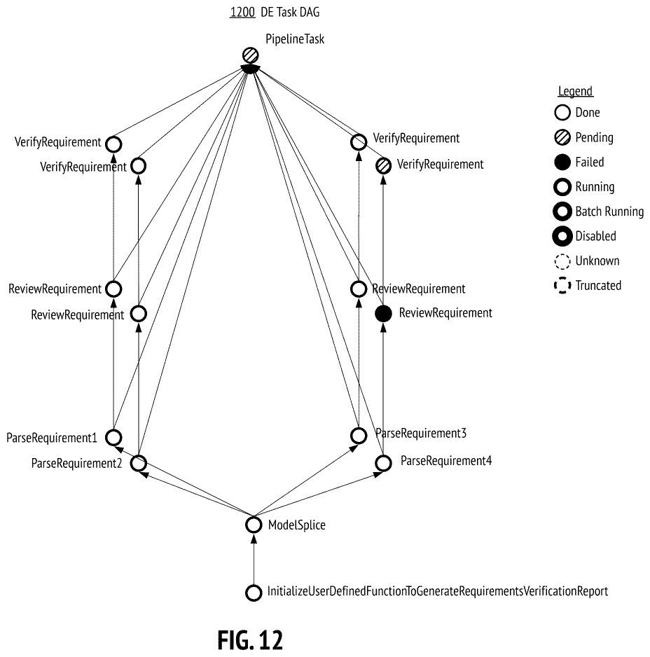

FIG. 12 shows an exemplary directed acyclic graph (DAG) representation of pipelined DE tasks related to digital threads, in accordance with some embodiments of the present invention.

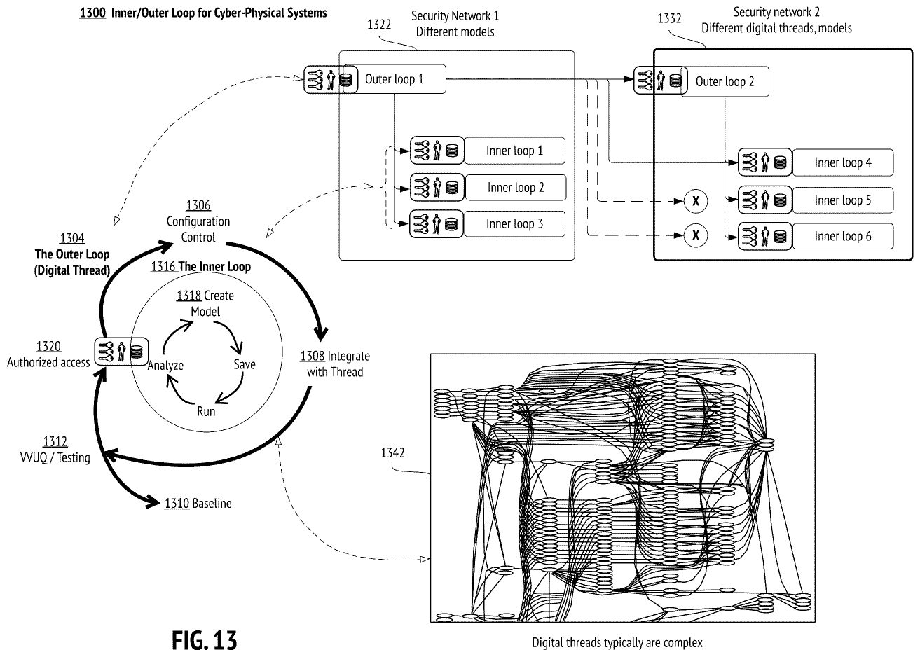

FIG. 13 is an exemplary schematic illustrating the interplay between a digital thread and the individual models or artifacts it uses, defining outer and inner loop processes, in accordance with some embodiments of the present invention.

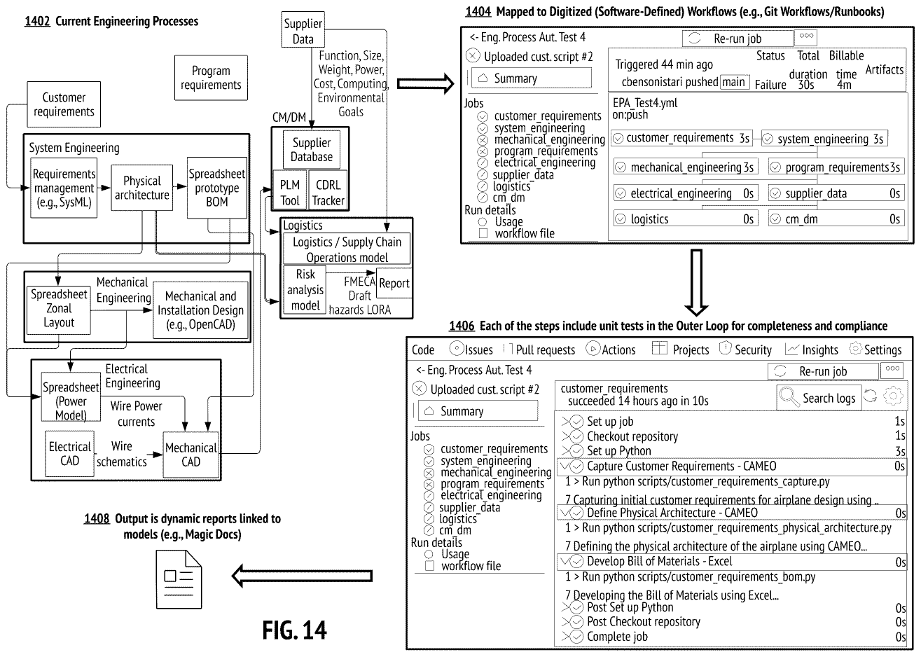

FIG. 14 illustrates an exemplary digital engineering process in the aerospace industry, showing outer loop processes, in accordance with some embodiments of the present invention.

### Introduction to Neural Networks and their Training

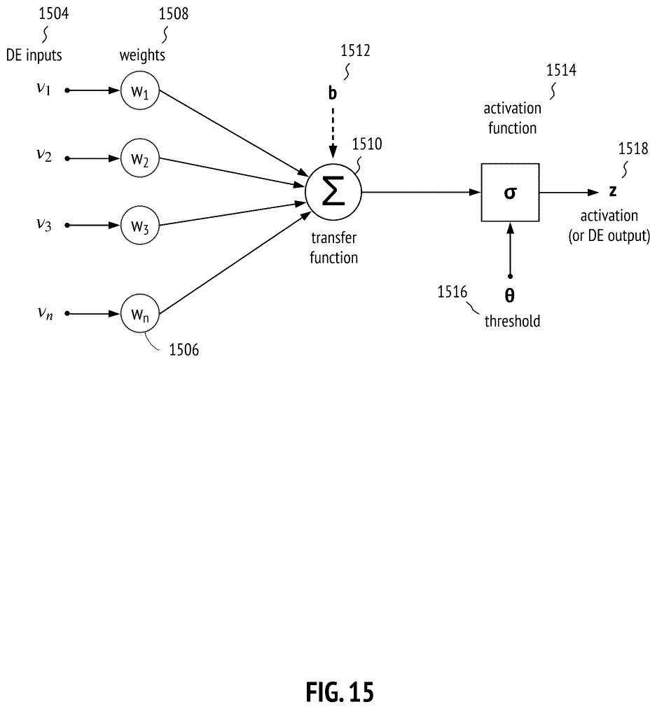

FIG. 15 describes neural network operation fundamentals, in accordance with some embodiments of the present invention.

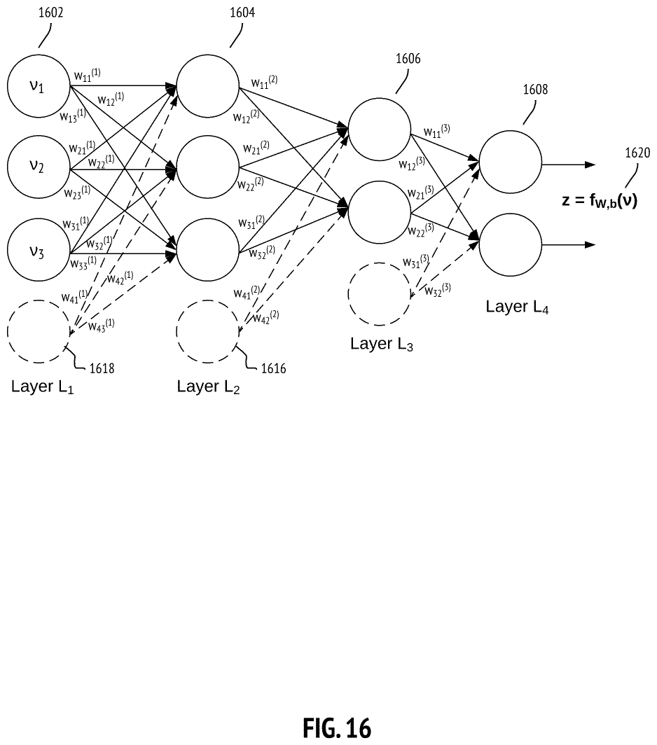

FIG. 16 shows a multi-layer neural network, in accordance with some embodiments of the present invention.

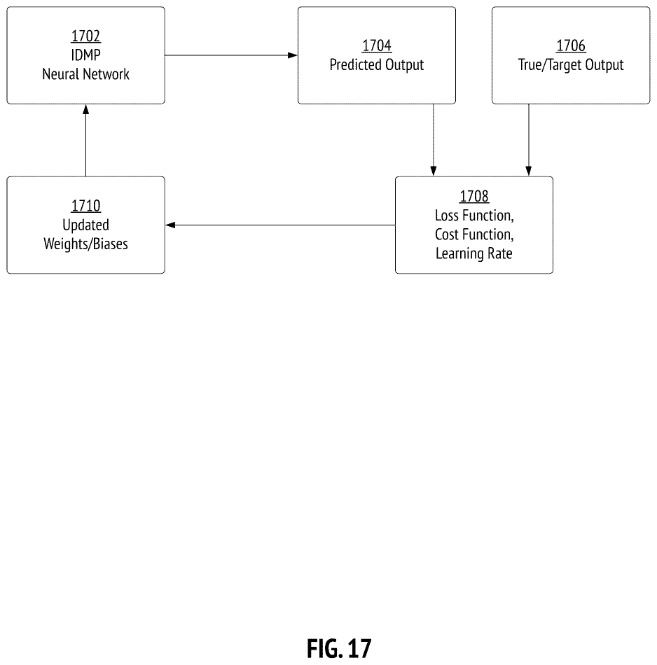

FIG. 17 shows an overview of an IDMP neural network training process, in accordance with some embodiments of the present invention.

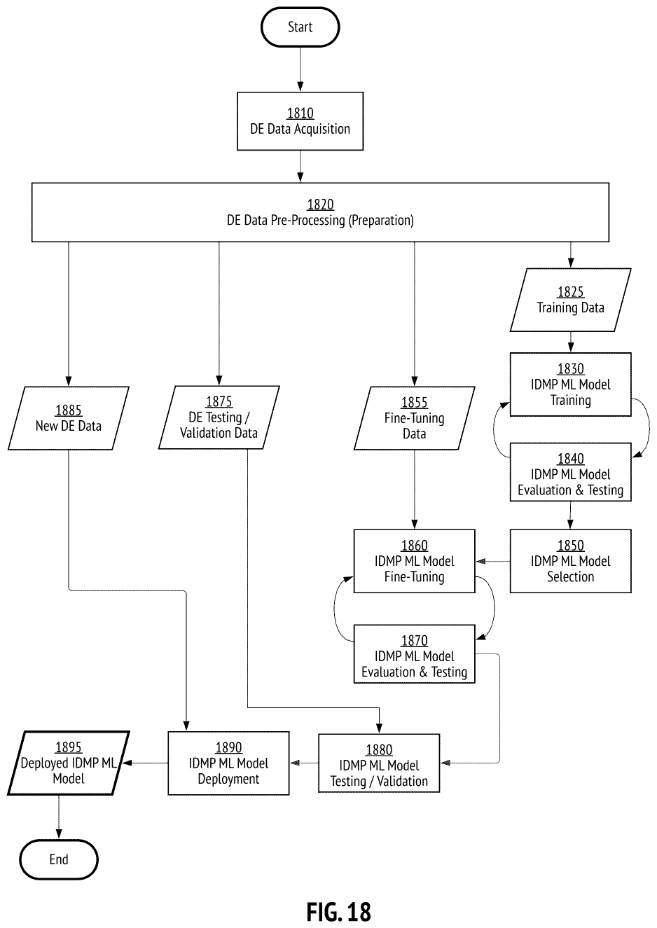

FIG. 18 is an illustrative flow diagram showing the different phases and datasets involved in training an IDMP machine learning model, in accordance with some embodiments of the present invention.

### Data Sovereignty Assurance for AI Models

### Summary of Data Sovereignty Methods Used in Embodiments 1 and 2

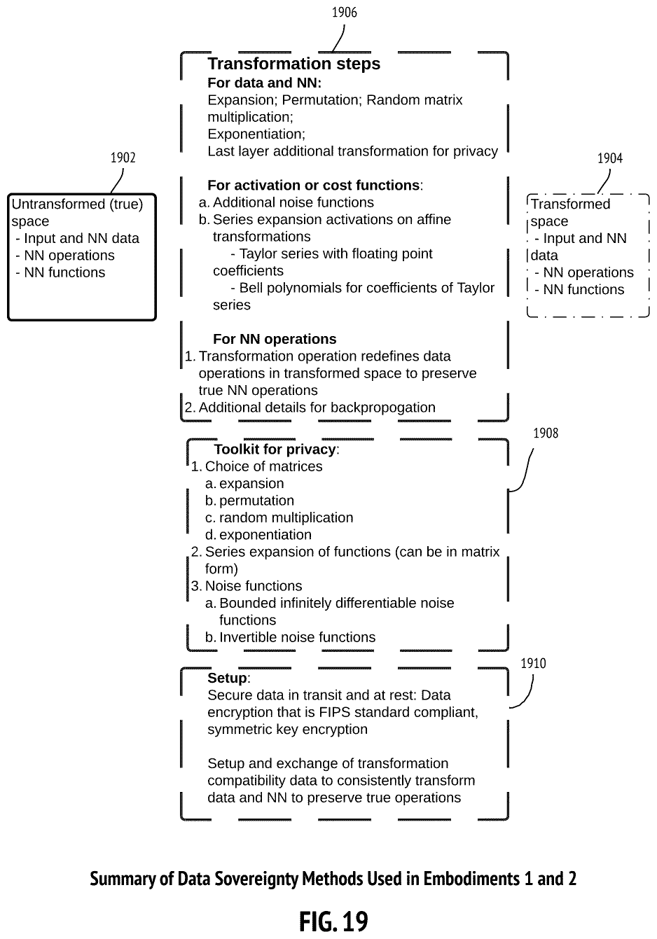

FIG. 19 shows a summary of various data sovereignty assurance methods used in various embodiments of the present invention.

### Embodiment 1: Matrix-Only Operations

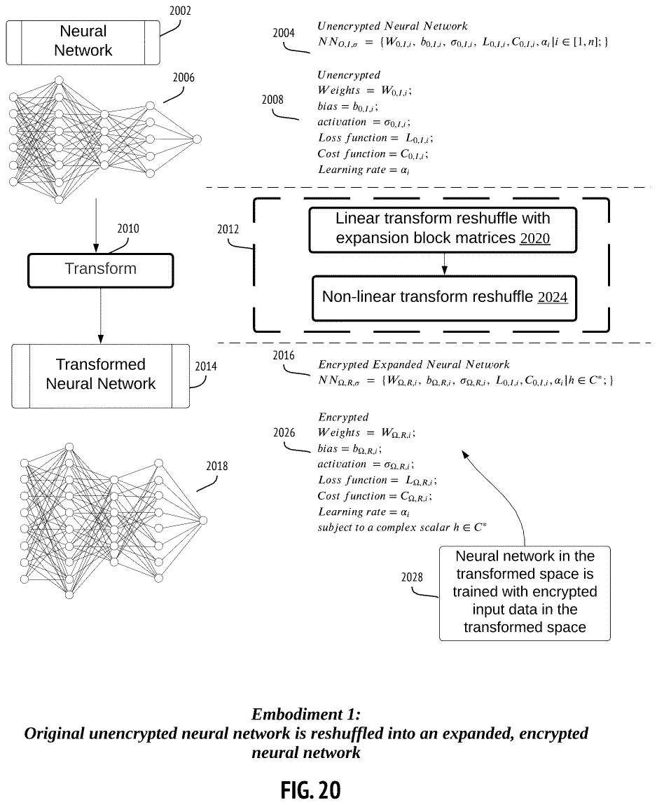

FIG. 20 shows an overview of the reshuffle process using a data-sovereignty enabled neural network, according to an embodiment of the present invention.

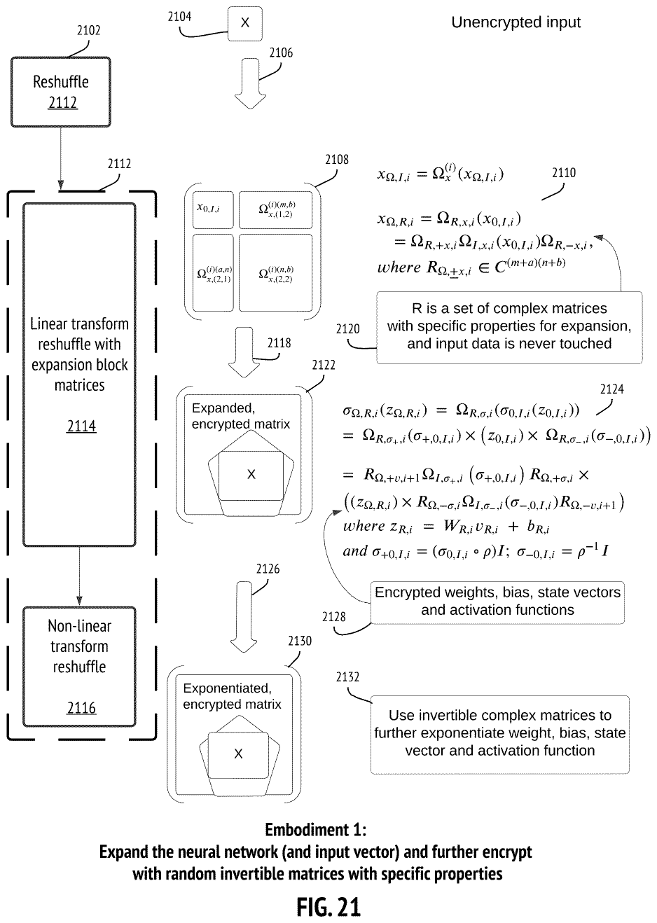

FIG. 21 shows an overview of the reshuffle process using a data-sovereignty enabled neural network, according to embodiments of the present invention.

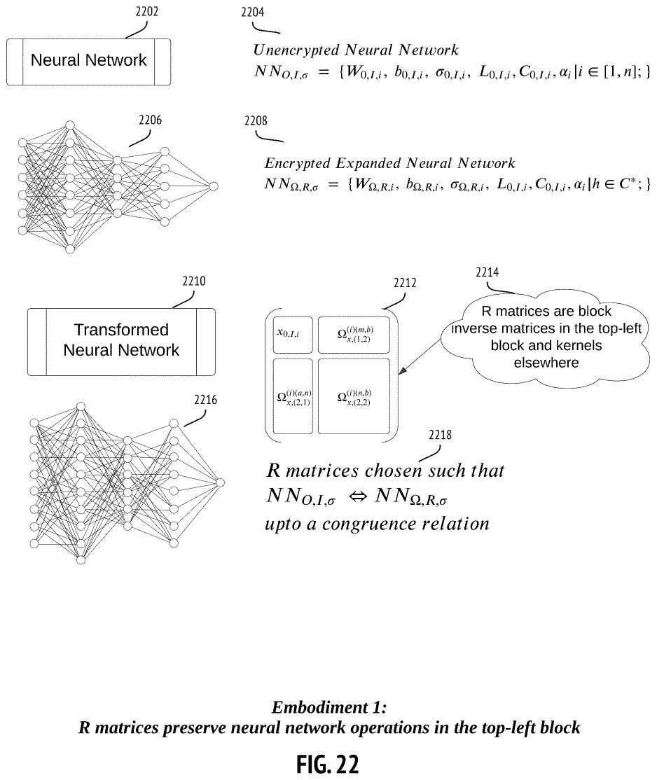

FIG. 22 shows the selection of block matrices for the reshuffle process using a data-sovereignty enabled neural network, according to an embodiment of the present invention.

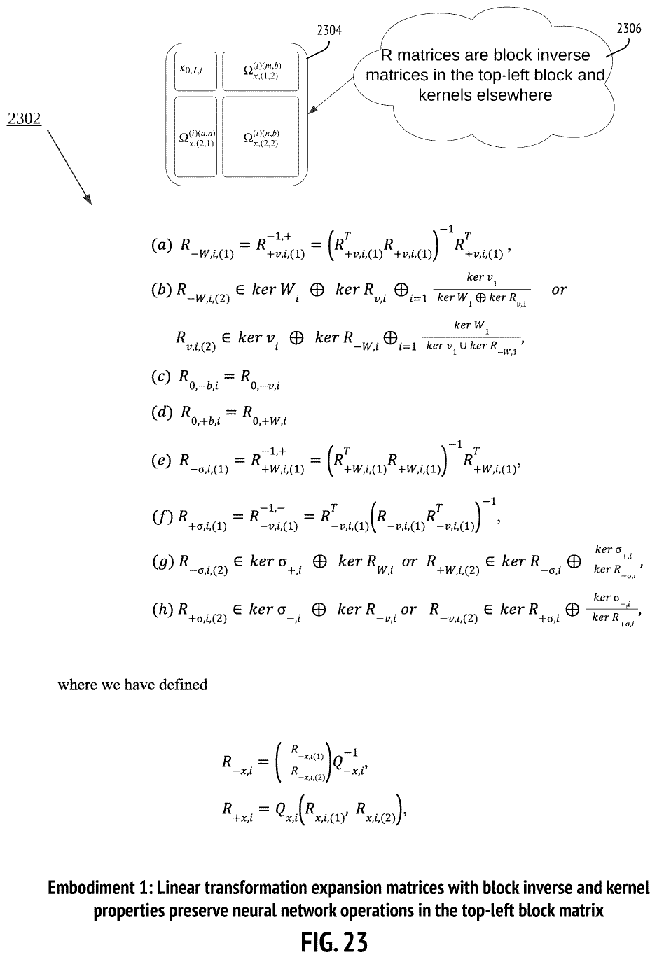

FIG. 23 shows the properties of block matrices for the reshuffle process using a data-sovereignty enabled neural network, according to embodiments of the present invention.

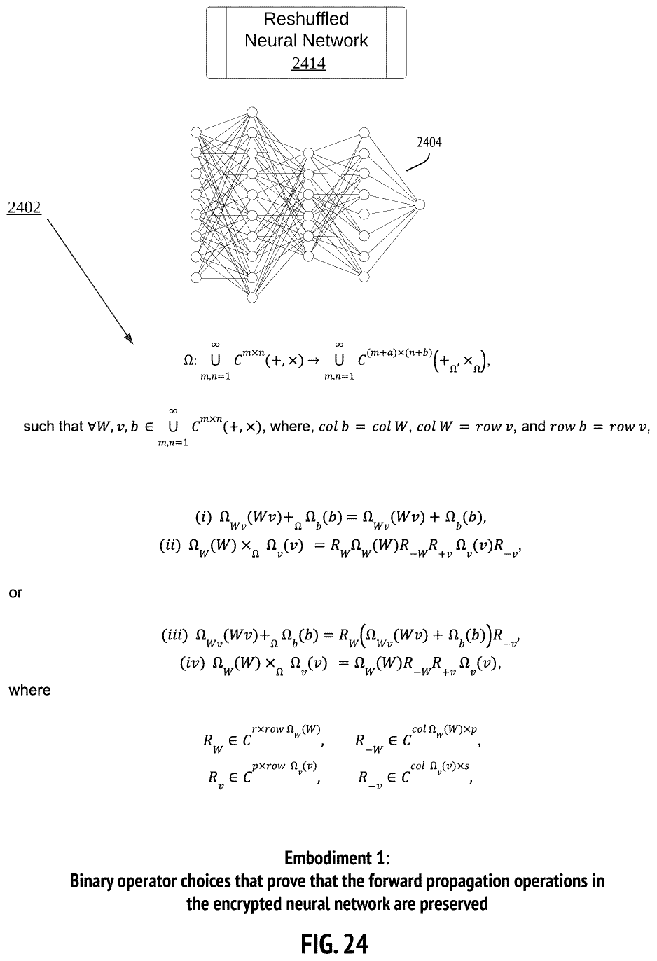

FIG. 24 shows an example binary operation demonstrating that a data-sovereignty enabled neural network preserves forward propagation, according to embodiments of the present invention.

### Embodiment 2: Matrix and Term-Wise Operations

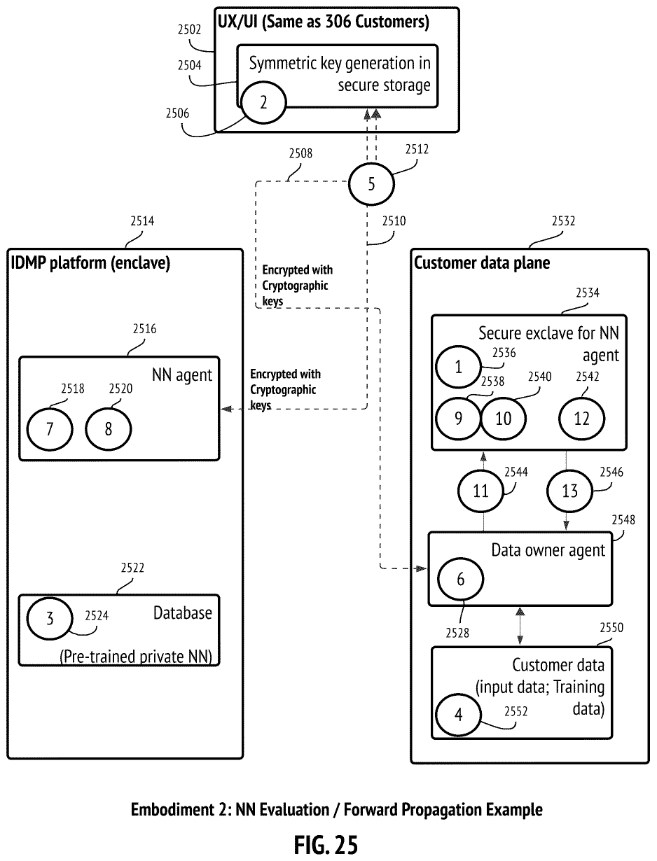

FIG. 25 shows the parties and steps involved in an exemplary forward propagation implementation, according to an embodiment of the present invention.

### Sub-Embodiment 2A: Shared Data

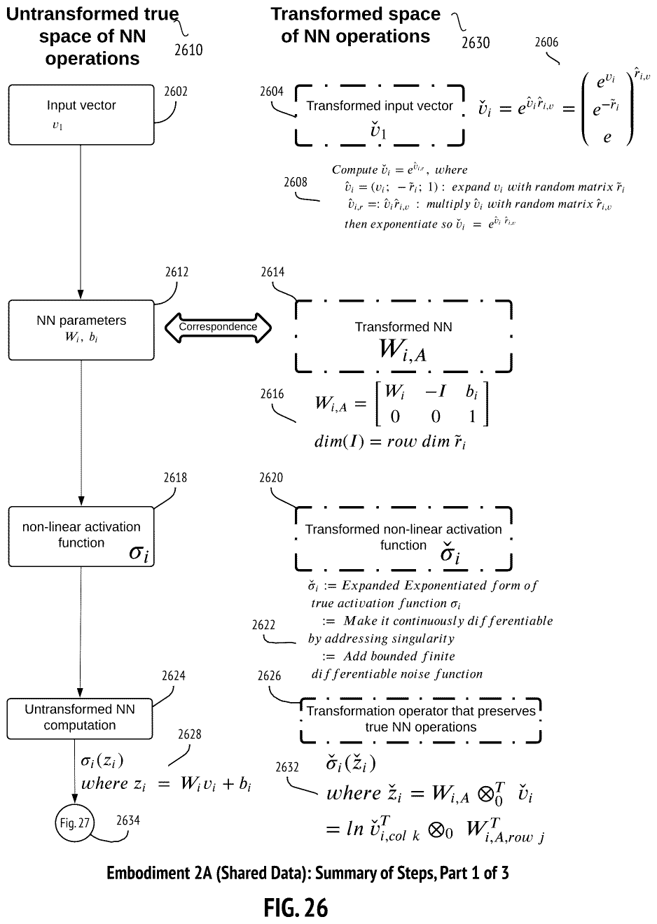

FIG. 26 shows some of the steps involved to maintain data sovereignty and privacy when the data owner uses their data as input, training, or context data for neural network computations, according to one embodiment of the present invention.

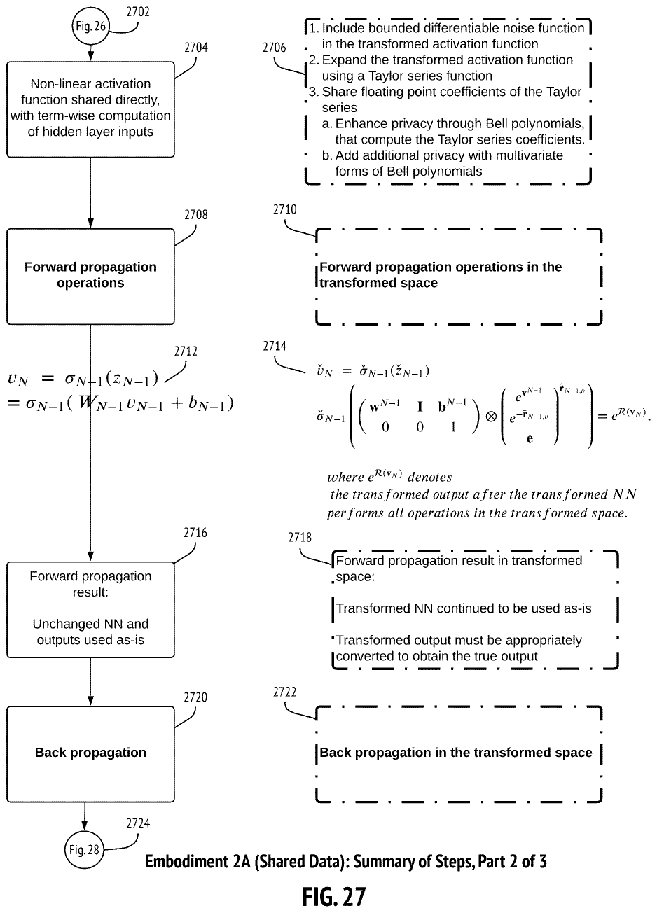

FIG. 27 shows additional steps involved to maintain data sovereignty and privacy when the data owner uses their data as input, training, or context data for neural network computations, according to one embodiment of the present invention.

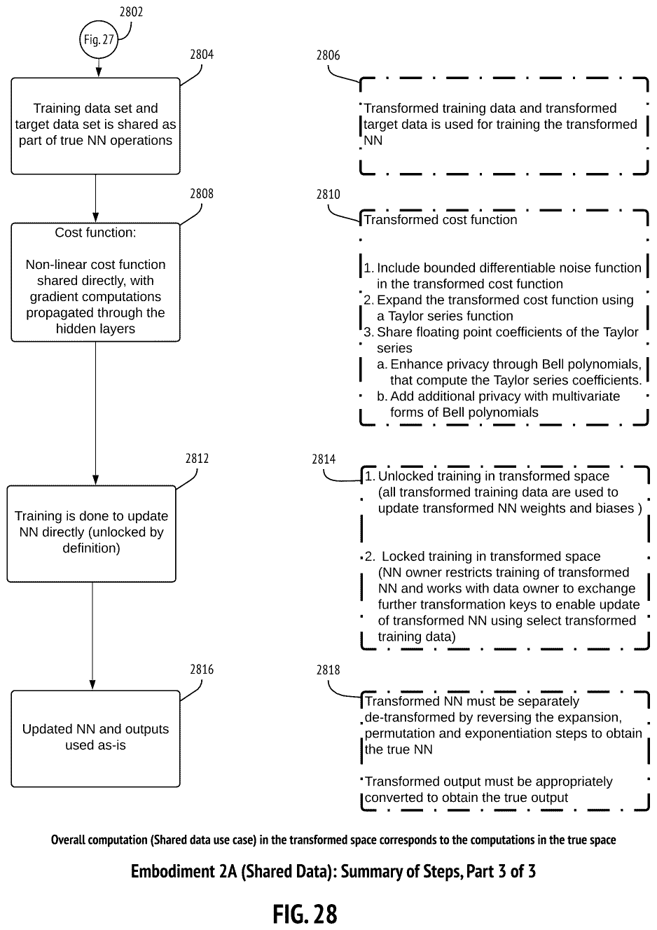

FIG. 28 shows additional steps involved to maintain data sovereignty and privacy when the data owner uses their data as input, training, or context data for neural network computations, according to one embodiment of the present invention.

### Sub-Embodiment 2B: Shared NN

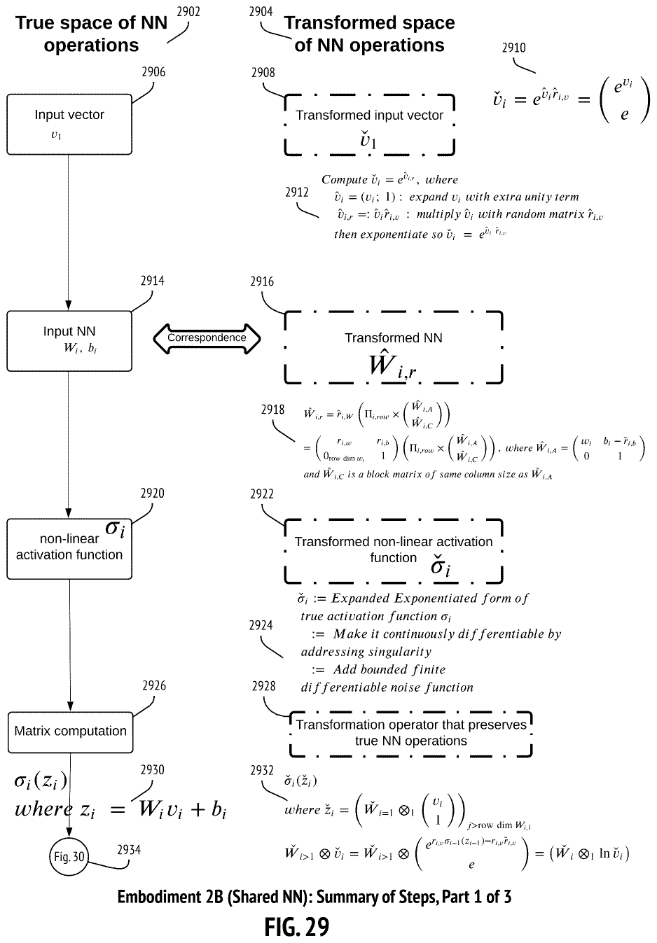

FIG. 29 shows some of the steps involved to maintain data sovereignty and privacy when the neural network model owner shares elements of their model, according to one embodiment of the present invention.

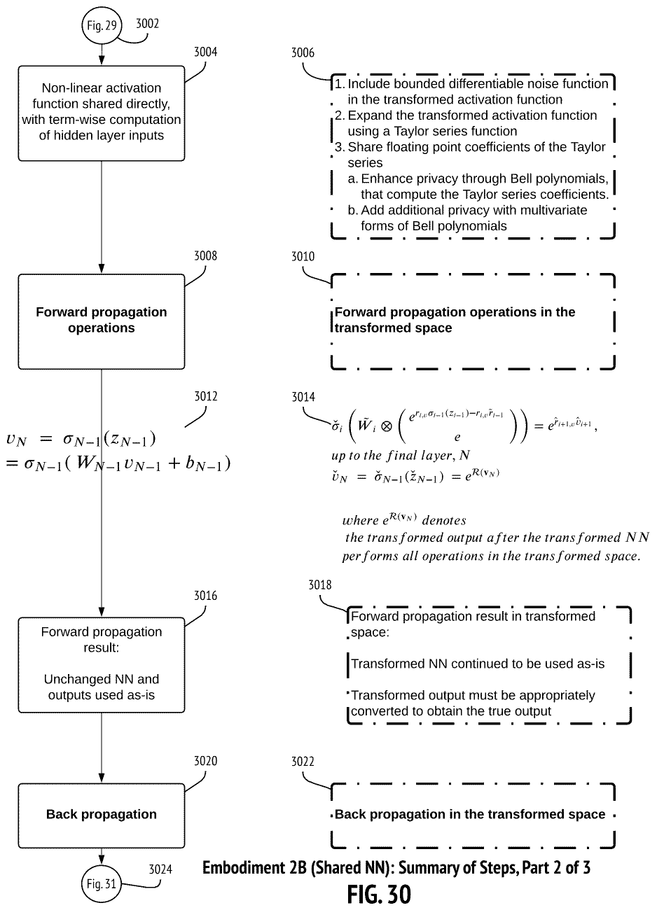

FIG. 30 shows additional steps involved to maintain data sovereignty and privacy when the neural network model owner shares elements of their model, according to one embodiment of the present invention.

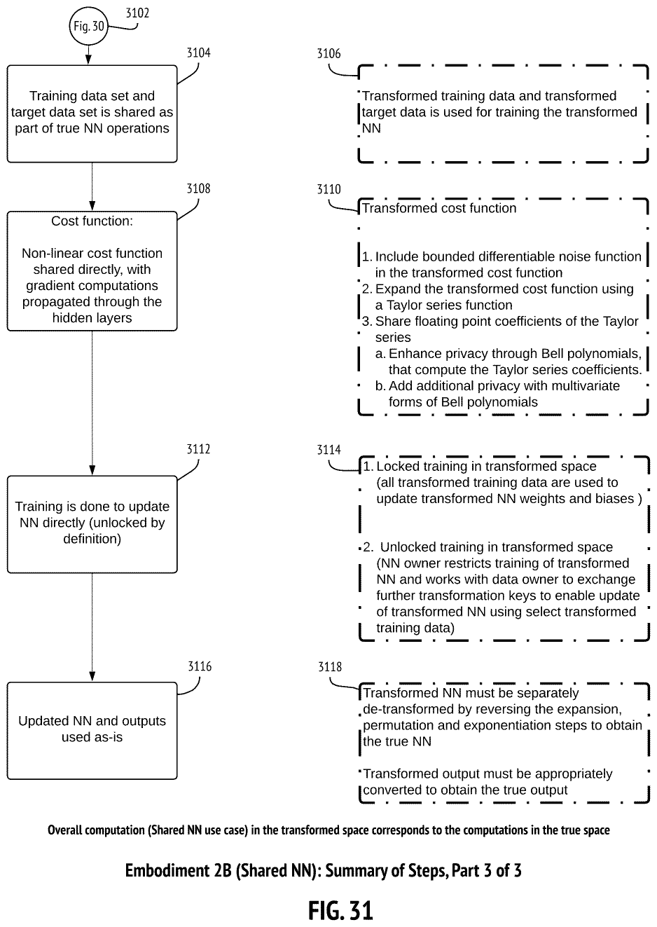

FIG. 31 shows additional steps involved to maintain data sovereignty and privacy when the neural network model owner shares elements of their model, according to one embodiment of the present invention.

### Embodiment 2: Adding Noise Components to Activation Functions

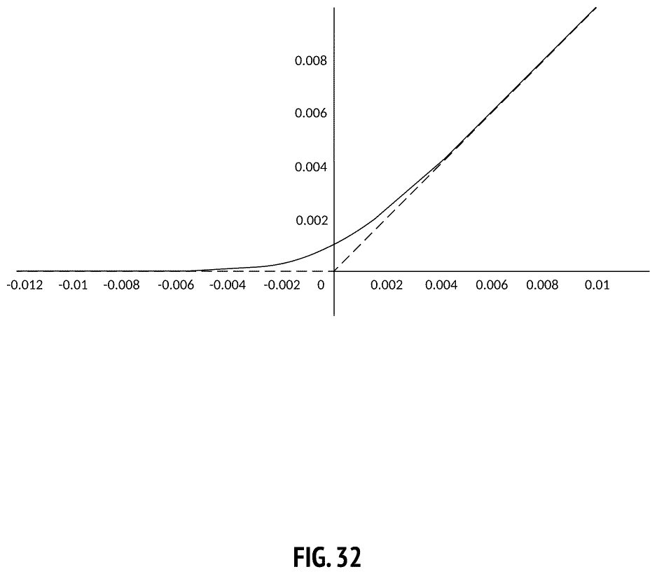

FIG. 32 illustrates an example of adding a variation to an activation function, according to one embodiment of the present invention.

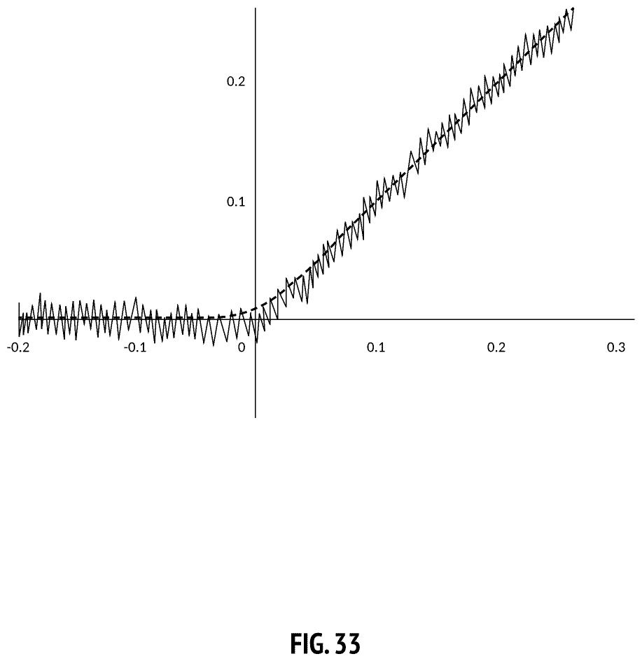

FIG. 33 illustrates an example of adding variation to an activation function, according to one embodiment of the present invention.

### Embodiment 2: Examples

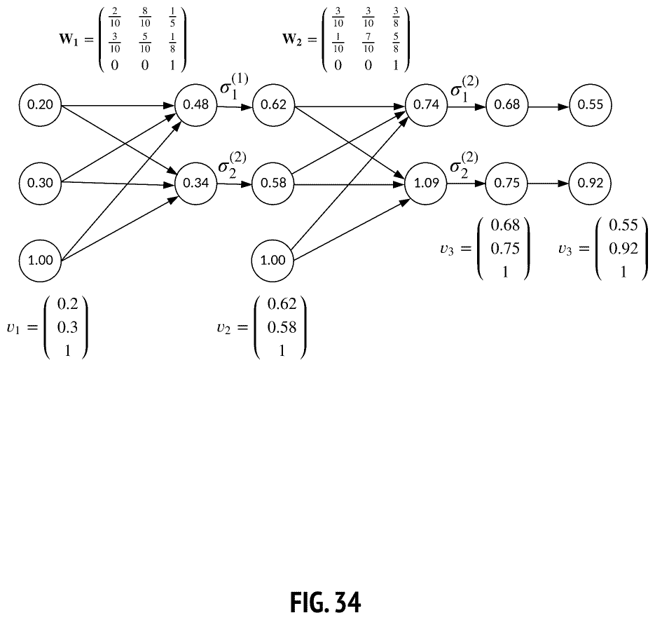

FIG. 34 illustrates the matrix operations involved in a privacy-preservation scenario, according to one embodiment of the present invention.

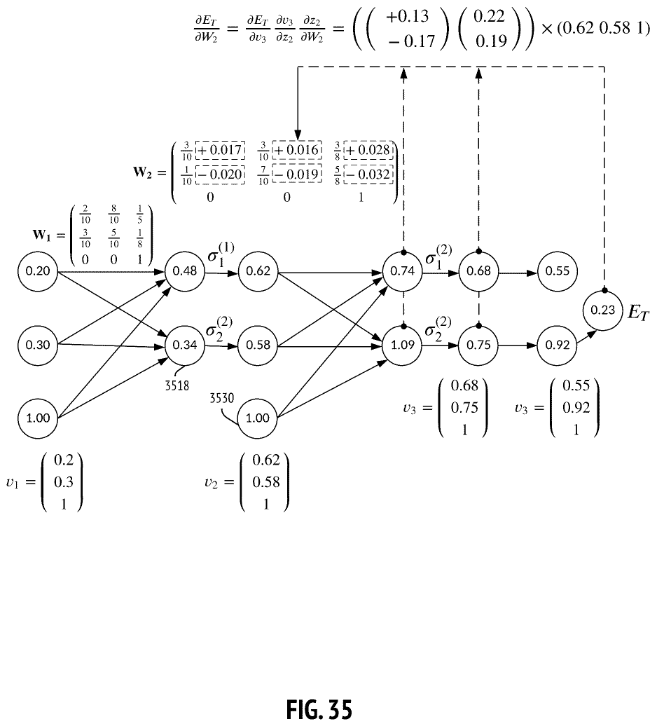

FIG. 35 illustrates the matrix operations involved in a privacy-preservation scenario, according to one embodiment of the present invention.

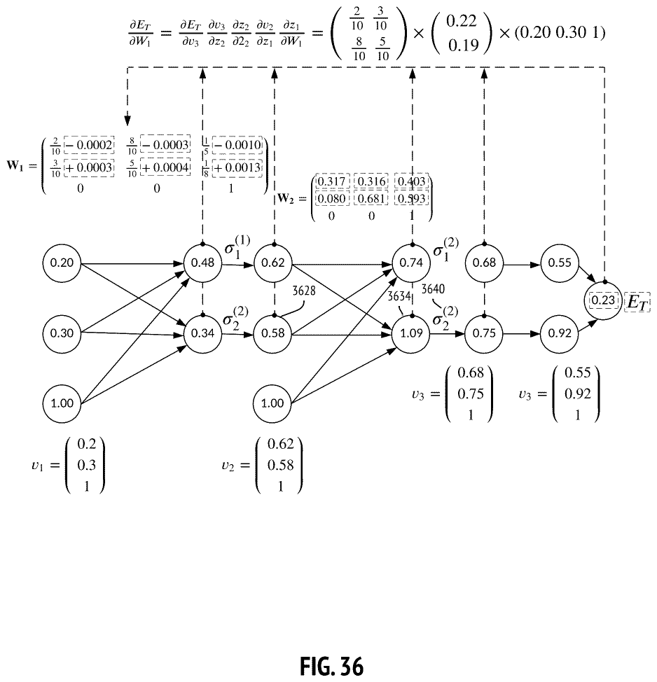

FIG. 36 illustrates the matrix operations involved in a privacy-preservation scenario, according to one embodiment of the present invention.

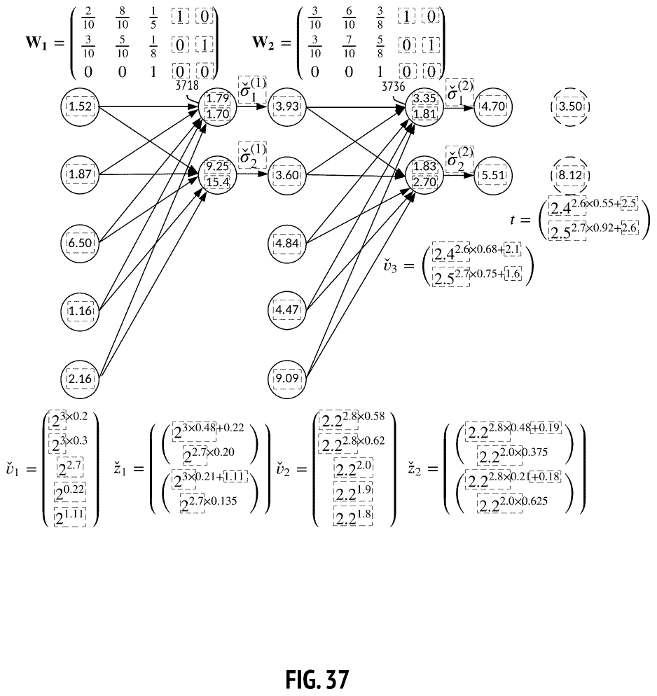

FIG. 37 illustrates the matrix operations involved in a privacy-preservation scenario, according to one embodiment of the present invention.

### System Architectures

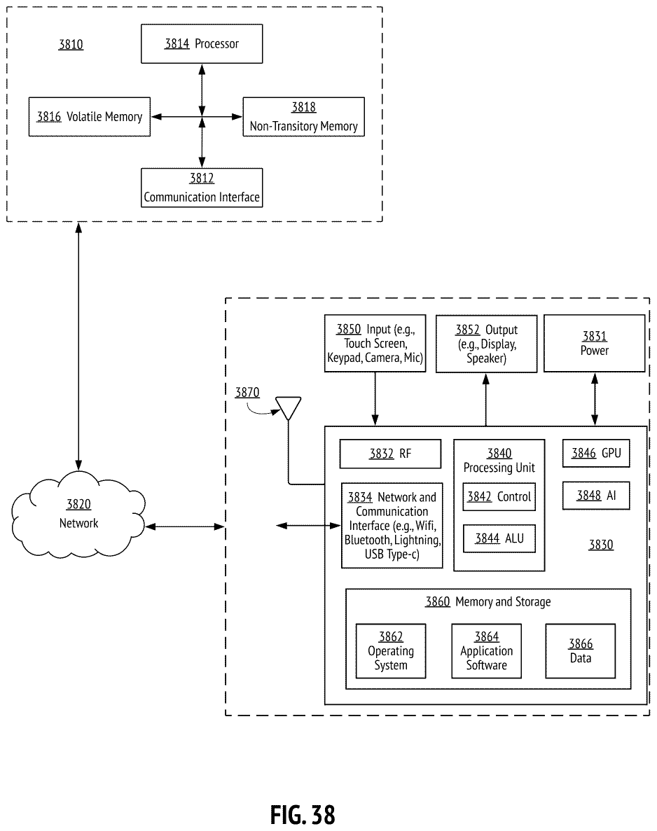

FIG. 38 provides illustrative schematics of a server (management computing entity) and a client (user computing entity) used within an IDMP, in accordance with some embodiments of the present invention.

### DETAILED DESCRIPTION OF THE INVENTION

### 1. Table of Contents

1. Table of Contents
2. Introduction and Motivation
3. Overview: Embodiments of the Invention (FIGS. 1-2)
   a. Embodiment 1: “Matrix-Only Operations” (Transformed Data and/or NN)
   b. Embodiment 2: “Matrix and Term-Wise Operations”
      i. Sub-Embodiment 2A: Shared Data
      ii. Sub-Embodiment 2B: Shared NN
      iii. Sub-Embodiment 2.1: Combination of Embodiments 1 & 2 in a common matrix
   c. Embodiment 3: Trusted Third Party Embodiments
4. Data Sovereignty-Specific Terminology (Applicable to both Embodiments 1 and 2)
5. Introduction to the Interconnected Digital Model Platform (IDMP) (FIGS. 3-14)
6. Introduction to Neural Networks and their Training (FIGS. 15-18)
7. Summary of Data Sovereignty Preserving Methods Used in Embodiments 1 and 2 (FIG. 19)
8. Embodiment 1: Matrix-Only Operations (FIGS. 20-24)
   a. Embodiment 1: Introduction and Overview
   b. Embodiment 1: Mathematical Glossary
   c. Embodiment 1: Encryption by Reshuffling
   d. Embodiment 1: Mathematical Proofs of Matrix Operations
   e. Embodiment 1: Alternative Sub-Embodiments
9. Embodiment 2: Matrix and Term-Wise Operations (FIGS. 25-37)
   a. Embodiment 2: Updated Flow Sequence and Forward Propagation Example (FIG. 25)
   b. Sub-Embodiment 2A: Shared Data (FIGS. 26-28)
   c. Sub-Embodiment 2B: Shared NN (FIGS. 29-31)
   d. Embodiment 2: Proof of Matrix Operations
   e. Embodiment 2: Adding Noise Components to Activation Functions (FIGS. 32-33)
   f. Embodiment 2: Examples (FIGS. 34-37)
   g. Sub-Embodiment 2.1: Uniform Matrix-Led Operations
10. Embodiment 3: Trusted Third Party Embodiments
11. Process Flows of Various Embodiments
12. System Architectures (FIG. 38)
13. IDMP Terminology—and—14. Conclusions

### 2. Introduction and Motivation

As the world is currently moving rapidly towards switching to “Software 2.0”—which is mainly driven by using data to train machine learning models—instead of “Software 1.0”, which mainly relies on writing rules as complex code, an urgent need arises to how to secure the data that is used to train such machine learning models. Data integrity, quality, and relevancy are big drivers to the increase of the value of data as organizations race to build superior machine learning models to keep them ahead of competition and thus organizations will be more protective of their IP and data as the value of data continues to grow on an exponential basis. Who owns the best data—is best positioned to win the race. Such a race to build a strong arsenal of machine learning models also faces a number of threats.

The following are some important takeaways:
1. Accelerated computing is going to empower faster, cheaper ways to train on big and complex data and would drive the inference time down.
2. Software 2.0 is going to be the new norm which requires a lot of data that is often represented as embeddings.
3. Embeddings help secure a machine learning model by providing a more efficient, compact, and expressive representation of data, increasing the model's accuracy and robustness and masking sensitive data for privacy.
4. Embeddings alone cannot protect a machine learning model from being hacked. While embeddings are useful for representing complex data in a more efficient and useful manner, they do not inherently provide security or protection against attacks.
5. Neural networks can fall victim to model inversion attacks, which reconstruct private input data from model outputs. Such attacks can expose sensitive information of users and organizations, raising security concerns. For example, see thenewstack.io/microsoft-machine-learning-models-can-be-easily-reverse-engineered/(retrieved November 2024).
6. To protect data from unintended exposure, data holders and model providers can use encryption or limit model querying access.
7. Differential privacy can be used to preserve privacy while maintaining the utility of the data analysis.
8. Data sovereignty assurance methods—as introduced in this patent—serve as another key toolkit in ensuring data privacy for data owners.
9. Implementing such privacy and security measures is essential for preventing data breaches and preserving the trust and legal standing of organizations using neural networks.

In short, unlike Software 1.0 which relies on explicit, handcrafted programming, Software 2.0 involves training neural networks to learn patterns and make decisions based on large datasets. Machine learning uses much smaller code to train a model but generally would require a lot of data and computing power for training. This data needs to be represented in a numerical form, and embeddings is one form that can be used to represent the data especially in sequential data.

Unfortunately, the introduction of Software 2.0 introduces new security concerns for underlying customer data, even when that data is stored in the form of seemingly unintelligible embeddings. Protecting a machine learning model from being hacked requires a combination of strong security protocols, data encryption, secure transfer, and restricted access to essential components. Additionally, the model should be designed to be resistant to adversarial attacks and other types of data poisoning methods. Regular model updates, monitoring for anomalies or unusual activities, and penetration testing can also help build resilience against hacking attempts.

In short, organizations must be aware of the possible risks posed by neural networks and should actively implement security measures, such as the data sovereignty assurance methodologies introduced in this patent.

Accordingly, we propose systems and methods where both data and neural network parameters are transformed into a secure mathematical space, enabling collaborative training and deployment of neural networks without exposing sensitive information. The systems and methods proposed here resolve data and model privacy issues by allowing data owners and neural network owners to work together securely, ensuring that neither party's assets are compromised, while still enabling effective collaboration.

In the following description, for purposes of explanation, numerous specific details are set forth in order to provide a thorough understanding of the invention. It will be apparent, however, to one skilled in the art that the invention can be practiced without these specific details. In other instances, structures, devices, activities, methods, and processes are shown using schematics, use cases, and/or diagrams in order to avoid obscuring the invention. Although the following description contains many specifics for the purposes of illustration, anyone skilled in the art will appreciate that many variations and/or alterations to suggested details are within the scope of the present invention. Similarly, although many of the features of the present invention are described in terms of each other, or in conjunction with each other, one skilled in the art will appreciate that many of these features can be provided independently of other features. Accordingly, this description of the invention is set forth without any loss of generality to, and without imposing limitations upon, the invention.

What follows is a detailed explanation of illustrative embodiments of the invention, and its numerous applications and uses in the field of machine learning models and AI, based on neural networks.

### 3. Overview: Embodiments of the Invention

Current data security frameworks are insufficient to address growing concerns from data owners and machine learning model owners about confidentiality and misuse of data and/or models by the other party. The systems and methods disclosed herein allow collaboration between the two parties by transforming data and/or neural network parameters into a secure mathematical space, enabling collaborative training and deployment of machine learning models—such as neural networks—without exposing sensitive information, particularly customer data.

The methods and systems disclosed herein describe the detailed steps allowing privacy-preserving interactions between data and model owners. The following three embodiments are introduced here:
Embodiment 1 involves reshuffling with matrix operations and matrix exponentiation (or any equivalently invertible matrix function) within the linear transformation steps.
Embodiment 2 integrates affine transformations within the activation function using a series expansion, such as a Taylor series, along with simpler row/column permutations and Hadamard exponentials. Similar transformations are carried out for other model-related functions, such as cost functions.
Embodiment 3 introduces trusted third-party operations, which can be used to implement either Embodiment 1 or Embodiment 2.

Table 1 describes the Embodiments 1 and 2, highlighting the assumptions around each one.

TABLE 1
Embodiments of the Invention

| | Embodiment 1 | Embodiment 2 |
|---|---|---|
| Untransformed | Unencrypted | Private |
| vs. | vs. | vs. |
| Transformed | Transformed, expanded, & | Transformed (shared), where |
| Space Description | encrypted | transformation can be a set of expansion, |
| Terminology | | permutation, exponentiation with some |
| | | matrix-based and some term-wise |
| | | operations (e.g., Hadamard multiples or |
| | | exponentials) |
| Base Neural | Unencrypted | True NN/True data (Private) |
| Network | | |
| Transformed NN | Expansion with block matrices | Expansion with column or row blocks |
| Architecture and | Matrix Exponentiation | Row or column permutation |
| Data | | Term-wise exponentiation |
| Transformed | Forward propagation with | Forward propagation with transformed |
| Operations | transformed matrix operations | matrix and term-wise operations |
| Transformed | Back propagation with | Back propagation with transformed matrix |
| Operations | transformed matrix operations | and term-wise operations |
| Transformed | Shared activation function | Transformed activation function, with |
| Functions | | matrix and term-wise privacy |
| Forward | | preserving operations, shared as Taylor |
| propagation | | series coefficients, or as multivariate |
| | | polynomial coefficients |
| Transformed | Shared cost function | Transformed cost function, with matrix |
| Functions | | and term-wise privacy preserving |
| Back Propagation | | operations, shared as Taylor series |
| | | coefficients, or as multivariate polynomial |
| | | coefficients |

Note that in some sub-embodiments of Embodiment 2, more of the term-wise operations (e.g., activation function transformation operations) may be carried out using matrix-only operations.

As discussed above, two major sub-embodiments of Embodiments 1 and 2 are discussed in the present disclosure. In a “shared data” sub-embodiment of the invention, the data owner shares a transformed representation of their data with the NN owner, and the NN owner carries out the NN operation in the transformed space. Conversely, in a “shared NN” sub-embodiment of the invention, the NN owner shares a transformed representation of their NN with the data owner, and the data owner carries out the NN operation in the transformed space.

FIG. 1 illustrates the privacy preservation process in the shared data sub-embodiment, in accordance with some embodiments of the present invention. Specifically, exemplary descriptions are provided to illustrate steps carried out by a data owner 100 and a neural network (NN) owner 150 when input data are shared. In this embodiment, data owner 100 shares private-key-protected input data and a shared key with NN owner 150. The private-key-protect input data can be viewed as belonging to a transformed space illegible to NN owner 150. NN owner 150 uses the shared key to move its NN into the same transformed space to deploy on the transformed input data, and the corresponding transformed output, once sent back data owner 100, may be reverse transformed using the private key to obtain a desired output in the original data space. Similarly, the private-key-protected data may be used to train the NN in the transformed space.

More specifically, upon initial handshakes between data owner 100 and NN owner 150, a secure session is established, and transformation setup data 105 is exchanged. Such transformation setup or transformation compatibility data comprises agreed-upon dimensionality data for performing transforms and other relevant neural network operations.

At step 112, data owner 100 generates a data owner private transformation key 114. This data owner private transformation key 114 is kept confidential, and not shared with NN owner 150. Next, at step 116, data owner 100 transforms a set of true data 110 from a true space into transformed data 118 in a transformed space. At step 164, NN owner 150 generates a transformed output 164 in the transformed space, using the data owner private transformation key 114. Concurrently or subsequently, at step 120, data owner 100 generates a shared transformation key 122, which may be used by the NN owner 150 to propagate transformed data through a transformed NN in the transformed space. At steps 124 and 126, data owner 100 transmits transformed data 118 and shared transformation key 122 to NN network owner 150.

Upon receiving these at steps 154 and 160, At step 156, NN owner 150 transforms the NN 152 from the true space to a transformed NN 158 in a transformed space using information within shared transformation key 122 received from data owner 100. At step 162, NN owner 150 propagates transformed data 118 through transformed NN 158 in the transformed space. At step 164, NN owner 150 generates a transformed output 166 in the transformed space. As the input transformed data 118 is protected by data owner private transformation key 114, NN owner 150 is unable to read any transformed output such as 166.

During forward propagation (e.g., Embodiment 1 & 2), true data 110 serves as input data for applying the true NN 152. At step 168, NN owner 150 sends transformed output 166 to data owner 100. Data owner 100 receives transformed output 166 correspondingly at step 128. Next at step 130, data owner 100 reverses the transformation of the transformed output 166 using data owner private transformation key 114 to generate de-transformed output data 148 in the true space. This de-transformed output data 148 is equivalent to a true space output generated by forward-propagating true input data 110 through true NN 152 in the true space up to a predetermined error threshold.

During backward propagation (e.g., Embodiment 2), true data 110 is used as (unlocked) true training data and true target data for training true NN 152, and transformed data 118 is used as (unlocked) transformed training data and transformed target data for training transformed NN 158. Specifically, at step 170, NN owner 150 backpropagates one or more data points of transformed training data 118 and transformed target data through transformed NN 158 in the transformed space to generate one or more transformed error gradients 12 in the transformed space. At step 174, NN owner 150 trains transformed NN 158 using the one or more transformed error gradients 172 in the transformed space to generate a transformed trained NN 16. Finally, at step 178, NN owner 150 de-transforms the transformed trained NN 176 by reversing the transformation using information within shared transformation key 122 received from data owner 100, to generate a trained NN 198 in the true space.

Table 2 shows a description of some of the key steps carried out by the data owner and the NN owner in the shared data sub-embodiments.

TABLE 2
Shared/Transformed Data Case (See FIG. 1)

| Data Owner | NN Owner |
|---|---|
| [Setup secure session; | [Setup secure session; |
| Exchange transformation setup data] | Exchange transformation setup data] |
| Generate a data owner private transformation key, | — |
| keeping it confidential. | |
| Transform true data from a true space into | — |
| transformed data in a transformed space using the | |
| data owner private transformation key. | |
| Generate a shared transformation key necessary for | — |
| the NN owner to propagate the transformed data | |
| through a transformed NN in the transformed space | |
| Transmit the transformed data and the shared | Receive the transformed data and the shared |
| transformation key. | transformation key. |
| — | Transform the NN from the true space to the |
| | transformed NN in a transformed space using |
| | information within the shared transformation key |
| | received from the data owner |
| — | Propagate the transformed data through the |
| | transformed NN in the transformed space. (The |
| | NN owner cannot read the transformed output.) |

Forward Propagation (Embodiment 1 & 2): The true data is input data for applying the NN

| | |
|---|---|
| Receive the transformed output | Generate a transformed output in the transformed |
| | space and send it to the data owner. |
| Reverse the transformation of the transformed | — |
| output using the data owner private transformation | |
| key to generate de-transformed output data in the | |
| true space. | |
| (The de-transformed output data is equivalent to a | |
| true space output generated by forward-propagating | |
| the input data through the NN in the true space up | |
| to a predetermined error threshold.) | |

Backward Propagation (Below Description Applicable to Embodiment 2 Only):
The true data is (unlocked) true training data and true target data for training the NN
The transformed data is (unlocked) transformed training data and transformed target data for
training the transformed NN

| | |
|---|---|
| — | Backpropagate one or more data points of the |
| | transformed training data and the transformed |
| | target data through the transformed NN in the |
| | transformed space to generate one or more |
| | transformed error gradients in the transformed |
| | space. |
| — | Train the transformed NN using the one or more |
| | transformed error gradients in the transformed |
| | space to generate a transformed trained NN. |
| — | De-transform the transformed NN by reversing the |
| | transformation using information within the shared |
| | transformation key received from the data owner, |
| | to generate a trained NN in the true space. |

FIG. 2 further illustrates the privacy preservation process in the shared neural network (NN) sub-embodiment, in accordance with some embodiments of the present invention. Specifically, exemplary descriptions are provided to illustrate steps carried out by a data owner 200 and a neural network (NN) owner 250 when a neural network is shared. In this embodiment, NN owner 250 shares a private-key-protected NN with data owner 200. The private-key-protect NN can be viewed as belonging to a transformed space illegible to data owner 200. Data owner 200 pre-processes its input data to move into the same transformed space to deploy the transformed NN, and the corresponding transformed output is sent to NN owner 250 to be de-transformed. Similarly, the private-key-protected NN may be trained in the transformed space.

More specifically, upon initial handshakes between data owner 200 and NN owner 250, a secure session is established, and transformation setup data 205 is exchanged. Such transformation setup or transformation compatibility data comprises agreed-upon dimensionality data for performing transforms and other relevant neural network operations.

At step 254, NN owner 250 generates a NN owner private transformation key 256, which is kept confidential from data owner 200. Next, at step 258, NN owner 250 transforms a true NN 252 from a true space using NN owner private transformation key 256 to generate a transformed NN 260 in a transformed space. NN owner 250 then transmits transformed NN 260 to data owner 200 at step 262. At step 216, data owner 200 receives transformed NN 260 from NN owner 250.

Before deploying transformed NN 260, data owner 200 pro-processes true data 210 from the true space at step 212 into transformed data 214 in the transformed space. At step 218, data owner 200 propagates transformed data 214 through transformed NN 216 in the transformed space. Because transformed NN is protected by key 256, data owner 200 cannot read any transformed output from transformed NN 260 without collaboration with NN owner 250.

During forward propagation (e.g., Embodiments 1 & 2), true data 210 serves as input data for applying NN 252. At step 220, NN owner 250 generates a transformed output 222 in the transformed space. Concurrently or subsequently, data owner 250 generates a data owner private output transformation key 226, which is kept confidential from NN owner 250, at step 224. At step 228, data owner 200 locks the transformed output 222 using the data owner private output transformation key 226 to generate a locked transformed output 230, ensuring that de-transformation does not prevent subsequent unlocking in the true space. NN owner 250 transmits the locked transformed output 230 in the transformed space to NN owner 250 at step 232.

Once the locked transformed output 230 is received by NN owner 250 at step 264, NN owner 250 de-transforms the locked transformed output 230 at step 266 using the NN owner private transformation key 256 to generate a locked de-transformed output 268 in the true space. NN owner 250 cannot read this output as it is locked with the data owner private output transformation key 226. NN owner 250 instead sends the locked de-transformed output 268 to data owner 200 at step 270.

Data owner 200 receives the locked de-transformed output 268 at step 234. Subsequently at step 236, data owner 200 unlocks the locked de-transformed output 268 using the data owner private output transformation key 226 to generate de-transformed output data 248. This is equivalent to a true space output generated by forward-propagating input data 210 through NN 252 in the true space up to a predetermined error threshold.

During backward propagation (e.g., Embodiment 2), true data 210 serves as unlocked true training data and true target data for training the true NN 252, while transformed data 214 is unlocked transformed training data and transformed target data for training transformed NN 260. At step 240, data owner 200 backpropagates one or more data points of transformed training data 214 and the transformed target data through the transformed NN 260 in the transformed space to generate one or more transformed error gradients 242. Data owner 200 then trains transformed NN 260 using these transformed error gradients 242 to generate a trained transformed NN 274 at step 244, noting that the data owner 200 cannot de-transform the transformed NN 260 or any transformed output without collaboration with NN owner 250. At step 246, data owner 200 sends the trained transformed NN 274 to NN owner 250, which receives it at step 272.

Finally, at step 276, NN owner 250 de-transforms the trained transformed NN 274 by reversing the transformation using the NN owner private transformation key 256 to generate a trained de-transformed NN 292 in the true space. This NN 292 has been trained on data owner's data 210 without NN owner 250 having access to the data owner's data.

Table 3 shows a description of some of the key steps carried out by the data owner and the NN owner in the shared data sub-embodiments.

TABLE 3
Shared/Transformed NN Case (See FIG. 2)

| Data Owner | NN Owner |
|---|---|
| [Setup secure session; | [Setup secure session; |
| Exchange transformation setup data] | Exchange transformation setup data] |
| — | Generate a NN owner private transformation key, |
| | where the NN owner private transformation key is |
| | kept confidential by the NN owner. |
| — | Transform a true NN from a true space using the |
| | NN owner private transformation key, to generate a |
| | transformed NN in a transformed space. |
| Receive the transformed NN. | Send the transformed NN. |
| Transform a true data from the true space into a | — |
| transformed data in the transformed space. | |
| Propagate the transformed data through the | — |
| transformed NN in the transformed space. (The | |
| data owner cannot read the transformed output | |
| from the transformed NN without collaboration | |
| of the NN owner.) | |

Forward Propagation (Embodiment 1 & 2): The true data is input data for applying the NN

| | |
|---|---|
| Generate a transformed output in the transformed | — |
| space. | |
| Generate a data owner private output transformation | |
| key, keeping it confidential. | |
| Lock, using the data owner private output | — |
| transformation key, the transformed output, to | |
| generate a locked transformed output, so that | |
| de-transformation does not prevent subsequent | |
| unlocking in the true space. | |
| Transmit the locked transformed output in the | Receive the locked transformed output. |
| transformed space. | |
| — | De-transform, using the NN owner private |
| | transformation key, the locked transformed output, |
| | to generate a locked de-transformed output in the |
| | true space. (The NN owner cannot read the locked |
| | de-ransformed output because it is ‘locked’ with |
| | the data owner private output transformation key.) |
| Receive the locked de-transformed output. | Send the locked de-transformed output. |
| Unlock the locked de-transformed output, using the | — |
| data owner private output transformation key, to | |
| generate de-transformed output data. | |
| (The de-transformed output data is equivalent to a | |
| true space output generated by forward-propagating | |
| the input data through the NN in the true space up | |
| to a predetermined error threshold. | |

Backward Propagation (Below Description Applicable to Embodiment 2 Only):
The true data is (unlocked) true training data and true target data for training the NN
The transformed data is (unlocked) transformed training data and transformed target data for
training the transformed NN

| | |
|---|---|
| Backpropagate one or more data points of the | — |
| transformed training data and the transformed target | |
| data through the transformed NN in the transformed | |
| space to generate one or more transformed error | |
| gradients in the transformed space. | |
| Train the transformed NN using the one or more | — |
| transformed error gradients in the transformed | |
| space to generate a trained transformed NN. | |
| (The data owner cannot de-transform the | |
| transformed NN or any transformed output | |
| from the transformed NN collaboration with the | |
| NN owner.) | |
| Send the trained transformed NN to the NN owner. | Receive the trained transformed NN. |
| — | De-transform the trained transformed NN by |
| | reversing the transformation using the NN owner |
| | private transformation key, to generate a trained |
| | de-transformed NN in the true space. (The NN has |
| | been trained on the data owner's data without |
| | the NN owner having access to the data owner's |
| | data.) |

The remainder of this document is organized as follows. As shown in the Table of Contents, data-sovereignty-specific terminology is introduced next, followed by an illustration of some of the principles relevant to the present invention (FIGS. 1-2). The interconnected digital model platform (IDMP) is then described in detail, followed by a few neural network and machine learning fundamentals. That is, FIGS. 3-14 describe the operation of an integrated digital model platform (IDMP), according to embodiments of the present invention. General concepts related to the training of neural networks, transformer architectures, and the use of embeddings, are described in FIGS. 15-18.

Also as shown in the Table of Contents, various embodiments of the disclosed data sovereignty preserving methods are described next. Embodiment 1 is described in FIGS. 20-24, whereas FIGS. 25-37 describe Embodiment 2. For Embodiments 1 and 2, various scenarios are presented, and mathematical analysis is provided in support of some of the key process steps. For Embodiment 2, relevant matrix operations are illustrated through example scenarios. Embodiment 3, which introduces a trusted third party for some of the operations described herein, is then introduced. Penultimately, processes for various embodiments are then discussed. Finally, hardware and software implementation details that are relevant to the invention are described (FIG. 38).

### 4. Data Sovereignty-Specific Terminology

Some illustrative terminologies specific to the transformation of NNs and data for ensuring data sovereignty discussed herein are provided here to assist in understanding the present invention. The provided terminology is not to be read as restricting the scope of the present invention. The terms may be used in the form of nouns, verbs, or adjectives, within the scope of the definition.
Untransformed (True) vs. Transformed space (see Eqn. (B17))
Untransformed data: Untransformed input and/or training data owned by the data owner (see Eqn. (B5))
Transformed data: Transformed input and/or training data for the transformed space that the data owner generates using a private transformation key. Untransformed/private input data is first expanded resulting in dimensionality expansion, including the use of dummy random matrix data, such as:

$${v}_{i} = ( \begin{matrix}{v}_{i} \\ - {\tilde{r}}_{i} \\ 1\end{matrix} ) .$$

The resulting expanded matrix is right-multiplied by another random scrambling matrix with an example as shown here: \hat{v}_{i,r}=:\hat{v}ᵢ\hat{r}_{i,v}. Finally, the result is exponentiated to obtain the transformed input data, as shown here:

$$\text{?} = \text{?} = ( \begin{matrix}\text{?} \\ \text{?} \\ e\end{matrix} \text{?}$$

$$\text{?} \text{indicates text missing or illegible when filed}$$

Here, the exponentiation can be either element-wise in some embodiments (Embodiment 2) or row-column matrix-wise in other embodiments (Embodiment 3) depending on the privacy convention.
Transformation compatibility data (or transformation setup data): Non-confidential data shared between the two parties up front to ensure correct transformed space neural network mathematical operations. Such compatibility data may be shared using a graphical user interface with human input or in a structured format like JSON, suitable for automated exchanges. This may include:
   dimensions of the expansion of the input data,
   location of the bias vector and unit vector,
   definitions of addition, multiplication, exponentiation, and/or any other pseudo-invertible functions chosen for compositions with the untransformed activation and/or cost functions in the transformed space,
   untransformed activation and cost function (though not technically required should the privacy key owner dictate it, but in practice, agreeing on the NN non-linearity does not detract from privacy),
   dimensionality for variate matrix elements (as a means to ensure or increase privacy), and/or
   error transformation key (\tilde{R}) for converting transformed output data into true output data, as well as for privacy during back propagation.
Private transformation key (r and \tilde{r}): Private transformation keys are generated by the data owner and not shared with the NN owner (shared data sub-embodiment), or alternately, generated by the NN owner and not shared with the data owner (shared NN sub-embodiment). For example, in the shared data case, they may include random matrices that the data owner utilizes as part of the transformation steps for expansion or exponentiation. Similarly, in the shared NN case, the NN owner may utilize different random matrices as part of their transformation steps for expansion, multiplication, or exponentiation, and include those in the private transformation keys.
Private output transformation key out [symbol] ₒᵤₜ: Generated by data owner and not shared with NN owner. For example, a random matrix may be used to right exponentiate and lock the transformed output from a transformed NN before sharing back with the NN owner to unlock from their end.
Shared Transformation Key: Based on shared hidden layer transformation data, the shared transformation key includes transformed data generated by the data owner and shared with NN owner that such that the NN owner can perform transformed space NN operations that preserved untransformed space operations in recoverable form (i.e., pseudo-invertible by the private data owner without a priori knowledge of the hidden layers, where “pseudo” refers to the requirement that operations involving untransformed NN data must either be fully invertible, while those involving “dummy” data inserted as a privacy means need not be, or invertible up to an acceptable estimation error based on injected noise). For, example, the bottom components of transformed hidden layer inputs.
An example of shared hidden layer transformation data would be the bottom two components in the v̌ᵢ matrix (on right hand side), which ensure subsequent operations in the transformed space (i) preserve the augmented matrix form of the hidden layer inputs and final output and (ii) are mathematically compatible, as well as compatible with the private transformation key

$${\check{v}}_{i} = \text{?} = ( \begin{matrix}\text{?} \\ \text{?} \\ e\end{matrix} \text{?}$$

$$\text{?} \text{indicates text missing or illegible when filed}$$

Untransformed activation function: One or more activation functions in the untransformed space, for computation of activation within the hidden and output layers of the NN, either agreed upon as part of transformation compatibility data or part and parcel of the untransformed neural network. See righthand side of Eqn. (B1) and FIG. 32 as an example of an untransformed activation function. FIG. 33 is an example of an untransformed activation function including a noise function.
Transformed activation function: Activation functions in the transformed space, which is capable of performing computations with transformed space data (i.e., transformed weights and biases or transformed inputs and training data with transformed mathematical operations) in the transformed space of the transformed NN. See Eqn. (B18) as an example of a transformed activation function.
Untransformed cost function: Cost functions in the untransformed space whose inputs are the output data and target data in the untransformed NN. See righthand side of Eqn. (B38) as an example of an untransformed cost function.
Transformed cost function: Cost functions in the transformed space whose inputs are the transformed output and transformed target data of the transformed NN (i.e., the transformed space). See steps in Eqns. (B38) and (B39) as steps for computing transformed cost function.
Transformation (mathematical) operator: The transformed operator embodies data operations defined in the transformed space between the transformed NN data (i.e., transformed weights and biases or transformed input and training data) such that the transformed forward and backwards propagations preserve the untransformed forward and backwards propagations, respectively, in recoverable form (i.e., pseudo-invertible by the private key owner without a priori knowledge of the hidden layers, where “pseudo” refers to the requirement that operations involving untransformed NN data must either be fully invertible, while those involving “dummy” data inserted as a privacy means need not be, or invertible up to an acceptable estimation error based on injected noise) without knowledge of the hidden layers a priori. See Eqn. (B17) as an example transformation operator.
Transformed output: Output from the transformed NN in the transformed space. See righthand side of Eqn. (B50) as an example transformed output.
Untransformed output: True, untransformed output data that is recoverable (i.e., pseudo-invertible by the private key owner without a priori knowledge of the hidden layers, where “pseudo” refers to the requirement that operations involving untransformed NN data must either be fully invertible, while those involving “dummy” data inserted as a privacy means need not be, or invertible up to an acceptable estimation error based on injected noise) by the data owner from the transformed output using the private transformation key.
Locked transformed output data: Transformed output data is locked using the private output transformation key ( [symbol] ₒᵤₜ) generated by the data owner as a data privacy protection measure in the “Shared NN” case. The locked transformed output data can then be sent to the NN owner for de-transformation back into the true/untransformed space. Upon reversing the transformation (i.e., operating a de-transformation) using its private transformation key (r and \tilde{r}), the NN owner obtains a locked untransformed output data that it sends back to the data owner for unlocking. Upon reception, the data owner can generate unlocked untransformed output data (i.e., untransformed output) by unlocking the locked transformed output data using the private output transformation key. The described operations are detailed in Table 3.
Transformed forward propagation operators: A subset of transformed mathematical operations pertaining to forward propagation operations in the transformed space. (See Eqns. (B15) and (B17).)
Transformed backpropagation operators: A subset of transformed mathematical operations pertaining to backpropagation operations in the transformed space. (See Eqns. (B50) and (B51).)
Transformed Error Gradient: Computed in the transformed space during backpropagation to train the transformed NN. The transformed error gradient is generated locked or unlocked, depending on the choice of the private transformation keys (r and \tilde{r}), as depicted in Eqns. (B50) and (B51) for ‘Shared data’ use case and Eqns. (B57) and (B58) for the ‘Shared NN’ use case. A locked transformed error gradient may be partially unlocked by the data owner using the private transformation keys (see Eqns. (B52) and (B58)), thus allowing the NN owner to fully unlock it using the error transformation key (R), as shown in Eqns. (B53) and (B59).
Target Data and Training Data Set: Originating at the data owner, the target data represents the desired output of the NN when the training data set is used for training the NN. The target data and training data set include a plurality of data points that may be generated as locked data points, depending on the choice of the private transformation key (r and \tilde{r}), as shown in Eqn. (B52).
Noise component: A noise component (e.g., a bounded differentiable noise function) may be embedded within the transformed activation function, the transformed cost function, or any transformed function describing NN operation, by adding the noise component to the untransformed function prior to the series expansion, as illustrated in Eqn. (B60) and FIG. 33.

In various embodiments, the “exchange” of a data element (e.g., transformation setup data) may include various combinations of the following actions: (1) an agreement between the two parties on one or more parameters relevant to the data element, (2) a generation of the data element by a first party, and (3) a sending or sharing of said data from the first party to the second party.

The IDM platform is discussed next. The IDMP platform may use NNs in which the transformation of NN and data for privacy preservation are very useful. Some illustrative terminologies specific to the IDMP platform discussed next are provided in a section at the end of this document to assist in understanding the present invention, but these are not to be read as restricting the scope of the present invention. The terms may be used in the form of nouns, verbs, or adjectives, within the scope of the definition.

### 5. Introduction to the Interconnected Digital Model Platform (IDMP)

The interconnected digital model platform (IDMP) enables the threading and manipulation of systems and digital models, as described below in detail. The current disclosure presents methods and systems by which a machine learning model such as a Neural Network (NN) may be shared, trained, fine-tuned, provided with context data, and utilized in a privacy-preserving manner for both the data owner and the model owner, leading to enhanced IDMP operation. FIGS. 3-14 describe the operation of an integrated digital model platform (IDMP), according to embodiments of the present invention.

### An Interconnected Digital Model Platform (IDMP) Architecture

FIG. 3 shows an exemplary interconnected digital model platform (IDMP) architecture, in accordance with some embodiments of the present invention. In the context of digital engineering (DE), IDMP 300 streamlines the process of product development from conception to production, by using a virtual representation or digital twin (DTw) 322 of the product to optimize and refine features before building a physical prototype or physical twin (PTw) 332, and to iteratively update DTw 322 until DTw 322 and PTw 332 are in sync to meet the product's desired performance goals. In what follows, the terms IDMP and IDEP are used interchangeably, as an interconnected digital engineering platform (IDEP) is a representative type of IDMPs.

Specifically, a product (e.g., airplane, spacecraft, exploration rover, missile system, automobile, rail system, marine vehicle, remotely operated underwater vehicle, robot, drone, medical device, biomedical device, pharmaceutical compound, drug, power generation system, smart grid metering and management system, microprocessor, integrated circuit, building, bridge, tunnel, chemical plants, oil and gas pipeline, refinery, etc.) manufacturer may use IDMP platform 300 to develop a new product. The engineering team from the manufacturer may create or instantiate digital twin (DTw) 322 of the product in a virtual environment 320, encompassing detailed computer-aided design (CAD) models and finite element analysis (FEA) or computational fluid dynamics (CFD) simulations of component systems such as fuselage, wings, engines, propellers, tail assembly, and aerodynamics. DTw 322 represents the product's design and performance characteristics virtually, allowing the team to optimize and refine features before building a physical prototype 332 in a physical environment 330. In some embodiments, PTw 332 may be an existing entity, while DTw 322 is a digital instance that replicates individual configurations of PTw 332, as-built or as-maintained. In the present disclosure, for illustrative purposes only, DTw 322 and PTw 332 are discussed in the context of building a new product, but it would be understood by persons of ordinary skill in the art that the instantiation of DTw 322 and PTw 332 may take place in any order, based on the particular use case under consideration.

Digital models (e.g., CAD models, FEA models, CFD models) used for creating DTw 322 are shown within a model plane 380 in FIG. 3. Also shown in model plane 380 is a neural network (NN) model 384, which may provide machine-learning based predictive modeling and simulation for a DE process. A DE model such as 382 may be spliced into one or more model splices, such as 372 and 373 within a splice plane 370. Individual DTws such as 322 are instantiated from splice plane 370 via an application plane 360. A model splice such as 372 may be linked to another model splice such as 371 by a platform script or application 362 on application plane 360 into a digital thread. Multiple digital threads such as 362 and 363 may be further linked across different stages or phases of a product life cycle, from concept, design, testing, to production. Digital threads further enable seamless data exchange and collaboration between departments and stakeholders, ensuring optimized and validated designs.

As model splicing provides input and output splice functions that can access and modify DE model data, design updates and DE tasks associated with the digital threads may be represented by scripted, interconnected, and pipelined tasks arranged in Directed Acyclic Graphs (DAGs) such as 324. A DE task DAG example is discussed in further detail with reference to FIG. 12.

To enhance the design, external sensory data 340 may be collected, processed, and integrated into application plane 360. This process involves linking data from different sources, such as physical sensors 334 on prototype 332, physical environmental sensors 336, and other external data streams such as simulation data from model plane 380. API endpoints provide access to digital artifacts from various environments (e.g., physical twin (PTw) sensor 334 data) and integrate them into the spliced plane 370 for the DTw 322. Model splices on the splice plane 370 enable autonomous data linkages and digital thread generation, ensuring DTw 322 accurately represents the product's real-world performance and characteristics.

To validate DTw 322's accuracy, the engineering team may build or instantiate PTw 332 based on the same twin configuration (i.e., digital design). Physical prototype 332 may be equipped with numerous sensors 334, such as accelerometers and temperature sensors, to gather real-time performance data. This data may be compared with the DTw's simulations to confirm the product's performance and verify its design.

Processed sensory data 344 may be used to estimate parameters difficult to measure directly, such as aerodynamic forces or tire contact patch forces. Such processed sensory data provide additional data for DTw 322, further refining its accuracy and reliability. Processed sensory data 344 may be generated from physical environment sensors 336 with physical environment 330, and may be retrieved from other external databases 342, as discussed below.

During development, feedback from customers and market research may be collected to identify potential improvements or adjustments to the product's design. At an analysis & control plane (ACP) 350, subject matter experts (SMEs) may analyze processed sensory data 344 and external expert feedback 314, to make informed decisions on necessary design changes. Such analysis may be done by an analysis module 354, and may be enhanced or entirely enabled by algorithms (i.e., static program code) or artificial intelligence (AI) modules. Linking of digital threads such as 362, physical sensors 334 and 336, processed sensory data 344, and expert feedback data 314 occurs at ACP 350, where sensor and performance data is compared, analyzed, leading to modifications of the underlying model files through digital threads. Within the ACP 350, the analysis module 354 may carry out testing of the product. Additionally, testing of the twin configuration set 356, which includes feature testing, may occur in the connection between the analysis module 354 and the twin configuration set 356.

In particular, sensory data 344 from physical environment 330 and performance data 326 from virtual environment 320 may be fed into a comparison engine 352. Comparison engine 352 may comprise tools that enable platform users to compare various design iterations with each other and with design requirements, identify performance lapses and trends, and run verification and validation (V&V) tools.

Model splicing is discussed in further detail with reference to FIGS. 9 to 11. Model splicing enables the scripting of any DE operation involving DE model files in model plane 380, where each DE model is associated with disparate and siloed DE tools. Codification of DE models and DE operations with a unified corpus of scripts enable IDMP 300 to become an aggregator where a large space of DE activities associated with a given product (e.g., airplane, spacecraft, exploration rover, missile system, automobile, rail system, marine vehicle, remotely operated underwater vehicle, robot, drone, medical device, biomedical device, pharmaceutical compound, drug, power generation system, smart grid metering and management system, microprocessor, integrated circuit, building, bridge, tunnel, chemical plants, oil and gas pipeline, refinery, etc.) may be threaded through program code. Thus, model splicing enables the linking and manipulation of all model files (e.g., 382, 384) associated with a given product within the same interconnected platform or ecosystem 300. As a consequence, the generation and training of AI modules for the purpose of manipulating DE models (e.g., 382), digital threads (e.g., 362), and digital twins (e.g., 322) become possible over the programmable and unified IDMP 300.

### Virtual and Physical Feedback Loops

FIG. 3 uses letter labels “A” to “H” to denote different stages of a product's lifecycle. At each stage, IDMP 300 enables feedback loops whereby data emanating from a PTw or a DTw is analyzed at ACP 350, leading to the generation of a new twin configuration based on design modifications. The new twin configuration may be stored in a twin configuration set and applied through the application and splice planes, yielding modified model files that are registered on the digital thread.

A virtual feedback loop 304 starts with a decision 306 to instantiate new DTw 322. A DAG of hierarchical tasks 324 allows the automated instantiation of DTw 322 within virtual environment 320, based on a twin configuration applied at a process step 308 from a twin configuration set 356. DTw 322 and/or components thereof are then tested in virtual environment 320, leading to the generation of DTw performance data 326. Concurrently, DTw 322 and/or components thereof may be tested and simulated in model plane 380 using DE software tools, giving rise to test and simulation performance data 374. Performance data 326 and 374 may be combined, compared via engine 352, and analyzed at ACP 350, potentially leading to the generation and storage of a new twin configuration. The eventual decision to instantiate a DTw from the new twin configuration completes virtual feedback loop 304.

A physical feedback loop 302 starts with a decision 306 to instantiate a new PTw 332. PTw 332 may be instantiated in a physical environment 330 from the model files of model plane 380 that are associated with an applied twin configuration from the twin configuration set 356. PTw 332 and/or components thereof are then tested in physical environment 332, leading to the generation of sensory data from PTw sensors 334 and environmental sensors 336 located in physical environment 330. This sensory data may be combined with data from external databases to yield processed sensory data 344. In one exemplary embodiment, temperature readings from environmental sensors located within the physical environment are completed, adjusted (e.g., shifted), and/or calibrated using data from external temperature databases.

Data from PTw sensors 334 may be directly added to the model files in model plane 380 by the DE software tools used in the design process of PTw 332. Alternatively, PTw sensor data may be added to digital thread 362 associated with PTw 332 directly via application plane 360. In addition, processed sensory data 344 may be integrated into IDMP 300 directly via application plane 360. For example, processed sensory data 344 may be sent to ACP 350 for analysis, potentially leading to the generation and storage of a new twin configuration. The eventual decision to instantiate a PTw from the new twin configuration completes physical feedback loop 302.

At each stage A to H of the product life cycle, the system may label one twin configuration as a current design reference, herein described as an “authoritative twin” or “authoritative reference”. The authoritative twin represents the design configuration that best responds to actual conditions (i.e., the ground truth). PCT application No. PCT/US24/27898 (Docket No. IST-03.001PCT) provides a more complete description of authoritative twins and their determination, and is incorporated by reference in its entirety herein.

With faster feedback loops from sensor data and expert recommendations, the system updates DTw 322 to reflect latest design changes. This update process may involve engineering teams analyzing feedback 354 and executing the changes through IDMP 300, or automated changes enabled by IDMP 300 where updates to DTw 322 are generated through programmed algorithms or AI modules. This iterative updating process continues until DTw 322 and PTw 332 are in sync and the product's performance meets desired goals. While IDMP 300 may not itself designate the authoritative reference between a DTw or a PTw, the platform provides configurable mechanisms such as policies, algorithms, voting schema, and statistical support, whereby agents may designate a new DTw as the authoritative DTw, or equivalently in what instances the PTw is the authoritative source of truth.

When significant design improvements are made, a new PTw prototype may be built based on the updated DTw. This new prototype undergoes further testing and validation, ensuring the product's performance and design align with project objectives.

Once DTw 322 and PTw 332 have been validated and optimized, the product is ready for production. A digital thread connecting all stages of development can be queried via splice plane 370 to generate documentation as needed to meet validation and verification requirements. The use of model splicing, along with the feedback architecture shown in FIG. 3, improves the efficiency of the overall product innovation process.

### Interconnected DE Platform and Product Lifecycle

In FIG. 3, letter labels “A” to “H” indicate the following major steps of a product lifecycle, according to some embodiments of the current invention:
A. Digital models reside within customer environments: a product may be originally represented by model files that are accessible via software tools located within customer environments. Model plane 380 encompasses all model files (e.g., 382) associated with the product.
B. Preparatory steps for design in the digital realm: splice plane 370 encompasses model splices (e.g., 372) generated from DE model file through model splicing. Model splicing enables the integration and sharing of DE model files within a single platform, as described in detail with reference to FIGS. 9 to 11.
C. Link threads as needed among model splices: to implement a product, model splices are linked through scripts within application plane 360. A digital twin (DTw) 322 englobing as-designed product features may be generated from application plane 360 for running in virtual environment 320. The complete twin configuration of a generated DTw is saved in twin configuration set 356 located at the analysis & control plane (ACP) 350. Features or parts of DTw 322 may be simulated in model plane 380, with performance data 374 accessed through splice plane 370. In one embodiment, features or parts of PTw 332 or DTw 322 configuration may be simulated outside the platform, where performance data is received by the ACP 350 for processing, in a similar way as performance data 326 received from DTw 322.
D. Finalize “As-designed”: performance data 326 from DTw 322 or simulation performance data 374 attained through model plane 380 and accessed through model splicing may be collected and sent to ACP 350 for analysis. Performance data from different iterations of DTw 322 may be compared via engine 352 to design requirements. Analysis of the differences may lead to the generation of new twin configurations that are stored at twin configuration set 356. Each twin configuration in twin configuration set 356 may be applied at application plane 360 and splice plane 370 via process step 308 to instantiate a corresponding DTw. Multiple DTws may be generated and tested, consecutively or simultaneously, against the design requirements, through comparison engine 352 and analysis module 354. Verification and validation tools may be run on the various DTw iterations.
E. Finalize “As-manufactured”: once a DTw 322 satisfies the design requirements, a corresponding PTw 332 prototype may be instantiated from the spliced model files (e.g., 372). Sensor data originating from the PTw 334 or from within the physical environment 336 may be collected, combined with other external data 342 (e.g., sensor data from other physical environments). The resulting processed sensory data 344 may be sent to the analysis & control plane 350 to be compared with performance data 326 from DTws and simulations (e.g., 374), leading to further DTw 322 and PTw 332 iterations populating the twin configuration set 356. Processed sensory data 344 may also be mapped to the digital threads (e.g., 364) and model splices (e.g., 372) governing the tested PTw 332 through the application plane 360.
F. Finalize “As-assembled”: once the manufacturing process is completed for the various parts, as a DTw and as a PTw, the next step is to finalize the assembled configuration. This involves creating a digital representation of the assembly to ensure it meets the specified requirements. The digital assembly takes into account the dimensions and tolerances of the “as-manufactured” parts. To verify the feasibility of the digital assembly, tests are conducted using the measured data obtained from the physical assembly and its individual components. Measurement data from the physical component parts may serve as the authoritative reference for the digital assembly, ensuring alignment with the real-world configuration. The digital assembly is compared with the actual physical assembly requirements for validation of the assembled configuration. Subsequently, the digital assembly tests and configurations serve as an authoritative reference for instructions to guide the physical assembly process and ensure accurate replication. IDEP 300 components described above may be used in the assembly process. In its authoritative iteration, DTw 322 ultimately captures the precise details of the physical assembly, enabling comprehensive analysis and control in subsequent stages of the process.
G. Finalize “As-operated”: to assess the performance of the physical assembly or its individual component parts, multiple digital twins 322 may be generated as needed. These digital twins are created based on specific performance metrics and serve as virtual replicas of the physical system. Digital twins 322 are continuously updated and refined in real-time using the operational data (e.g., 344) collected from monitoring the performance of the physical assembly or its components. This data may include, but are not limited to, processed sensory data, performance indicators, and other relevant information. By incorporating this real-time operational data, digital twins 322 stay synchronized with the actual system and provide an accurate representation of its operational performance. Any changes or improvements observed via sensory data 344 during the real-world operation of the assembly are reflected in DE models within the digital twins and recorded in the twin configuration set 356. This ensures that the digital twins remain up-to-date and aligned with the current state of the physical system.
H. Predictive analytics/Future performance: The design process may continue iteratively in virtual environment 320 through new DTw 322 configurations as the product is operated. Multiple digital twins may be created to evaluate the future performance of the physical assembly or its component parts based on specific performance metrics. Simulations are conducted with various control policies to assess the impact on performance objectives and costs. The outcome of these simulations helps in deciding which specific control policies should be implemented (e.g., tail volume coefficients and sideslip angle for an airplane product). The digital twin DE models (e.g., 382) are continuously updated and refined using the latest sensor data, control policies, and performance metrics to enhance their predictive accuracy. This iterative process ensures that the digital twins (e.g., 322, 356) provide reliable predictions of future performance and assist in making informed decisions.

The hardware components making up IDMP 300 (e.g., servers, computing devices, storage devices, network links) may be centralized or distributed among various entities, including one or more DE service providers and DE clients, as further discussed in the context of FIGS. 5 and 6. FIG. 6 shows an illustration of various potential configurations for instancing a DE platform within a customer's physical system and information technology (IT) environment, usually a virtual private cloud (VPC) protected by a firewall.

Digital Documentation through Live Digital Objects

The methods and systems described herein enable the updating and generation of digital documents using the full functionality of the IDMP shown in FIG. 3. In FIG. 3, the IDMP virtual feedback loop 304 allows the scripting of program code within a digital thread 362 for the generation, storing, and updating of digital twins 322 and twin configurations 356. Similarly, the IDMP virtual feedback loop 304 also allows the scripting of program code within a digital thread 362 for the generation, storing, and updating of digital documents. This enables the creation and maintenance of so-called live digital objects.

Live digital objects are more akin to a DTw than a conventional static document in that they are configured, through a digital thread, to be continuously updated to reflect the most current changes within a particular twin configuration. In particular, an authoritative/trusted live digital object is configured to reflect the latest authoritative/trusted twin configuration. Specifically, live digital objects are digital objects that (1) include a digital artifact extracted from a digital model through a model presentation (e.g., model splice), where (2) a modification of the digital artifact appears in the live digital object within a predetermined delay. In various embodiments, the updates are effectively real-time or near real-time.

Live digital objects may use a document interface, yielding live digital documents, or live documents. Live digital documents may pull data from multiple model files. Preliminary design reviews may thus take the form of a live digital document.

Live digital objects may also use a dashboard interface, yielding live digital boards, or live boards. In some embodiments, a live digital board may display one or more documents and one or more applications on a two-dimensional (2D) screen rendered on a modality of a multimodal interface such as a 2D display, a two-and-a-half-dimensional (2.5D) display, and a three-dimensional (3D) semi-immersive or fully immersive display. Live digital boards may combine multiple documents through a VR/AR and/or conversational interface, into a board/screen 2D, 2.5D format. For example, a live board may combine multiple model files from a CAD software with collaboration chat rooms over a 2D screen rendered on a 2D display (traditional display), a 2.5D display, or a 3D semi immersive or fully immersive display. In one embodiment, the live board combines multiple view screens.

Finally, a live digital object may take the form of a live digital space (or live space), a 3D virtual environment or an augmented environment. In some embodiments, a live digital space displays one or more documents and one or more other applications in a virtual space rendered through a 3D spatial display. Live digital spaces may combine multiple documents through VR/AR and/or conversational interfaces into a 3D spatial representation. For example, a live space may display multiple 3D model files from a CAD software with collaboration chat rooms over a 3D semi immersive or fully immersive display spatial display.

Live digital objects may be stored and accessed through an IDMP. Specifically, live digital objects may be used to provide the background context for a given digital thread, and may specifically be used to display and organize a digital thread's associated artifacts, as described herein.

Live digital objects may hence be known as magic objects (i.e., live documents may be denoted “magic documents”, live boards may be denoted “magic boards”, and live spaces may be denoted “magic spaces”) as changes implemented within a twin configuration (e.g., through a modification of a model file) may appear instantaneously within the relevant data fields of the live digital objects. Similarly, authoritative/trusted live digital objects may also be known as authoritative/trusted magic objects as they continuously reflect data from the authoritative twin, thus always representing the authoritative source of truth.

Given the massive quantities of data and potential modifications that are carried out during a product's lifecycle, the scripts implementing live digital objects may be configured to allow for a predefined maximum delay between the modification of a model file (e.g., the modification of a digital artifact) and the execution of the corresponding changes within a live digital object. Moreover, for similar reasons, the scripts implementing live digital objects may be restricted to operate over a specified subset of model files within a DTw or a system, thus reflecting changes only to key parameters and configurations of the DTw or the system.

The “printing” of a live digital document or board corresponds to the generation of a frozen (i.e., static) time-stamped version of a live digital document or board. Therefore, “printing”—for a live digital document or board—is equivalent to “instantiation” for a digital twin. Similarly, the “printing” of a live digital space may also be envisaged, yielding a frozen 3D representation of a given system or digital thread.

In one embodiment of the present invention, an IDMP script (e.g., an IDEP application) having access to model data via one or more model splices and digital document templates to create and/or update a live digital object may dynamically update the live digital object using software-defined digital threads over an IDMP platform. In such an embodiment, the IDMP script may receive user interactions dynamically. In response to the user updating data for a model and/or a specific parameter setting, the IDMP script may dynamically propagate the user's updates into the digital object through a corresponding digital thread.

In another embodiment of the present invention, an IDMP script may instantiate a digital object with sufficient specification to generate a physical twin (PTw). In such an embodiment, the IDMP script may receive a digital twin configuration of a physical twin, generate a live digital object associated with the digital twin configuration, receive a predetermined timestamp, and generate a printed digital object (i.e., a static, time-stamped version of the live digital object at the predetermined timestamp). Such an operation may be referred to as the “printing of a digital twin”.

In yet another embodiment of the present invention, an IDMP script may instantiate (i.e., “print”) a digital object specifying an updated digital twin upon detecting the update. In such an embodiment, the IDMP script may detect a modification of a digital model or an associated digital thread. In response to detecting the modification, the IDMP script may update relevant data fields and sections of the live digital object based on the detected modification, and generate an updated printed digital object with the updated relevant data fields and sections based on the always-updated live digital object.

In various embodiments, a software-defined digital thread can be associated with a companion magic document (or “magic doc”) that encompasses live updates for one or more core parameters of the digital thread. In one embodiment, the magic doc includes key parameters describing the implementation of a user's intent. For example, In one embodiment, a companion magic doc for a given digital thread may include key data points and key orchestration script examples illustrating a user's intent (e.g., “increase a drone's wing span by 1%”). In one embodiment, a script-generating ML model receiving as input pseudocode or detailed user instructions derived from a user's intent, is trained on prior IDEP digital threads and documents. In addition to generating a digital thread (with orchestration scripts and comments), the script-generating ML model is also configured to generate a magic doc that explains how the generated digital thread addresses the user intent.

In some embodiments, receiving user interactions with a DE model, modifications to a DE model, or modifications to an associated digital thread, may be carried out through a push configuration, where a model splicer or a script of the digital thread sends any occurring relevant updates to the IDEP script immediately or within a specified maximum time delay. In other embodiments, receiving user interactions with a DE model, modifications of a DE model, or modifications of an associated digital thread, may be carried out through a pull configuration, where a model splicer or a script of the digital thread flag recent modifications until the IDEP script queries relevant DE models (via their model splices) or associated digital threads, for flagged modification. In these embodiments, the IDEP script may extract the modified information from the modified DE models (via their model splices) or the modified digital threads, in order to update a live DE document. In yet other embodiments, receiving user interactions with a DE model, modifications of a DE model, or modifications of an associated digital thread, may be carried out through a pull configuration, where the IDEP script regularly checks relevant DE models (via their model splices) or associated digital threads, for modified data fields, by comparing the data found in the live DE document with regularly extracted model and digital thread data. In these embodiments, the IDEP script may use the modified data to update the live DE document.

### Dynamic Document Updates

Some embodiments described herein center around documentation, or document preparation and update and on document management (e.g., for reviews). As discussed, some embodiments of the system allow for dynamic updates to documents, which pertain to software-defined digital threads in the IDEP platform and the accompanying documentation.

Use of an ML engine with the model data and templates to create and/or update documents almost instantaneously as a one-time action have been presented. Furthermore, the digital engineering platform interacts dynamically with the user. As the user interacts with the system and updates data for a model or a specific parameter setting, these changes may be propagated through the corresponding digital threads and to the associated documentation. The AI architectures involved include locally-instanced large language model (LLMs, for data security reasons) as well as non-LLM approaches (e.g., NLP-based), in order to create, update, or predict documentation in the form of sentences, paragraphs, and whole documents. At the same time, trying to update the entire system of digital threads for every update may be prohibitively slow and may present security risks to the system. Generating live DE documents that are updated based on a subset of a system's DE models and within a maximum time delay may therefore be more efficient.

### Interconnected Digital Engineering and Certification Ecosystem

FIG. 4 shows an exemplary implementation of the IDEP as an interconnected digital engineering (DE) and certification ecosystem 400, and exemplary digitally certified products, in accordance with some embodiments of the present invention. Interconnected DE and certification ecosystem 400 may be viewed as a particular instantiation or implementation of IDEP 300 shown in FIG. 3. The IDEP may also be referred to as a “DE Metaverse.”

Interconnected DE and certification ecosystem 400 is a computer-based system that links models and simulation tools with their relevant requirements in order to meet verification, validation, and certification purposes. Verification refers to methods of evaluating whether a product, service, or system meets specified requirements and is fit for its intended purpose. For example, in the aerospace industry, a verification process may include testing an aircraft component to ensure it can withstand the forces and conditions it will encounter during flight. Verification also includes checking externally against customer or stakeholder needs. Validation refers to methods of evaluating whether the overall performance of a product, service, or system is suitable for its intended use, including its compliance with regulatory requirements and its ability to meet the needs of its intended users. Validation also includes checking internally against specifications and regulations. Interconnected DE and certification ecosystem 400 as disclosed herein is designed to connect and bridge large numbers of disparate DE tools and models from multitudes of engineering domains and fields, or from separate organizations who may want to share models with each other but have no interactions otherwise. In various embodiments, the system implements a robust, scalable, and efficient DE model collaboration platform, with extensible model splices having data structures and accompanying functions for widely distributed DE model types and DE tools, an application layer that links or connects DE models via APIs, digital threads that connect live engineering model files for collaboration and sharing, digital documentation management to assist with the preparation of engineering and certification documents appropriate for verification and validation (V&V) purposes, and AI-assistance with the functionalities of the aforementioned system components.

More specifically, FIG. 4 shows an example of an interconnected DE and certification ecosystem and examples of digitally certified products 412A, 412B, and 412C (collectively referred to as digitally certified products 412). For example, in some implementations, digitally certified product 412A may be an unmanned aerial vehicle (UAV) or other aircraft, digitally certified product 412B may be a drug or other chemical or biologic compound, and the digitally certified product 412C may be a process such as a manufacturing process. In general, the digitally certified products 412 can include any product, process, or solution that can be developed, tested, or certified (partially or entirely) using DE tools such as 402. In some implementations, digitally certified products 412 may not be limited to physical products, but can include non-physical products such as methodologies, processes and software, etc. While physical and physically-interacting systems often require multiple DE tools to assess for compliance with common V&V products simply by virtue of the need for modeling and simulation (M&S), many complex non-physical systems may also require multiple DE tools for product development, testing, and/or certification. With this in mind, various other possibilities for digitally certified products will be recognized by one of ordinary skills in the art. The inclusion of regulatory and certification standards, compliances, calculations, and tests (e.g., for the development, testing, and certification of products and/or solutions) enables users to incorporate relevant regulatory and certification standards, compliances, calculations, and test data directly into their DE workflow. Regulatory and certification standards, compliances, calculations, and tests are sometimes referred to herein as “common validation and verification (V&V) products.”

Digitally certified products 412 in FIG. 4 may be designed and/or certified using interconnected DE and certification ecosystem 400. Interconnected DE and certification ecosystem 400 may include a user device 406A, API 406B, or other similar human-to-machine, or machine-to-machine communication interfaces operated by a user. A user may be a human 404 of various skill levels, or artificial users such as algorithms, artificial intelligence, or other software that interface with ecosystem 400 through API 406B. Ecosystem 400 may further comprise a computing and control system 408 (“computing system 408” hereinafter) connected to and/or including a data storage unit 418, an artificial intelligence (AI) engine 420, and an application and service layer 422. In some embodiments, the artificial intelligence (AI) engine 420 is a machine learning (ML) engine. References to “machine learning engine 420” or “ML engine 420” may be extended to artificial intelligence (AI) engine 420 more generally. For the purposes of clarity, any user selected from various potential human or artificial users is referred to herein simply as the user 404. In some implementations, computing system 408 may be a centralized computing system; in some implementations, computing system 408 may be a distributed computing system. In some cases, user 404 may be considered part of ecosystem 400, while in other implementations, user 404 may be considered separately from ecosystem 400. Ecosystem 400 may include one or more DE tools 402, such as data analysis tool 402A, computer-aided design (CAD) and finite element analysis (FEA) tool 402B, simulation tool 402C, drug modeling and simulation (M&S) tools 402D-402E, manufacturing M&S tools 402F-402G, etc. Ecosystem 400 may also include a repository of common V&V products 410, such as regulatory standards 410A-410F related to the development and certification of a UAV, medical standard 410G (e.g., CE marking (Europe), FCC Declaration of Conformity (USA), IECEE CB Scheme (Europe, North America, parts of Asia & Australia), CDSCO (India), FDA (USA), etc.), medical certification regulation 410H (e.g., ISO 13485, ISO 14971, ISO 9001, ISO 62304, ISO 10993, ISO 15223, ISO 11135, ISO 11137, ISO 11607, IEC 60601, etc.), manufacturing standard 410I (e.g., ISO 9001, ISO 9013, ISO 10204, EN 1090, ISO 14004, etc.), and manufacturing certification regulation 410J (e.g., General Certification of Conformity (GCC), etc.), etc.

In FIG. 4, computing system 408 is centrally disposed within the architecture and is configured to communicate with (e.g., receive data from and transmit data to) user device 406A or API 406B such as an API associated with an artificial user, DE tools 402 via an API or software development kit (SDK) 414, and repository of common V&V products 410 via an API/SDK interface 416. For example, computing system 408 may be configured to communicate with user device 406A and/or API 406B to send or receive data corresponding to a prototype of a design, information about a user (e.g., user credentials), engineering-related inputs/outputs associated with DE tools 402, digitized common V&V products, an evaluation of a product design, user instructions (e.g., search requests, data processing instructions, etc.), and more. Computing system 408 may also be configured to communicate with one or more DE tools 402 to send engineering-related inputs for executing analyses, models, simulations, tests, etc. and to receive engineering-related outputs associated with the results. Computing system 408 may also be configured to communicate with repository of common V&V products 410 to retrieve data corresponding to one or more digitized common V&V products 410 and/or upload new common V&V products, such as those received from user 404, to repository of common V&V products 410. All communications may be transmitted and corroborated securely, for example, using methods relying on zero-trust security. In some implementations, the computing system of the ecosystem may interface with regulatory and/or certification authorities (e.g., via websites operated by the authorities) to retrieve digitized common V&V products published by the regulatory authorities that may be relevant for a product that a user is designing. In some implementations, the user may upload digitized common V&V products to the ecosystem themselves.

Computing and control system 408 may process and/or store the data that it receives to perform analysis and control functionalities, and in some implementations, may access machine learning engine 420 and/or application and service layer 422, to identify useful insights based on the data, as further described herein. The central disposition of computing system 408 within the architecture of the ecosystem has many advantages including reducing the technical complexity of integrating the various DE tools; improving the product development experience of user 404; intelligently connecting common V&V products such as standards 410A-410F to DE tools 402 most useful for satisfying requirements associated with the common V&V products; and enabling the monitoring, storing, and analysis of the various data that flows between the elements of the ecosystem throughout the product development process. In some implementations, the data flowing through and potentially stored by the computing system 408 can also be auditable to prevent a security breach, to perform data quality control, etc. Similarly, any analysis and control functions performed via computing system 408 may be tracked for auditability and traceability considerations.

Referring to one particular example shown in FIG. 4, user 404 may use the DE and certification ecosystem to produce a digitally certified UAV 412B. For example, user 404 may be primarily concerned with certifying the UAV as satisfying the requirements of a particular regulatory standard 410E relating to failure conditions of the UAV (e.g., “MIL-HDBK 516C 4.1.4—Failure Conditions”). In this usage scenario, user 404 may develop a digital prototype of the UAV on user device 406A or using API 406B and may transmit prototype data (e.g., as at least one of a CAD file, a MBSE file, etc.) to computing system 408. Along with the prototype data, user 404 can transmit, via user device 406A, additional data including an indication of the common V&V product that user 404 is interested in certifying the product for (e.g., regulatory standard 410E), user credential information for accessing one or more capabilities of computing system 408, and/or instructions for running one or more digital models, tests, and/or simulations using a subset of DE tools 402.

Referring to another example shown in FIG. 4, user 404 can use the DE and certification ecosystem to produce a digitally certified drug, chemical compound, or biologic 412A. For example, user 404 may be primarily concerned with certifying drug, chemical compound, or biologic 412A as satisfying the requirements of a particular medical standard 410G and medical certification regulation 410H. In this usage scenario, user 404 can develop a digital prototype of the drug, chemical compound, or biologic on user device 406A or using API 406B and can transmit the prototype data (e.g., as a molecular modeling file) to computing system 408. Along with the prototype data, user 404 can transmit, via user device 406A, additional data including an indication of the common V&V products that user 404 is interested in certifying the product for (e.g., medical standard 410G and medical certification regulation 410H), user credential information for accessing one or more capabilities of computing system 408, and/or instructions for running one or more digital models, tests, and/or simulations using a subset of DE tools 402 (e.g., drug M&S tools 402D-402E).

Referring to yet another example shown in FIG. 4, user 404 can use the digital engineering and certification ecosystem to produce a digitally certified manufacturing process 412C. For example, user 404 may be primarily concerned with certifying manufacturing process 412C as satisfying the requirements of a particular manufacturing standard 410I and manufacturing certification regulation 410J. In this usage scenario, user 404 can develop a digital prototype of the manufacturing process on user device 406A or using API 406B and can transmit the prototype data to computing system 408. Along with the prototype data, user 404 can transmit, via the user device 406A, additional data including an indication of the common V&V products that user 404 is interested in certifying the process for (e.g., manufacturing standard 410I and manufacturing certification regulation 410J), user credential information for accessing one or more capabilities of computing system 408, and/or instructions for running one or more digital models, tests, and/or simulations using a subset of DE tools 402 (e.g., manufacturing M&S tools 402F-402G).

In any of the aforementioned examples, computing system 408 can receive the data transmitted from user device 406A and/or API 406B and can process the data to evaluate whether the common V&V product of interest (e.g., regulatory standard 410E, medical standard 410G, medical certification regulation 410H, manufacturing standard 410I, manufacturing certification regulation 410J, etc.) is satisfied by the user's digital prototype, in the context of analysis and control plane 350 shown in FIG. 3. For example, this can involve communicating with the repository of common V&V products 410 via the API/SDK 416 to retrieve the relevant common V&V product of interest and processing the regulatory and/or certification data associated with the common V&V product to identify one or more requirements for the UAV prototype; the drug, chemical compound, or biologic prototype; the manufacturing process prototype; etc. In some implementations, repository of common V&V products 410 can be hosted by a regulatory and/or certification authority (or another third party), and retrieving the regulatory and/or certification data can involve using API/SDK 416 to interface with one or more data resources maintained by the regulatory and/or certification authority (or another third party). In some implementations, the regulatory and/or certification data can be provided directly by user 404 via user device 406A and/or API 406B (e.g., along with the prototype data).

Evaluating whether the common V&V product of interest is satisfied by the user's digital prototype can also involve processing the prototype data received from user device 406A or API 406B to determine if the one or more identified requirements are actually satisfied. In some implementations, computing system 408 can include one or more plugins, local applications, etc. to process the prototype data directly at the computing system 408. For example, model splicing and digital threading applications are discussed in detail later with reference to FIGS. 8 to 11. In some implementations, the computing system can simply pre-process the received prototype data (e.g., to derive inputs for DE tools 402) and can then transmit instructions and/or input data to a subset of DE tools 402 via API/SDK 414 for further processing.

Not all DE tools 402 are necessarily required for the satisfaction of particular regulatory and/or certification standards. Therefore, in the UAV example provided in FIG. 4, computing system 408 may determine that only a data analysis tool 402A and a finite element analysis tool 402B are required to satisfy regulatory standard 410E for failure conditions. In the drug, chemical compound, or biologic example provided in FIG. 4, computing system 408 may determine that only drug M&S tools 402D-402E are required to satisfy medical standard 410G and medical certification regulation 410H. In the manufacturing process example provided in FIG. 4, computing system 408 may determine that only manufacturing M&S tools 402F-402G are required to satisfy manufacturing standard 410I and manufacturing certification regulation 410J. In other implementations, user 404 may themselves identify the particular subset of DE tools 402 that should be used to satisfy the common V&V product of interest, provided that user 404 is a qualified subject matter expert (SME). In other implementations, user 404 may input to computing system 408 some suggested DE tools 402 to satisfy a common V&V product of interest, and computing system 408 can recommend to user 404 a modified subset of DE tools 402 for final approval by user 404, provided that user 404 is a qualified SME. After a subset of DE tools 402 has been identified, computing system 408 can then transmit instructions and/or input data to the identified subset of DE tools 402 to run one or more models, tests, and/or simulations. The results (or “engineering-related data outputs” or “digital artifacts”) of these models, tests, and/or simulations can be transmitted back and received at computing system 408.

In still other implementations, user 404 may input a required DE tool such as 402F for meeting a common V&V product 410I, and the computing system 408 can determine that another DE tool such as 102G is also required to satisfy common V&V product 410I. The computing system can then transmit instructions and/or input data to both DE tools (e.g., 402F and 402G), and the outputs of these DE tools can be transmitted and received at computing system 408. In some cases, the input data submitted to one of the DE tools (e.g., 402G) can be derived (e.g., by computing system 408) from the output of another of the DE tools (e.g., 402F).

After receiving engineering-related data outputs or digital artifacts from DE tools 402, computing system 408 can then process the received engineering-related data outputs to evaluate whether or not the requirements identified in the common V&V product of interest (e.g., regulatory standard 410E, medical standard 4110G, medical certification regulation 410H, manufacturing standard 410I, manufacturing certification regulation 410J, etc.) are satisfied. For example, applications and services 422 may provide instructions for orchestrating validation or verification activities. In some implementations, computing system 408 can generate a report summarizing the results of the evaluation and can transmit the report to device 406A or API 406B for review by user 404. If all of the requirements are satisfied, then the prototype can be certified, resulting in digitally certified product 412 (e.g., digitally certified drug, chemical compound, or biologic 412A; digitally certified UAV 412B; digitally certified manufacturing process 412C, etc.). However, if some of the regulatory requirements are not satisfied, then additional steps may need to be taken by user 404 to certify the prototype of the product. In some implementations, the report that is transmitted to the user can include recommendations for these additional steps (e.g., suggesting one or more design changes, suggesting the replacement of one or more components with a previously designed solution, suggesting one or more adjustments to the inputs of the models, tests, and/or simulations, etc.). If the requirements of a common V&V product are partially met, or are beyond the collective capabilities of distributed engineering tools 402, computing systems 408 may provide user 404 with a report recommending partial certification, compliance, or fulfillment of a subset of the common V&V products (e.g., digital certification of a subsystem or a sub-process of the prototype). The process of generating recommendations for user 404 is described in further detail below.

In response to reviewing the report, user 404 can make design changes to the digital prototype locally and/or can send one or more instructions to computing system 408 via user device 406A or API 406B. These instructions can include, for example, instructions for computing system 408 to re-evaluate an updated prototype design, use one or more different DE tools 402 for the evaluation process, and/or modify the inputs to DE tools 402. Computing system 408 can, in turn, receive the user instructions, perform one or more additional data manipulations in accordance with these instructions, and provide user 404 with an updated report. Through this iterative process, user 404 can utilize the interconnected digital engineering and certification ecosystem to design and ultimately certify (e.g., by providing certification compliance information) the prototype (e.g., the UAV prototype, drug prototype, manufacturing process prototype, etc.) with respect to the common V&V product of interest. Importantly, since all of these steps occur in the digital world (e.g., with digital prototypes, digital models/tests/simulations, and digital certification), significant amount of time, cost, and materials can be saved in comparison to a process that would involve the physical prototyping, evaluation and/or certification of a similar UAV, drug, manufacturing process, etc. If the requirements associated with a common V&V product are partially met, or are beyond the collective capabilities of DE tools 402, computing system 408 may provide user 404 with a report recommending partial certification, compliance or fulfillment of a subset of the common V&V products (e.g., digital certification of a subsystem or a sub-process of the prototype).

While the examples described above focus on the use of the interconnected digital engineering and certification ecosystem by a single user, additional advantages of the ecosystem can be realized through the repeated use of the ecosystem by multiple users. As mentioned above, the central positioning of computing system 408 within the architecture of the ecosystem enables computing system 408 to monitor and store the various data flows through the ecosystem. Thus, as an increasing number of users utilize the ecosystem for digital product development, data associated with each use of the ecosystem can be stored (e.g., in storage 418), traced (e.g., with metadata), and analyzed to yield various insights, which can be used to further automate the digital product development process and to make the digital product development process easier to navigate for non-subject matter experts.

Indeed, in some implementations, user credentials for user 404 can be indicative of the skill level of user 404, and can control the amount of automated assistance the user is provided. For example, non-subject matter experts may only be allowed to utilize the ecosystem to browse pre-made designs and/or solutions, to use DE tools 402 with certain default parameters, and/or to follow a predetermined workflow with automated assistance directing user 404 through the product development process. Meanwhile, more skilled users may still be provided with automated assistance, but may be provided with more opportunities to override default or suggested workflows and settings.

In some implementations, computing system 408 can host applications and services 422 that automate or partially automate components of common V&V products; expected or common data transmissions, including components of data transmissions, from user 404; expected or common interfaces and/or data exchanges, including components of interfaces, between various DE tools 402; expected or common interfaces and/or data exchanges, including components of interfaces, with machine learning (ML) models implemented on computing system 408 (e.g., models trained and/or implemented by the ML engine 420); and expected or common interfaces and/or data exchanges between the applications and services themselves (e.g., within applications and services layer 422).

In some implementations, the data from multiple uses of the ecosystem (or a portion of said data) can be aggregated to develop a training dataset. For example, usage records 417 collected via computing system 408 may be de-identified or anonymized, before being added to the training set. Such usage records may comprise model parameters and metadata, tool configurations, common V&V product matching to specific models or tools, user interactions with the system including inputs and actions, and other user-defined or system-defined configurations or decisions in using the ecosystem for digital engineering and certification. For instance, an exemplary de-identified usage record may comprise the combination of a specific DE tool, a specific target metric, a specific quantity deviation, and a corresponding specific user update to a DE model under this configuration. Another exemplary de-identified usage record may comprise a user-identified subset of DE tools 402 that should be used to satisfy a common V&V product of interest.

This training dataset can then be used to train ML models (e.g., using ML engine 420) to learn the steps and actions for certification processes and to perform a variety of tasks including the identification of which of DE tools 402 to use to satisfy a particular common V&V product; the identification of specific models, tests, and/or simulations (including inputs to them) that should be performed using DE tools 402; the identification of the common V&V products that need to be considered for a product of a particular type; the identification of one or more recommended actions for user 404 to take in response to a failed regulatory requirement; the estimation of model/test/simulation sensitivity to particular inputs; etc. The outputs of the trained ML models can be used to implement various features of the interconnected digital engineering and certification ecosystem including automatically suggesting inputs (e.g., inputs to DE tools 402) based on previously entered inputs, forecasting time and cost requirements for developing a product, predictively estimating the results of sensitivity analyses, and even suggesting design changes, original designs or design alternatives (e.g., via assistive or generative AI) to a user's prototype to overcome one or more requirements (e.g., regulatory and/or certification requirements) associated with a common V&V product. In some implementations, with enough training data, ML engine 420 may generate new designs, models, simulations, tests, common V&V products and/or digital threads on its own based on data collected from multiple uses of the ecosystem. Furthermore, such new designs, models, simulations, tests, common V&V products and digital threads generated by ML engine 420, once approved and adjusted by a user, may be added to the training set for further fine-tuning of ML algorithms in a reinforcement learning setup.

As shall be discussed in the context of FIGS. 9 to 11, the aforementioned collection of training datasets and the training of ML and AI modules including ML engine 420 may be enabled by model splicing technologies. Model splicing, as described herein, allows the scripting of DE model operations encompassing disparate DE tools into a corpus of normative program code, and facilitates the code-defined digital threading of a large space of DE activities involving DE models across different disciplines. ML and AI techniques may be used to create scripts to carry out almost any DE task and to execute any digital thread, allowing for programmable, machine-learnable, and dynamic changes to DE model files, digital threads, and ultimately to digital or physical twins, throughout the product life cycle. For example, in the embodiment shown in FIG. 4, ML engine 420 may manage or orchestrate the interactions between spliced DE models, DE tools, and common V&V products (e.g., DE requirements), based on digital thread options specific to user's intent and input. Sample DE tasks that may be carried out by ML engine 420 include, but are not limited to, (1) aligning models/analysis to certification lifecycle requirement steps, (2) optimizing compute by determining the appropriate fidelity of each model, (3) optimizing compute resources for specific tools/models, or (4) optimizing compute resources across multiple models. ML-enabled executions of DE tasks are not limited to certification or resource optimization, but encompass the whole DE space of operations. Rather, ML engine 420 may act as an AI multiplexer for the DE platform.

In addition to storing usage data to enable the development of ML models, previous prototype designs and/or solutions (e.g., previously designed components, systems, models, simulations and/or other engineering representations thereof) can be stored within the ecosystem (e.g., in storage 418) to enable users to search for and build upon the work of others. For example, previously designed components, systems, models, simulations and/or other engineering representations thereof can be searched for by user 404 and/or suggested to user 404 by computing system 408 in order to satisfy one or more requirements associated with a common V&V product. The previously designed components, systems, models, simulations and/or other engineering representations thereof can be utilized by user 404 as is, or can be utilized as a starting point for additional modifications. This store, or repository, of previously designed components, systems, models, simulations and/or other engineering representations thereof (whether or not they were ultimately certified) can be monetized to create a marketplace of digital products, which can be utilized to save time during the digital product development process, inspire users with alternative design ideas, avoid duplicative efforts, and more. In some implementations, data corresponding to previous designs and/or solutions may only be stored if the user who developed the design and/or solution opts to share the data. In some implementations, the repository of previous designs and/or solutions can be containerized for private usage within a single company, team, organizational entity, or technical field for private usage (e.g., to avoid the unwanted disclosure of confidential information). In some implementations, user credentials associated with user 404 can be checked by computing system 408 to determine which designs and/or solutions stored in the repository can be accessed by user 404. In some implementations, usage of the previously designed components, systems, models, simulations and/or other engineering representations thereof may be available only to other users who pay a fee for a usage.

Exemplary IDEP Implementation Architecture with Services and Features

FIG. 5 shows another exemplary implementation of the IDEP illustrating its offered services and features, in accordance with some embodiments of the present invention. Specifically, an exemplary implementation architecture diagram 500 is shown in FIG. 5 to include multiple illustrative components: an IDEP enclave 502, cloud services 504, and a customer environment 510 which optionally includes an IDEP exclave 516. This exemplary architecture 500 for the IDEP is designed in accordance with zero-trust security principles and is further designed to support scalability as well as robust and resilient operations. IDEP enclave 502 and IDEP exclave 516 together instantiate IDEP 300 shown in FIG. 3, with IDEP exclave 516 implementing model splicing and splice plane 370 in some embodiments of the present invention. An enclave is an independent set of cloud resources that are partitioned to be accessed by a single customer (i.e., single-tenant) or market (i.e., multi-tenant) that does not take dependencies on resources in other enclaves. An exclave is a set of cloud resources outside enclaves managed by the IDEP, to perform work for individual customers. Examples of exclaves include virtual machines (VMs) and/or servers that the IDEP maintains to run DE tools for customers who need such services.

In particular, IDEP enclave or DE platform enclave 502 may serve as a starting point for services rendered by the IDEP, and may be visualized as a central command and control hub responsible for the management and orchestration of all platform operations. For example, enclave 502 may be implemented using computer system 208 of the interconnected DE and certification ecosystem shown in FIG. 4. DE platform enclave 502 is designed to integrate both zero-trust security models and hyperscale capabilities, resulting in a secure and scalable processing environment tailored to individual customer needs. Zero-trust security features include, but are not limited to, strict access control, algorithmic impartiality, and data isolation. Enclave 502 also supports an ML engine such as 420 for real-time analytics, auto-scaling features for workload adaptability, and API-based interoperability with third-party services. Security and resource optimization are enhanced through multi-tenancy support, role-based access control, and data encryption both at rest and in transit. DE platform enclave 502 may also include one or more of the features described below.

First, IDEP enclave 502 may be designed in accordance with zero-trust security principles. In particular, DE platform enclave 502 may employ zero-trust principles to ensure that no implicit trust is assumed between any elements, such as digital models, platform agents or individual users (e.g., users 204) or their actions, within the system. That is, no agent may be inherently trusted and the system may always authenticate or authorize for specific jobs. The model is further strengthened through strict access control mechanisms, limiting even the administrative team (e.g., a team of individuals associated with the platform provider) to predetermined, restricted access to enclave resources. To augment this robust security stance, data encryption is applied both at rest and in transit, effectively mitigating risks of unauthorized access and data breaches.

IDEP enclave 502 can also be designed to maintain isolation and independence. A key aspect of the enclave's architecture is its focus on impartiality and isolation. DE enclave 502 disallows cryptographic dependencies from external enclaves and enforces strong isolation policies. The enclave's design also allows for both single-tenant and multi-tenant configurations, further strengthening data and process isolation between customers 506 (e.g., users 204). Additionally, DE enclave 502 is designed with decoupled resource sets, minimizing interdependencies and thereby promoting system efficiency and autonomy.

IDEP enclave 502 can further be designed for scalability and adaptability, aligning well with varying operational requirements. For example, the enclave 502 can incorporate hyperscale-like properties in conjunction with zero-trust principles to enable scalable growth and to handle high-performance workloads effectively.

IDEP enclave 502 can further be designed for workflow adaptability, accommodating varying customer workflows and DE models through strict access control mechanisms. This configurability allows for a modular approach to integrate different functionalities ranging from data ingestion to algorithm execution, without compromising on the zero-trust security posture. Platform 500's adaptability makes it highly versatile for a multitude of use-cases, while ensuring consistent performance and robust security.

IDEP enclave 502 can further be designed to enable analytics for robust platform operations. At the core of the enclave's operational efficiency is a machine learning engine (e.g., machine learning engine 220) capable of performing real-time analytics. This enhances decision-making and operational efficiency across platform 500. Auto-scaling mechanisms can also be included to enable dynamic resource allocation based on workload demand, further adding to the platform's responsiveness and efficiency.

In the exemplary embodiment shown in FIG. 5, IDEP enclave 502 includes several components as described in further detail herein.

A “Monitoring Service Cell. may provide “Monitoring Service” and “Telemetry Service.” A cell may refer to a set of microservices, for example, a set of microservices executing within a kubernetes pod. These components focus on maintaining, tracking and analyzing the performance of platform 500 to ensure good service delivery, including advanced machine learning capabilities for real-time analytics. A “Search Service Cell” provides “Search Service” to aid in the efficient retrieval of information from DE platform 500, adding to its overall functionality. A “Logging Service Cell” and a “Control Plane Service Cell” provide “Logging Service,” “File Service”, and “Job Service” to record and manage operational events and information flow within platform 500, and are instrumental in the functioning of platform 500. A “Static Assets Service Cell,” provides “Statics Service”, and may house user interface, SDKs, command line interface (CLI), and documentation for platform 500. An “API Gateway Service Cell” provides “API Gateway Service,” and may provide DE platform API(s) (e.g., APIs 214, 216) and act as a mediator for requests between the client applications (e.g., DE tools 202, the repository of common V&V products 210, etc.) and the platform services. In some embodiments, the API gateway service cell may receive and respond to requests from agents such as DE platform exclave 516 to provide splice functions for model splicing purposes.

As shown in FIG. 5, the architecture of DE platform 500 may also include a cloud services 504 that provide services which cannot interact with customer data but can modify the software for the orchestration of DE platform operations. In example implementations, several cloud resources provide support and foundational services to the platform. For example, in the embodiment of the DE platform 500 shown in FIG. 5, cloud services 504 includes a “Customer Identity and Access Management (IAM) Service” that ensures secure and controlled access to platform 500. Cloud services 504 also includes a “Test Service” that tests tools to validate platform operations. In the context of software testing, the Test Service can be thought of as the execution layer that manages and orchestrates the different types of tests on the platform. The Test Service may utilize the test scripts generated, and additionally has functionality to generate tests for specific UI or API level testing. Cloud services 504 may also include an “Orchestration Service” that controls and manages the lifecycle of containers on the platform 500. Cloud services 504 may also include an “Artifact Service” and “Version Control and Build Services,” which may be used to maintain the evolution of projects, codes, and instances in the system, while also managing artifacts produced during the product development process.

As shown in FIG. 5, the architecture of DE platform 500 may also include a customer environment 510 with an “Authoritative Source of Truth” 512, customer tools 514, and an optional DE platform exclave 516. Customer environment 510 is where customer data resides and is processed in a zero-trust manner by DE platform 500. As described previously, DE platform enclave 502, by focusing on both zero-trust principles and hyperscale-like properties, provides a robust and scalable environment for the secure processing of significant workloads, according to the customer's unique needs. In some examples, DE platform exclave 516 may be situated within customer environment 510 in order to assist the customer(s) 506 with their DE tasks and operations, including model splicing and digital threading.

When a customer 506 (e.g., user 404) intends to perform a DE task using DE platform 500 (e.g., IDEP 100), typical operations may include secure data ingestion and controlled data retrieval. Derivative data generated through the DE operations, such as updated digital model files or revisions to digital model parameters, may be stored only within customer environment 510, and DE platform 500 may provide tools to access the metadata of the derivative data. Here, metadata refers to data that can be viewed without opening the original data, and may comprise versioning information, time stamps, access control properties, and the like. Example implementations may include secure data ingestion, which utilizes zero-trust principles to ensure customer data is securely uploaded to customer environment 510 through a pre-validated secure tunnel, such as Secure Socket Layer (SSL) tunnel. This can enable direct and secure file transfer to a designated cloud storage, such as a simple storage service (S3) bucket, within customer environment 510. Example implementations may also include controlled data retrieval, in which temporary, pre-authenticated URLs generated via secure token-based mechanisms are used for controlled data access, thereby minimizing the risk of unauthorized interactions. Example implementations may also include immutable derivative data, with transformed data generated through operations like data extraction being securely stored within customer environment 510 while adhering to zero-trust security protocols. Example implementations may also include tokenization utility, in which a specialized DE platform tool referred to as a “tokenizer” is deployed within customer environment 510 for secure management of derivative metadata, conforming to zero-trust guidelines.

Customer environment 510 may interact with other elements of secure DE platform 500 and includes multiple features that handle data storage and secure interactions with platform 500. For example, one element of the customer environment 510 is “Authoritative Source of Truth” 512, which is a principal repository for customer data, ensuring data integrity and accuracy. Nested within this are “Customer Buckets” where data is securely stored with strict access controls, limiting data access to authorized users or processes through pre-authenticated URL links. This setup ensures uncompromising data security within customer environment 510 while providing smooth interactions with other elements of DE platform 500.

Customer environment 510 may also include additional software tools such as customer tools 514 that can be utilized based on specific customer requirements. For example, a “DE Tool Host” component may handle necessary DE applications for working with customer data. It may include a DE Tools Command-Line Interface (DET CLI), enabling user-friendly command-line operation of DE tools (e.g., DE tools 102). A “DE platform Agent” ensures smooth communication and management between customer environment 510 and elements of DE platform 500. Furthermore, there can be another set of optional DE tools designed to assist customer-specific DE workflows. Native DE tools are typically access-restricted by proprietary licenses and end-user license agreements paid for by the customer. IDEP platform functions call upon native DE tools that are executed within customer environment 510, therefore closely adhering to the zero-trust principle of the system design. Exemplary DE tools include, but are not limited to, proprietary and open-source versions of model-based systems engineering (MBSE) tools, augmented reality (AR) tools, computer aided design (CAD) tools, data analytics tools, modeling and simulation (M&S) tools, product lifecycle management (PLM) tools, multi-attribute trade-space tools, simulation engines, requirements model tools, electronics model tools, test-plan model tools, cost-model tools, schedule model tools, supply-chain model tools, manufacturing model tools, cyber security model tools, or mission effects model tools.

In some cases, an optional “IDEP Exclave” 516 may be employed within customer environment 510 to assist with customer DE tasks and operations, supervise data processing, and rigorously adhering to zero-trust principles while delivering hyperscale-like platform performance. IDEP exclave 516 is maintained by the IDEP to run DE tools for customers who need such services. IDEP exclave 516 may contain a “DE Tool Host” that runs DE tools and a “DE Platform Agent” necessary for the operation. Again, native DE tools are typically access-restricted by proprietary licenses and end-user license agreements paid for by the customer. IDEP exclave 516 utilities and manages proprietary DE tools hosted with customer environment 510, for example, to implement model splicing and digital threading functionalities.

In some embodiments, the machine learning (ML) models and artificial intelligence (AI) assistance approaches as described herein adapt to suit different customer instances of the IDEP (see FIG. 6) and the availability of training data. In an example, a pre-trained ML or AI model (e.g., within the IDEP enclave 502) is deployed in instances where there are restrictions around sharing customer data. In another example, AI models are deployed in a federated manner adjacent to DE agents and DE tools in the customer environment (e.g., within IDEP exclave 516). In another example, an AI model deployed inside the customer environment is trained behind its firewalls. In yet another example, the customer may allow sharing of subsets of their metadata for a training database located within the IDEP enclave.

### IDEP Deployment Scenarios

FIG. 6 shows potential scenarios for instantiating an IDEP in connection to a customer's physical system and IT environment, in accordance with some embodiments of the present invention. Specifically, FIG. 6 illustrates various potential configurations for instancing or instantiating an IDEP (“DE platform) 602 in connection to a customer's IT environment and physical system 604. The IT environment may be located on a virtual private cloud (VPC) protected by a firewall. The physical system may refer to a physical twin as discussed with reference to FIG. 3. In some embodiments, IDEP 602 may be instanced as an enclave such as 502 shown in FIG. 5. For example, IDEP 602 may be instanced on the cloud, possibly in a software-as-a-service (SaaS) configuration. The platform instances in these embodiments include software and algorithms, and may be described as follows:
1. External Platform Instance 610: This option showcases the IDEP as a separate platform instance. The platform interacts with the physical system through the customer's virtual environment, or a Customer Virtual Private Cloud (“Customer VPC”), which is connected to the physical system.
2. External Platform Instance with Internal Agent 620: The IDEP is instantiated as a separate platform, connected to an internal agent (“DE Agent”) wholly instanced within the Customer VPC. For example, the IDEP may be instantiated as enclave 302, and the DE agent may be instantiated as exclave 316 within the Customer VPC linked to the physical system.
3. External Platform Instance with Internal Agent and Edge Computing 630: This scenario displays the IDEP as a separate instantiation, connected to an internal DE Agent wholly instanced within the Customer VPC, which is further linked to an edge instance (“DE Edge Instance”) on the physical system. The DE agent is nested within the customer environment, with a smaller edge computing instance attached to the physical system.
4. Edge Instance Connection 640: This option shows the DE platform linked directly to an DE edge instance on the physical system. The DE platform and the physical system are depicted separately, connected by an edge computing instance in the middle, indicating the flow of data.
5. Direct API Connection 650: This deployment scenario shows the DE platform connecting directly to the physical system via API calls. In this depiction, an arrow extends directly from the platform sphere to the physical system sphere, signifying a direct interaction through API.
6. Air-Gapped Platform Instance 660: This scenario illustrates the IDEP being completely instanced on an air-gapped, or isolated, physical system as a DE agent. The platform operates independently from any networks or Internet connections, providing an additional layer of security by eliminating external access points and potential threats. Interaction with the platform in this context would occur directly on the physical system, with any data exchange outside the physical system being controlled following strict security protocols to maintain the air-gapped environment.

Across these deployment scenarios, the IDEP plays an important role in bridging the gap between a digital twin (DTw) established through the IDEP and its physical counterpart. Regardless of how the IDEP is instantiated, it interacts with the physical system, directly or through the customer's virtual environment. The use of edge computing instances in some scenarios demonstrates the need for localized data processing and the trade-offs between real-time analytics and more precise insights in digital-physical system management. Furthermore, the ability of the platform to connect directly to the physical system through API calls underscores the importance of interoperability in facilitating efficient data exchange between the digital and physical worlds. In all cases, the DE platform operates with robust security measures.

In some embodiments, the IDEP deployment for the same physical system can comprise a combination of the deployment scenarios described above. For example, for the same customer, some physical systems may have direct API connections to the DE platform (scenario 5), while other physical systems may have an edge instance connection (scenario 4).

### Multimodal User Interfaces

FIG. 7 illustrates the use of multimodal user interfaces 790 for the interconnected DE platform, which can handle various input and output modalities such as Virtual Reality (VR), Mixed Reality (MR), auditory, text, and code. These interfaces are designed to manage the complexity of data streams and decision-making processes, and provide decision support including option visualization, impact prediction, and specific decision invocation. Specifically, data streams 702 and 704 are processed in the Analysis & Control Plane (ACP) 350 of FIG. 3. The user interface may receive data streams from physical and virtual feedback loops 302 and 304, as well as external expert feedback 314, analysis module 354, and twin configuration set 356 of ACP 350.

The multimodal interfaces illustrated in FIG. 7 are configured to carry out all the DE tasks and actions described in the context of FIG. 3, by catering to both humans and bots/algorithms, handling the intricacies of data stream frequency and complexity, decision-making time scales, and latency impacts. In the case of human decision makers, the user interface may need to manage inputs and outputs while for algorithmic decision making, the user interface may need to present rationale and decision analysis to human users. Some examples of human interfaces include a dashboard-style interface 794, a workflow-based interface 796, conversational interfaces 798, spatial computer interfaces 792, and code interfaces 799.

Dashboard-style interface 794 offers a customizable overview of data visualizations, performance metrics, and system status indicators. It enables monitoring of relevant information, sectional review of documents, and decision-making based on dynamic data updates and external feedback. Such an interface may be accessible via web browsers and standalone applications on various devices.

Workflow-based interface 796 guides users through the decision-making process, presenting relevant data, options, and contextual information at each stage. It integrates external feedback and is designed as a progressive web app or a mobile app. In the context of alternative tool selection, workflow-based interface 796 may provide options on individual tools at each stage, or provide combinations of tool selections through various stages to achieve better accuracy or efficiency for the overall workflow.

Conversational interfaces 798 are based on the conversion of various input formats such as text, prompt, voice, audio-visual, etc. into input text, then integrating the resulting input text within the DE platform workflow. Outputs from the DE platform may undergo the reverse process. This enables interoperability with the DE platform, and specifically the manipulation of model splices. In the broad context of audio-visual inputs, the conversational interfaces may comprise data sonification, which involves using sound to represent data, information, or events, and using auditory cues or patterns to communicate important information to users, operators, or reviewers. Sonified alerts (e.g., alerts sent via sound, e.g., via a speaker) are especially useful when individuals need to process information quickly without having to visually focus on a screen. For example, sonified alerts can be used to notify security analysts of potential threats or breaches.

According to the latest prior art, a “conversational interface” or “conversational user interface” refers to a human-computer interaction model that enables users to interact with digital systems through natural language, either via text or voice. These interfaces utilize advanced natural language processing (NLP), machine learning, and artificial intelligence technologies to understand and respond to user inputs in a manner that mimics human conversation. Conversational interfaces can take various forms, including chatbots, voice assistants, and messaging platforms, allowing users to communicate with systems using everyday language rather than traditional graphical user interface elements. The goal of these interfaces is to provide a more intuitive, accessible, and personalized user experience by leveraging the familiar paradigm of conversation, enabling users to accomplish tasks, retrieve information, or control devices through natural dialogue without requiring specialized knowledge of complex commands or navigation structures.

FIG. 7 also illustrates the use of spatial computing interfaces 792 and code interfaces 799 in the management of DTws and PTws. Spatial computing interfaces allow for more immersive and intuitive user experiences, and enable real-time synchronization between DTws and PTws. Code interfaces allow bots and digital engineers to interact with the DE platform through scripting and code. It also allows the collection of user preference, task history, and tool usage patterns for alternative tool selection purposes.

A “spatial interface” or “spatial user interface” refers to a user interaction paradigm that leverages three-dimensional space and spatial relationships to present and manipulate digital information. This approach goes beyond traditional 2D graphical user interfaces by incorporating depth, volume, and spatial positioning to create more intuitive and immersive user experiences. Spatial interfaces often utilize technologies such as augmented reality (AR), virtual reality (VR), or mixed reality (MR) to overlay digital content onto the physical world or create entirely virtual environments. These interfaces allow users to interact with digital objects and information as if they were physical entities in space, using natural gestures, body movements, direction of audio or eye gaze, and spatial awareness to navigate, manipulate, and organize content in ways that more closely mimic real-world interactions.

Note that in the context of multimodal interfaces, “2.5 dimension” (often referred to as 2.5D) describes a visual representation that falls between traditional 2D and full 3D interfaces. It typically involves adding depth and perspective to 2D elements to create a pseudo-3D effect, without fully rendering a complete 3D environment. The 2.5D approach is typically designed to create the illusion of depth and dimensionality on flat, two-dimensional displays such as computer monitors, smartphone screens, or tablets, although it may be used within a 3D setting (e.g., 2D screens overlaid into 3D). This approach often uses techniques such as layering, parallax scrolling, or isometric projections to give the illusion of depth and volume while maintaining the simplicity and familiarity of 2D interfaces.

### Digital Threads and Autonomous Data Linkages

As discussed previously, a “digital thread” is intended to connect two or more digital engineering (DE) models for traceability across the systems engineering lifecycle, and collaboration and sharing among individuals performing DE tasks. In a digital thread, appropriate outputs from a preceding digital model may be provided as the inputs to a subsequent digital model, allowing for information and process flow. That is, a digital thread may be viewed as a communication framework or data-driven architecture that connects traditionally siloed elements to enable the flow of information and actions between digital models.

FIG. 8 describes the architecture and inherent complexity of digital threads, in accordance with the examples disclosed herein. Specifically, FIG. 8 is a schematic diagram comparing exemplary digital threads 800 of various complexities that manipulate and/or connect DE models, in accordance with some embodiments of the present invention. In the most basic sense, a digital thread may “thread” together DE models into a simple daisy-chain architecture 802 where modifications in any upstream DE model will affect all DE models downstream from the modified DE model. For example, a modification of any parameter or process of a DE model B will cause changes in DE model C, which in turn will cause changes in DE model D. Cause-and-effect changes will therefore cascade downstream. As another example, diagram 804 represents a more complex digital thread where a change in one DE model may affect more than one downstream model. In both 802 and 804, digital threads are represented by a directed acyclic graph (DAG).

DAGs are frequently used in many kinds of data processing and structuring tasks, such as scheduling tasks, data compression algorithms, and more. In the context of service platforms and network complexities, a DAG might be used to represent the relationships between different components or services within the platform. In digital thread 804, different models may depend on each other in different ways. Model A may affect models B, C, and D, with models B and C affecting model E, and models D and E affecting model G. Such dependencies are denoted as a DAG, where each node is associated with a component (e.g., a model), and each directed edge represents a dependency.

A major issue with dealing with interdependent DE models is that graph consistencies can be polynomial, and potentially exponential, in complexity. Hence, if a node fails (e.g., a model is unreliable), this can have a cascading effect on the rest of the digital thread, disrupting the entire design. Furthermore, adding nodes or dependencies to the graph does not yield a linear increase in complexity because of the interdependencies between models. If a new model is added that affects or depends on several existing models, the resulting increase in graph complexity is multiplicative in nature, hence potentially exponential. The multiplicative nature of digital thread consistencies is compounded by the sheer number of interconnected models, which may number in the hundreds or thousands. Diagram 806 is a partial representation of a real-world digital thread, illustrating the complexity of digital threads and its multiplicative growth.

FIG. 8 further shows special cases 803, 805, 807, 808, and 809 of exemplary simple digital threads. Diagram 807 represents a degenerate digital thread where data is shared from a single DE model. Diagram 808 represents a model-to-document digital thread where data (e.g., system attributes, performance attributes) extracted from a single DE model may be used to generate or update a text-based document (e.g., a Capability Development Document (CDD)). Diagrams 803 and 805 are generalized from 808 to represent cases where data extracted from a single model may be used to update multiple models, or vice versa. Specifically, diagram 805 may represent the dynamic updates of live or magic documents discussed in the context of FIG. 3. Here, the logic to connect the DE models shown is clear: data are extracted from multiple DE models A, B, and C to update a document model D. There are no interactions between the extracted data. Furthermore, diagram 809 shows a special case of a digital thread where data is loaded to and extracted from only a single model A. For example, as discussed in the context of FIG. 9 next, input splice functions of the model A shown in 809 may be executed to update the model, and output splice functions of model A shown in 809 may be executed to produce digital artifacts for sharing. For these special simple threads, the IDEP may provide a GUI-based interface to the user to connect the models and execute the digital threads. For complex threads such as 806, a code-based interface may be necessary.

### Model Splicing for Digital Threading and Digital Twin Generation

As disclosed herein, model splicing encapsulates and compartmentalizes digital engineering (DE) model data and model data manipulation and access functionalities. As such, model splices provide access to selective model data within a DE model file without exposing the entire DE model file, with access control to the encapsulated model data based on user access permissions. Model splicing also provides the DE model with a common, externally-accessible Application Programming Interface (API) for the programmatic execution of DE models. Model splices thus generated may be shared, executed, revised, or further spliced independently of the native DE tool and development platform used to generate the input digital model. The standardization of DE model data and the generalization of API interfaces and functions allow the access of DE model type files outside of their native software environments, and enable the linking of different DE model type files that may not previously be interoperable. Model splicing further enables the scripting and codification of DE operations encompassing disparate DE tools into a corpus of normative program code, facilitating the generation and training of artificial intelligence (AI) and machine learning (ML) models for the purpose of manipulating DE models through various DE tools across different stages of a DE process, DE workflow, or a DE life cycle.

Digital threads are created through user-directed and/or autonomous linking of model splices. A digital thread is intended to connect two or more DE models for traceability across the systems engineering life cycle, and collaboration and sharing among individuals performing DE tasks. In a digital thread, appropriate outputs from a preceding digital model are provided as inputs to a subsequent digital model, allowing for information flow. That is, a digital thread may be viewed as a communication framework or data-driven architecture that connects traditionally siloed elements to enable the flow of information between digital models. The extensibility of model splicing over many different types of DE models and DE tools enables the scaling and generalization of digital threads to represent each and every stage of the DE life cycle.

A digital twin (DTw) is a real-time virtual replica of a physical object or system, with bi-directional information flow between the virtual and physical domains, allowing for monitoring, analysis, and optimization. Model splicing allows for making individual DE model files into executable splices that can be autonomously and securely linked, thus enabling the management of a large number of DE models as a unified digital thread. Such a capability extends to link previously non-interoperable DE models to create digital threads, receive external performance and sensor data streams (e.g., data that is aggregated from DE models or linked from physical sensor data), calibrate digital twins with data streams from physical sensors outside of native DTw environments, and receive expert feedback that provides opportunity to refine simulations and model parameters.

Unlike a DTw, a virtual replica, or simulation, is a mathematical model that imitates real-world behavior to predict outcomes and test strategies. Digital twins use real-time data and have bidirectional communication, while simulations focus on analyzing scenarios and predicting results. In other words, a DTw reflects the state of a physical system in time and space. A simulation is a set of operations done on digital models that reflects the potential future states or outcomes that the digital models can progress to in the future. A simulation model is a DE model within the context of the IDEP as disclosed herein.

When testing different designs, such as variations in wing length or chord dimensions, multiple DTws (sometimes numbering in 100s to 1,000s) may be created, as a bridge between design specifications and real-world implementations of a system, allowing for seamless updates and tracking of variations through vast numbers of variables, as detailed in the context of FIG. 3. As an example, if three variations of a system are made, each one would have its own DTw with specific measurements. These DTws may be accessed and updated via API function scripts, which allow for easy input of new measurements from the physical parts during the manufacturing process. By autonomous linking with appropriate data, a DTw may be updated to reflect the actual measurements of the parts, maintaining traceability and ensuring accurate data representation through hundreds or thousands of models.

### Exemplary Model Splicing Setup

FIG. 9 is a schematic 900 showing an exemplary model splicing setup, according to some embodiments of the present invention. Specifically, FIG. 9 is a schematic showing an embedded CAD model splicing example.

In the present disclosure, a “model splice”, “model wrapper”, or “model graft” of a given DE model file comprises locators to or copies of (1) DE model data or digital artifacts extracted or derived from the DE model file, including model metadata, and (2) splice functions (e.g., API function scripts) that can be applied to the DE model data. A model splice may take on the form of a digital file or a group of digital files. A locator refers to links, addresses, pointers, indexes, access keys, Uniform Resource Locators (URL) or similar references to the aforementioned DE digital artifacts and splice functions, which themselves may be stored in access-controlled databases, cloud-based storage buckets, or other types of secure storage environments. The splice functions provide unified and standardized input and output API or SDK endpoints for accessing and manipulating the DE model data. The DE model data are model-type-specific, and a model splice is associated with model-type-specific input and output schemas. One or more different model splices may be generated from the same input DE model file, based on the particular user application under consideration, and depending on data access restrictions. In some contexts, the shorter terms “splice”, “wrapper”, and/or “graft” are used to refer to spliced, wrapped, and/or grafted models.

Model splicing is the process of generating a model splice from a DE model file. Correspondingly, model splicers are program codes or uncompiled scripts that perform model splicing of DE models. A DE model splicer for a given DE model type, when applied to a specific DE model file of the DE model type, retrieves, extracts, and/or derives DE model data associated with the DE model file, generates and/or encapsulates splice functions, and instantiates API or SDK endpoints to the DE model according to input/output schemas. In some embodiments, a model splicer comprises a collection of API function scripts that can be used as templates to generate DE model splices. “Model splicer generation” refers to the process of setting up a model splicer, including establishing an all-encompassing framework or template, from which individual model splices may be deduced.

Thus, a DE model type-specific model splicer extracts or derives model data from a DE model file and/or stores such model data in a model type-specific data structure. A DE model splicer further generates or enumerates splice functions that may call upon native DE tools and API functions for application on DE model data. A DE model splice for a given user application contains or wraps DE model data and splice functions that are specific to the user application, allowing only access to and enabling modifications of limited portions of the original DE model file for collaboration and sharing with stakeholders of the given user application.

Additionally, a document splicer is a particular type of DE model splicer, specific to document models. A “document” is an electronic file that provides information as an official record. Documents include human-readable files that can be read without specialized software, as well as machine-readable documents that can be viewed and manipulated by a human with the help of specialized software such as word processor and/or web services. Thus, a document may contain natural language-based text and/or graphics that are directly readable by a human without the need of additional machine compilation, rendering, visualization, or interpretation. A “document splice”, “document model splice” or “document wrapper” for a given user application can be generated by wrapping document data and splice functions (e.g., API function scripts) that are specific to the user application, thus revealing text at the component or part (e.g., title, table of contents, chapter, section, paragraph) level via API or SDK endpoints, and allowing access to and enabling modifications of portions of an original document or document template for collaboration and sharing with stakeholders of the given user application, while minimizing manual referencing and human errors.

In the CAD model splicing example shown in FIG. 9, a CAD model file diesel-engine.prt 904 proceeds through a model splicing process 910 that comprises a data extraction step 920 and a splice function generation step 930. This input DE model 904 is in a file format .prt native to certain DE tools. Data extraction may be performed via a DE model crawling agent implemented as model crawling scripts within a model splicer to crawl through the input DE model file and to distill model data with metadata 922. Metadata are data that can be viewed without opening the entire input DE model file, and may include entries such as file name, file size, file version, last modified date and time, and potential user input options as identified from a user input 906. Model data are extracted and/or derived from the input DE model, and may include but are not limited to, parts (e.g., propeller, engine cylinder, engine cap, engine radiator, etc.), solids, surfaces, polygon representation, and materials, etc. When a model splicer crawls through the model file, it determines how model data may be organized and accessed, as fundamentally defined by a DE tool 902 that is being used in splicing the DE model, and establishes a model data schema. This data schema describes the structure and format of the model data, some of which are translated into, or used to create input/output API endpoints with corresponding input/output schemas. In some embodiments, model data with metadata 922 may be stored in an access-restricted storage 926, such as the “customer buckets” 512 within customer environment 510 in FIG. 5, so that model splices such as 942, 944, and 946 may be generated on-demand once an input DE model 904 has been crawled through.

The model splicer further generates splice functions (e.g., API function scripts) 932 from native APIs 902 associated with the input CAD model. In the present disclosure, “native” and “primal” refer to existing DE model files, functions, and API libraries associated with specific third-party DE tools, including both proprietary and open-source ones. Native API 902 may be provided by a proprietary or open-source DE tool. For example, the model splicer may generate API function scripts that call upon native APIs of native DE tools to perform functions such as: HideParts(parts_list), Generate2DView( ), etc. These model-type-specific splice functions may be stored in a splice function database 936, again for on-demand generation of individual model splices. A catalog or specification of splice functions provided by different model splices supported by the IDEP, and orchestration scripts that link multiple model splices, constitutes a Platform API. This platform API is a common, universal, and externally-accessible platform interface that masks native API 902 of any native DE tool integrated into the IDEP, thus enabling engineers from different disciplines to interact with unfamiliar DE tools, and previously non-interoperable DE tools to interoperate freely.

Next, based on user input or desired user application 906, one or more model splices or wrappers 942, 944, and 946 may be generated, wrapping a subset or all of the model data needed for the user application with splice functions or API function scripts that can be applied to the original input model and/or wrapped model data to perform desired operations and complete user-requested tasks. In various embodiments, a model splice may take on the form of a digital file or a group of digital files, and a model splice may comprise locators to or copies of the aforementioned DE digital artifacts and splice functions, in any combination or permutation. Any number of model splices/wrappers may be generated by combining a selective portion of the model data such as 922 and the API function scripts such as 932. As the API function scripts provide unified and standardized input and output API endpoints for accessing and manipulating the DE model and DE model data, such API handles or endpoints may be used to execute the model splice and establish links with other model splices without directly calling upon native APIs. Such API endpoints may be formatted according to an input/output scheme tailored to the DE model file and/or DE tool being used, and may be accessed by orchestration scripts or platform applications that act on multiple DE models.

In some embodiments, when executed, an API function script inputs into or outputs from a DE model or DE model splice. “Input” splice functions or “input nodes” such as 933 are model modification scripts that allow updates or modifications to an input DE model. For example, a model update may comprise changes made via an input splice function to model parameters or configurations. “Output” splice functions or “output nodes” 934 are data/artifact extraction scripts that allow data extraction or derivation from a DE model via its model splice. An API function script may invoke native API function calls of native DE tools. An artifact is an execution result from an output API function script within a model splice. Multiple artifacts may be generated from a single DE model or DE model splice. Artifacts may be stored in access-restricted cloud storage 926, or other similar access-restricted customer buckets.

One advantage of model splicing is its inherent minimal privileged access control capabilities for zero-trust implementations of the IDEP as disclosed herein. In various deployment scenarios discussed with reference to FIG. 6, and within the context of IDEP implementation architecture discussed with reference to FIG. 5, original DE input model 904 and model data storage 926 may be located within customer buckets 512 in customer environment 510 of FIG. 5. Splice functions 932 stored in database 936 call upon native APIs 902. The execution or invocation of splice functions 932 may rely on job-specific authentication or authorization via proprietary licenses of DE tools (e.g., residing within customer environment 510 of FIG. 5 and/or information security clearance levels of the requesting user. Thus, model splicing unbundles monolithic access to digital model-type files as whole files and instead provides specific access to a subset of functions that allow limited, purposeful, and auditable interactions with subsets of the model-type files built from component parts or atomic units that assemble to parts.

### Digital Threading of DE Models Via Model Splicing

FIG. 10 is a schematic showing digital threading of DE models via model splicing, according to some embodiments of the present invention. A digital thread is intended to connect two or more DE models for traceability across the systems engineering lifecycle, and collaboration and sharing among individuals performing DE tasks.

Linking of model splices generally refers to jointly accessing two or more DE model splices via API endpoints or splice functions. For example, data may be retrieved from one splice to update another splice (e.g., an input splice function of a first model splice calls upon an output splice function of a second model splice); data may be retrieved from both splices to generate a new output (e.g., output splice functions from both model splices are called upon); data from a third splice may be used to update both a first splice and a second splice (e.g., input splice functions from both model splices are called upon). In the present disclosure, “model linking” and “model splice linking” may be used interchangeably, as linked model splices map to correspondingly linked DE models. Similarly, linking of DE tools generally refers to jointly accessing two or more DE tools via model splices, where model splice functions that encapsulate disparate DE tool functions may interoperate and call each other, or be called upon jointly by an orchestration script to perform a DE task.

Thus, model splicing allows for making individual digital model files into model splices that can be autonomously and securely linked, enabling the management of a large number of digital models as a unified digital thread written in scripts. Within the IDEP as disclosed herein, a digital thread is a platform script that calls upon the platform API to facilitate, manage, or orchestrate a workflow through linked model splices. Model splice linking provides a communication framework or data-driven architecture that connects traditionally siloed elements to enable the flow of information between digital models via corresponding model splices. The extensibility of model splicing over many different types of digital models enables the scaling and generalization of digital threads to represent each and every stage of the DE lifecycle and to instantiate and update DTws as needed.

In the particular example shown in FIG. 10, an orchestration script 1094 is written in Python code and designed to interact via API endpoints such as 1092 to determine if a CAD model meets a total mass requirement. API endpoint 1092 is an output splice function and part of a platform API 1090. Platform API 1090 comprises not only splice functions but also platform scripts or orchestration scripts such as 1094 itself.

Orchestration script 1094 is divided into three main steps:
1. Get Data From a CAD Model Splice: A POST request may be sent via the IDEP platform API to execute a computer-aided design (CAD) model splice 1071. This model splice provides a uniform interface to modify and retrieve information about a CAD model 1081. The parameters for the CAD model, such as hole diameter, notch opening, flange thickness, etc., may be sent in the request and set via an input splice function. The total mass of the CAD model may be derived from model parameters and retrieved via an output splice function. The response from the platform API includes the total mass of CAD model 1081, and a Uniform Resource Identifier/Locator (URL) for the CAD model. The response may further comprise a URL for an image of the CAD model.
2. Get Data From a SvsML Model Splice: Another POST request may be sent via the IDEP platform API to execute a Systems Modeling Language (SysML) model splice 1072. SysML is a general-purpose modeling language used for systems engineering. Output function 1092 of model splice 1072 retrieves the total mass requirements for the system from a SysML model 1082. The response from the platform API includes the total mass requirement for the system.
3. Align the Variables and Check If Requirement Met: The total mass from CAD model 1081 is compared with the total mass requirement from SysML model 1082. If the two values are equal, a message is printed indicating that the CAD model aligns with the requirement. Otherwise, a message is printed indicating that the CAD model does not align with the requirement.

In short, orchestration script 1094, which may be implemented in application plane 360 of IDEP 300 shown in FIG. 3, links digital models 1081 and 1082 via model splice API calls. Orchestration script 1094 is a scripted platform application that modifies a CAD model, retrieves the total mass of the modified CAD model, retrieves the total mass requirement from a SysML model, and compares the two values to check if the CAD model meets the requirement. In some embodiments, a platform application within IDEP 100 utilizes sets of functions to act upon more than one DE model.

### Model Splice Plane

FIG. 11 is a schematic illustrating the linking of DE model splices in a splice plane and comparing digital threading with and without model splicing, according to some embodiments of the present invention. The bottom model plane 380 demonstrates current digital threading practices, where each small oval represents a DE model, and the linking between any two DE models, such as models 1182 and 1184, requires respective connections to a central platform 1110, and potential additional linkages from every model to every other model. The central platform 1110 comprises program code that is able to interpret and manipulate original DE models of distinct model types. For example, platform 1110 under the control of a subject matter expert may prepare data from digital model 1182 into formats that can be accessed by digital model 1184 via digital model 1184's native APIs, thus allowing modifications of digital model 1182 to be propagated to digital model 1184. Any feedback from digital model 1184 to digital model 1182 would require similar processing via platform 1110 so that data from digital model 1184 are converted into formats that can be accessed by digital model 1182 via digital model 1182's native APIs. This hub-and-spoke architecture 1134 is not scalable to the sheer number (e.g., hundreds or thousands) of digital models involved within typical large-scale DE projects, as model updates and feedback are only possible through central platform 1110.

In contrast, once the DE models are spliced, each original model is represented by a model splice including relevant model data, unified and standardized API endpoints for input/output, as shown in the upper splice plane 370. Splices within splice plane 370 may be connected through scripts (e.g., python scripts) that call upon API endpoints or API function scripts and may follow a DAG architecture, as described with reference to FIG. 3 and FIG. 8. Note that in FIG. 3, only a set of generated splices is shown within splice plane 370, while in FIG. 11, scripts that link model splices are also shown for illustrative purposes within the splice plane. Such scripts are referred to as orchestration scripts or platform scripts in this disclosure, as they orchestrate workflow through a digital thread built upon interconnected DE model splices. Further note that while splice plane 370 is shown in FIG. 3 as part of IDEP 100 for illustrative purposes, in some embodiments, splice plane 370 may be implemented behind a customer firewall and be part of an agent of the DE platform, as discussed in various deployment scenarios shown in FIG. 6. That is, individual API function scripts generated via model splicing by a DE platform agent may be tailored to call upon proprietary tools the customer has access to in its private environment. No centralized platform 1110 with proprietary access to all native tools associated with all individual digital models shown in FIG. 11 is needed. Instead, orchestration scripts call upon platform API function scripts that may be implemented differently in different customer environments.

Hence, model splicing allows model splices such as model splice 1172 from digital model 1182 and model splice 1174 from digital model 1184 to access each other's data purposefully and directly, thus enabling the creation of a model-based “digital mesh” 1144 via platform scripts and allowing autonomous linking without input from subject matter experts.

An added advantage of moving from the model plane 380 to the splice plane 370 is that the DE platform enables the creation of multiple splices per native model (e.g., see FIG. 9), each with different subsets of model data and API endpoints tailored to the splice's targeted use. For example, model splices may be used to generate multiple digital twins (DTws) that map a physical product or process or object design into the virtual space. Two-way data exchanges between a physical object and its digital object twin enable the testing, optimization, verification, and validation of the physical object in the virtual world, by choosing optimal digital model configuration and/or architecture combinations from parallel digital twins built upon model splices, each reacting potentially differently to the same feedback from the physical object.

Supported by model splicing, digital threading, and digital twinning capabilities, the IDEP as disclosed herein connects DE models and DE tools to enable simple and secure collaboration on digital engineering data across engineering disciplines, tool vendors, networks, and model sources such as government agencies and institutions, special program offices, contractors, small businesses, Federally Funded Research and Development Centers (FFRDC), University Affiliated Research Centers (UARC), and the like. An application example 1150 for the IDEP is shown on the right side of FIG. 11, illustrating how data from many different organizations may be integrated to enable cross-domain collaboration while maintaining data security, traceability, and auditability. Here DE models from multiple vendors or component constructors are spliced or wrapped by IDEP agents, and data artifacts are extracted with data protection. Turning DE models into data artifacts enables cross-domain data transfer and allows for the protection of critical information, so that model owners retain complete control over their DE models using their existing security and IT stack, continue to use DE tools that best fit their purposes, and also preserve the same modeling schema/ontology/profile that best fit their purposes. The IDEP turns DE models into micro-services to provide minimally privileged data bits that traverse to relevant stakeholders without the DE models ever leaving their home servers or being duplicated or surrogate. The IDEP also provides simple data access and digital threading options via secure web applications or secure APIs.

### DAG Representation of Threaded Tasks

Model splicing provides a unified interface among DE models, allowing model and system updates to be represented by interconnected and pipelined DE tasks. FIG. 12 shows an exemplary directed acyclic graph (DAG) representation 1200 of pipelined DE tasks related to digital threads, in accordance with some embodiments of the present invention. In diagram 1200, tasks performed through a digital thread orchestration script (e.g., 1094) are structured as nodes within a DAG. Actions are therefore interconnected and carried out in a pipeline linking the DE model splices with a range of corresponding parameter values. Therefore, a digital thread can be created by establishing, via interpretable DE platform scripts, the right connections between any model splices for their corresponding models at the relevant endpoints.

Referring to FIGS. 3 and 10, DAGs of threaded tasks are built from digital threads and are part of the DE platform's application plane 360. Different DAGs may target different DE actions. For example, in FIG. 3, building or updating a DTw 322 in the virtual environment 320 has its own DAG 324. Model splicing turns DE models into data structures that can be accessed via API, thus enabling the use of software development tools, from simple python scripts to complex DAGs, in order to execute DE actions. A digital thread of model splices eliminates the scalability issue of digital thread management, and speeds up the digital design process, including design updates based on external feedback.

### Inner/Outer Loop Architecture for Digital Threads in Cyber-Physical Systems

FIG. 13 is an exemplary schematic 1300 illustrating the interplay between a digital thread and the individual digital models or digital artifacts it uses, thus defining outer and inner loop processes, in accordance with some embodiments of the present invention.

In various embodiments of the IDMP, the architecture for managing digital threads and their associated digital models in cyber-physical systems involves an interaction between an Outer Loop (representing the digital thread) and an Inner Loop (representing individual models or artifacts). This structure enables secure, permission-based collaboration across multiple models, ensuring traceability, controlled data flow, and efficient interaction within the digital workflow. Based on software engineering principles, this inner/outer loop design is modular: the Outer Loop manages high-level coordination and communication, while the Inner Loop handles the detailed, iterative operations of each model or system. While the Outer Loop and Inner Loop interactions commonly seen in software packages may involve access to all of the software packages within the same Integrated Development Environment (IDE), the Outer Loop/Inner Loop interactions for cyber-physical systems must manage to link interoperably with different digital models and tools, while also ensuring zero trust security. Various embodiments of the IDMP are well suited to manage such digital threads for cyber-physical systems as the platform is able to interoperably link with various digital models and tools (in different Inner Loops) through the model splicer architecture (see FIGS. 9 and 10). Additionally, the IDMP uses zero trust and zero knowledge security, ensuring that every interaction, whether within the same security network or across different networks, is strictly authorized, while keeping sensitive data private (e.g., through tokenization).

In the embodiment shown in 1310, an Outer Loop 1304 manages the sequence of tasks in a digital workflow, where user actions are authorized for access through a process 1320 in an Inner Loop 1316. Outer Loop 1304 can issue instructions to Inner Loop 1316 to:
Create models by defining structure, behavior, and parameters (1318).
Fetch data artifacts from a model.
Update artifacts with controlled, traceable changes.

For example, when Outer Loop 1304 commands a data artifact retrieval, the IDMP platform may manage it using zero trust principles, as described in FIG. 5. Each user request in Outer Loop 1304 is authorized through an enclave 502 and its Control Plane service cell, coordinated with platform exclave 516. Different Inner Loops exist within Customer Tools 514, each operating in specific Customer Environments 510 where each request is authorized for access to the necessary data operations.

After retrieving data artifacts from Inner Loop 1316, Outer Loop 1304 handles configuration control 1306, versioning, and integrates the artifacts into the broader digital thread 1308 for testing or validation at a process step 1312.

Inner Loop 1316, by contrast, is responsible for localized operations related to individual digital models, including:
Model creation, where digital models are initialized or updated.
Model execution, through automation, simulations or data analysis.
Saving results, preserving outcomes from model runs.
Analyzing data, providing insights and validation for digital workflow improvements.

Outer Loop 1304 interacts with any step in Inner Loop 1316 to access or update data artifacts. Outer loop computations often compare the current workflow to a baseline 1310.

Outer and Inner Loops 1304 and 1316 work together in an iterative process, integrating localized model adjustments with system-wide digital workflow coordination and validation. The Outer Loop manages tasks like configuration control, system integration, and VVUQ (Verification, Validation, and Uncertainty Quantification), while the Inner Loop handles model-based operations. FIG. 13 shows the Outer Loop performing authorized access 1320, configuration control 1306, digital thread integration 1308, and VVUQ/testing 1312. In various implementations of digital threads in the IDMP, these steps can vary in sequence or iterate as needed. Ultimately, the outer and inner loop architecture enables continuous integration and development (CI/CD) of digital workflows and digital threads across the digital platform.

### Decentralized Digital Threads in the IDMP

The IDMP enables decentralized management of digital threads across different models, security networks, and user permissions under a zero trust security principle. This architecture enforces strict access controls and permission-based interactions between models, ensuring security across diverse environments. In some embodiments, a zero knowledge approach further secures sensitive data during orchestration, ensuring no unauthorized access (e.g., by using tokenization).

In FIG. 13, two exemplary setups 1322 and 1332 illustrate IDMP embodiments with decentralized digital threads across different security networks. In 1322, Outer Loop 1 operates within Security Network 1, connecting to multiple Inner Loops (e.g., Inner Loop 1, Inner Loop 2, and Inner Loop 3). These Inner Loops manage data operations within the same security framework, allowing collaboration while maintaining security.

In 1332, Outer Loop 2 operates in a separate Security Network 2, linking to additional Inner Loops (e.g., Inner Loop 4, Inner Loop 5, and Inner Loop 6). For links from Outer Loop 1, dotted lines and “X” symbols represent isolated models or components, indicating access restrictions enforced by the zero trust framework. Only authenticated users can access authorized models and artifacts.

In various implementations, 1322 and 1332 can be regarded as different instances of the Customer environment 510 shown in FIG. 5.

In the IDMP, digital threads handle both simple and complex model connections. FIG. 8 shows simple threads with sequential model links (e.g., 802, 804), while the more complex thread 806 is shown in FIG. 13 as an illustrative element 1342. Simple threads propagate changes in a linear fashion, while complex threads manage branching dependencies, where changes in one model affect multiple downstream models. In complex threads implemented by the IDMP, the Outer Loop coordinates interactions across multiple Outer loops and Inner loops, ensuring secure, scalable execution of the entire digital workflow with appropriate permission controls.

Converting Digital Workflows into Digital Threads with Data Relationships

The IDMP links different types of digital model files in a decentralized fashion with zero-trust security. When a user requests a data operation on a digital model file using a specific digital tool, IDMP executes the request via digital tool-specific and platform agents within the customer's environment. These agents extract data artifacts and, when changes to a digital artifact occur, a newer version of the digital model file is made. During the versioning step, platform agents ensure sensitive data is protected through tokenized version control.

Extracted data artifacts are securely stored in the customer's cloud data storage (e.g., an S3 bucket). If changes are made to the digital model, the agents save the updated version of the model or data artifact, extract the relevant data artifacts, and store it securely.

Using the IDMP, users are able to link data artifacts into a magic doc for documentation and commentary, which can include AI-assistance in various embodiments. A digital thread accompanying the magic doc lists data artifacts in sequence, creating a digital workflow. The IDMP further tracks data relationships between data artifacts (e.g., derivation, grouping, or data flow). This digital workflow of user actions and data relationships is stored in a non-proprietary format within the customer's environment.

Emergent digital workflows and sequence of tasks captured by data relationships of various types:
1. Generational—(Between version 1 and version 2 of a model)
2. Parent/Child—(The Model and Derived information from a model)
3. Sibling—(Different bits of derived data from the same model (e.g., an image view of a CAD model and an associated parameter)
4. Generational (derived)—The same piece of data extracted from version 1 or version 2 of a model
5. Data Context (Connected by how they are used for a mission or business purpose in a Magic Doc)
6. Data Flow (Connected via digital threads—data from one model into another)

Such data relationships can vary from one user to another even for the same overall digital workflow task.

Converting Digital Workflows into Digital Thread Scripts in an API-First Manner

FIG. 14 illustrates an exemplary digital engineering process in the aerospace industry, showing outer loop processes, according to one embodiment of the present invention. The left of FIG. 14 contains a simplified depiction 1402 of current engineering processes related to a digital engineering operation in the aerospace industry. The digital platform is instrumental in mapping those processes 1404 to digitized (software-defined) workflows. Each process step may be connected to software-defined digital threads (outer loop) using Git Workbooks or Runbooks. The generated workflows may belong to the inner or outer loops, as depicted in FIG. 13. For completeness and compliance, the digital platform may further add tests for the key steps and tasks of the digitized workflows in the outer loop 1406. These outer-loop threads incorporate built-in feature tests and unit tests, ensuring the digital thread is validated as it is being created. Finally, the scripts for the digital threads are executed, generating outputs that can be presented as dynamic reports, such as magic docs, linked to digital models or data artifacts. The digital platform may hence generate dynamic reports 1408 (e.g., Magic Docs) linked to the inner-loop models used by the digital workflows. In various implementations, the IDMP adopts an API-first approach, where digital workflows are structured around secure and modular API integrations. In the IDMP, digital threads link to specific data artifacts through authorized API endpoints in a zero-trust framework, ensuring secure access. Process steps are connected to software-defined workflows using tools like Git Workbooks or Runbooks, with user intent driving both platform and tool-specific API calls. This approach enables seamless integration, modularity, and validation, with built-in feature and unit tests ensuring the reliability of each API interaction throughout the system.

### 6. Introduction to Neural Networks and their Training

### Machine Learning (ML) and Neural Networks

Machine learning (ML) algorithms are characterized by the ability to improve their performance at a task over time without being explicitly programmed with the rules to perform that task (i.e., learn). An ML model is the output generated when a ML algorithm is trained on data. As described herein, embodiments of the present invention use one or more artificial intelligence (AI) and ML algorithms. Various exemplary ML algorithms are within the scope of the present invention. The following description describes illustrative ML techniques for implementing various embodiments of the present invention.

### Neural Networks

A neural network is a computational model including interconnected units called “neurons” that work together to process information. It is a type of ML algorithm that is particularly effective for recognizing patterns and making predictions based on complex data. Neural networks are widely used in various applications such as image and speech recognition and natural language processing, due to their ability to learn from large amounts of data and improve their performance over time. FIG. 15 describes neural network operation fundamentals, according to exemplary embodiments of the present invention.

FIG. 15 shows a single-layered neural network, also known as a single-layer perceptron. The operation of a single-layered neural network involves the following steps:
1. Input: Receiving a DE input vector v 1504 with elements vⱼ, with j∈[1, n] representing the j^{th} DE input, and where each element of the vector corresponds to an element 1506 in the input layer. A DE input can be a user prompt, a DE document, a DE model, DE program code, system data from the IDMP, and/or any useful form of data in digital engineering.
2. Transfer Function: Multiplying each element of the DE input vector by a corresponding weight wⱼ 1508. These weighted inputs are then summed together as the transfer function, yielding the net input to the activation function

$${\sum }_{j = 1}^{n} {v}_{j} \cdot {w}_{j} 1510.$$

Each neuron in a neural network may have a bias value 1512, which is added to the weighted sum of the inputs to that neuron. Both the weights and bias values are learned during the training process. The purpose of the bias is to provide every neuron with a trainable constant value that can help the model fit the data better. With biases, the net input to the activation function is

$${\sum }_{j = 1}^{n} \{ {v}_{j} \cdot {w}_{j} \} + b .$$

3. Activation Function: Passing the net input through an activation function 1514. The activation function σ determines the activation value z 1518, which is the output of the neuron. It is typically a non-linear function such as a sigmoid or ReLU (Rectified Linear Unit) function. The threshold θ 1516 of the activation function is a value that determines whether a neuron is activated or not. In some activation functions, such as the step function, the threshold is a specific value. If the net input is above the threshold, the neuron outputs a constant value, and if it's below the threshold, it outputs a zero value. In other activation functions, such as the sigmoid or ReLU (Rectified Linear Unit) functions, the threshold is not a specific value but rather a point of transition in the function's curve.
4. Output: The activation value z 1518 is the output of the activation function. This value is what gets passed on to the next layer in the network or becomes the final DE output in the case of the last layer. A DE output can also be an updated twin configuration, digital twin, physical twin, DE document, DE model, DE program code, or any useful form of data in digital engineering.

The principles discussed above extend to neural networks with multiple layers. FIG. 16 shows a multi-layer neural network, in accordance with some embodiments of the present invention. A multi-layer neural network is a sophisticated machine learning model inspired by the structure and function of biological neural networks, extending the single-layer neural network of FIG. 15 into multiple layers. It consists of interconnected nodes, or “neurons,” represented by circles in FIG. 16, organized into distinct layers that process and transmit information.

The network typically begins with an input layer 1602, Layer L₁ in FIG. 16, which receives the initial data in the form of an input vector v. This vector contains the features or attributes of the data being analyzed. Following the input layer are one or more hidden layers, which perform intermediate computations and extract higher-level features from the input. FIG. 16 shows two hidden layers, Layer L₂ (1604) and Layer L₃ (1606). The final layer is the output layer, which produces the network's prediction or classification in the form of an output vector. In FIG. 16, the final layer is Layer L₄ (1608), yielding output vector z (1620). In FIG. 16, the output vector (1620) is composed of the two elements z generated by the two nodes of the output layer L₄ (1608).

The connections between neurons in adjacent layers are associated with weights, which are adjusted during the learning process. In FIG. 16, weights are represented on each link between neurons, where

$${w}_{ij}^{( k )}$$

represents the weight multiplying the i^{th} output of the k^{th} layer at the j^{th} node of the (k+1)^{st} layer.

Each layer in the network may include bias units, which are depicted as dashed nodes with dashed connections to the nodes of the next layer (e.g., 1618 in L₁ and 1616 in L₂). These units provide additional flexibility to the model by allowing it to shift the activation function. At each node, the weighted sum of inputs to a neuron, combined with its bias, is passed through an activation function, which introduces non-linearity and enables the network to learn complex patterns. In FIG. 16, contrary to FIG. 15, the activation function and additional bias term are represented by the solid nodes and are not otherwise shown explicitly. As discussed in more detail in subsequent sections, the output vector z 1620 may be represented as a function ƒ of the input vector z=ƒ_{W,b}(v), where the function ƒ depends on a global weights matrix Wand a global biases matrix b.

As further described in the sections below, the process of feeding data through the network from input to output is called forward propagation. During this phase, each neuron receives inputs from the previous layer, applies its activation function, and passes the result to the next layer. The network's performance is evaluated using a cost function, which measures the difference between the predicted output and the actual target values. To improve the network's performance, a backpropagation algorithm is employed. This process involves calculating the gradient of the cost function with respect to each weight and bias in the network. The gradients are then used to update the network's parameters through a process called gradient descent, which iteratively adjusts the weights and biases to minimize the cost function and improve the network's predictions.

FIG. 17 shows an overview of an IDMP neural network training process, according to exemplary embodiments of the present invention. The training of the IDMP neural network involves repeatedly updating the weights and biases 1710 of the network to minimize the difference between the predicted output 1704 and the true or target output 1706, where the predicted output 1704 is the result produced by the network when a set of inputs from a dataset is passed through it. The predicted output 1704 of an IDMP neural network 1702 corresponds to the DE output 1518 of the final layer of the neural network. The true or target output 1706 is the true desired result. The difference between the predicted output and the true output is calculated using a loss function 1708, which quantifies the error made by the network in its predictions.

The loss function is a part of the cost function 1708, which is a measure of how well the network is performing over the whole dataset. The goal of training is to minimize the cost function 1708. This is achieved by iteratively adjusting the weights and biases 1710 of the network in the direction that leads to the steepest descent in the cost function. The size of these adjustments is determined by the learning rate 1708, a hyperparameter that controls how much the weights and biases change in each iteration. A smaller learning rate means smaller changes and a slower convergence towards the minimum of the cost function, while a larger learning rate means larger changes and a faster convergence, but with the risk of overshooting the minimum.

Neural network training combines the processes of forward propagation and backpropagation. Forward propagation is the process where the input data is passed through the network from the input layer to the output layer. During forward propagation, the weights and biases of the network are used to calculate the output for a given input. Backpropagation, on the other hand, is the process used to update the weights and biases 1710 of the network based on the error (e.g., cost function) 1708 of the output. After forward propagation through the IDMP neural network 1702, the output 1704 of the network is compared with true output 1706, and the error 1708 is calculated. This error is then propagated back through the network, starting from the output layer and moving towards the input layer. The weights and biases 1710 are adjusted in a way that minimizes this error. This process is repeated for multiple iterations or epochs until the network is able to make accurate predictions.

The neural network training method described above, in which the network is trained on a labeled dataset (e.g., sample pairs of input user prompts and corresponding output recommendations), where the true outputs are known, is called supervised learning. In unsupervised learning, the network is trained on an unlabeled dataset, and the goal is to discover hidden patterns or structures in the data. The network is not provided with the true outputs, and the training is based on the intrinsic properties of the data. Furthermore, reinforcement learning is a type of learning where an agent learns to make decisions from the rewards or punishments it receives based on its actions. Although reinforcement learning does not typically rely on a pre-existing dataset, some forms of reinforcement learning can use a database of past actions, states, and rewards during the learning process. Any neural network training method that uses a labeled dataset is within the scope of the methods and systems described herein, as is clear from the overview below.

FIG. 18, described below, provides additional details on the training process of an IDMP machine learning model, according to exemplary embodiments of the present invention.

### Transformer Model Architecture

The transformer architecture is a neural network design that was introduced in the paper “Attention is All You Need” by Vaswani et al. published in June 2017 (available at arxiv.org/abs/1706.03762), and incorporated herein by reference as if fully set forth herein. Large Language Models (LLMs) heavily rely on the transformer architecture.

The architecture (see FIG. 1 in Vaswani et al.) is based on the concept of “attention”, allowing the model to focus on different parts of the input sequence when producing an output. Transformers consist of an encoder and a decoder. The encoder processes the input data and the decoder generates the output. Each of these components is made up of multiple layers of self-attention and point-wise, fully connected layers.

The layers of self-attention in the transformer model allow it to weigh the relevance of different parts of the input sequence when generating an output, thereby enabling it to capture long-range dependencies in the data. On the other hand, the fully connected layers are used for transforming the output of the self-attention layers, adding complexity and depth to the model's learning capability.

The transformer model is known for its ability to handle long sequences of data, making it particularly effective for tasks such as machine translation and text summarization. In the transformer architecture, positional encoding is used to give the model information about the relative positions of the words in the input sequence. Since the model itself does not have any inherent sense of order or sequence, positional encoding is a way to inject some order information into the otherwise order-agnostic attention mechanism.

### The Embeddings Vector Space

In the context of neural networks, tokenization refers to the process of converting the input and output spaces, such as natural language text or programming code, into discrete units or “tokens”. This process allows the network to effectively process and understand the data, as it transforms complex structures into manageable, individual elements that the model can learn from and generate.

In the training of neural networks, embeddings serve as a form of distributed word representation that converts discrete categorical variables (i.e., tokens) into a continuous vector space (i.e., embedding vectors). This conversion process captures the semantic properties of tokens, enabling tokens with similar meanings to have similar embeddings. These embeddings provide a dense representation of tokens and their semantic relationships. Embeddings are typically represented as vectors, but may also be represented as matrices or tensors.

The input of a transformer typically requires conversion from an input space (e.g., the natural language token space) to an embeddings space. This process, referred to as “encoding”, transforms discrete inputs (tokens) into continuous vector representations (embeddings). This conversion is a prerequisite for the transformer model to process the input data and understand the semantic relationships between tokens (e.g., words). Similarly, the output of a transformer typically requires conversion from the embeddings space to an output space (e.g., natural language tokens, programming code tokens, etc.), in a process referred to as “decoding”. Therefore, the training of a neural network and its evaluation (i.e., its use upon deployment) both occur within the embeddings space.

In this document, the processes of tokenization, encoding, decoding, and de-tokenization may be assumed. In other words, the processes described below occur in the “embeddings space”. Hence, while the tokenization and encoding of training data and input prompts may not be represented or discussed explicitly, they may nevertheless be implied. Similarly, the decoding and de-tokenization of neural network outputs may also be implied.

### Training and Fine-Tuning Machine Learning (ML) Modules

FIG. 18 is an illustrative flow diagram showing the different phases and datasets involved in training an IDMP ML model, according to exemplary embodiments of the present invention.

The training process starts at step 1810 with DE data acquisition, retrieval, assimilation, or generation. At step 1820, acquired DE data are pre-processed, or prepared. At step 1830, the IDMP ML model is trained using training data 1825. At step 1840, the IDMP ML model is evaluated, validated, and tested, and further refinements to the IDMP ML model are fed back into step 1830 for additional training. Once its performance is acceptable, at step 1850, optimal IDMP ML parameters are selected.

Training data 1825 is a dataset containing multiple instances of system inputs and correct outcomes. It trains the IDMP ML model to optimize the performance for a specific target task, such as the prediction of a specific target output data field within a specific target document. In FIG. 18, training data 1825 may also include subsets for validating and testing the IDMP ML model, as part of the training iterations 1830 and 1840. For an NN-based ML model, the quality of the output may depend on (a) NN architecture design and hyperparameter configurations, (b) NN coefficient or parameter optimization, and (c) quality of the training data set. These components may be refined and optimized using various methods. For example, training data 1825 may be expanded via a document database augmentation process.

In some embodiments, an additional fine-tuning 1860 phase including iterative fine-tuning 1860 and evaluation, validation, and testing 1870 steps, is carried out using fine-tuning data 1855. Fine-tuning in machine learning is a process that involves taking a selected 1850 pre-trained model and further adjusting or “tuning” its parameters to better suit a specific task or fine-tuning dataset 1855. This technique is particularly useful when dealing with deep learning models that have been trained on large, general training datasets 1825 and are intended to be applied to more specialized tasks or smaller datasets. The objective is to leverage the knowledge the model has already acquired during its initial training (often referred to as transfer learning) and refine it so that the model performs better on a more specific task at hand.

The fine-tuning process typically starts with a model that has already been trained on a large benchmark training dataset 1825, such as ImageNet (available at image-net.org/) for image recognition tasks. The model's existing weights, which have been learned from the original training, serve as the starting point. During fine-tuning, the model is trained further on a new fine-tuning dataset 1855, which may contain different classes or types of data than the original training set. This additional training phase allows the model to adjust its weights to better capture the characteristics of the new fine-tuning dataset 1855, thereby improving its performance on the specific task it is being fine-tuned for.

In some embodiments, additional test and validation 1880 phases are carried out using DE test and validation data 1875. Testing and validation of a ML model both refer to the process of evaluating the model's performance on a separate dataset 1875 that was not used during training, to ensure that it generalizes well to new unseen data. Validation of a ML model helps to prevent overfitting by ensuring that the model's performance generalizes beyond the training data.

While the validation phase is considered part of ML model development and may lead to further rounds of fine-tuning, the testing phase is the final evaluation of the model's performance after the model has been trained and validated. The testing phase provides an unbiased assessment of the final model's performance that reflects how well the model is expected to perform on unseen data, and is usually carried out after the model has been finalized to ensure the evaluation is unbiased.

Once the IDMP ML model is trained 1830, selected 1850, and optionally fine-tuned 1860 and validated/tested 1880, the process ends with the deployment 1890 of the IDMP ML model. Deployed IDMP ML models 1895 usually receive new DE data 1885 that was pre-processed 1880.

In machine learning, data pre-processing 1820 is tailored to the phase of model development. During model training 1830, pre-processing involves cleaning, normalizing, and transforming raw data into a format suitable for learning patterns. For fine-tuning 1860, pre-processing adapts the data to align with the distribution of the specific targeted task, ensuring the pre-trained model can effectively transfer its knowledge. Validation 1880 pre-processing mirrors that of training to accurately assess model generalization without leakage of information from the training set. Finally, in deployment 1890, pre-processing ensures real-world data matches the trained model's expectations, often involving dynamic adjustments to maintain consistency with the training and validation stages.

Unless otherwise stated, the methods and systems disclosed herein regarding training, particularly pertaining to training data collection, generally apply to tuning, fine-tuning, pre-training, and/or post-training.

### Machine Learning Algorithms

Various exemplary ML algorithms are within the scope of the present invention. Such machine learning algorithms include, but are not limited to, random forest, nearest neighbor, decision trees, support vector machines (SVM), Adaboost, gradient boosting, Bayesian networks, evolutionary algorithms, various neural networks (including deep learning networks (DLN), convolutional neural networks (CNN), and recurrent neural networks (RNN)), etc. In particular, the methods described herein apply to any ML module that may be represented using matrix operations and non-linear functions (e.g., activation and cost functions), including but not limited to neural networks. ML modules based on transformers and Large Language Models (LLMs) are particularly well suited for the tasks described herein. The online article “Understanding Large Language Models—A Transformative Reading List”, by S. Raschka (posted Feb. 7, 2023, available at sebastianraschka.com/blog/2023/llm-reading-list.html), describes various LLM architectures that are within the scope of the methods and systems described herein, and is hereby incorporated by reference in its entirety herein as if fully set forth herein.

The input to each of the listed ML modules is a feature vector comprising the input data described above for each ML module. The output of the ML module is a feature vector comprising the corresponding output data described above for each ML module. Prior to deployment, each of the ML modules listed above may be trained on one or more respective sample input datasets and on one or more corresponding sample output datasets. The input and output training datasets may be generated from a database containing a history of input instances and output instances, or may be generated synthetically by subject matter experts.

### 7. Summary of Data Sovereignty Preserving Methods Used in Embodiments 1 and 2

FIG. 19 shows a summary of various privacy-preserving measures used in various embodiments of the present invention. These privacy-preserving measures are used and discussed in the context of Embodiments 1 and 2 in the present disclosure.

Specifically, FIG. 19 illustrates various embodiments of the invention that implement privacy-preserving measures to transform data, operations, and functions from an untransformed (true) space (1902) to a secure transformed space (1904). Transformation steps (1906) provide multiple options for altering neural network (NN) components, including data and parameters (e.g., weights and biases), NN functions (e.g., activation, cost, or loss functions), and computational operations (e.g., forward and back propagation). These transformations can include expansion using block matrices, permutations (e.g., matrix-based, or row/column permutations), and exponentiation (e.g., matrix-based or term-wise). Additionally, NN function transformations may incorporate noise functions or series expansions, with coefficients shared directly or represented through multivariate Bell polynomials. The transformed space contains data that is expanded, permuted, and exponentiated. A transformation operator is defined for the NN's hidden layers to ensure that all operations in the transformed space faithfully replicate true operations in the untransformed space.

The transformation steps described above can be applied individually or in combination, offering a flexible toolkit for privacy-preserving machine learning model development and usage. This privacy toolkit (1908) includes a selection of invertible matrices (e.g., left or right matrices) for operations such as expansion, row/column permutations, random matrix multiplication, and exponentiation. The toolkit also supports series expansions of functions. Furthermore, it includes options for bounded, infinitely differentiable noise functions and invertible noise functions, enabling precise control over privacy transformations.

These embodiments enable computations directly within the transformed space while maintaining strict data security through encryption of data both in transit and at rest. As outlined in 1910, the system employs cryptographic keys (e.g., FIPS-compliant) generated via shared, symmetric key encryption between the collaborating parties. During the setup phase, the data owner and NN owner exchange transformation compatibility information to ensure their respective data and NN parameters can be consistently transformed. This alignment guarantees that all operations in the transformed space accurately preserve the functionality of the untransformed space.

### 8. Embodiment 1: Matrix-Only Operations

Embodiment 1 involves reshuffling with matrix operations and matrix exponentiation within the linear transformation steps. In exemplary applications of neural networks, such as multiple banks collaboratively training a fraud detection model without sharing sensitive customer data, the disclosed methods offer a secure and efficient solution under specific conditions. These methods meet critical requirements such as data privacy, independent verification, and comparable computational burdens, while necessitating trade-offs in activation function choices. As described in Embodiment 1, the approach is most effective when simpler, standard activation functions are agreed upon in advance. Each bank encrypts its transaction data into a reshuffled format, while the neural network provider reshuffles the model parameters, ensuring privacy and enabling zero-trust collaboration. However, the reliance on predefined activation functions limits applicability in scenarios requiring custom or unconventional functions, making these methods ideal for use cases where simple activation functions suffice. The method uses a reshuffling methodology that takes advantage of algebraic groups that preserve neural network linear algebra operations up to a congruence relation for block matrices that extend the neural networks to higher ranks using dummy data.

### Embodiment 1: Introduction and Overview

Neural networks are having a major impact on all aspects of human life. As their performances (i.e., accuracy, low loss function values, etc.) grow linearly with complexity, and with their size reaching 100 trillion parameters, transformer-based models may soon be capable of associating significant portions of humanity's data. As the reach of neural networks extends to everyday life, the security and privacy surrounding the use of neural works must be equally powerful.

The methods disclosed herein may be applied by a single party or multiple parties seeking to keep their data and/or neural network private from each other. Specifically, they may be applied by (1) a data owning entity seeking to share its data for training purposes while keeping it private, (2) a neural network entity seeking to offer a trained neural network without compromising the privacy of a data-owning entity's training data or a third-party user entity's input/output data, and (3) a third-party user entity seeking to use a trained neural network without compromising the privacy of its input/output data. Importantly, the methods disclosed herein do not assume the trustworthiness of the neural network entity.

The methods and systems disclosed herein describe encryption processes for both neural networks and input training data, called “reshuffling”. Reshuffling refers to the “shuffling” of matrices representing neural network parameters and operations, as well as both input and output embeddings. Reshuffling (and its reverse operation, “deshuffling”) exploit algebraic groups that preserve linear algebra operations in matrix representations of neural networks and embeddings. In particular, the disclosed methods identify algebraic groups of interest that preserve matrix operations at least to within a congruence equivalence. Such privacy-preserving properties apply specifically for block matrices that are formed by extending the original matrices to higher ranks using synthetic (i.e., dummy) data, as discussed below. Thus, reshuffling may be a form of encryption, and in some embodiments, the framework of encryption as developed in computer communications may be adopted and extended.

The encryption methods disclosed permit the implementation of data sovereignty, which allows parties to work to collaborate on machine learning functions like forward propagating and backward propagating without having to trust the other person or party for having followed the correct procedures. Each party may validate that the correct procedures have been done independently of having to trust the other parties, like a “checksum” equivalent for neural nets. Zero-trust means that a first party need not trust a second party for that second party to give the first party an answer, and the second party need not trust the first party to give the first party the second party's data. The parties need not reveal their source data, and yet they are able to validate that any services have been performed correctly.

In some embodiments, three parties—the party who owns the neural network, the party who provides training data, and the party who deploys in the network—are able to be in a zero-trust relationship unless for expedient reasons. According to the disclosed reshuffling algorithm, the forward propagation and backward propagation are obscured through maintenance, matrix manipulations and adding dummy data, but in a way that ensures not only is the calculation being done correctly, it does it in a way that can be independently performed by every party. Each party can verify that the calculation was performed correctly without ever getting access to the input data that each party brought to the table.

The methods disclosed herein rely on the observation that neural network training data, weights, and biases do not matter in absolute terms, as long as the neural network (embodied by its underlying matrix operations) makes correct predictions. That is, a NN responding to transformed input data and transformed weights is as good as a NN where the input data and weights were not transformed, as long as its performance (e.g., accuracy, precision, sensitivity, F1, loss, etc.) is equivalent. In that sense, the input data and weights do not matter in absolute terms. For instance, there are many changes of bases—and many more congruences within those bases—where matrix operations are preserved. Given all these degrees of freedom, there is ample opportunity to select the matrix transformations that enable data sovereignty by transforming both the neural network and the training data sets into a reshuffled basis.

Hence, neural network outcomes that do matter absolutely (i.e., neural network predictions in the reshuffled basis, along with their underlying matrix operations), are preserved. Other neutral network operations (see, for example, FIGS. 5 and 6) are only preserved up to a congruence relation, as that is all that is needed to make the neural network predictions in the reshuffled basis, as discussed below. Since the neural network operations are preserved, the reshuffled predictions can be transformed back into the original basis, with all output-resulting predictions preserved.

The disclosed methods focus on classifying a wide class of reshuffling encryption schemes. In some embodiments, to balance cost tradeoffs, specific choices of matrix groups such as skew-symmetric matrices, orthogonal matrices, or circulant matrices may improve computational efficiency. In other embodiments, unitary matrices or finite cyclic groups may also be used, and are within the scope of the disclosed methods.

Note that “encryption” and “decryption” operations may also be equivalently referred to as “reshuffling” and “deshuffling” herein, as discussed below. Another term used below in relation to embodiment 2 is “true/untransformed” and “transformed”, whereby an isomorphism is carried out between the untransformed space and transformed space.

### Data-Sovereignty Enabled Neural Networks

With respect to data use in the training of neural networks and other AI models, data sovereignty refers to the principle that the data owner should maintain control over their data even when third parties are using it for training, or when the trained neural network is deployed. For example, the data owner should be protected against accidental exposure or intentional extraction of their training data through manipulation of the neural network, or through mere access to it. Similarly, an end user of the neural network should be protected against accidental exposure or intentional extraction of their input or output data through manipulation of the neural network, or through mere access to it.

The main requirements of data sovereignty are hence:
1) Creating a barrier to the extraction of training data from the output of a trained neural network by any neural network user (i.e., a third party) (during training: privacy of training data to 3rd party NN user),
2) Creating a barrier to access to training data by the neural network entity itself (during training: privacy of training data to NN entity),
3) Enabling a secure way to share training data between a data owner entity and a neural network entity, train the neural network, exchange prompts and outputs between a third party and the neural network entity, while implementing requirements 1) and 2) (during deployment: privacy of 3rd party NN user input/output data to NN entity).

### Neural Network and Data Transformations

In various embodiments, the methods disclosed herein describe transformations between various sets and vector spaces: the training data and prompt (not shown) may said to belong to an input vocabulary/token set, the input embeddings to an input embedding vector space, the reshuffled input embeddings to a reshuffled input vector space, the reshuffled output embeddings to a reshuffled output vector space, and the usable output (not shown) to an output vocabulary/token set (or “normal space”). In particular, the reshuffling and deshuffling transformations separate the vector spaces and sets used by the data owner entity (P−) from the vector spaces used by the neural network entity (P+).

The sections below demonstrate that the methods described herein create a barrier to access to original training or prompt data (represented by the input embeddings) through the use of the reshuffled/trained neural network by the neural network entity (P+). Furthermore, the sections below demonstrate that the methods described herein create a barrier for any third party receiving the reshuffled and trained neural network's output to access the original training or prompt data (i.e., the input embeddings), thus realizing the goals listed above. The use of a Key Manager (i.e., a trusted third-party entity) may alleviate the bandwidth and computational requirements of data owners, end users, and neural network entities.

The reshuffling and deshuffling operations, as described in further detail below, operate as an asymmetric key cryptography method for embeddings and enterprise foundation models, where the process includes an initial exchange of data to build the cryptographic keys. The sections below demonstrate that the methods described herein maintain computational efficiency while preserving data privacy. Furthermore, privacy fairness is preserved, whereby each party benefits from an identical approach to privacy protection, and no single party is protected more or less than their counterparts. Moreover, the reshuffling encryption approach disclosed herein works equally for two or more parties that exchange data, with a trusted third party shouldering all the computational burden (e.g., Key Manager), as discussed below.

Owing to their privacy-enhancing features, the disclosed methods and systems hold the promise to massively expand the scale of emerging services such as “Training-Data-as-a-Service” and “Model-as-a-Service.” Note that although the methods and systems disclosed herein apply to the training and use of neural networks generally, the methods find multiple applications in the realm of digital engineering (DE), where the sharing of data and MBSE models emanating from various entities holds tremendous promise in emerging DE platform applications (see Related Applications above).

### Mutually-Invertible Ordered-Pair Transformation Operations

In some implementations of the Integrated Digital Model Platform (IDMP), transformation steps to move from untransformed space to transformed space include matrix exponentiations. Matrix exponentiation is applied to enhance data privacy during transmission by encoding data, such as neural network (NN) weights, biases, or input data, into a transformed form. This approach typically involves using matrix exponentiation to obscure the data, with the option of applying logarithmic matrix transformations later to reverse the encoding and retrieve the original values. Exponentials and logarithms offer computationally efficient methods for transforming and reversing the transformation (or encoding and decoding) in a consistent manner.

However, these transformation steps are not limited to exponentials and logarithms. A variety of other transformations, such as scaling, rotations, and permutations, can also be applied. Additionally, ordered pairs of matrix-based transformations, such as mappings to kernel and co-kernel spaces, can be selected. Each of these transformations has a corresponding inverse operation (e.g., descaling, counter-rotations, and counter-permutations) that enables recovery of the original data from the transformed form.

This flexibility allows both the neural network owner and the data owner to select from a broader set of ordered pairs of matrix-based transformations that, when applied together in the transformed space, yield a net effect of unity or zero as appropriate. Indeed, any such invertible transformation is within the scope of the present invention. This approach enables the use of privacy-preserving transformations that align with specific system requirements, providing a customized solution for data protection.

### Linear Transformations of Vectors

The training of neural networks may be viewed as the manipulation of data (e.g., input data, neural network weight data, training data), which may be transformed in order to encrypt information. A subset of such transformations benefit from the tools of linear algebra and group theory. Data (e.g., input data, training data) may be represented as data objects. In some embodiments, such data objects are vectors. In some embodiments, the vectors may be real-valued; in other embodiments, the vectors may be complex-valued. In other embodiments, such data objects are matrices. In still other embodiments, such data objects are tensors. Although this disclosure discusses data objects as vectors, it would be apparent to those skilled in the art to extend the principles disclosed to matrices, tensors, and other data objects as well.

In some embodiments, vectors of dimension n may be transformed into vectors of dimension m. In some embodiments, dimensions n and m are equal. In other embodiments, dimensions n and m are not equal. In some embodiments, the transformation of a vector is invertible. In other embodiments, the transformation of a vector is non-invertible.

In some embodiments, the transformation of a vector is linear. In other embodiments, the transformation of a vector is non-linear. The linear transformations of vectors may be succinctly described using matrices. In general, such vectors and matrices may contain real numbers, complex numbers, or other fields. A linear transformation is a function that preserves vector addition and scalar multiplication. When representing a linear transformation using matrices, each vector is typically arranged as a column vector, and the transformation is defined by multiplying the matrix with the input vector. Given a linear transformation T, which takes an n-dimensional vector as input and outputs an m-dimensional vector, the transformation can be represented as:

$$T ( x ) = Ax$$

where x is the input vector, A is an m×n matrix, and T(x) is the transformed output vector. The matrix A encapsulates the properties of the linear transformation, and can be viewed in two ways: (1) the i^{th} entry in the resulting vector T(x) is the inner product (or dot product) of the i^{th} row of A with the input vector x, and (2) the resulting vector T(x) is the linear combination of the n columns of A, weighted by the corresponding entries of input vector x.

Matrices allow for the concise representation of various linear transformations, including rotations, scalings, shears, reflections, and projections. Each transformation can be associated with a specific matrix, and applying that matrix to a vector will yield the transformed vector. The properties of the matrix A can provide insights into the linear transformation. For example, the rank of A determines the dimension of the vector space that the transformation maps to. The null space of A represents the set of vectors that are mapped to the zero vector by the transformation.

The linear transformation of vectors distributes over addition and subtraction and commutes with scalar multiplication. In particular, for any vectors x₁ and x₂, scalars c₁ and c₂, and linear transformation A:

$$A ( {c}_{1} {x}_{1} + {c}_{2} {x}_{2} ) = {c}_{1} A {x}_{1} + {c}_{2} A {x}_{2} .$$

### Invertible Transformations

Some transformations T represented by matrix A are invertible: Given an output vector y, where y=Ax, the input vector x may be recovered. When matrix A is a square matrix, this is achieved by transforming y by the inverse of A: x=A⁻¹y, where A⁻¹×A=A×A⁻¹=I, and I is the identity matrix. Similar principles may be applied when A is not a square matrix. For example, when an input vector x of dimension n is transformed by an m×n matrix A to obtain an output vector y of dimension m, where m is greater than n, i.e., y=Ax, x may be recovered given y.

### Asymmetric Privacy-Preserving Key Encryption

A novel encryption method for both neural networks and input training data, called “reshuffling,” is disclosed. In particular, reshuffling takes advantage of algebraic groups that preserve neural network linear algebra operations up to a congruence relation for block matrices that extend the neural networks to higher ranks using dummy data. The method may be applied by a single party or multiple parties seeking to keep their data and/or neural network private from one another. Through specific choices of matrix groups, e.g., unitary matrices, finite cyclic groups, may improve computational efficiency, this disclosure focuses on classifying all reshuffling encryption schemes.

Consequently, various neural networking training information, such as inputs, weights, and biases, do not matter absolutely. There are many candidate changes of bases (and many more congruences within those bases) where matrix operations, which do matter absolutely, are preserved. Given all these degrees of freedom, the present invention allows selection of a basis that enables data sovereignty.

An embodiment of the invention uses the asymmetric key encryption combined with matrix transformations of embeddings to provide a means for performing various tasks, such as digital engineering, in a lossless way that maintains data sovereignty. Furthermore, the asymmetric key cryptography presented herein for embeddings and enterprise foundation models may extend beyond merely a digital engineering platform. Industry is moving to multiple LLM deployments, and security for tokenization through matrix transformations may be a powerful tool in that revolution.

### Embodiment 1: Mathematical Glossary

Below is a non-exhaustive glossary for variables, functions, objects, and other terms used herein:
1. Subscripts:
   a. The subscripts in W_{0,I,i} for the weights of an unencrypted neural network, include 0 indicating no encryption, with an encryption key of I, the identity matrix, and i representing the i-th layer of the neural network,
   b. The subscripts in W_{Ω,Q,i} for the weights of an encrypted neural network, with Ω indicating encryption, with an encryption key of Q, the expansion matrix, and i representing the i-th layer of the neural network.
2. NN_{0,I,σ}: an unencrypted neural network, having weights W, biases b, and activation function σ, as well as loss function, cost function, and learning rate (not shown in Eqn. (A0)), as defined further below.

$$y = σ ( Wx + b ) \qquad ( A0 )$$

where y=z=output vector, σ=activation function, W=weights matrix, b=biases vector, and x=v⁽⁰⁾=input vector, see for example FIGS. 13 and 14.
3. W_{0,I,i}: weights represented by row rᵢ× column cᵢ matrices over the field of complex numbers, of a neural network NN_{0,I,σ}
4. b_{0,I,i}: biases, represented by rank cᵢ vectors, of a neural network NN_{0,I,σ}
5. σ_{0,I,i}: a (complex) activation function, of a neural network NN_{0,I,σ}
6. L_{0,I,i}: a (complex) loss function, of a neural network NN_{0,I,σ}
7. C_{0,I,i}: a (complex) cost function, of a neural network NN_{0,I,σ}
8. αᵢ: a (complex) learning rate, of a neural network NN_{0,I,σ}
9. v₁: state vector progressing through a neural network NN_{0,I,σ}
10. ρ: a rho-function, an invertible complex function
11. Q: encryption Q-operators, a set of non-singular (invertible) operator functions associated with the weights, the biases, and the activation function, that serve as encryption keys, satisfying a specific set of properties
12.

$${Ω}_{x , ( 1 , 2 )}^{( i ) ( m , b )} , {Ω}_{x , ( 2 , 1 )}^{( i ) ( a , n )} , and {Ω}_{x , ( 2 , 2 )}^{( i ) ( a , b )} :$$

omega-operators, a set of complex matrices
13. σ_{±Ω,0,I,i}: sigma-operators, a set of complex operator matrices
14. R_{Ω,±σ,i}, and R_{Ω,-v,i}: R-operators, a set of complex operator matrices
15. R_{-x,i} and R_{+x,i}: expanded and encrypted R-operators, based on R-operators R_{-x,i(1)} and R_{-x,i,(2)}, and encryption Q-operators Q_{x,i}
16. σ_{+0,I,i} and σ_{-0,I,i}: sigma-rho activation functions, based on an invertible complex function ρ and a complex activation function σ_{0,I,i}
17. Ωₓ⁽ⁱ⁾: an expansion function of a vector x_{0,I,i} (i.e., weights, biases, activation function, state vector), based on a vector x_{0,I,i} and omega-operators

$${Ω}_{x , ( 1 , 2 )}^{( i ) ( m , b )} , {Ω}_{x , ( 2 , 1 )}^{( i ) ( a , n )} , and {Ω}_{x , ( 2 , 2 )}^{( i ) ( a , b )}$$

18. x_{Ω,I,i}: expanded neural network matrices, based on applying an expansion function

$${Ω}_{x}^{( i )}$$

to a vector x_{0,I,i}.
19. Ω_{R,x,i}: an encrypted expansion function of a vector x_{0,I,i} (i.e., weights, biases, activation function, state vector), based on a vector x_{0,I,i}, an expansion function

$${Ω}_{x}^{( i )} ,$$

and R-operators R_{Ω,+x,i} and R_{Ω,-x,i}
20. x_{Ω,R,i}: encrypted expanded neural network matrices, based on applying an encrypted expansion function Ω_{R,x,i} to a vector x_{0,I,i}
21. σ_{Ω,R,i}: encrypted activation functions, which act on linear combinations z_{Ω,R,i} of encrypted expanded neural network matrices for weights, biases, and state vectors, or equivalently, is applying an encrypted expansion function Ω_{R,σ,i} for an activation function σ_{0,I,i} to the output of applying the activation function σ_{0,I,i} to linear combinations z_{0,I,i} of the (unencrypted and unexpanded) weights, biases, and state vectors.
22. NN_{Ω,R,σ}: an encrypted neural network, encrypting unencrypted neural network NN_{0,I,σ} using the expansion functions

$${Ω}_{x}^{( i )} .$$

### Embodiment 1: Encryption by Reshuffling—An Overview

In one embodiment, the encryption process includes a reshuffling method that reshuffles an input matrix with a combination of expansion (i.e., augmenting matrices with additional rows and/or columns), linear functions (e.g., block matrices specially selected to preserve neural network operations in the training data block), non-linear functions (e.g., exponentiation), and subsequent decryption in such a manner that both data sovereignty and correctness of a neural network's forward propagation is preserved, subject to at most a congruence relation. The principal aspects of the reshuffling method are as follows.
1. Preprocessing between two parties towards encrypted NN computation involves key generation, data preparation and sharing:
   a. Each party generates a set of invertible complex functions, along with associated scalars, as seed for encryption. These functions and scalars are then exchanged between the two parties.
   b. Each party prepares a congruent copy of the set of data they own, which can include weights, biases, and an activation function. The congruent copies of respective input matrices at each party can be used later for verification.
   c. Each party generates invertible complex matrices (‘h’ matrices)
2. Define cost function and loss functions
   a. A cost function, which can be different for weights and biases, is modified with the logarithms of scalar values, with either natural logarithms or other select complex numbers as a base. The function is then split into matrices.
   b. In many implementations, the cost function and the loss function are treated synonymously. In some implementations, a separate loss function can also be similarly defined.
3. Generate encryption keys through left and right expansion block matrices called encryption R-operators, that are randomly selected while meeting specific criteria for encryption and correctness, using the following selection criteria
   a. Invertibility: Encryption R-operators are random and invertible. This property enables novel ways of reshuffling and altering the order of the neural network data during encryption.
   b. Expansion: The subscript, assigned to these encryption R-operators, denotes the expansion block of a matrix. Their role as expansion matrices allows a smaller matrix to be transformed into a larger one, contributing complexity and security to the encryption process.
   c. Kernel Requirement: During the encryption process, the encryption R-operators must satisfy certain Kernel requirements, meaning certain submatrices when multiplied must equate to zero. The kernels represent the vector space in which random matrices need to be generated.
   d. Inverse Requirement: During the encryption process, the encryption R-operators must satisfy certain inverse requirements, meaning certain submatrices when multiplied must equate to the identity matrix in the block for the training data. The inverse requirement will apply to the random block matrices that need to be generated.
   e. Equivalence Class Preservation: The encryption R-operators assist in preserving equivalence classes between different mathematical spaces. This function ensures that addition and multiplication operations in the altered ‘expanded’ space correspond to the original ‘unexpanded’ space even though they're being carried out differently.
   f. Exponentiation: There are parts of the encryption process where encryption R-operators are exponentiated. This step provides additional encryption strength and further obscures the original data from potential decryption attempts.
   g. Separate Encryption Steps: Encryption R-operators facilitate ‘split-key’ encryption by allowing for the transactional exchange of certain encrypted information between two parties. Each party can generate independent encryption R-operators, adding an extra layer of security to the encryption model.
   h. Roles in both forward and back propagation: encryption R-operators are used during the backpropagation process. They are involved in the alteration of error functions, allowing for the calculation of changes in the gradients of error functions to be related to the changes in weights and biases in the original neural network.
   i. Independent verification: The reshuffling method along with the choices of encryption R-operators as defined above, allows for either party to independently verify the computations.
   j. Ease of decryption: Decryption can occur by the party that owns their copy of the encrypted neural net, providing a high degree of control. This property is paramount to the proposed encryption scheme.
4. Exchange of a subset of encryption R-operators as keys with the counterparty
5. Encrypt through expansion and exponentiation
   a. Data expansion: Application of the left and right block matrices transforms the neural network into an expanded, encrypted space
   b. Data Exponentiation and Key Encryption: Exponential encryption is applied to weights and biases, using the earlier exchanged scalars. This data is then sent to the other party.
   c. Activation Function and Cost Function Encryption: The same process of exponentiation and encryption is repeated for the activation and cost functions.
6. Evaluation (NN forward propagation)
   a. Encryption (“Reshuffling”)
      During forward propagation, the encrypted data from the data owner entity is input to the encrypted neural network and the encrypted neural network performs the computations to provide an encrypted output.
   b. Decryption (“Deshuffling”)
      At the end of forward propagation operations, the output of the encrypted neural network is shared with the data owner entity. With data owner keys, the data owner entity is able to decrypt the encrypted output.
7. Training (Iterative NN forward propagation+NN back propagation)
   a. Encryption (“Reshuffling”)
      During forward propagation, the encrypted data from the data owner entity is input to the encrypted neural network and the encrypted neural network performs the computations to provide an encrypted output. During back propagation operations, further computations on the encrypted loss function and encrypted neural network gradients relative to Weights and biases are performed, in order to train the encrypted neural network.
   b. Decryption (“Deshuffling”)
      At the end of forward propagation operations, the output of the encrypted neural network is shared with the data owner entity. With data owner keys, the data owner entity is able to decrypt the encrypted output. During back propagation operations, the data owner shares encrypted expectation value of the data as well. The neural network owner shares encrypted gradients with the data owner to decrypt at their end. Both neural network owner and data owner are able to independently perform back propagation operations for independent verification.
8. Symmetric Protections: The proposed reshuffling method ensures that each party has the same degree of protection and control over the data, maintaining symmetry throughout the process, and has similar computational burden.
9. Security Assurance: The proposed encryption process is secure as it resets with each operation, keeping the true biases hidden from both parties. No party has better security, ensuring fairness.
10. Alternative options
   a. While the implementation of left and right split-key expansion matrix approach is most general for encryption, there are select matrices within the group that can be selected for further improvements
   b. Additional requirements placed on encryption R-operators (e.g., as skew-symmetric matrices, orthogonal matrices) can further improve the computational performance
   c. Unitary matrices are another implementation that can be used for encryption but without expansion.

Below, the most generic implementation for encrypting neural networks is disclosed, including expansion, encryption with linear transformation and reshuffling, and non-linear encryption options with exponentiation, with specific choices of direction of exponentiation and options to make logarithms easier. Of these choices, skew-symmetric and orthogonal matrix choices, or circulant matrix choices, offer better computation efficiency. An example implementation shows how the computation burden is similar across two parties and allows for independent verification. These present options for “model as a service” and “training data as a service” application. Note that encryption while minimizing compute overhead is a major challenge. The following specific exemplary types of matrices offer efficient inverse operations and are possible for encryption keys: unitary matrices within the class of inner product spaces, and equivalents. As an example, a specific embodiment using unitary matrices is disclosed at the end of this document.

### Embodiment 1: Encryption by Reshuffling—Figures

As described above, in one embodiment, the encryption process includes a reshuffling method that reshuffles an input matrix with a combination of expansion (i.e., augmenting matrices with additional rows and/or columns), linear functions (e.g., block matrices specially selected to preserve neural network operations in the training data block), non-linear functions (e.g., exponentiation), and subsequent decryption in such a manner that both data sovereignty and correctness of a neural network's forward propagation is preserved, subject to at most a congruence relation. The principal aspects of the reshuffling method are summarized on an abstract level in FIGS. 20-22.

As shown in FIG. 20, the reshuffle process 2012 for the encrypted neural network (2014, 2018) includes both a linear transformation step 2020, that is performed by the R-operator block matrices, and a non-linear exponentiation step 2024. In some embodiments, a reshuffling process is performed for each layer of the neural network (2002, 2006), represented in expression 2004, with attributes 2008. In other embodiments, some layers of the neural network undergo a reshuffling process whereas the other layers of the neural network do not. Together, the linear and non-linear transformation processes provide greater encryption. The encrypted neural network (2014, 2018), represented in expression 2016, is reshuffled across all its data attributes—the state vectors, weights, biases, cost functions, loss functions and activation function 2026. The data owner entity reshuffles the data and only provides the encrypted data to the neural network owner. The encrypted neural network in the transformed space 2018 is trained with encrypted input data in the transformed space 2028. The visual of the reshuffled or encrypted neural network in FIG. 20 indicates that the encrypted neural network may have more features and individual edges of the neural network, representing the weights, biases and activation, are further encrypted.

Note that the neural network and all its attributes are transformed using an expansion step consisting of a combination of left and right block matrix operations using specific R-operator matrices. The activation functions are expanded and encrypted with the use of R-operators and additional complex invertible matrices.

FIG. 21 provides additional details of the reshuffle process including both the linear transform reshuffle steps 2114 and non-linear transform reshuffle steps 2116, showing the neural network and all its attributes are transformed using an expansion step consisting of a combination of left and right block matrix operations using specific R-operator matrices. The linear transform reshuffle steps 2114 are depicted by the illustrative schematics 2108 and 2122. The activation functions are expanded and encrypted with the use of R-operators and additional complex invertible matrices, as shown in illustrative matrix transformations 2110 and 2124.

FIG. 22 shows that the selection of R-operator block matrices (as shown in 2212, 2214 and 2218) for the reshuffle process has a set of inverse block matrices and kernels such that the neural network operations in the encrypted expanded (reshuffled) neural network is preserved up to a congruence. FIG. 23 shows the properties of R-operator block matrices in 2302 used in the reshuffle process that show specific block inverses and kernels as necessary properties in order for neural network operations to be preserved in the top-left block of 2304, and similarly in 2212. FIG. 24 shows an example of binary operators 2402 in the transformed space of the encrypted neural network that demonstrate that forward propagation operations in the encrypted neural network are preserved.

In an implementation of a two party reshuffling method, the neural network is expanded and encrypted to perform forward propagation and backpropagation operations only using data that is encrypted and exchanged by a data owner, using the following sequence of steps (not using the same numbering as the steps in the math equations for process flow below):
1. Both parties independently generate encryption keys, based on a seed complex number or complex matrix, either generated by themselves or by a third-party key manager.
2. Neural network owner expands the row and column rank of the weight matrices (W) to include randomly generated data satisfying a predetermined distribution. Similarly expand the bias matrices (b) and activation matrices (σ).
3. Neural network owner linearly transform the now expanded weight matrices, bias matrices and activation matrices via left and right matrix multiplications obeying predetermined rules for partial invertibility.
4. Both parties exchange a copy of required block matrix inverses (to generate required block identity matrices) and block kernels and cokernels (to generate required block zero matrices) so that multiplications in the now transformed neural network preserve underlying multiplications in the original, untransformed neural net.
5. Both parties generate invertible complex matrices and complex scalars, and exchange a copy with the other party.
6. Neural network owner non-linearly transforms the now linearly transformed matrices (Weight matrices, bias matrices and activation matrices), with left exponentiated matrices of complex matrices.
7. Data owner exchanges an encrypted, exponentiated copy of elements of the state vector and the activation matrix. The data owner further encrypts their copy of elements of the state vector and the activation matrix using keys shared by the data owner.
8. Neural network owner takes matrix logarithms of the encrypted copy of elements of the state vector and the activation matrix, using complex matrix keys previously exchanged. The neural network owner further encrypts the state vector with right block matrices and creates an encrypted activation matrix.
9. Neural network owner encrypts and exponentiates the Weights, bias and activation matrices, and exchanges them with the data owner. The neural network separately encrypts their copy of Weights, biases and activation matrices with left and right block matrices.
10. Data owner takes matrix logarithms of the exchanged encrypted, exponentiated Weight, bias and activation matrices. The data owner forward propagates their data through the decrypted matrices to generate the output from the expanded, encrypted neural network. The data owner exponentiates the output further with the complex matrix keys previously shared and exchanges the encrypted exponentiated output with the neural network owner. The exchange of the encrypted exponentiated output facilitates independent verification by the neural network owner of correctness of the forward propagation.
11. Neural network owner independently forward propagates their state vector through the expanded, encrypted neural network to obtain an encrypted output. The neural network owner further decrypts the encrypted output to prepare a copy of their neural network's output. A copy of the neural network's output is further re-encrypted through exponentiation and exchanged with the data owner, for their independent verification.
12. In implementation examples for evaluation of the data input from the data owner through the neural network owned by the neural network owner, the above independent verification is the final step.
13. For implementations with training, there are a corresponding additional set of steps for backpropagation that are performed.
14. In an example of training, the data owner further exchanges an encrypted, exponentiated copy of elements of the data vector representing the expectation value of the output with the neural network owner. The data owner also exchanges an encrypted, exponentiated copy of the error function that is computed based on the output data and the expectation value.
15. In an implementation of training, both parties independently generate a different set of encryption keys, based on a seed complex number or matrix, either generated by themselves or by a third-party key manager.
16. In an implementation of training, both parties exchange a copy of required block matrix inverses (to generate required block identity matrices) and block kernels and cokemels (to generate required block zero matrices) so that multiplications in the now transformed neural network preserve underlying multiplications in the original, untransformed neural net.
17. Neural network owner encrypts the cost function matrices (C) by expanding and exponentiating with the exchanged keys and exchanged block matrices.
18. The data network owner further computes the error function, logarithmically encrypts the error function and exchanges with the neural network owner.
19. The neural network owner uses the encrypted error function to perform backpropagation operations in the encrypted neural network space using the encrypted cost function to estimate the changes in the Weight, bias and activation matrices.
20. As part of back propagation, the neural network owner further computes the gradients of the cost function with respect to the weight, bias and activation matrices, further encrypts them using exponentiated matrices and exchanges with the data owner.
21. The data owner uses the encrypted cost gradients in order to perform backpropagation on their data for verification. The data owner logarithmically encrypts the exponentiated, encrypted cost function shared by the neural network owner to estimate the error function in the encrypted space of the neural network.
22. The data owner decrypts the exchanged encrypted, exponentiated cost gradients to compute the changes matrices for the respective Weight, bias and activation matrices. The data owner further encrypts the change matrices for the Weight, bias and activation matrices using right exponentiation matrices and exchanges them with the neural network owner.
23. For the sake of independent verification, the neural network owner decrypts the exchanged encrypted, exponentiated change matrices for Weight, bias and activation matrices and performs a comparison with their local copy of Weight, bias and activation matrices. Similar to the forward propagation operations, the data owner decrypts the encrypted, exponentiated output from the neural network owner and performs a comparison with their local copy of the output.

A selection of steps above, such as steps 2, 3, 6, 8, and 10 that include encryption with expansion, exponentiation and taking logarithms, provide for the security of the implementation. Meanwhile, the exchange of corresponding encryption keys, block matrices and complex matrices at various steps, such as steps 1, 4, 5, 7 and 11, are necessary for correctness of the approach and for independent verification by the two parties.

### Embodiment 1: Encryption by Reshuffling—Process Flow

The steps shown below constitute an embodiment of a two-party reshuffling method, R₂, which creates two sets of congruent neural network matrix operations that protect the input data of both parties while providing a zero-trust means of verifying that congruent operations have been performed to produce congruent final output vectors and updates to weights and biases.

Let the two parties be designated by P₊ (the owner of the neural network) and P₋ (the owner of the input data).

In step 1, P₋ generates invertible complex functions, ρᵢ, ρ̅ᵢ, and exchanges with P₊. In all steps, overbars indicate copies that will be shared with the opposite party, and not used by the generating party, instead of complex conjugation.

In step 2, P_{±} generate congruent copies, x_{I,i} and x̅_{I,i}, of input matrices: x∈{v, W, b, σ_{±}, C_{±}}, where i=1 when x=v.

In step 3, For each input matrix corresponding to i<n, P₊ generates invertible complex matrices, h̅_{W,i} and h̅_{+σ,i}, and likewise for P₋ with h̅_{-v,i} and h̅_{-σ,i}, such that

$${\overline{h}}_{+ σ , i} s . t . \vert ln {\overline{h}}_{W , i} \vert \neq 0 , \qquad ( i )$$

$${\overline{h}}_{- σ , i} s . t . \vert ln {\overline{h}}_{- v , i} \vert \neq 0. \qquad ( ii )$$

In step 4, P₊ generates

$$\{ {\overline{R}}_{- W , i}^{( + )} , {R}_{+ W , i}^{( + )} , {R}_{- W , i}^{( + )} , {\overline{R}}_{- b , i}^{( + )} , {R}_{- σ , i}^{( + )} , {R}_{v , i > 1}^{( + )} \} ,$$

and P₋ generates

$$\{ {\overline{R}}_{+ v , i}^{( - )} , {R}_{- v , i}^{( - )} , {\overline{R}}_{- v , i}^{( - )} , {\overline{r}}_{- v , i}^{( - )} , {R}_{+ σ , i}^{( - )} \} ,$$

respectively, such that W_{R,i}, b_{R,i}, v_{R,1}, and σ_{±R,i} are square matrices. In all steps, superscripts (±) indicate the generating party. Also,

$${\overline{R}}_{- W , n}^{( + )} and {\overline{R}}_{- v , n}^{( - )}$$

are only generated if backpropagation is to be performed. Then,

$${P}_{-} exchanges {\overline{Q}}_{v , 1}^{( - )} {\overline{R}}_{v , 1 , ( 1 )}^{( - )} , ker {\overline{Q}}_{v , 1}^{( - )} {\overline{R}}_{v , 1}^{( - )} , {\overline{r}}_{- v , i ( 1 )}^{( - )} {\overline{Q}}_{- v , i}^{( - )} , and ker {\overline{r}}_{- v , i}^{( - )} {\overline{Q}}_{- v , i}^{( - )} with {P}_{+} , \qquad ( i )$$

$${P}_{+} exchanges {\overline{R}}_{- W , 1 , ( 1 )}^{( + )} {\overline{Q}}_{- W , 1}^{( + )} , ker {\overline{R}}_{- W , 1}^{( + )} {\overline{Q}}_{- W , 1}^{( + )} , {\overline{R}}_{- b , i , ( 1 )}^{( + )} {\overline{Q}}_{- b , i}^{( + )} , and ker {\overline{R}}_{- b , i}^{( + )} {\overline{Q}}_{- b , i}^{( + )} with {P}_{-} . \qquad ( ii )$$

In step 5, P₋ performs the following substeps: (Note that the (+) and (−) will be dropped in the scalar superscript when carrying it in an associated exponentiated matrix.)

$$generate {Q}_{- W , 1}^{( - )} = {\overline{Q}}_{ν , 1}^{( - ) - 1} , {Q}_{- b , i}^{( - )} = {\overline{Q}}_{- ν , i}^{( - ) - 1} , {\overline{Q}}_{- b , i + 1}^{( - )} = {\overline{Q}}_{{r}_{- v} , t + 1}^{( - ) - 1} , \qquad ( i )$$

$$generate {R}_{+ ν , 1}^{( - )} = ( \begin{matrix}{\overline{Q}}_{- W , 1}^{( - ) - 1} {\overline{R}}_{- W , 1 , ( 1 )}^{( - ) - 1 , -} \\ ∈ ker {\overline{Q}}_{- W , 1}^{( + )} {\overline{R}}_{- W , 1}^{( + )}\end{matrix} ) , \qquad ( ii )$$

$$generate {\overline{R}}_{- b , i}^{( - )} s . t . {\overline{R}}_{- b , i , ( 1 )}^{( - )} = {\overline{Q}}_{{r}_{- v} , i}^{( - ) - 1} {\overline{r}}_{- ν , i ( 1 )}^{( - ) - 1 , -} , {\overline{R}}_{- b , 1 , ( 2 )}^{( - )} ∈ coker {\overline{r}}_{- b , i , ( 1 )}^{( - )} , \qquad ( iii )$$

$$generate non - zero complex scalars , {\overline{k}}_{- σ , - ν , i} , \qquad ( iv )$$

$$generate complex matrices , {\overline{R}}_{- v , i}^{( - )} s . t . {\overline{R}}_{- v , i , ( 2 )}^{( - )} ∈ ker {\overline{R}}_{- v , i , ( 1 )}^{( - ) T} , \qquad ( v )$$

$$encrypt , exponentiate {\overline{v}}_{I , 1} : {\overline{R}}_{v , 1}^{( - )} {\overline{v}}_{I , 1} {\overline{R}}_{- ν , 1}^{( - )} \to {}^{{\overline{R}}_{v , 1}^{( - )} {\overline{v}}_{I , 1} {\overline{R}}_{- ν , 1}^{( - )}} {\overline{h}}_{- ν , 1} , \qquad ( vi )$$

$$encrypt , exponentiate {\overline{R}}_{- v , i}^{( - )} : {\overline{r}}_{- v , i}^{( - )} {\overline{R}}_{- ν , i}^{( - )} \to {}^{{\overline{r}}_{- v , i}^{( - )} {\overline{R}}_{- ν , i}^{( - )}} {\overline{h}}_{- ν , i} \qquad ( vii )$$

$$encrypt , exponentiate {\overline{σ}}_{- , I , i} \to {\overline{h}}_{- σ , i}^{{\overline{R}}_{+ σ , i}^{( - )} {\overline{σ}}_{- , I , i} {\overline{R}}_{- b , i + 1}^{( - )}} , where \qquad ( viii )$$

$${\overline{R}}_{+ σ , i , ( 1 )}^{( - )} - \frac{1}{{\overline{k}}_{- σ , - v , i}} {( ln {\overline{h}}_{- σ , i} )}^{- 1} {( ln {\overline{h}}_{- ν , i} )}^{- 1} {\overline{Q}}_{- ν , i}^{( - ) - 1} {\overline{R}}_{- ν , i , ( 1 )}^{( - ) - 1 , -} ,$$

$${\overline{R}}_{+ σ , i , ( 2 )}^{( - )} - ∈ coker {( ln {\overline{h}}_{- σ , i} )}^{- 1} {( ln {\overline{h}}_{- ν , i} )}^{- 1} {\overline{Q}}_{- ν , i}^{( - ) - 1} {\overline{R}}_{- ν , i}^{( - )} ,$$

$$encrypt {v}_{I , 1} : {R}_{ν , 1}^{( - )} {v}_{I , 1} {R}_{- ν , 1}^{( - )} , \qquad ( ix )$$

$$encrypt {σ}_{- , I , t} \to {R}_{+ σ , i}^{( - )} {σ}_{- , I , i} {R}_{- ν , i + 1}^{( - )} . \qquad ( x )$$

Outputs of (v) through (viii),

$${\overline{r}}_{- ν , i , ( 1 )}^{( - ) - 1 , -} {\overline{Q}}_{{r}_{- v} , i}^{( - ) - 1} , and coker {\overline{Q}}_{{r}_{- v} , i}^{( - )} {\overline{r}}_{- ν , i , ( 2 )}^{( - )}$$

are exchanged with P₊.

In step 6, P₊ performs the following substeps:

$$generate {R}_{- W , 1}^{( + )} = ( {\overline{R}}_{ν , 1 , ( 1 )}^{( - ) - 1 , -} {\overline{Q}}_{ν , 1}^{( - ) - 1} , ∈ ker {\overline{R}}_{ν , 1}^{( - )} {\overline{Q}}_{ν , 1}^{( - )} ) , \qquad ( i )$$

$$generate {R}_{- b , i}^{( + )} s . t . {R}_{- b , i , ( 1 )}^{( + )} = {\overline{r}}_{- ν , i , ( 1 )}^{( - ) - 1 , -} {\overline{Q}}_{{r}_{- v} , i}^{( - ) - 1} , {R}_{- b , i , ( 1 )}^{( + )} ∈ coker {\overline{Q}}_{{r}_{- v} , i}^{( - )} {\overline{r}}_{- ν , i , ( 2 )}^{( - )} , \qquad ( ii )$$

$$take {log}_{{k}_{v , 1}} of {}^{{\overline{R}}_{v , 1}^{( - )} {\overline{v}}_{I , 1} {\overline{R}}_{- ν , 1}^{( - )}} {\overline{h}}_{- ν , 1} \to {\overline{R}}_{v , 1}^{( - )} {\overline{v}}_{I , 1} {\overline{R}}_{- ν , 1}^{( - )} {log}_{{k}_{- v , 1}} {\overline{h}}_{- v , 1} \qquad ( iv )$$

$$take {log}_{{k}_{- v , 1}} , encrypt {}^{{\overline{r}}_{- v , 1} {\overline{R}}_{- ν , i}^{( - )}} {\overline{h}}_{- ν , i} \to {\overline{R}}_{W , i}^{( + )} {\overline{b}}_{I , i} {\overline{R}}_{- b , i}^{( + )} {\overline{r}}_{- v , i}^{( - )} {\overline{R}}_{- ν , i}^{( - )} {log}_{{k}_{- v , i}} {\overline{k}}_{- v , i} , \qquad ( v )$$

$$take {log}_{{k}_{- σ , i}} of {\overline{h}}_{- σ , i}^{{\overline{R}}_{+ σ , i}^{( - )} {\overline{σ}}_{- , I , i} {\overline{R}}_{- b , i + 1}^{( - )}} \to ( {log}_{{k}_{- σ , i}} {\overline{h}}_{- σ , i} ) {\overline{R}}_{+ σ , i}^{( - )} {\overline{v}}_{- , I , i} {\overline{R}}_{- b , i + 1}^{( - )} , {k}_{- σ , i} = {e}^{\frac{{\overline{k}}_{- σ , - v , i}}{ln {\overline{k}}_{- v , i}}} , \qquad ( vi )$$

$$“ right - encrypt ” ( vi ) \to ( {log}_{{k}_{- σ , i}} {\overline{h}}_{- σ , i} ) {\overline{R}}_{+ σ , i}^{( - )} {\overline{σ}}_{- , I , i} {\overline{R}}_{- b , i + 1}^{( - )} {\overline{r}}_{- v , i + 1} {\overline{R}}_{- v , i + 1}^{( - )} , \qquad ( vii )$$

$$adopt activation function {σ}_{i}^{( + )} : {σ}_{i}^{( + )} ( z ) = {σ}_{+ , i} ( ( z ) {\overline{σ}}_{- , i} ) . \qquad ( viii )$$

$$generate complex scalars , {\overline{k}}_{σ , W , i} \neq 0 , \qquad ( ix )$$

$$generate complex matrix , {\overline{R}}_{- W , i}^{( + )} s . t . {\overline{R}}_{- W , i , ( 2 )}^{( + )} ∈ ker {\overline{R}}_{- W , i , ( 1 )}^{( + ) T} , \qquad ( x )$$

$$encrypt , exponentiate {\overline{W}}_{I , i} \to {\overline{h}}_{W , i}^{{\overline{R}}_{W , i}^{( + )} {\overline{W}}_{I , i} {\overline{R}}_{- W , i}^{( + )}} , \qquad ( xi )$$

$$encrypt , exponentiate {\overline{b}}_{I , i} \to {\overline{h}}_{W , i}^{{\overline{R}}_{W , i}^{( + )} {\overline{b}}_{I , i} {\overline{R}}_{- b , i}^{( + )}} , \qquad ( xii )$$

$$encrypt , exponentiate {\overline{σ}}_{+ I , i} \to {}^{{\overline{R}}_{v , i + 1}^{( + )} {\overline{σ}}_{+ I , i}^{( + )} {\overline{R}}_{- σ , i}^{( + )}} {\overline{h}}_{+ σ , i} , where \qquad ( xiii )$$

$${\overline{R}}_{- σ , i , ( 1 )}^{( + )} = \frac{1}{{\overline{k}}_{σ , W , i}} {\overline{R}}_{W , i , ( 1 )}^{( + ) - 1 , +} {\overline{Q}}_{W , i}^{( + ) - 1} {( ln {\overline{h}}_{W , i} )}^{- 1} {( ln {\overline{h}}_{- σ , i} )}^{- 1} ,$$

$${\overline{R}}_{+ σ , i , ( 2 )}^{( - )} - ∈ coker {\overline{R}}_{W , i}^{( + ) - 1 , +} {\overline{Q}}_{W , i}^{( + ) - 1} {( ln {\overline{h}}_{W , i} )}^{- 1} {( ln {\overline{h}}_{- σ , i} )}^{- 1} , {\overline{k}}_{σ , i} = {e}^{\frac{{\overline{k}}_{σ , W , i}}{ln {\overline{k}}_{W , i}}} ,$$

$$encrypt {W}_{I , t} \to {R}_{W , i}^{( + )} {W}_{I , i} {R}_{- W , i}^{( + )} , \qquad ( xiii )$$

$$encrypt {b}_{I , i} \to {R}_{W , i}^{( + )} {b}_{I , i} {R}_{- b , i}^{( + )} , \qquad ( xiv )$$

$$encrypt {σ}_{+ , I , i} \to {R}_{ν , + 1}^{( + )} {σ}_{+ I , i}^{( + )} {R}_{- σ , i}^{( + )} , \qquad ( xv )$$

Outputs of (viii) through (xii) are exchanged with P₋.

In step 7, P₋ performs the following substeps:

$$takes {log}_{{k}_{W , i}} of {\overline{h}}_{W , i}^{{\overline{R}}_{W , i}^{( + )} {\overline{W}}_{- , I , i} {\overline{R}}_{- W , i}^{( + )}} \to ( {log}_{{k}_{W , i}} {\overline{h}}_{W , i} ) {\overline{R}}_{W , i}^{( + )} {\overline{W}}_{I , i} {\overline{R}}_{- W , i}^{( + )} , \qquad ( i )$$

$$takes {log}_{{k}_{W , 1}} , encrypts {\overline{h}}_{W , i}^{{\overline{R}}_{W , i}^{( + )} {\overline{b}}_{I , i} {\overline{R}}_{- b , i}^{( + )}} \to ( {log}_{{k}_{W , i}} {\overline{h}}_{W , i} ) {\overline{R}}_{W , i}^{( + )} {\overline{b}}_{I , i} {\overline{R}}_{- b , i}^{( + )} {\overline{r}}_{- v , i}^{( - )} {\overline{R}}_{- ν , i}^{( - )} , \qquad ( ii )$$

$$takes {log}_{{k}_{σ , i}} of {}^{{\overline{R}}_{v , i + 1}^{( + )} {\overline{σ}}_{+ I , i}^{( + )} {\overline{R}}_{- σ , i}^{( + )}} {\overline{h}}_{+ σ , i} \to {\overline{R}}_{v , i + 1}^{( - )} {\overline{σ}}_{+ , I , i}^{( + )} {\overline{R}}_{- σ , i}^{( + )} ( {log}_{{k}_{σ , i}} {\overline{h}}_{+ σ , i} ) , {k}_{σ , i} = {e}^{\frac{{\overline{k}}_{σ , W , i}}{ln {\overline{k}}_{W , i}}} . \qquad ( iii )$$

In step 8, P₋ forward propagates to the final state vector, v_{R,n}, using the following operations for each hidden layer, i≤n−1:

$$( {log}_{{k}_{W , 1}} {\overline{h}}_{W , 1} ) {\overline{R}}_{W , 1}^{( + )} ( {z}_{I , 1}^{( - )} ) {R}_{- ν , 1}^{( - )} = ( {log}_{{k}_{W , 1}} {\overline{h}}_{W , 1} ) ( {\overline{W}}_{\overline{R} , 1} {v}_{R , 1} + {\overline{b}}_{\overline{R} , 1} {r}_{- v , 1}^{( - )} {R}_{- v , 1}^{( - )} ) ,$$

$$( {log}_{{k}_{W , i}} {\overline{h}}_{W , i} ) {\overline{R}}_{W , i}^{( + )} ( {z}_{I , i > 1}^{( - )} ) {R}_{- ν , i}^{( - )} = ( {log}_{{k}_{W , i}} {\overline{h}}_{W , i} ) ( {\overline{W}}_{\overline{R} , i} {\overline{R}}_{v , i}^{( + )} {v}_{- I , i}^{( - )} {R}_{- v , i}^{( - )} + {\overline{b}}_{\overline{R} , i} {r}_{- v , i}^{( - )} {R}_{- v , i}^{( - )} ) ,$$

$${\overline{R}}_{v , i + 1}^{( + )} {v}_{I , i + 1}^{( - )} {R}_{- v , i + 1}^{( - )} = {\overline{R}}_{v , i + 1}^{( + )} {\overline{σ}}_{+ , I , i}^{( - )} {R}_{- σ , i}^{( + )} ( {log}_{{k}_{σ , i}} {\overline{h}}_{+ σ , i} ) ( {log}_{{k}_{W , i}} {\overline{h}}_{W , i} ) {\overline{R}}_{W , i}^{( + )} {z}_{I , i}^{( - )} {R}_{- v , i}^{( - )} {σ}_{- , R , i} .$$

Then P₋ exponentiates

$${}^{{\overline{R}}_{v , n}^{( + )} {v}_{I , n}^{( - )} {R}_{- v , n}^{( - )}} {\overline{h}}_{- v , n}$$

and exchanges with P₊.

In step 9, P₊ forward propagates to the final state vector, v_{R,n}, using the following operations for each hidden layer, i≤n−1:

$${R}_{W , 1}^{( + )} ( {z}_{I , 1}^{( + )} ) {\overline{R}}_{- ν , 1}^{( - )} ( {log}_{{k}_{- v , 1}} {\overline{h}}_{- v , 1} ) = ( {\overline{W}}_{\overline{R} , 1} {\overline{v}}_{\overline{R} , 1} + {b}_{R , 1} {\overline{r}}_{- v , 1}^{( - )} {\overline{R}}_{- v , 1}^{( - )} ) ( {log}_{{k}_{- v , 1}} {\overline{h}}_{- v , 1} ) ,$$

$${R}_{W , i}^{( + )} ( {z}_{I , i}^{( + )} ) {\overline{R}}_{- ν , i}^{( - )} ( {log}_{{k}_{- v , i}} {\overline{h}}_{- v , i} ) = ( {W}_{R , i} {\overline{R}}_{v , i}^{( + )} {v}_{I , i}^{( + )} {\overline{R}}_{- v , i}^{( - )} + {b}_{R , i} {\overline{r}}_{- v , i}^{( - )} {\overline{R}}_{- v , i}^{( - )} ) ( {log}_{{k}_{- v , i}} {\overline{h}}_{- v , i} ) ,$$

$${\overline{R}}_{v , i + 1}^{( + )} {v}_{I , i + 1}^{( + )} {R}_{- v , i + 1}^{( - )} = {σ}_{+ , R , i} {\overline{R}}_{W , i}^{( + )} {z}_{I , i}^{( + )} {\overline{R}}_{- V , i}^{( - )} ( {log}_{{k}_{- v , i}} {\overline{h}}_{- v , i} ) ( {log}_{{k}_{- σ , i}} {\overline{h}}_{- σ , i} ) {\overline{R}}_{+ σ , i}^{( - )} {σ}_{- , I , i}^{( - )} {R}_{- b , i + 1}^{( - )} {\overline{r}}_{- v , i + 1}^{( - )} {\overline{R}}_{- v , i + 1}^{( - )} .$$

Then P₊ then performs the following steps:

$$decrypt {R}_{ν , n}^{( + )} {v}_{I , n}^{( + )} {\overline{R}}_{- ν , n}^{( - )} \to {v}_{I , n}^{( + )} {\overline{R}}_{- ν , n}^{( - )} , \qquad ( i )$$

$$take {log}_{{h}_{ν , n}} , decrypt , re - exponentiate {}^{{\overline{R}}_{v , n}^{( + )} {v}_{I , n}^{( - )} {R}_{- v , n}^{( - )}} {\overline{h}}_{- v , n} \to {}^{{v}_{I , n}^{( - )} {R}_{- v , n}^{( - )}} {\overline{h}}_{- v , n} , \qquad ( ii )$$

$$re - exponentiate {v}_{I , n}^{( + )} {R}_{- ν , n}^{( - )} ( {log}_{{k}_{- v , n}} {\overline{h}}_{- v , n} ) \to {}^{{v}_{I , n}^{( + )} {\overline{R}}_{- v , n}^{( - )}} {\overline{h}}_{- v , n} . \qquad ( iii )$$

In step 10, If v_{I,n} is part of a training set with expected value, t_{I,n}, then Steps 10 through 16 are performing, beginning with P₊ generating invertible complex matrices, h̅_{+C,i<n} and h̅_{v,n}, and likewise for P₋ with h̅_{-C,i<n} and h̅_{-v,n}, where
(i) no h̅ matrix has eigenvalue equal to zero or one,

$${\overline{h}}_{+ C , n} = {{\overline{k}}_{+ C , n} ( {log}_{{\overline{k}}_{v , n}} {\overline{h}}_{v , n} )}^{- 1} , \qquad ( ii )$$

$${\overline{h}}_{- C , n} = {{\overline{k}}_{- v , n} ( {log}_{{k}_{- v , n}} {\overline{h}}_{- v , n} )}^{- 1} , \qquad ( iii )$$

where k̅_{±C,n} are non-zero complex scalars.

In step 11, P₊ performing the following substeps:

$$generate complex matrices , {R}_{- C , n}^{( + )} and {R}_{- C , n}^{( + )} s . t . {Q}_{- C , n}^{( + )} = {Q}_{v , n}^{( + ) - 1} , {R}_{- C , n , ( 1 )}^{( + )} = {\overline{R}}_{v , n , ( 1 )}^{( + ) - 1} , {R}_{- C , n , ( 1 )}^{( + )} = {R}_{- C , n , ( 2 )}^{( + )} , ∈ ker {R}_{v , n , ( 1 )}^{( + )} , {\overline{R}}_{- C , n , ( 2 )}^{( + )} ∈ ker {\overline{R}}_{v , n , ( 1 )}^{( + )} , \qquad ( i )$$

$$generate complex matrices {r}_{C , n}^{( + )} and {\overline{r}}_{C , n}^{( + )} s . t . ∃ {r}_{C , n , ( 1 )}^{( + ) - 1 , +} , {r}_{C , n , ( 1 )}^{( + ) - 1 , +} respectively , \qquad ( ii )$$

$$generate complex matrix {\overline{r}}_{v , n}^{( + )} s . t . ∃ {\overline{r}}_{v , n , ( 1 )}^{( + ) - 1 , -} , \qquad ( iii )$$

$$encrypt , exponentiate {\overline{R}}_{v , n}^{( + )} \to {\overline{h}}_{v , n}^{{\overline{R}}_{v , n}^{( + )} {\overline{r}}_{v , n}} . \qquad ( iv )$$

Outputs of (iv),

$${\overline{r}}_{v , n , ( 1 )}^{( + )} , {Q}_{v , n}^{( + )} , ker {\overline{r}}_{v , n}^{( + )} {\overline{Q}}_{v , n}^{( + )}$$

are exchanged with P₋.

In step 12, P₋ performs the following substeps:

$$generate complex matrices {R}_{C , n}^{( - )} and {\overline{R}}_{C , n}^{( - )} s . t . {Q}_{C , n}^{( - )} = {Q}_{- v , n}^{( - ) - 1} , {R}_{C , n , ( - )}^{( - )} = {R}_{- v , n , ( - )}^{( - ) - 1 , -} , {\overline{R}}_{C , n , ( 2 )}^{( - )} ∈ ker {\overline{R}}_{- v , n , ( 1 )}^{( - )} , {\overline{R}}_{C , n , ( 1 )}^{( - )} = {R}_{- v , n , ( 1 )}^{( - ) - 1 , -} , and {\overline{R}}_{C , n , ( 2 )}^{( - )} ∈ ker {\overline{R}}_{- v , n , ( 1 )}^{( - )} , \qquad ( i )$$

$$generate complex matrices {r}_{C , n}^{( - )} and {\overline{r}}_{C , n}^{( - )} s . t . ∃ {r}_{C , n , ( 1 )}^{( - ) - 1 -} and {\overline{r}}_{C , n , ( 1 )}^{( - ) - 1 , -} respectively , \qquad ( ii )$$

$$generate complex matrix {\overline{r}}_{v , n}^{( - )} s . t . ∃ {\overline{r}}_{v , n , ( 1 )}^{( - ) - 1 , -} , calculate {\overline{Q}}_{v , n}^{( - ) - 1} {\overline{r}}_{v , n , ( 1 )}^{( - ) - 1 -} , ker {Q}_{v , n}^{( - )} {r}_{v , n}^{( - )} , \qquad ( iii )$$

$$generate {r}_{v , n}^{( - )} = ( \begin{matrix}{\overline{Q}}_{v , n}^{( + ) - 1} {\overline{r}}_{v , n ( 1 )}^{( + ) - 1 , -} \\ ∈ ker {\overline{Q}}_{- W , 1}^{( + )} {\overline{R}}_{- W , 1}^{( + )}\end{matrix} ) , \qquad ( iv )$$

$$take {log}_{{k}_{- v , n}} and right - encrypt {\overline{h}}_{ν , n}^{{\overline{R}}_{v , n}^{( + )} {\overline{r}}_{ν , n}^{( + )}} \to ( {log}_{{k}_{v , n}} {\overline{h}}_{v , n} ) {\overline{R}}_{v , n}^{( + )} {\overline{r}}_{v , n}^{( + )} {r}_{v , n}^{( - )} {t}_{I , n} {R}_{- v , n}^{( - )} , \qquad ( v )$$

$$calculate Δ {v}_{R , n}^{( - )} ≡ ( {log}_{{k}_{v , n}} {\overline{h}}_{v , n} ) {\overline{R}}_{v , n}^{( + )} ( {\overline{r}}_{v , n}^{( + )} {r}_{v , n}^{( - )} {t}_{I , n} - {v}_{I , n}^{( - )} ) {R}_{- v , n}^{( - )} , \qquad ( vi )$$

(vii) generate invertible complex error functions, [symbol] ᵢ, and [symbol] ᵢ

$$encrypt , exponentiate {\overline{t}}_{I , n} \to {}^{{\overline{r}}_{v , n}^{( - )} {t}_{I , n} {\overline{R}}_{- v , n}^{( - )}} {\overline{h}}_{- v , n} , \qquad ( viii )$$

$$generate complex scalars , {\overline{k}}_{- C , - v , n} \neq 0 , \qquad ( ix )$$

$$encrypt , exponentiate {\overline{C}}_{- , R , n}^{( + )} \to {\overline{h}}_{- C , n}^{{\overline{R}}_{+ C , n}^{( - )} {\overline{C}}_{- , I , n} {\overline{r}}_{- C , n}^{( - )}} {k}_{- C , n} = {e}^{\frac{{\overline{k}}_{- C , - v , n}}{ln {\overline{k}}_{- v , n}}} . \qquad ( x )$$

Outputs of (iii) and (vii) through (x) are exchanged with P₊.

In step 13, P₊ backpropagates to calculate the weight and bias changes,

$$Δ {W}_{I , i}^{( + )} and Δ {b}_{I , i}^{( + )} ,$$

using the following substeps:

$${r}_{- ν , n}^{( + )} = ( {\overline{r}}_{ν , n , ( 1 )}^{( - ) - 1 , +} {\overline{Q}}_{ν , n}^{( - ) - 1} , ∈ ker {\overline{r}}_{ν , n}^{( - )} {\overline{Q}}_{ν , n}^{( - )} ) , \qquad ( i )$$

$$take {log}_{{k}_{ν , n}} , encrypt {}^{{\overline{r}}_{v , n}^{( - )} {t}_{I , n} {\overline{R}}_{- v , n}^{( - )}} {\overline{h}}_{- v , n} \to {R}_{v , n}^{( + )} {r}_{- v , n}^{( + )} {\overline{r}}_{v , n}^{( - )} {\overline{t}}_{I , n} {\overline{R}}_{- v , n}^{( - )} ( {log}_{{k}_{- v , n}} {\overline{h}}_{- v , n} ) , \qquad ( ii )$$

$$calculate Δ {v}_{R , n}^{( + )} ≡ {R}_{v , n}^{( + )} ( {r}_{- v , n}^{( + )} {\overline{r}}_{v , n}^{( - )} {\overline{t}}_{I , n} - {v}_{I , n}^{( + )} ) {\overline{R}}_{- v , n}^{( - )} ( {log}_{{k}_{- v , n}} {\overline{h}}_{- v , n} ) , \qquad ( iii )$$

$$take {log}_{{k}_{- C , n}} of {\overline{h}}_{+ C , n}^{{\overline{R}}_{+ C , n}^{( - )} {\overline{C}}_{- , I , n} {\overline{r}}_{- C , n}^{( - )}} \to ( {log}_{{k}_{- C , n}} {\overline{h}}_{- C , n} ) {\overline{R}}_{+ C , n}^{( - )} {\overline{C}}_{- , I , n} {\overline{r}}_{- C , n}^{( - )} , {k}_{- C , n} = {e}^{\frac{{\overline{k}}_{- C , - v , n}}{ln {\overline{k}}_{- v , n}}} , \qquad ( iv )$$

$$calculate {C}_{R , n}^{( + )} ( Δ {v}_{R , n}^{( + )} ) \to {r}_{C , n}^{( + )} {C}_{W , I , n} {R}_{- C , n}^{( + )} Δ {v}_{R , n}^{( + )} ( {log}_{{k}_{- C , n}} {\overline{h}}_{- C , n} ) {\overline{R}}_{+ C , n}^{( - )} {\overline{C}}_{- , I , n} {\overline{r}}_{- C , n}^{( - )} , \qquad ( v )$$

$$generate complex nonsingular matrices , {\overline{h}}_{Δ W , i} , {\overline{h}}_{Δ b , i} , \qquad ( vi )$$

$$calculate , exponentiate \frac{- \partial {C}_{R , n}^{( + )} ( Δ {v}_{R , n}^{( + )} )}{\partial {W}_{R , 1}} \to {\overline{h}}_{Δ W , 1}^{( \frac{1}{{α}_{1}} {r}_{C , 1}^{( + )} {R}_{- σ , 1}^{( + ) T} ) Δ {W}_{I , 1}^{( + )} ( {\overline{R}}_{v , 1}^{( - ) T} {\overline{r}}_{- C , 1}^{( - )} )} , \qquad ( vii )$$

$$calculate , exponentiate \frac{- \partial {C}_{R , n}^{( + )} ( Δ {v}_{R , n}^{( + )} )}{\partial {W}_{R , i > 1}} \to {\overline{h}}_{Δ W , i > 1}^{( \frac{1}{{α}_{i}} {r}_{C , i}^{( + )} {R}_{- σ , i}^{( + ) T} ) Δ {W}_{I , i}^{( + )} ( {R}_{v , i}^{( + ) T} {\overline{r}}_{- C , i}^{( - )} )} , \qquad ( viii )$$

$$calculate , exponentiate \frac{- \partial {C}_{R , n}^{( + )} ( Δ {v}_{R , n}^{( + )} )}{\partial {W}_{R , i}} \to {\overline{h}}_{Δ b , i}^{( \frac{1}{{α}_{i}} {r}_{C , i}^{( + )} {R}_{- σ , i}^{( + ) T} ) Δ {b}_{I , i}^{( + )} ( {\overline{R}}_{σ , i}^{( - ) T} {\overline{r}}_{- C , i}^{( - )} )} , \qquad ( ix )$$

$$generate complex scalars , {\overline{k}}_{C , v , n} \neq 0 , 1 , \qquad ( x )$$

$$encrypt , exponentiate {\overline{C}}_{+ , I , i} \to {}^{{\overline{r}}_{+ C , i}^{( + )} {\overline{C}}_{W , I , i} {\overline{R}}_{- C , i}^{( + )}} {\overline{h}}_{C , i} , {\overline{k}}_{C , n} = {e}^{\frac{{\overline{k}}_{C , v , n}}{ln {\overline{k}}_{v , n}}} . \qquad ( xi )$$

Outputs of (vi) through (x) are exchanged with P₋.

In step 14, P₋ backpropagates to calculate the weight and bias changes,

$$Δ {W}_{I , i}^{( - )} and Δ {b}_{i , i}^{( - )}$$

using the following substeps:

$$\begin{matrix}( i ) take {log}_{{k}_{C , n}} of {}^{{\overline{r}}_{C , i}^{( + )} {\overline{C}}_{W , I , i} {\overline{R}}_{- C , i}^{( + )}} {\overline{h}}_{C , n} \to {}^{{\overline{r}}_{C , i}^{( + )} {\overline{C}}_{W , I , i} {\overline{R}}_{- C , i}^{( + )}} ( {log}_{{k}_{C , n}} {\overline{h}}_{C , n} ) , {k}_{C , n} = {e}^{\frac{{\overline{k}}_{C , v , n}}{kn {k}_{v , n}}} , \\ ( ii ) calculate {C}_{R , n}^{( - )} ( Δ {v}_{R , n}^{( - )} ) \to {\overline{r}}_{C , i}^{( + )} {\overline{C}}_{W , I , i} {\overline{R}}_{- C , i}^{( + )} ( {log}_{{k}_{C , n}} {\overline{h}}_{C , n} ) Δ {v}_{R , n}^{( - )} {R}_{+ C , n}^{( - )} {C}_{- , I , n} {r}_{- C , n}^{( - )} , Δ {v}_{R , n}^{( - )} \to ( {log}_{{k}_{v , n}} {\overline{h}}_{v , n} ) {\overline{R}}_{v , n}^{( + )} {\overline{r}}_{v , n}^{( + )} {r}_{v , n}^{( - )} ( {t}_{I , n} - {v}_{I , n}^{( - )} ) {R}_{- v , n}^{( - )} , \\ ( iii ) calculate , decrypt \frac{- \partial {C}_{R . n}^{( - )} ( Δ {v}_{R , n}^{( - )} )}{\partial {W}_{R , 1}} \to ( \frac{1}{{α}_{1}} {\overline{r}}_{C , 1}^{( + )} {\overline{R}}_{- σ , 1}^{( + )} ) Δ {W}_{I , 1}^{( - )} , \\ ( iv ) calculate , decrypt \frac{- \partial {C}_{R , n}^{( - )} ( Δ {v}_{R , n}^{( - )} )}{\partial {W}_{R , i > 1}} \to ( \frac{1}{{α}_{i}} {\overline{r}}_{C , i}^{( + )} {\overline{R}}_{- σ , i}^{( + ) T} ) Δ {W}_{I , i}^{( - )} {\overline{R}}_{v , i}^{( + ) T} , \\ ( v ) calculate , decrypt \frac{- \partial {C}_{R , n}^{( - )} ( Δ {v}_{R , n}^{( - )} )}{\partial {b}_{R , i}} \to ( \frac{1}{{α}_{i}} {\overline{r}}_{C , i}^{( - )} {\overline{R}}_{- σ , i}^{( + ) T} ) Δ {b}_{I , i}^{( - )} , \\ ( vi ) take {log}_{{k}_{Δ W , 1}} , decrypt {\overline{h}}_{Δ W , 1}^{( \frac{1}{{α}_{1}} {r}_{C , i}^{( + )} {R}_{- σ , 1}^{( + ) T} ) Δ {W}_{I , 1}^{( + )} ( {\overline{R}}_{v , 1}^{( - ) T} {\overline{r}}_{- C , 1}^{( - )} )} \to ( {log}_{{k}_{Δ W , 1}} {\overline{h}}_{Δ W , 1} ) ( \frac{1}{{α}_{1}} {r}_{C , 1}^{( + )} {R}_{- σ , 1}^{( + ) T} ) Δ {W}_{I , 1}^{( + )} , \\ ( vii ) take {log}_{{k}_{Δ W , i}} , decrypt {\overline{h}}_{Δ W , i > 1}^{( \frac{1}{{α}_{1}} {r}_{C , i}^{( + )} {R}_{- σ , 1}^{( + ) T} ) Δ {W}_{I , i}^{( + )} ( {R}_{v , i}^{( + ) T} {\overline{r}}_{- C , i}^{( - )} )} \to ( {log}_{{k}_{Δ W , i}} {\overline{h}}_{Δ W , i} ) ( \frac{1}{{α}_{i}} {r}_{C , i}^{( + )} {R}_{- σ , i}^{( + ) T} ) Δ {W}_{I , i}^{( + )} , {R}_{v , i}^{( + ) T} , \\ ( viii ) take {log}_{{k}_{Δ b , i}} , decrypt {\overline{h}}_{Δ b , i}^{( \frac{1}{{α}_{1}} {r}_{C , i}^{( + )} {R}_{- σ , 1}^{( + ) T} )} \to ( {log}_{{k}_{ΔbW , i}} {h}_{Δ b , i} ) ( \frac{1}{{α}_{i}} {r}_{C , i}^{( + )} {R}_{- σ , i}^{( + ) T} ) Δ {b}_{I , i}^{( + )} , \\ ( ix ) re - exponentiate ( {log}_{{k}_{Δ W , 1}} {\overline{h}}_{Δ W , 1} ) ( \frac{1}{{α}_{1}} {r}_{C , 1}^{( + )} {R}_{- σ , 1}^{( + ) T} ) Δ {W}_{I , 1}^{( + )} \to {\overline{h}}^{( \frac{1}{{α}_{1}} {r}_{C , 1}^{( + )} {R}_{- σ , 1}^{( + ) T} ) Δ {W}_{I , 1}^{( + )}} , \\ ( x ) re - exponentiate ( {log}_{{k}_{Δ b , i}} {h}_{Δ b , i} ) ( \frac{1}{{α}_{i}} {r}_{C , i}^{( + )} {R}_{- σ , i}^{( + ) T} ) Δ {b}_{I , i}^{( + )} \to {\overline{h}}_{Δ b , i}^{( \frac{1}{{α}_{i}} {r}_{C , i}^{( + )} {R}_{- σ , i}^{( + ) T} ) Δ {W}_{I , i}^{( + )} {R}_{v , i}^{( + ) T}} , \\ ( xi ) re - exponentiate ( {log}_{{k}_{Δ b , i}} {h}_{Δ b , i} ) ( \frac{1}{{α}_{1}} {r}_{C , i}^{( + )} {R}_{- σ , i}^{( + ) T} ) Δ {b}_{I , i}^{( + )} \to {\overline{h}}_{Δ b , i}^{( \frac{1}{{α}_{i}} {r}_{C , i}^{( + )} {R}_{- σ , i}^{( + ) T} ) Δ {W}_{I , i}^{( + )} {R}_{v , i}^{( + ) T}} .\end{matrix}$$

In step 15, P₊ and P₋ perform the following respective substeps:
(i) P₊ exchanges outputs of Step 9 (iii) and (iv) with P₋,
(ii) P₋ exchanges outputs of Step 14 (iii) through (v) and (ix) through (xi) with P₊.

In step 16, P₊ performs the following substeps:

$$\begin{matrix}( i ) decrypt ( \frac{1}{{α}_{1}} {\overline{r}}_{C , 1}^{( + )} {\overline{R}}_{- σ , 1}^{( + ) T} ) Δ {W}_{I , 1}^{( - )} \to Δ {W}_{I , 1}^{( - )} , \\ ( ii ) decrypt ( \frac{1}{{α}_{i}} {\overline{r}}_{C , i}^{( + )} {R}_{- σ , i}^{( + ) T} ) Δ {W}_{I , i > 1}^{( - )} {\overline{R}}_{v , i}^{( + ) T} \to Δ {W}_{I , i}^{( - )} , \\ ( iii ) decrypt ( \frac{1}{{α}_{i}} {\overline{r}}_{C , i}^{( - )} {\overline{R}}_{- σ , i}^{( - ) T} ) Δ {b}_{I , i}^{( - )} \to Δ {b}_{I , i}^{( - )} , \\ ( iv ) decrypt {\overline{h}}_{Δ W , i > 1}^{( \frac{1}{{α}_{i}} {\overline{r}}_{C , i}^{( + )} {R}_{- σ , i}^{( + ) T} ) Δ {W}_{I , i}^{( + )}} \to Δ {W}_{I , 1}^{( + )} , \\ ( v ) decrypt {\overline{h}}_{Δ W , i > 1}^{( \frac{1}{{α}_{i}} {\overline{r}}_{C , i}^{( + )} {R}_{- σ , i}^{( + ) T} ) Δ {W}_{I , i}^{( + )} {R}_{v , i}^{( + ) T}} \to Δ {W}_{I , i}^{( + )} , \\ ( vi ) decrypt {\overline{h}}_{Δ b , i}^{( \frac{1}{{α}_{i}} {r}_{C , i}^{( + )} {R}_{- σ , i}^{( + ) T} ) Δ {b}_{I , i}^{( + )}} \to Δ {b}_{I , i}^{( + )} , \\ ( vii ) calculate Δ {W}_{0 , I , i}^{( + )} - Δ {W}_{0 , I , i}^{( - )} , \\ ( viii ) calculate Δ {b}_{0 , I , i}^{( + )} - Δ {b}_{0 , I , i}^{( - )} .\end{matrix}$$

In step 17, P₋ performs the following substeps:

$$\begin{matrix}( i ) decrypt {}^{{v}_{l , n}^{( + ) -} {\overline{R}}_{- v , n}^{( - )}} {\overline{h}}_{- v , n} \to {v}_{I , n}^{( - )} \\ ( ii ) decrypt {}^{{v}_{l , n}^{( - )} {R}_{- v , n}^{( - )}} {\overline{h}}_{- v , n + 1} \to {v}_{I , n}^{( + )} , \\ ( iii ) calculate {v}_{0 , I , n}^{( - )} - {v}_{0 , I , n}^{( + )} .\end{matrix}$$

In step 18, if Step 16, substep (iii) equals zero, P₋ knows P₊ applied an equivalent set of neural net operations to the (+) copy, modulo the congruence class, and likewise for P₊ with Step 16, substeps (vii) and (viii).

### Embodiment 1: Mathematical Proofs of Matrix Operations

The following mathematical proofs provide the reasoning that support the validity of the two-party reshuffling method, R₂, from first principles of neural network operations. As above, R₂ creates two sets of congruent neural network matrix operations that protect the input data of both parties while providing a zero-trust means of verifying that congruent operations have been performed to produce congruent final output vectors and updates to weights and biases. As before, the two parties are designated by P₊ (the owner of the neural network) and P₋ (the owner of the input data).

### Let

$${NN}_{0 , I , σ} = ( {W}_{0 , I , i} , {b}_{0 , I , i} , {σ}_{0 , I , i} , {L}_{0 , I , i} , {C}_{0 , I , i} , {α}_{i} \vert i ∈ [ 1 , n ] ) \qquad ( A 1 )$$

be an unencrypted neural network with weights, W_{0,I,i}, represented by row rᵢ×column cᵢ matrices over the field of complex numbers; biases, b_{0,I,i}, represented by rank cᵢ vectors; complex activation function, σ_{0,I,i}; complex loss function, L_{0,I,i}; complex cost function, C_{0,I,i}; and complex learning rate, αᵢ.
Now define an encrypted neural network to be

$$N {N}_{Ω , R , σ} = ( {W}_{Ω , R , i} , {b}_{Ω , R , i} , {σ}_{Ω , R , i} , {L}_{0 , I , i} , {C}_{0 , I , i} , {α}_{i} \vert h ∈ {C}^{*} ) , \qquad ( A 2 )$$

where the expanded neural network matrices are given by

$${x}_{Ω , I , i} ≡ {Ω}_{x}^{( i )} ( {x}_{0 , I , i} ) = ( \begin{matrix}{x}_{0 , I , i} & {Ω}_{x , ( 1 , 2 )}^{( i ) ( m , b )} \\ {Ω}_{x , ( 2 , 1 )}^{( i ) ( a , n )} & {Ω}_{x , ( 2 , 2 )}^{( i ) ( a , b )}\end{matrix} ) , x ∈ \{ W , b , σ , {v}_{1} \} , a , b , m , n , ∈ {R}_{\geq 0} , \qquad ( A 3 )$$

for

$${Ω}_{x , ( 1 , 2 )}^{( i ) ( m , b )} , {Ω}_{x , ( 2 , 1 )}^{( i ) ( a , n )} , and {Ω}_{x , ( 2 , 2 )}^{( i ) ( a , b )} ∈ {C}^{i \times j} ,$$

and their encrypted forms by

$${x}_{Ω , R , i} = {Ω}_{Rx , i} ( {x}_{0 , I , i} ) = {R}_{Ω , + x , i} {Ω}_{I , x , i} ( {x}_{0 , I , i} ) {R}_{Ω , - x , i} , {R}_{Ω , \pm x , t} ∈ {C}^{( m + a ) \times ( n + b )} \qquad ( A 4 )$$

Define the encrypted activation functions as

$$\begin{matrix}{σ}_{Ω , R , i} ( {z}_{Ω , R , i} ) = {Ω}_{R , σ , i} ( {σ}_{0 , I , i} ( {z}_{0 , I , i} ) ) = {Ω}_{R , {σ}_{+} , i} ( {σ}_{+ , 0 , I , i} ) \times ( {z}_{0 , I , i} \times {Ω}_{R , σ\_ , i} ( {σ}_{- , 0 , I , i} ) ) = \\ {R}_{Ω , + v , i + 1} {Ω}_{I , {σ}_{+} , i} ( {σ}_{+ , 0 , I , i} ) {R}_{Ω , + σ , i} \times ( ( {z}_{Ω , R , i} ) \times {R}_{Ω , - σ , i} {Ω}_{I , {σ}_{-} , i} ( {σ}_{- , 0 , I , i} ) {R}_{Ω , - v , i + 1} ) ,\end{matrix} \qquad ( A 5 )$$

where (i) z_{R,i}=W_{R,i}v_{R,i}+b_{R,i}, (ii) σ_{±Ω,0,I,i}, R_{Ω,W,i}, and R_{Ω,-v,i} are complex operator matrices, (iii) σ_{+0,I,i}=(σ_{0,I,i}∘ρ)I, and (iv) σ_{-0,I,i}=ρ⁻¹I, where ρ is an invertible complex function. (Note that the choice of placing the activation activation on the left hand side is a convention, which will be relevant later.)
Finally, let the R matrices satisfy

$$\begin{matrix}( a ) {R}_{- W , i , ( 1 )} = {R}_{+ v , i , ( 1 )}^{- 1 , +} = {( {R}_{+ v , i ( 1 )}^{T} {R}_{+ v , i , ( 1 )} )}^{- 1} {R}_{+ v , i , ( 1 )}^{T} , \\ ( b ) {R}_{- W , i , ( 2 )} ∈ ker {W}_{i} ⊕ ker {R}_{v , i} {⊕}_{i = 1} \frac{ker v}{ker {W}_{1} ⊕ ker {R}_{v , 1}} or \\ {R}_{v , i , ( 2 )} ∈ ker {v}_{i} ⊕ ker {R}_{- W , i} {⊕}_{i = 1} \frac{ker {W}_{1}}{ker {v}_{1} ⋃ ker {R}_{- W , 1}} , \\ ( c ) {R}_{0 , - b , i} = {R}_{0 , - v , i} \\ ( d ) {R}_{0 , + b , i} = {R}_{0 , + W , i} \\ ( e ) {R}_{- σ , i , ( 1 )} = {R}_{+ W , i , ( 1 )}^{- 1 , +} = {( {R}_{+ W , i , ( 1 )}^{T} {R}_{+ W , i , ( 1 )} )}^{- 1} {R}_{+ W , i , ( 1 )}^{T} , \\ ( f ) {R}_{+ σ , i , ( 1 )} = {R}_{- v , i , ( 1 )}^{- 1 , -} = {{R}_{- v , i , ( 1 )}^{T} ( {R}_{- v , i , ( 1 )} {R}_{- v , i , ( 1 )}^{T} )}^{- 1} , \\ ( g ) {R}_{- σ , i , ( 2 )} ∈ ker {σ}_{+ , i} ⊕ ker {R}_{W , i} or {R}_{+ W , i , ( 2 )} ∈ ker {R}_{- σ , i} ⊕ \frac{ker {σ}_{+ , i}}{ker {R}_{- σ , i}} , \\ ( h ) {R}_{+ σ , i , ( 2 )} ∈ ker {σ}_{- , i} ⊕ ker {R}_{- v , i} or {R}_{- v , i , ( 2 )} ∈ ker {R}_{+ σ , i} ⊕ \frac{ker {σ}_{- , i}}{ker {R}_{+ σ , i}} ,\end{matrix} \qquad ( A 6 )$$

where we have defined

$$\begin{matrix}{R}_{- x , i} = ( \begin{matrix}{R}_{- x , i ( 1 )} \\ {R}_{- x , i , ( 2 )}\end{matrix} ) {Q}_{- x , i}^{- 1} , \\ {R}_{+ x , i} = {Q}_{x , i} ( {R}_{x , i , ( 1 )} , {R}_{x , i , ( 2 )} ) ,\end{matrix} \qquad ( A 7 )$$

for some nonsingular matrix, Q, and x∈{v, W, b, σ}.
We will drop the Ω subscripts going forward, unless needed for clarity, and will specify Ω=0 when in the unencrypted neural network.
THEOREM 1: When information regarding W_{0,I,i}, v_{0,I,i}, and b_{0,I,i} may not be replicated in matrix expansions or R matrices, forward propagation operations in NN_{R,σ} preserves forward propagation operations in NN_{0,I,i} on z_{0,i} and σᵢ(z_{0,i}) if Eqn. (A6) is satisfied.
Proof: Assume that all R matrices and σ_{±0,I,i} are unconstrained in Eqn. (A4). Let

$${{⋃}^{∞}}_{m , n = 1} {C}^{m \times n} ( + , \times )$$

be the set of m x n complex matrices under binary operators, matrix addition and multiplication, where addition is defined between matrices of equal rank, and multiplication, between matrices whose left column dimension equals the right row dimension.
Lemma 1.1: For the transformation Ω in Eqn. (A3), define two binary operators,

$$Ω : {{⋃}^{∞}}_{m , n = 1} {C}^{m \times n} ( + , \times ) \to {{⋃}^{∞}}_{m , n = 1} {C}^{( m + a ) \times ( n + b )} ( {+}_{Ω} , {\times }_{Ω} ) ,$$

such that

$$∀ W , v , b ∈ {{⋃}^{∞}}_{m , n = 1} {C}^{m \times n} ( + , \times )$$

where, col b=col W, col W=row v, and row b=row v,

$${Ω}_{Wv} ( Wv ) + {}_{Ω} {Ω}_{b} ( b ) = {Ω}_{Wv} ( Wv ) + {Ω}_{b} ( b ) , \qquad ( i )$$

$${Ω}_{W} ( W ) \times {}_{Ω} {Ω}_{v} ( v ) = {R}_{W} {Ω}_{W} ( W ) {R}_{- W} {R}_{+ v} {Ω}_{v} ( v ) {R}_{- v} , \qquad ( ii )$$

$$or$$

$${Ω}_{Wv} ( Wv ) + {}_{Ω} {Ω}_{b} ( b ) = {R}_{W} ( {Ω}_{Wv} ( Wv ) + {Ω}_{b} ( b ) ) {R}_{- v} , \qquad ( iii )$$

$${Ω}_{W} ( W ) \times {}_{Ω} {Ω}_{v} ( v ) = {Ω}_{W} ( W ) {R}_{- W} {R}_{+ v} {Ω}_{v} ( v ) , \qquad ( iv )$$

$$where$$

$$\begin{matrix}{R}_{W} ∈ {C}^{r \times row {Ω}_{W} ( W )} , {R}_{- W} ∈ {C}^{col {Ω}_{W} ( W ) \times p} , \\ {R}_{ν} ∈ {C}^{p \times row {Ω}_{ν} ( ν )} , {R}_{- v} ∈ {C}^{col {Ω}_{ν} ( ν ) \times s} ,\end{matrix}$$

for p, r, s∈N, and where both R_{±W} and R_{±v} obey Eqns. (A6a), (A6b) and (A6c), then

$${Ω}_{W} ( W ) ≡ W mod ( row W , col W ) = W mod W ,$$

where mod W indicates equivalence in the top-left block matrix of rank corresponding to W, is a congruence relation on

$${{⋃}^{∞}}_{m , n = 1} {C}^{m \times n} ( + , \times ) .$$

Proof: An equivalence must preserve normal matrix addition and multiplication when these binary operations are defined. For Wv, b, R∈C^{m×n}(+), where m, n∈N,

$${Ω}_{b} ( Wv + b ) = {Ω}_{b} ( Wv ) {+}_{Ω} {Ω}_{b} ( b ) = {Ω}_{b} ( b ) {+}_{Ω} {Ω}_{b} ( Wv ) = {Ω}_{b} ( b + Wv ) . \qquad ( A 8 )$$

(Note that using the product of Wv is a convention to illustrate the application of the equivalence relation to neural networks later on.)
For each b, Ω_{b}(b)+_{Ω}Ω_{b}(−b)=Ω_{b}(0), which preserves unique additive inverses and the unique identity element, Ω_{b}(0). Also,

$$\begin{matrix}( {Ω}_{b} ( Wv ) {+}_{Ω} {Ω}_{b} ( b ) ) {+}_{Ω} {Ω}_{b} ( R ) = {Ω}_{b} ( Wv + b + R ) = \\ {Ω}_{b} ( Wv ) {+}_{Ω} ( {Ω}_{b} ( b ) {+}_{Ω} {Ω}_{b} ( R ) ) ,\end{matrix} \qquad ( A 9 )$$

which preserves additive associativity. (Note that we never actually need additive associativity for neural network operations, as only the bias is added at each layer.) Therefore,

$$( Wv + b ) mod b ≡ {Ω}_{b} ( Wv + b ) = {Ω}_{b} ( Wv ) + {}_{Ω} {Ω}_{b} ( b ) , \qquad ( A 10 )$$

so Ω preserves the abelian subgroup, C^{m×n}(+), under addition.
For multiplication, consider the product W∈C^{m×n} and v∈C^{n×m},

$$\begin{matrix}{Ω}_{W} ( W ) {\times }_{Ω} {Ω}_{ν} ( v ) = {R}_{W} {WR}_{- W} {R}_{+ ν} {vR}_{- ν} = \\ = {R}_{W} W ( \begin{matrix}{R}_{- W , ( 1 )} Q {Q}^{- 1} {R}_{v , ( 1 )} & {R}_{- W , ( 1 )} Q {Q}^{- 1} {R}_{v , ( 2 )} \\ {R}_{- W , ( 2 )} Q {Q}^{- 1} {R}_{v , ( 1 )} & {R}_{- W , ( 2 )} Q {Q}^{- 1} {R}_{v , ( 2 )}\end{matrix} ) v {R}_{- v} ,\end{matrix} \qquad ( A 11 )$$

where we see the Q matrices cancel under normal multiplication. We desire R matrices that (i) preserve neural network operations in the top-left block matrix, (ii) have no dependence on W_{0,(1,1)} or v_{0,(1,1)}, (iii) have no dependence on derived matrices, (i.e., vᵢ for i>0 and zᵢ) that are not known a priori.
Applying these three restrictions to the previous equations gives

$$\begin{matrix}{Ω}_{{W}_{0} {ν}_{0}} ( {W}_{0} {v}_{0} ) = {Ω}_{{W}_{0}} ( {W}_{0} ) {\times }_{Ω} {Ω}_{{W}_{0}} ( {v}_{0} ) = {R}_{+ W} {W}_{I} {R}_{- W} {R}_{+ ν} {vR}_{- ν} \\ + {R}_{+ b} {b}_{I} {R}_{- b} = {W}_{I} ( {R}_{- W , ( 1 )} {R}_{- W , ( 2 )} ) ⊗ ( \begin{matrix}{R}_{v , ( 1 )} \\ {R}_{v , ( 2 )}\end{matrix} ) {v}_{I} + {R}_{+ b} {b}_{I} {R}_{- b} ,\end{matrix} \qquad A ( 12 )$$

which implies

$$\begin{matrix}{Q}_{- W} , = {Q}_{ν}^{- 1} , {R}_{- W , ( 1 )} = {R}_{+ ν , ( 1 )}^{- 1 , +} , {W}_{I} {R}_{- W , ( i )} {R}_{+ v , ( j )} {v}_{I} = 0 , i \neq 1 \neq j ⇒ \\ {R}_{- W , ( 2 )} ∈ ker W ⊕ ker {R}_{v , ( 2 )} ⊕ \frac{Im v}{ker W ⊕ ker {R}_{v , ( 2 )}} , \\ {R}_{v , ( 2 )} ∈ ker v ⊕ ker {R}_{- W , ( 2 )} ⊕ \frac{Im W}{ker v ⊕ ker {R}_{- W , ( 2 )}} ,\end{matrix} \qquad ( A 13 )$$

where

$${R}_{+ v , ( 1 )}^{- 1 , +}$$

is a left inverse, which may generally be expressed as in Eqn. (A6a), requiring row R_{+v,(1)}≥col R_{+v,(1)} to have sufficient linearly independent vectors to invert from the left. (The outer R matrices will be needed next when we require preservation of underlying neural network operations under the encrypted expanded activation functions.)
Note that the dependence on v in Eqn. (A14) is problematic, save when i=1, since these matrices derive from hidden neural network operations, not ones we begin with a priori. Removing these subsets reduces the dimensionality in the previous equation when v≠v₁ (i.e., the initial input vector):

$$\begin{matrix}{Q}_{- W} , = {Q}_{v}^{- 1} , {R}_{- W , ( 1 )} = {R}_{+ v , ( 1 )}^{- 1 , +} , \\ {R}_{- W , ( 2 )} ∈ ker W ⊕ ker {R}_{v , ( 2 )} , or {R}_{v , ( 2 )} ∈ ker v ⊕ ker {R}_{- W , ( 2 )} .\end{matrix} \qquad ( A 14 )$$

The previous two equations are the same as Eqns. (A6a), (A6,b), and (A6c) for each neural network layer index index, i. Applying these in Eqn. (A13) gives

$${Ω}_{{W}_{0}} ( {W}_{0} ) \times {}_{Ω} {Ω}_{{v}_{0}} ( {v}_{0} ) = {Ω}_{{W}_{0} {ν}_{0}} ( {W}_{0} {v}_{0} ) , \qquad ( A 15 )$$

for all W₀, v₀ where col W₀=row v₀. When left or right inverses exist, they are preserved under Ω and multiply to yield the square matrix identity element:

$${Ω}_{{R}^{- 1 , +}} ( {R}^{- 1 , +} ) \times {}_{Ω} {Ω}_{R} ( R ) = {Ω}_{{W}_{0}} ( {R}^{- 1 , +} R ) = {Ω}_{{R}^{1 , +} R} ( I ) . \qquad ( A 16 )$$

Next, multiplicative associativity is preserved for matrices with scalar elements (which we do not need for neural networks) whereas multiplications of matrices with operators remains order dependent for arbitrary ρ:

$$\begin{matrix}{Ω}_{{σ}_{+}} ( {σ}_{+} ) {\times }_{Ω} ( {Ω}_{z} ( z ) \times {}_{Ω} {Ω}_{σ\_} ( {σ}_{\_} ) ) = {Ω}_{{σ}_{+}} ( {σ}_{+} ) \times {}_{Ω} {Ω}_{z σ\_} ( ρ ( z ) ) = \\ {Ω}_{z} ( σ ( z ) ) \neq {Ω}_{z} ( ρ ( σ ( {ρ}^{- 1} ( z ) ) ) ) = ( {Ω}_{{σ}_{+}} ( {σ}_{+} ) \times {}_{Ω} {Ω}_{z} ( z ) ) \times {}_{Ω} {Ω}_{σ\_} ( {σ}_{\_} ) .\end{matrix} \qquad ( A 17 )$$

However, multiplicative distributivity over addition (which we do need for neural network operations) is preserved from the left and right:

$$\begin{matrix}{Ω}_{{σ}_{+}} ( {σ}_{+} ) {\times }_{Ω} ( {Ω}_{Wν} ( Wv ) {+}_{Ω} {Ω}_{b} ( b ) ) = {Ω}_{{σ}_{+} b} ( {σ}_{+} ( Wv + b ) ) , \\ ( {Ω}_{Wν} ( Wv ) {+}_{Ω} {Ω}_{b} ( b ) ) {\times }_{Ω} {Ω}_{σ\_} ( σ\_ ) = {Ω}_{σ\_ b} ( σ\_ ( Wv + b ) ) ,\end{matrix} \qquad ( A 18 )$$

where Wv, b∈C^{m×n}, σ₊∈C^{p,m}, and σ_∈C^{n,r} for m, n, p, r∈N.
Finally, the inverse mapping of Ωₓ(x) is given by

$${Ω}_{x}^{- 1} ( Ω ( x ) ) = {Ω}_{x}^{- 1} ( \begin{matrix}x & {Ω}_{x , ( 1 , 2 )} \\ {Ω}_{x , ( 2 , 1 )} & {Ω}_{x , ( 2 , 2 )}\end{matrix} ) mod x = x \qquad ( A19 )$$

making Ωₓ an isomorphism,

$${Ω}_{x} : {{⋃}^{∞}}_{m , n = 1} {C}^{m \times n} ( + , \times ) \to {{⋃}^{∞}}_{m , n = 1} {C}^{( m + a ) \times ( n + b )} ( {+}_{Ω} , {\times }_{Ω} ) , \qquad ( A20 )$$

$${Ω}_{x}^{- 1} : {{⋃}^{∞}}_{m , n = 1} {C}^{( m + a ) \times ( n + b )} ( {+}_{Ω} , {\times }_{Ω} ) \to {{⋃}^{∞}}_{m , n = 1} {C}^{m \times n} ( + , \times ) ,$$

and Ω_{R,W}(W)≡W mod W a congruence relation on

$${{⋃}^{∞}}_{m , n = 1} {C}^{m \times n} ( + , \times ) . \#$$

The subscript for Ω_{W} should not be confused with the rank in the modulus. Rather, it indicates some specifically chosen dimension for each matrix, W. For weight, bias, and input matrix operations, this implies,

$$( i ) {W}_{0} {v}_{0} mod {W}_{0} {v}_{0} ≡ {Ω}_{{W}_{0} {ν}_{0}} ( {W}_{0} {v}_{0} ) = \qquad ( A21 )$$

$${Ω}_{{W}_{0}} ( {W}_{0} ) {\times }_{Ω} {Ω}_{{ν}_{0}} ( {v}_{0} ) = {W}_{R} {\times }_{Ω} {v}_{R} ,$$

$$( ii ) ( {W}_{0} {v}_{0} + {b}_{0} ) mod {z}_{0} ≡ {Ω}_{{W}_{0} {ν}_{0}} ( {W}_{0} {v}_{0} + {b}_{0} ) =$$

$${Ω}_{{W}_{0} {ν}_{0}} ( {W}_{0} {v}_{0} ) {+}_{Ω} {Ω}_{{b}_{0}} ( {b}_{0} ) = {W}_{R} {v}_{R} + {b}_{R} ,$$

$$where row {W}_{0} = row {b}_{0} and col {v}_{0} = col {b}_{0} ,$$

in accordance with Eqn. (A6). This leaves a large degree of arbitrary data in both the matrix expansion and encryption matrices, which will aid our encryption algorithm later.
Eqn. (A21) also allows input data owners to gain control of some of the neural network's nonlinearity via the right hand side of the bias and, thereby, the right hand side of the activation function, which we will now consider.
Applying the congruence relation to matrix products for σ_{R}(z_{R}) gives,

$${σ}_{0} ( {z}_{0} ) mod {z}_{0} ≡ Ω ( {σ}_{0} ( {z}_{0} ) ) = \qquad ( A22 )$$

$${R}_{+ v , i + 1} {σ}_{+ , I} {R}_{- σ} {R}_{+ W} {z}_{I} {R}_{- v} {R}_{+ σ} {σ}_{- , I} {R}_{- v , i + 1} ⇔ {Q}_{- σ ,} = {Q}_{W}^{- 1} ,$$

$${R}_{- σ , ( 1 )} = {R}_{+ W , ( 1 )}^{- 1 , +} , {R}_{+ σ , ( 1 )} = {R}_{- ν , ( 1 )}^{- 1 , -} ,$$

$${R}_{- σ , ( 2 )} ∈ ker {σ}_{+ , i} ⊕ ker {R}_{W} or {R}_{+ W , ( 2 )} ∈ ker {R}_{- σ} ⊕ \frac{ker {σ}_{+}}{ker {R}_{- σ}} ,$$

$${R}_{+ σ , i , ( 2 )} ∈ ker {σ}_{-} ⊕ ker {R}_{- ν} or {R}_{- ν , ( 2 )} ∈ ker {R}_{+ σ} ⊕ \frac{ker {σ}_{-}}{ker {R}_{+ σ}} ,$$

where

$${R}_{+ W , ( 1 )}^{- 1 , +}$$

is a left inverse analogous to

$${R}_{+ ν , ( 1 )}^{- 1 , +} and {R}_{- ν , ( 1 )}^{- 1 , -}$$

is a right inverse, which may be generally expressed as in Eqn. (A6(e)), requiring col R₋ᵥ≥row R₋ᵥ to have sufficient linearly independent vectors for the inversion. (Note also that these are matrices of operators, not just scalars, requiring functions appearing in the inverses to be invertible.) Unlike before, we have dropped all terms depending on z_{I} since it is always a derived, vice a priori, matrix.
These operator matrices can be useful in introducing non-linearity into expanded encrypted neural network outputs without affecting matrix operations in the underlying unencrypted unexpanded neural network. This adds a third equation to the previous two in Eqn. (A21):

$$( iii ) σ ( {z}_{0} ) mod {z}_{0} ≡ {Ω}_{σ ( {z}_{0} )} ( σ ( {z}_{0} ) ) = \qquad ( A23 )$$

$${Ω}_{{σ}_{+ , 0}} ( {σ}_{+ , 0} ) {\times }_{Ω} {Ω}_{{z}_{0}} ( {z}_{0} ) {\times }_{Ω} {Ω}_{{σ}_{- , 0}} ( {σ}_{- , 0} ) = {σ}_{+ , R} {z}_{R} {σ}_{- , R} ,$$

Thus, the constraints in Theorem 1 ensure operations in NN_{0,I,σ} are preserved in the top-left components of the block matrices NN_{0,I,σ}, which gives us encryption for forward propagation through NN_{R,σ}. #
Backpropagation begins by evaluating the output against the expected output (from training data) via the loss function, Lᵢ, which is some function of the difference between expected versus actual value, and then changing the weights and biases based on an overall cost function, Cᵢ. Note that for the remainder of this paper, we use the term “cost function” to represent any form of error function, including loss functions. The intent is to show backpropagation may be encrypted for any such function.
In the unexpanded unencrypted neural network, the weights and biases are then adjusted to minimize Cᵢ based on its gradients:

$${W}_{0 , I , i}^{new} = {W}_{0 , I , i}^{old} - {α}_{i} \frac{\partial {C}_{i}}{\partial {W}_{0 , I , i}^{old}} \qquad ( A24 )$$

$${b}_{0 , I , i}^{new} = {b}_{0 , I , i}^{old} - {α}_{i} \frac{\partial {C}_{i}}{\partial {b}_{0 , I , i}^{old}} .$$

Lemma 1.2. Backpropagation in NN_{I,σ} is preserved in NN_{R,σ} iff

$$Δ {W}_{0 , I , i} mod {W}_{0 , I , i} ≡ {α}_{i} {R}_{W , i}^{T} \frac{- \partial C}{\partial {W}_{R , i}} {R}_{- W , i}^{T} ,$$

$$Δ {b}_{0 , I , i} mod {b}_{0 , I , i} ≡ {α}_{i} {R}_{W , i}^{T} \frac{- \partial C}{\partial {b}_{R , i}} {R}_{- v , i}^{T} .$$

$$Δ {W}_{0 , I , i} mod {W}_{0 , I , i} ≡ {α}_{i} {R}_{W , i}^{T} \frac{- \partial C}{\partial {W}_{R , i}} {R}_{W , i}^{T} {R}_{- W , i}^{T} ,$$

$$Δ {b}_{0 , I , i} mod {b}_{0 , I , i} ≡ {α}_{i} {R}_{W , i}^{T} \frac{- \partial C}{\partial {b}_{R , i}} {R}_{- v , i}^{T} .$$

Proof: Expanding the training data, Ω(t_{0,I,i})=t_{I,i}, and transforming it under t_{R,i}=R_{v,i}t_{I,i}R_{-v,i} ensures the difference between actual versus predicted values in NN_{R,σ}, i.e., Δt_{R,i}, are a matrix transformation of Δt_{I,i}. However, error functions (e.g., loss functions, cost functions) are unlike the activation function, which preserves the rank of its matrix arguments. They contract matrix ranks, so care is needed in defining C. Let

$${C}_{R , i} ( Δ {t}_{R , i} ) = ( {r}_{C , i} {C}_{+ , i} {R}_{- C , i} \times {R}_{ν , i} Δ {t}_{I , i} {R}_{- ν , i} ) \times {R}_{C , i} {C}_{- , i} {r}_{- C , i} = \qquad ( A25 )$$

$$( {r}_{C , i} {C}_{+ , i} ( \begin{matrix}{R}_{- C , i ( 1 )} \\ {R}_{- C , i , ( 2 )}\end{matrix} ) {Q}_{- C , i}^{- 1} \times {Q}_{ν , i} ( {R}_{ν , i , ( 1 )} , {R}_{ν , i , ( 2 )} ) Δ {t}_{I , i} ( \begin{matrix}{R}_{- v , i ( 1 )} \\ {R}_{- v , i , ( 2 )}\end{matrix} ) {Q}_{- v , i}^{- 1} ) \times$$

$${Q}_{C , i} ( {R}_{C , i , ( 1 )} , {R}_{C , i , ( 2 )} ) {C}_{- , i} {r}_{- C , i} \to {Q}_{- C , i} = {Q}_{v , i}^{- 1} , {Q}_{C , i} = {Q}_{- v}^{- 1} ,$$

$${R}_{- C , i , ( 1 )} = {R}_{+ ν , i , ( 1 )}^{- 1 , +} , {R}_{+ C , i , ( 1 )} = {R}_{- ν , ( 1 )}^{- 1 , -} ,$$

$${R}_{- C , i , ( 2 )} ∈ ker {R}_{ν , i} or {R}_{+ ν , i , ( 2 )} ∈ ker {R}_{- C , i} ,$$

$${R}_{+ C , i , ( 2 )} ∈ ker {R}_{- ν , i} or {R}_{- ν , i , ( 2 )} ∈ ker {R}_{+ C} ,$$

where the scripted rho is some invertible function C_{±,i} are 2×2 operator block matrices, (each element of these matrices is some error function acting on some specified submatrix)

$${C}_{+ , i} = ( \begin{matrix}{ϱ}_{1} ∘ {C}_{i} & {C}_{+ , i , 12} \\ {C}_{+ , i , 21} & {C}_{+ , i , 22}\end{matrix} ) , {C}_{- , i} = ( \begin{matrix}{ϱ}_{i}^{- 1} & {C}_{- , i , 12} \\ {C}_{- , i , 21} & {C}_{- , i , 22}\end{matrix} ) , \qquad ( A26 )$$

acting on the block components of Δt_{I,i}, and r_{±Ci} are 2×2 complex block matrices. Then Eqn. (A25) becomes

$${C}_{R , i} ( Δ {t}_{R , i} ) = {r}_{C , i} ( \begin{matrix}{C}_{i} ( Δ {t}_{0 , I , i} ) & {C}_{- , i , 12} ( {ϱ}_{i} ( {C}_{i} ( Δ {t}_{0 , I , i} ) ) ) \\ {ϱ}_{i}^{- 1} ( {C}_{+ , i , 21} ( Δ {t}_{0 , I , i} ) ) & {C}_{- , i , 12} ( {C}_{+ , i , 21} ( Δ {t}_{0 , I , i} ) )\end{matrix} ) {r}_{- C , i} . \qquad ( A27 )$$

Changing variables in Eqn. (A19), we find

$$Δ {W}_{0 , I , i} mod {W}_{0 , I , i} ≡ {α}_{i} \frac{- \partial C}{\partial {W}_{I , i}} = \qquad ( A28 )$$

$${α}_{i} {R}_{W , i}^{T} \frac{- \partial C}{\partial {W}_{R , i}} {R}_{ν , i}^{- 1 T} = ( {α}_{i} {R}_{W , i}^{T} {r}_{C , i}^{( - 1 )} ) \frac{- \partial {C}_{R , i}}{\partial {W}_{R , i}} ( {r}_{- C , i}^{( - 1 )} {R}_{ν , i}^{- 1 T} ) ,$$

$$Δ {b}_{0 , I , i} mod {b}_{0 , I , i} ≡ {α}_{i} \frac{- \partial {C}_{R , i}}{\partial {b}_{I , i}} =$$

$${α}_{i} {R}_{W , i}^{T} \frac{- \partial C}{\partial {b}_{R , i}} {R}_{- ν , i}^{T} = ( {α}_{i} {R}_{W , i}^{T} {r}_{C , i}^{( - 1 )} ) \frac{- \partial {C}_{R , i}}{\partial {b}_{R , i}} ( {r}_{- C , i}^{( - 1 )} {R}_{- ν , i}^{T} ) ,$$

where the singular value decomposition of

$${r}_{\pm C , i} = {U}_{\pm C , i} D ( … , {λ}_{\pm C , i , j} , … ) {V}_{\pm C , i}^{*}$$

has been used to create a generalized inverse:

$${r}_{\pm C , i}^{( - 1 )} = {U}_{\pm C , i}^{*} D ( … , \frac{1 - {δ}_{{λ}_{\pm C , i , j} , 0}}{{λ}_{\pm C , i , j}} + {δ}_{{λ}_{\pm C , i , j} , 0} {μ}_{{λ}_{\pm C , i , j} , 0} {μ}_{\pm , i , j} , … ) {V}_{\pm C , i} .$$

This preserves backpropagation on NN_{0,I,σ}. #
The congruence relations helps us understand the underlying encryption principles as a mapping between neural networks where the image contains addition is between elements of equal row and column dimensions under equal row and column expansions, and multiplication between the matrix expansions and R matrices of appropriate dimensions. It also provides an elegant way to represent the encrypted expanded neural network.
Lemma 1.3. An encrypted neural network preserves unencrypted neural network operations in the image of Ω_{R,x}, x∈NN, if

$$\begin{matrix}{z}_{0 , I , i} mod {z}_{0 , I , i} ≡ {W}_{Ω , I , i} \times {}_{Ω} {v}_{Ω , I , i} + {}_{Ω} {b}_{Ω , I , i} = {W}_{Ω , R , i} \times {v}_{Ω , R , i} + {b}_{Ω , R , i} , \\ {v}_{0 , I , i + 1} mod {v}_{0 , I , i + 1} ≡ {σ}_{+ , Ω , I , i} \times {}_{Ω} {z}_{Ω , I , i} \times {}_{Ω} {σ}_{- , Ω , I , i} = {σ}_{+ , Ω , R , i} \times {z}_{Ω , R , i} \times {σ}_{- , Ω , R , i} .\end{matrix}$$

Proof: These relations follow directly from Eqns. (A21) and (A23). #
This lemma will be useful later on as we apply different encryption matrices from two different parties.
Lemma 1.4: If X, Y, R are rank m×m complex matrices where X=Y^{R}, then

$$X , Y ∈ {GL}_{m}^{*} , \qquad ( i )$$

$$∃ h ∈ {GL}_{m}^{*} \qquad ( ii )$$

and rank m×m complex matrix, W, ∃X=h^{WR},

$${h}^{{Ω}_{X} ( X )} = {Ω}_{X} ( {h}^{X} ) , \qquad ( iii )$$

$${( {h}^{{Ω}_{W} ( W )} )}^{{Ω}_{W} ( Y )} = {h}^{{Ω}_{W} ( W ) {Ω}_{R} ( R )} = {Ω}_{XY} ( {h}^{XY} ) , \qquad ( iv )$$

and Ω_{X,R}(logₕ(X))=logₕ(Ω_{X,R}(X)).
Proof: Assume the logarithm base Y of matrix X exists. Then

$$X ∈ {GL}_{m}^{*}$$

for some m∈N, where the logarithm is defined along a branch (e.g., principle value) in order to be unique. Then there exists complex, rank m×m matrix, R, such that X=Y^{R}. Assume there exists some

$$h ∈ {GL}_{m}^{*}$$

and rank m×m matrix, W, such that Y=h^{W}. Then |Y|=h^{tr W}≠0, so

$$Y ∈ {GL}_{m}^{*} .$$

Now assume Y≠h^{W}. Then W≠logₕY, which implies

$$X ∉ {GL}_{m}^{*} .$$

### But if

$$X ∉ {GL}_{m}^{*} ,$$

then |X|=|S^{R}∥J^{R}∥S^{-R}|=|J|^{R}=0, where J is the Jordan normal form of Y whose determinant must be zero. This contradicts

$$X ∈ {GL}_{m}^{*} .$$

So, the base Y logarithm of matrix X exists iff X,

$$Y ∈ {GL}_{m}^{*} ,$$

which implies that

$$X = {h}^{( {log}_{h} Y ) R}$$

for non-zero complex scalar, h.
Now let X̅=Ω_{X}(X) and h∈C*. Then

$${h}^{\overline{X}} = {h}^{{Ω}_{X} ( X )} = {\sum }_{k = 1}^{∞} \frac{{ln}^{k} h}{k !} {{Ω}_{X} ( X )}^{k} = {\sum }_{k = 1}^{∞} {Ω}_{X} ( \frac{{ln}^{k} {hX}^{k}}{k !} ) = {Ω}_{X} ( {h}^{X} ) .$$

So exponentiation preserves the congruence relation since addition, +_{Ω}, and multiplication, ×_{Ω}, define it.
Next, let Y̅=Ω_{Y,R}(Y) and h∈C*. Then

$$\begin{matrix}{( {h}^{\overline{X}} )}^{\overline{Y}} = {\sum }_{k = 1}^{∞} \frac{{{Ω}_{X , R} ( X )}^{k} {ln}^{k} h}{k !} {{Ω}_{Y , R} ( Y )}^{k} = {\sum }_{k = 1}^{∞} {{Ω}_{XY , R} ( \frac{{ln}^{k} h}{k !} XY )}^{k} = \\ {h}^{{Q}_{XY , R} ( XY )} = {Ω}_{XY , R} ( {h}^{XY} ) ,\end{matrix}$$

and likewise for left exponentiation.
Finally, assume Ω_{X,R}(logₕ(X))=logₕ(Ω_{X,R}(X)). Then exponentiating on both sides gives

$$\begin{matrix}{Ω}_{X , R} ( X ) \\ = {h}^{{Ω}_{X , R} ( {log}_{h} ( X ) )} ,\end{matrix}$$

which is true. So as the inverse of the exponentials, logarithms also preserve the congruence relations. #
Lemma 1.5: Lemma 1.4 allows for right exponentials and associated logarithms.
Proof: For matrices, the direction of exponentiation and associated logarithms matters since matrices do not commute in general. The same calculation may be followed for right exponentiation and associated logarithms, with exponents and logarithms moved to the right hand side. #

### The Zero-Trust Two-Party Reshuffling Algorithm

Now it is time to put Theorem 1 and related Lemmas 1.1-1.5 into practice by creating an encryption algorithm by which two parties may receive and verify outputs from inputs to a neural network without trust, while keeping their data private from the opposite party.
Let the two parties be designated by P₊ (the owner of the neural network) and P₋ (the owner of the input data).
THEOREM 2: Steps 1 through 18 of the two-party “reshuffling” algorithm, R₂, create two sets of congruent neural network matrix operations that protect the input data of both parties while providing a zero-trust means of verifying that congruent operations have been performed to produce congruent final output vectors and updates to weights and biases:
Step 1: P₋ generates invertible complex functions, ρᵢ, ρ̅ᵢ, and exchanges with P₊.
In all steps, overbars indicate copies that will be shared with the opposite party, and not used by the generating party, instead of complex conjugation.
Step 2: P_{±} generate congruent copies, x_{I,i} and x̅_{I,i}, of input matrices: x∈{v, W, b, σ_{±}, C_{±}}, where i=1 when x=v.
Step 3: For each input matrix corresponding to i<n, P₊ generates invertible complex matrices, h̅_{W,i} and h̅_{+σ,i}, and likewise for P₋ with h̅_{-v,i} and h̅_{-σ,i}, such that

$${\overline{h}}_{+ σ , i} s . t . \vert ln {\overline{h}}_{W , i} \vert \neq 0 , \qquad ( i )$$

$${\overline{h}}_{- σ , i} s . t . \vert ln {\overline{h}}_{- v , i} \vert \neq 0. \qquad ( ii )$$

Step 4: P₊ generates

$$\{ {\overline{R}}_{- W , i}^{( + )} , {R}_{+ W , i}^{( + )} , {R}_{- W , i}^{( + )} , {\overline{R}}_{- b , i}^{( + )} , {R}_{- σ , i}^{( + )} , {R}_{v , i > 1}^{( + )} \} ,$$

P₋ generates

$$\{ {\overline{R}}_{+ v , 1}^{( - )} , {R}_{- v , i}^{( - )} , {\overline{R}}_{- v , i}^{( - )} , {\overline{r}}_{- v , i}^{( - )} , {R}_{+ σ , i}^{( - )} \} ,$$

respectively, such that W_{R,i}, b_{R,i}, v_{R,1}, and σ_{±R,i}. are square matrices.
In all steps, superscripts (±) indicate the generating party. Also,

$${\overline{R}}_{- W , n}^{( + )} and {\overline{R}}_{- v , n}^{( - )}$$

are only generated if backpropagation is to be performed.

### Then,

$${P}_{-} exchanges {\overline{Q}}_{v , 1}^{( - )} {\overline{R}}_{v , 1 , ( 1 )}^{( - )} , ker {\overline{Q}}_{v , 1}^{( - )} {\overline{R}}_{v , 1}^{( - )} , {\overline{r}}_{- v , i , ( 1 )}^{( - )} {\overline{Q}}_{v , i}^{( - )} , and ker {\overline{r}}_{- v , i}^{( - )} {\overline{Q}}_{- v , i}^{( - )} \qquad ( i )$$

$$with {P}_{+} ,$$

$${P}_{+} exchanges {\overline{R}}_{- W , 1 , ( 1 )}^{( + )} {\overline{Q}}_{- W , 1}^{( + )} , ker {\overline{R}}_{- W , 1}^{( + )} {\overline{Q}}_{- W , 1}^{( + )} , {\overline{R}}_{- b , i , ( 1 )}^{( + )} {\overline{Q}}_{- b , i}^{( + )} , and \qquad ( ii )$$

$$ker {\overline{R}}_{- b , i}^{( + )} {\overline{Q}}_{- b , i}^{( + )} with {P}_{-} .$$

Step 5: P₋ performs the following substeps (we will drop the (+) and (−) in the scalar superscript when carrying it in an associated exponentiated matrix):

$$generate {Q}_{- W , 1}^{( - )} = {\overline{Q}}_{v , 1}^{( - ) - 1} , {Q}_{- b , i}^{( - )} = {\overline{Q}}_{- v , i}^{( - ) - 1} , {\overline{Q}}_{- b , i + 1}^{( - )} = {\overline{Q}}_{{r}_{- v} , i + 1}^{( - ) - 1} , \qquad ( i )$$

$$generate {R}_{+ v , 1}^{( - )} = ( \begin{matrix}{\overline{Q}}_{- W , 1}^{( + ) - 1} {\overline{R}}_{- W , 1 , ( 1 )}^{( + ) - 1 , -} \\ ∈ ker {\overline{Q}}_{- W , 1}^{( + )} {\overline{R}}_{- W , 1}^{( + )}\end{matrix} ) , \qquad ( ii )$$

$$generate {\overline{R}}_{- b , i}^{( - )} s . t . {\overline{R}}_{- b , i , ( 1 )}^{( - )} = {\overline{Q}}_{{r}_{- v} , i}^{( - ) - 1} {\overline{r}}_{- v , i , ( 1 )}^{( - ) - 1} , {\overline{R}}_{- b , 1 , ( 2 )}^{( - )} ∈ coker {\overline{r}}_{- b , i , ( 1 )}^{( - )} , \qquad ( iii )$$

$$generate non - zero complex scalars , {\overline{k}}_{- σ , - v , i} , \qquad ( iv )$$

$$generate complex matrices , {R}_{- v , i}^{( - )} s . t . {R}_{- v , i , ( 2 )}^{( - )} ∈ ker {R}_{- v , i , ( 1 )}^{( - ) T} , \qquad ( v )$$

$$encrypt , exponentiate {\overline{v}}_{I , 1} : {\overline{R}}_{v , 1}^{( - )} {\overline{v}}_{I , 1} {\overline{R}}_{- v , 1}^{( - )} \to {}_{}^{{\overline{R}}_{v , 1}^{( - )} {\overline{v}}_{I , 1} {\overline{R}}_{- v , 1}^{( - )}} {\overline{h}}_{- v , 1}^{} , \qquad ( vi )$$

$$encrypt , exponentiate {\overline{R}}_{- v , i}^{( - )} : {\overline{r}}_{- v , i}^{( - )} {\overline{R}}_{- v , i}^{( - )} \to {}_{}^{{\overline{r}}_{- v , 1}^{( - )} {\overline{R}}_{- v , i}^{( - )}} {\overline{h}}_{- v , i}^{} \qquad ( vii )$$

$$encrypt , exponentiate {\overline{σ}}_{- , I , i} \to {h}_{- σ , i}^{{\overline{R}}_{+ σ , i}^{( - )} {\overline{σ}}_{- , I , i} {\overline{R}}_{- b , i + 1}^{( - )}} , where \qquad ( viii )$$

$${\overline{R}}_{+ σ , i , ( 1 )}^{( - )} = \frac{1}{{\overline{k}}_{- σ , - v , i}} {( ln {\overline{h}}_{- σ , i} )}^{- 1} {( ln {\overline{h}}_{- v , i} )}^{- 1} {\overline{Q}}_{- v , i}^{( - ) - 1} {\overline{R}}_{- v , i , ( 1 )}^{( - ) - 1 , -} ,$$

$${\overline{R}}_{+ σ , i , ( 2 )}^{( - )} ∈ coker {( ln {\overline{h}}_{- σ , i} )}^{- 1} {( ln {\overline{h}}_{- v , i} )}^{- 1} {\overline{Q}}_{- v , i}^{( - ) - 1} {\overline{R}}_{- v , i}^{( - )} ,$$

$$encrypt {v}_{I , 1} : {R}_{v , 1}^{( - )} {v}_{I , 1} {R}_{- v , 1}^{( - )} , \qquad ( ix )$$

$$encrypt {σ}_{- , I , i} \to {R}_{+ σ , i}^{( - )} {σ}_{- , I , i} {R}_{- v , i + 1}^{( - )} . \qquad ( x )$$

Outputs of (v) through (viii),

$${\overline{r}}_{- v , i , ( 1 )}^{( - ) - 1 , -} {\overline{Q}}_{{r}_{- v} , i}^{( - ) - 1} , and coker {\overline{Q}}_{{r}_{- v} , i}^{( - )} {\overline{r}}_{- v , i , ( 2 )}^{( - )}$$

are exchanged with P₊.
Step 6: P₊ performs the following substeps:

$$generate {R}_{- W , 1}^{( + )} = ( {\overline{R}}_{v , 1 , ( 1 )}^{( - ) - 1 , -} {\overline{Q}}_{v , 1}^{( - ) - 1} , ∈ ker {\overline{R}}_{v , 1}^{( - )} {\overline{Q}}_{- v , 1}^{( - )} ) , \qquad ( i )$$

$$generate {R}_{- b , i}^{( + )} s . t . {R}_{- b , i , ( 1 )}^{( + )} = {\overline{r}}_{- v , i , ( 1 )}^{( - ) - 1 , -} {\overline{Q}}_{{r}_{- v} , i}^{( - ) - 1} , {R}_{- b , i , ( 1 )}^{( + )} ∈ coker {\overline{Q}}_{{r}_{- v} , i}^{( - )} {\overline{r}}_{- v , i , ( 2 )}^{( - )} \qquad ( ii )$$

$$take {log}_{{k}_{v , 1}} of {}_{}^{{\overline{R}}_{v , 1}^{( - )} {\overline{v}}_{I , 1} {\overline{R}}_{- v , 1}^{( - )}} {\overline{h}}_{- v , 1}^{} \to {\overline{R}}_{v , 1}^{( - )} {\overline{v}}_{I , 1} {\overline{R}}_{- v , 1}^{( - )} {log}_{{k}_{- v , 1}} {\overline{h}}_{- v , 1} \qquad ( iv )$$

$$take {log}_{{k}_{- v , i}} , encrypt {}_{}^{{\overline{r}}_{- v , i}^{( - )} {\overline{R}}_{- v , i}^{( - )}} {\overline{h}}_{- v , i}^{} \to {R}_{W , i}^{( + )} {b}_{I , i} {R}_{- b , i}^{( + )} {\overline{r}}_{- v , i}^{( - )} {\overline{R}}_{- v , i}^{( - )} {log}_{{k}_{- v , i}} {\overline{k}}_{- v , i} , \qquad ( v )$$

$$take {log}_{{k}_{- σ , i}} of {\overline{h}}_{- σ , i}^{{\overline{R}}_{+ σ , i}^{( - )} {\overline{σ}}_{- , I , i} {\overline{R}}_{- b , i + 1}^{( - )}} \to ( {log}_{{k}_{- σ , i}} {\overline{h}}_{- σ , i} ) {\overline{R}}_{+ σ , i}^{( - )} {\overline{σ}}_{- , I , i} {\overline{R}}_{- b , i + 1}^{( - )} , \qquad ( vi )$$

$${k}_{- σ , i} = {e}^{\frac{{\overline{k}}_{- σ , - v , i}}{ln {k}_{- v , i}}} ,$$

$$“ right - encrypt ” ( vi ) \to ( {log}_{{k}_{- σ , i}} {\overline{h}}_{- σ , i} ) {\overline{R}}_{+ σ , i}^{( - )} {\overline{σ}}_{- , I , i} {\overline{R}}_{- b , i + 1}^{( - )} {\overline{r}}_{- v , i + 1}^{( - )} {\overline{R}}_{- v , i + 1}^{( - )} , \qquad ( vii )$$

$$adopt activation function {σ}_{i}^{( + )} : {σ}_{i}^{( + )} ( z ) = {σ}_{+ , i} ( ( z ) {\overline{σ}}_{- , i} ) . \qquad ( viii )$$

$$generate complex scalars , {\overline{k}}_{σ , W , i} \neq 0 , \qquad ( ix )$$

$$generate complex matrix , {\overline{R}}_{- W , i}^{( + )} s . t . {\overline{R}}_{- W , i , ( 2 )}^{( + )} ∈ ker {\overline{R}}_{- W , i , ( 1 )}^{( + ) T} , \qquad ( x )$$

$$encrypt , exponentitate {\overline{W}}_{I , i} \to {\overline{h}}_{W , i}^{{\overline{R}}_{W , i}^{( + )} {\overline{W}}_{I , i} {\overline{R}}_{- W , i}^{( + )}} , \qquad ( xi )$$

$$encrypt , exponentitate {\overline{b}}_{I , i} \to {\overline{h}}_{W , i}^{{\overline{R}}_{W , i}^{( + )} {\overline{b}}_{I , i} {\overline{R}}_{- b , i}^{( + )}} , \qquad ( xii )$$

$$encrypt , exponentiate {\overline{σ}}_{+ , I , i} \to {}_{}^{{\overline{R}}_{v , i + 1}^{( + )} {\overline{σ}}_{+ , I , i}^{( + )} {\overline{R}}_{- σ , i}^{( + )}} {{\overline{h}}_{+ σ , i}^{}}_{} , where \qquad ( xiii )$$

$${\overline{R}}_{- σ , i , ( 1 )}^{( + )} = \frac{1}{{\overline{k}}_{σ , W , i}} {\overline{R}}_{W , i , ( 1 )}^{( + ) - 1 , +} {\overline{Q}}_{W , i}^{( + ) - 1} {( ln {\overline{h}}_{W , i} )}^{- 1} {( ln {\overline{h}}_{- σ , i} )}^{- 1} ,$$

$${\overline{R}}_{- σ , i , ( 2 )}^{( + )} ∈ coker {\overline{R}}_{W , i}^{( + ) - 1 , +} {\overline{Q}}_{W , i}^{( + ) - 1} {( ln {\overline{h}}_{W , i} )}^{- 1} {( ln {\overline{h}}_{- σ , i} )}^{- 1} , {\overline{k}}_{σ , i} = {e}^{\frac{{\overline{k}}_{σ , W , i}}{ln {\overline{k}}_{W , i}}} ,$$

$$encrypt {b}_{I , i} \to {R}_{W , i}^{( + )} {b}_{I , i} {R}_{- b , i}^{( + )} , \qquad ( xiii )$$

$$encrypt {b}_{I , i} \to {R}_{W , i}^{( + )} {b}_{I , i} {R}_{- b , i}^{( + )} , \qquad ( xiv )$$

$$encrypt {σ}_{+ , I , i} \to {R}_{v , i + 1}^{( + )} {σ}_{+ , I , i}^{( + )} {R}_{- σ , i}^{( + )} , \qquad ( xv )$$

Outputs of (viii) through (xii) are exchanged with P₋.
Step 7: P₋ performs the following substeps:

$$takes {log}_{{k}_{W , i}} of {\overline{h}}_{W , i}^{{\overline{R}}_{W , i}^{( + )} {\overline{W}}_{I , i} {\overline{R}}_{- W , i}^{( + )}} \to ( {log}_{{k}_{W , i}} {\overline{h}}_{W , i} ) {\overline{R}}_{W , i}^{( + )} {\overline{W}}_{I , i} {\overline{R}}_{- W , i}^{( + )} , \qquad ( i )$$

$$takes {log}_{{k}_{W , i}} , encrypts \qquad ( ii )$$

$${\overline{h}}_{W , i}^{{\overline{R}}_{W , i}^{( + )} {\overline{b}}_{I , i} {\overline{R}}_{- b , i}^{( + )}} \to ( {log}_{{k}_{W , i}} {\overline{h}}_{W , i} ) {\overline{R}}_{W , i}^{( + )} {\overline{b}}_{I , i} {\overline{R}}_{- b , i}^{( + )} {r}_{- v , i}^{( - )} {R}_{- v , i}^{( - )} ,$$

$$takes {log}_{{k}_{σ , i}} of {}_{}^{{\overline{R}}_{v , i + 1}^{( + )} {\overline{σ}}_{+ , I , i}^{( + )} {\overline{R}}_{- σ , i}^{( + )}} {\overline{h}}_{+ σ , i}^{} \to {\overline{R}}_{v , i + 1}^{( + )} {\overline{σ}}_{+ , I , i}^{( + )} {\overline{R}}_{- σ , i}^{( + )} ( {log}_{{k}_{σ , i}} {\overline{h}}_{+ σ , i} ) , \qquad ( iii )$$

$${k}_{σ , i} = {e}^{\frac{{\overline{k}}_{σ , W , i}}{ln {\overline{k}}_{W , i}}} .$$

Step 8: P₋ forward propagates to the final state vector, v_{R,n}, using the following operations for each hidden layer, i≤n−1:

$$( {log}_{{k}_{W , 1}} {\overline{h}}_{W , 1} ) {\overline{R}}_{W , 1}^{( + )} ( {z}_{I , 1}^{( - )} ) {R}_{- v , 1}^{( - )} = ( {log}_{{k}_{W , i}} {\overline{h}}_{W , i} ) ( {\overline{W}}_{\overline{R} , 1} {v}_{R , 1} + {\overline{b}}_{\overline{R} , 1} {r}_{- v , 1}^{( - )} {R}_{- v , 1}^{( - )} ) ,$$

$$( {log}_{{k}_{W , i}} {\overline{h}}_{W , i} ) {\overline{R}}_{W , i}^{( + )} ( {z}_{I , i > 1}^{( - )} ) {R}_{- v , 1}^{( - )} = ( {log}_{{k}_{W , i}} {\overline{h}}_{W , i} ) ( {\overline{W}}_{\overline{R} , i} {\overline{R}}_{v , i}^{( + )} {v}_{I , i}^{( - )} {R}_{- v , i}^{( - )} + {\overline{b}}_{\overline{R} , i} {r}_{- v , i}^{( - )} {R}_{- v , i}^{( - )} ) ,$$

$${\overline{R}}_{v , i + 1}^{( + )} {v}_{I , i + 1}^{( - )} {R}_{- v , i + 1}^{( - )} = {\overline{R}}_{v , i + 1}^{( + )} {\overline{σ}}_{+ , I , i} {\overline{R}}_{- σ , i}^{( + )} ( {log}_{{k}_{σ , i}} {\overline{h}}_{+ σ , i} ) ( {log}_{{k}_{W , i}} {\overline{h}}_{W , i} ) {\overline{R}}_{W , i}^{( + )} {z}_{I , i}^{( - )} {R}_{- v , i}^{( - )} {σ}_{- , R , i} .$$

Then P₋ exponentiates

$${}_{}^{{\overline{R}}_{v , n}^{( + )} {v}_{I , n}^{( - )} {R}_{- v , n}^{( - )}} {\overline{h}}_{- v , n}^{}$$

and exchanges with P₊.
Step 9: P₊ forward propagates to the final state vector, v_{R,n}, using the following operations for each hidden layer, i≤n−1:

$${R}_{W , 1}^{( + )} ( {z}_{I , 1}^{( + )} ) {\overline{R}}_{- v , 1}^{( - )} ( {log}_{{k}_{- v , i}} {\overline{h}}_{v , i} ) = ( {W}_{R , 1} {\overline{v}}_{\overline{R} , 1} + {b}_{R , 1} {\overline{r}}_{- v , 1}^{( - )} {\overline{R}}_{- v , 1}^{( - )} ) ( {log}_{{k}_{- v , i}} {\overline{h}}_{v , i} ) ,$$

$${R}_{W , i}^{( + )} ( {z}_{I , i}^{( + )} ) {\overline{R}}_{- v , i}^{( - )} ( {log}_{{k}_{v , i}} {\overline{h}}_{- v , i} ) = ( {W}_{R , i} {R}_{v , i}^{( + )} {v}_{I , i}^{( + )} {\overline{R}}_{- v , i}^{( - )} + {b}_{R , i} {\overline{r}}_{- v , i}^{( - )} {\overline{R}}_{- v , i}^{( - )} ) ( {log}_{{k}_{- v , i}} {\overline{h}}_{v , i} ) ,$$

$${R}_{v , i + 1}^{( + )} {v}_{I , i + 1}^{( + )} {\overline{R}}_{- v , i + 1}^{( - )} = {σ}_{+ , R , i} {R}_{W , i}^{( + )} {z}_{I , i}^{( + )} {\overline{R}}_{- v , i}^{( - )} ( {log}_{{k}_{- v , i}} {\overline{h}}_{v , i} ) ( {log}_{{k}_{- σ , i}} {\overline{h}}_{- σ , i} ) {\overline{R}}_{+ σ , i}^{( - )} {\overline{σ}}_{- , I , i} {\overline{R}}_{- b , i + 1}^{( - )} {\overline{r}}_{- v , i + 1}^{( - )} {\overline{R}}_{- v , i + 1}^{( - )} .$$

Then P₊ then performs the following steps:

$$decrypt {R}_{v , n}^{( + )} {v}_{I , n}^{( + )} {\overline{R}}_{- v , n}^{( - )} \to {v}_{I , n}^{( + )} {\overline{R}}_{- v , n}^{( - )} , \qquad ( i )$$

$$take {log}_{{h}_{v , n}} , decrypt , re - exponentiate {}_{}^{{\overline{R}}_{v , n}^{( + )} {v}_{I , n}^{( - )} {R}_{- v , n}^{( - )}} {\overline{h}}_{- v , n}^{} \to {}_{}^{{v}_{I , n}^{( - )} {R}_{- v , n}^{( - )}} {\overline{h}}_{- v , n}^{} , \qquad ( ii )$$

$$re - exponentiate {v}_{I , n}^{( + )} {\overline{R}}_{- v , n}^{( - )} ( {log}_{{k}_{- v , n}} {\overline{h}}_{- v , n} ) \to {}_{}^{{v}_{I , n}^{( - )} {R}_{- v , n}^{( - )}} {\overline{h}}_{- v , n}^{} . \qquad ( iii )$$

Step 10: If v_{I,n} is part of a training set with expected value, t_{I,n}, then Steps 10 through 16 are performing, beginning with P₊ generating invertible complex matrices, h̅_{+C,i<n} and h̅_{v,n}, and likewise for P₋ with h̅_{-C,i<n} and h̅_{-v,n}, where
(i) no h̅ matrix has eigenvalue equal to zero or one,

$${\overline{h}}_{+ C , n} = {\overline{k}}_{+ C , n}^{{( {log}_{{\overline{k}}_{v , n}} {\overline{h}}_{v , n} )}^{- 1}} , \qquad ( ii )$$

$${\overline{h}}_{- C , n} = {\overline{k}}_{- v , n}^{{( {log}_{{\overline{k}}_{- v , n}} {\overline{h}}_{- v , n} )}^{- 1}} , \qquad ( iii )$$

where k̅_{±C,n} are non-zero complex scalars.
Step 11: P₊ performing the following substeps:

$$generate complex matrices {R}_{- C , n}^{( + )} and {\overline{R}}_{- C , n}^{( + )} s . t . {Q}_{- C , n}^{( + )} = {Q}_{v , n}^{( + ) - 1} , \qquad ( i )$$

$${\overline{Q}}_{- C , n}^{( + )} = {\overline{Q}}_{v , n}^{( + ) - 1} , {R}_{- C , n , ( 1 )}^{( + )} = {R}_{v , n , ( 1 )}^{( + ) - 1 , +} , {\overline{R}}_{- C , n , ( 1 )}^{( + )} = {\overline{R}}_{v , n , ( 1 )}^{( + ) - 1 , +} ,$$

$${R}_{- C , n , ( 2 )}^{( + )} ∈ ker {R}_{v , n , ( 1 )}^{( + )} , {\overline{R}}_{- C , n , ( 2 )}^{( + )} ∈ ker {\overline{R}}_{v , n , ( 1 )}^{( + )} ,$$

$$generate complex matrices {r}_{C , n}^{( + )} and \qquad ( ii )$$

$${r}_{C , n}^{( + )} s . t . ∃ {r}_{C , n , ( 1 )}^{( + ) - 1 , +} , {r}_{C , n , ( 1 )}^{( + ) - 1 , +} respectively ,$$

$$generate complex matrix {\overline{r}}_{v , n}^{( + )} s . t . ∃ {\overline{r}}_{v , n , ( 1 )}^{( + ) - 1 , -} , \qquad ( iii )$$

$$encrypt , exponentiate {\overline{R}}_{v , n}^{( + )} \to {\overline{h}}_{v , n}^{{\overline{R}}_{v , n}^{( + )} {\overline{r}}_{v , n}^{( + )}} . \qquad ( iv )$$

Outputs of (iv),

$${\overline{r}}_{v , n , ( 1 )}^{( + )} {\overline{Q}}_{v , n}^{( + )} , ker {\overline{r}}_{v , n}^{( + )} {\overline{Q}}_{v , n}^{( + )}$$

are exchanged with P₋.
Step 12: P₋ performs the following substeps:

$$generate complex matrices {R}_{C , n}^{( - )} and {\overline{R}}_{C , n}^{( - )} s . t . {Q}_{C , n}^{( - )} = {Q}_{- v , n}^{( - ) - 1} , \qquad ( i )$$

$${R}_{C , n , ( 1 )}^{( - )} = {R}_{- v , n , ( 1 )}^{( - ) - 1 , -} , {R}_{C , n , ( 2 )}^{( - ) \_} ∈ ker {R}_{- v , n , ( 1 )}^{( - )} , {\overline{R}}_{C , n ( 1 )}^{( - )} = {\overline{R}}_{- v , n , ( 1 )}^{( - ) - 1 , -} ,$$

$$and {\overline{R}}_{C , n , ( 2 )}^{( - )} ∈ ker {\overline{R}}_{- v , n , ( 1 )}^{( - )} ,$$

$$generate complex matrices {r}_{C , n}^{( - )} and {r}_{C , n}^{( - )} s . t . ∃ {r}_{C , n , ( 1 )}^{( - ) - 1 -} and {\overline{r}}_{C , n , ( 1 )}^{( - ) - 1 , -} \qquad ( ii )$$

$$repectively ,$$

$$generate complex matrix , {\overline{r}}_{v , n}^{( - )} , s . t . ∃ {\overline{r}}_{v , n , ( 1 )}^{( - ) - 1 , -} , calculate \qquad ( iii )$$

$${\overline{Q}}_{v , n}^{( - ) - 1} {\overline{r}}_{v , n , ( 1 )}^{( - ) - 1 , -} , ker {\overline{Q}}_{v , n}^{( - )} {\overline{r}}_{v , n}^{( - )} ,$$

$$generate {r}_{v , n}^{( - )} = ( \begin{matrix}{\overline{Q}}_{v , n}^{( + ) - 1} {\overline{r}}_{v , n , ( 1 )}^{( + ) - 1 , -} \\ ∈ ker {\overline{Q}}_{- W , 1}^{( + )} {\overline{R}}_{- W , 1}^{( + )}\end{matrix} ) , \qquad ( iv )$$

$$take {log}_{{k}_{v , n}} and right - encrypt {\overline{h}}_{v , n}^{{\overline{R}}_{v , n}^{( + )} {\overline{r}}_{v , n}^{( + )}} \to ( {log}_{{k}_{v , n}} {\overline{h}}_{v , n} ) {\overline{R}}_{v , n}^{( + )} {\overline{r}}_{v , n}^{( + )} {r}_{v , n}^{( - )} {t}_{I , n} {R}_{- v , n}^{( - 1 )} , \qquad ( v )$$

$$calculate Δ {v}_{R , n}^{( - )} ≡ ( {log}_{{k}_{v , n}} {\overline{h}}_{v , n} ) {\overline{R}}_{v , n}^{( + )} ( {\overline{r}}_{v , n}^{( + )} {r}_{v , n}^{( - )} {t}_{I , n} - {v}_{I , n}^{( - )} ) {R}_{- v , n}^{( - )} , \qquad ( vi )$$

$$generate invertible complex error functions , {ϱ}_{i} , and {\overline{ϱ}}_{i} \qquad ( vii )$$

$$encrypt , exponentiate {\overline{t}}_{I , n} \to {}_{}^{{\overline{r}}_{v , n}^{( - )} {\overline{t}}_{I , n} {\overline{R}}_{- v , n}^{( - )}} {\overline{h}}_{v , n}^{} , \qquad ( viii )$$

$$generate complex scalars , {\overline{k}}_{- C , - v , n} \neq 0 , \qquad ( ix )$$

$$encrypt , exponentiate {\overline{C}}_{- , R , n} \to {\overline{h}}_{- C , n}^{{\overline{R}}_{+ C , n}^{( - )} {\overline{C}}_{- I , n}^{( + )} {\overline{r}}_{- C , n}^{( - )}} , {\overline{k}}_{- C , n} = {e}^{\frac{{\overline{k}}_{- C , - v , n}}{ln {k}_{- v , n}}} . \qquad ( x )$$

Outputs of (iii) and (vii) through (x) are exchanged with P₊.
Step 13: P₊ backpropagates to calculate the weight and bias changes,

$$Δ {W}_{I , i}^{( + )} and Δ {b}_{I , i}^{( + )} ,$$

using the following substeps:

$$generate {r}_{- v , n}^{( + )} = ( {\overline{r}}_{v , n , ( 1 )}^{( - ) - 1 , +} {\overline{Q}}_{v , n}^{( - ) - 1} , ∈ ker {\overline{r}}_{v , n}^{( - )} {\overline{Q}}_{v , n}^{( - )} ) , \qquad ( i )$$

$$take {log}_{{k}_{- v , n}} , \qquad ( ii )$$

$$encrypt {}_{}^{{\overline{r}}_{v , n}^{( - )} {\overline{t}}_{I , n} {\overline{R}}_{- v , n}^{( - )}} {\overline{h}}_{- v , n}^{} \to {R}_{v , n}^{( + )} {r}_{- v , n}^{( + )} {\overline{r}}_{v , n}^{( - )} {\overline{t}}_{I , n} {\overline{R}}_{- v , n}^{( - )} , ( {log}_{{k}_{- v , n}} {\overline{h}}_{- v , n} ) ,$$

$$calculate Δ {v}_{R , n}^{( + )} ≡ {R}_{v , n}^{( + )} ( {r}_{- v , n}^{( + )} {\overline{r}}_{v , n}^{( - )} {\overline{t}}_{I , n} - {v}_{I , n}^{( + )} ) {\overline{R}}_{- v , n}^{( - )} ( {log}_{{k}_{- v , n}} {\overline{h}}_{- v , n} ) , \qquad ( iii )$$

$$take {log}_{{k}_{- C , n}} of {\overline{h}}_{- C , n}^{{\overline{R}}_{+ C , n}^{( - )} {\overline{C}}_{- I , n} {\overline{r}}_{- C , n}^{( - )}} \to ( {log}_{{k}_{- C , n}} {\overline{h}}_{- C , n} ) {\overline{R}}_{+ C , n}^{( - )} {\overline{C}}_{- , I , n} {\overline{r}}_{- C , n}^{( - )} , \qquad ( iv )$$

$${k}_{- C , n} = {e}^{\frac{{\overline{k}}_{- C , - v , n}}{ln {k}_{- v , n}}} ,$$

$$calculate {C}_{R , n}^{( + )} ( Δ {v}_{R , n}^{( + )} ) \to {r}_{C , n}^{( + )} {C}_{W , I , n} {R}_{- C , n}^{( + )} Δ {v}_{R , n}^{( + )} ( {log}_{{k}_{- C , n}} {\overline{h}}_{- C , n} ) {\overline{R}}_{+ C , n}^{( - )} {\overline{C}}_{- , I , n} {\overline{r}}_{- C , n}^{( - )} , \qquad ( v )$$

$$generate complex nonsingular matrices , {\overline{h}}_{Δ W , i} , {\overline{h}}_{Δ b , i} , \qquad ( vi )$$

$$( vii )$$

$$calculate , exponentiate \frac{- \partial {C}_{R , n}^{( + )} ( Δ {v}_{R , n}^{( + )} )}{\partial {W}_{R , 1}} \to {h}_{Δ W , 1}^{( \frac{1}{{α}_{1}} {r}_{C , 1}^{( + )} {R}_{- σ , 1}^{( + ) T} ) Δ {W}_{I , 1}^{( + )} ( {\overline{R}}_{v , 1}^{( - ) T} {\overline{r}}_{- C , 1}^{( - )} )} ,$$

$$( viii )$$

$$calculate , exponentiate \frac{- \partial {C}_{R , n}^{( + )} ( Δ {v}_{R , n}^{( + )} )}{\partial {W}_{R , i > i}} \to {h}_{Δ W , i > 1}^{( \frac{1}{{α}_{i}} {r}_{C , i}^{( + )} {R}_{- σ , i}^{( + ) T} ) Δ {W}_{I , i}^{( + )} ( {R}_{v , i}^{( + ) T} {\overline{r}}_{- C , i}^{( - )} )} ,$$

$$calculate , exponentiate \frac{- \partial {C}_{R , n}^{( + )} ( Δ {v}_{R , n}^{( + )} )}{\partial {b}_{R , i}} \to {\overline{h}}_{Δ W , i > 1}^{( \frac{1}{{α}_{i}} {r}_{C , i}^{( + )} {R}_{- σ , i}^{( + ) T} ) Δ {b}_{I , i}^{( + )} ( {\overline{R}}_{σ , i}^{( - ) T} {\overline{r}}_{- C , i}^{( - )} )} , \qquad ( ix )$$

$$generate complex scalars , {\overline{k}}_{C , v , n} \neq 0 , 1 , \qquad ( x )$$

$$encrypt , exponentiate {\overline{C}}_{+ , I , i} \to {}_{}^{{\overline{r}}_{C , i}^{( + )} {\overline{C}}_{W , I , i} {\overline{R}}_{- C , i}^{( + )}} {\overline{h}}_{C , i}^{} , {\overline{k}}_{C , n} = {e}^{\frac{{\overline{k}}_{C , v , n}}{ln {k}_{v , n}}} . \qquad ( xi )$$

Outputs of (vi) through (x) are exchanged with P₋.
Step 14: P₋ backpropagates to calculate the weight and bias changes,

$$Δ {W}_{I , i}^{( - )} and Δ {b}_{I , i}^{( - )} ,$$

using the following substeps:

$$take {log}_{{k}_{C , n}} of {}^{{r}_{+ C , i}^{- ( + )} {\overline{C}}_{W , I , i} {\overline{R}}_{- C , i}^{( + )}} {{\overline{h}}_{C , n}}^{} \to {\overline{r}}_{+ C , i}^{( - )} {\overline{C}}_{W , I , i} {\overline{R}}_{- C , i}^{( + )} ( {log}_{{k}_{C , n}} {\overline{h}}_{C , n} ) , \qquad ( i )$$

$${k}_{C , n} = {e}^{\frac{{\overline{k}}_{C , v , n}}{ln {k}_{v , n}}} ,$$

$$calculate {C}_{R , n}^{( - )} ( Δ {v}_{R , n}^{( - )} ) \to {\overline{r}}_{C , i}^{( + )} {C}_{W , I , i} {\overline{R}}_{- C , i}^{( + )} ( {log}_{{k}_{C , n}} {\overline{h}}_{C , n} ) Δ {v}_{R , n}^{( - )} {R}_{+ C , n}^{( - )} {C}_{- , I , n} {r}_{- C , n}^{( - )} , \qquad ( ii )$$

$$Δ {v}_{R , n}^{( - )} \to ( {log}_{{k}_{v , n}} {\overline{h}}_{v , n} ) {\overline{R}}_{v , n}^{( + )} {\overline{r}}_{v , n}^{( + )} {r}_{v , n}^{( - )} ( {t}_{I , n} - {v}_{I , n}^{( - )} ) {R}_{- v , n}^{( - )} ,$$

$$calculate , decrypt \frac{- \partial {C}_{R , n}^{( - )} ( Δ {v}_{R , n}^{( - )} )}{\partial {W}_{R , 1}} \to ( \frac{1}{{α}_{1}} {\overline{r}}_{C , 1}^{( + )} {\overline{R}}_{- σ , 1}^{( + ) T} ) Δ {W}_{I , 1}^{( - )} , \qquad ( iii )$$

$$calculate , decrypt \frac{- \partial {C}_{R , n}^{( - )} ( Δ {v}_{R , n}^{( - )} )}{\partial {W}_{R , i > 1}} \to ( \frac{1}{{α}_{i}} {\overline{r}}_{C , i}^{( + )} {\overline{R}}_{- σ , i}^{( + ) T} ) Δ {W}_{I , i}^{( - )} {\overline{R}}_{v , i}^{( + ) T} , \qquad ( iv )$$

$$calculate , decrypt \frac{- \partial {C}_{R , n}^{( - )} ( Δ {v}_{R , n}^{( - )} )}{\partial {b}_{R , i}} \to ( \frac{1}{{α}_{i}} {\overline{r}}_{C , i}^{( - )} {\overline{R}}_{- σ , i}^{( - ) T} ) Δ {b}_{I , i}^{( - )} , \qquad ( v )$$

$$take {log}_{{k}_{Δ W , 1}} , decrypt \qquad ( vi )$$

$${\overline{h}}_{Δ W , 1}^{( \frac{1}{{α}_{1}} {r}_{C , 1}^{( + )} {R}_{- σ , 1}^{( + ) T} ) Δ {W}_{I , 1}^{( + )} ( {\overline{R}}_{v , 1}^{( - ) T} {\overline{r}}_{- C , 1}^{( - )} )} \to ( {log}_{{k}_{Δ W , 1}} {\overline{h}}_{Δ W , 1} ) ( \frac{1}{{α}_{1}} {r}_{C , 1}^{( + )} {R}_{- σ , 1}^{( + ) T} ) Δ {W}_{I , 1}^{( + )} ,$$

$$take {log}_{{k}_{Δ W , i}} , decrypt \qquad ( vii )$$

$${\overline{h}}_{Δ W , i > 1}^{( \frac{1}{{α}_{i}} {r}_{C , i}^{( + )} {R}_{- σ , i}^{( + ) T} ) Δ {W}_{I , i}^{( + )} ( {R}_{v , i}^{( + ) T} {\overline{r}}_{- C , 1}^{( - )} )} \to ( {log}_{{k}_{Δ W , i}} {\overline{h}}_{Δ W , i} ) ( \frac{1}{{α}_{1}} {r}_{C , i}^{( + )} {R}_{- σ , i}^{( + ) T} ) Δ {W}_{I , i}^{( + )} {R}_{v , i}^{( + ) T} ,$$

$$take {log}_{{k}_{Δ b , i}} , decrypt \qquad ( viii )$$

$${\overline{h}}_{Δ b , i}^{( \frac{1}{{α}_{i}} {r}_{C , i}^{( + )} {R}_{- σ , i}^{( + ) T} ) Δ {b}_{I , i}^{( + )} ( {\overline{R}}_{σ , i}^{( - ) T} {\overline{r}}_{- C , i}^{( - )} )} \to ( {log}_{{k}_{Δ b , i}} {h}_{Δ b , i} ) ( \frac{1}{{α}_{i}} {r}_{C , i}^{( + )} {R}_{- σ , i}^{( + ) T} ) Δ {b}_{I , i}^{( + )} ,$$

$$re - exponentiate ( {log}_{{k}_{Δ W , i}} {\overline{h}}_{Δ W , 1} ) ( \frac{1}{{α}_{1}} {r}_{C , 1}^{( + )} {R}_{- σ , 1}^{( + ) T} ) Δ {W}_{I , i}^{( + )} \to {\overline{h}}_{Δ W , i}^{( \frac{1}{{α}_{i}} {r}_{C , 1}^{( + )} {R}_{- σ , 1}^{( + ) T} ) Δ {W}_{I , 1}^{( + )}} , \qquad ( ix )$$

$$re - exponentiate ( {log}_{{k}_{Δ W , i}} {\overline{h}}_{Δ W , i} ) ( \frac{1}{{α}_{i}} {r}_{C , i}^{( + )} {R}_{- σ , i}^{( + ) T} ) Δ {W}_{I , i}^{( + )} {R}_{v , i}^{( + ) T} \to {\overline{h}}_{Δ W , i > 1}^{( \frac{1}{{α}_{i}} {r}_{C , i}^{( + )} {R}_{- σ , i}^{( + ) T} ) Δ {W}_{I , i}^{( + )} {R}_{v , i}^{( + ) T}} , \qquad ( x )$$

$$re - exponentiate ( {log}_{{k}_{Δ b , i}} {h}_{Δ b , i} ) ( \frac{1}{{α}_{i}} {r}_{C , i}^{( + )} {R}_{- σ , i}^{( + ) T} ) Δ {b}_{I , i}^{( + )} \to {\overline{h}}_{Δ b , i}^{( \frac{1}{{α}_{i}} {r}_{C , i}^{( + )} {R}_{- σ , i}^{( + ) T} ) Δ {b}_{I , i}^{( + )}} . \qquad ( xi )$$

Step 15: P₊ and P₋ perform the following respective substeps:
(i) P₊ exchanges outputs of Step 9 (iii) and (iv) with P₋,
(ii) P₋ exchanges outputs of Step 14 (iii) through (v) and (ix) through (xi) with P₊.
   Step 16: P₊ performs the following substeps:

$$decrypt ( \frac{1}{{α}_{i}} {\overline{r}}_{C , 1}^{( + )} {\overline{R}}_{- σ , 1}^{( + ) T} ) Δ {W}_{I , 1}^{( - )} \to Δ {W}_{I , 1}^{( - )} , \qquad ( i )$$

$$decrypt ( \frac{1}{{α}_{i}} {\overline{r}}_{C , i}^{( + )} {\overline{R}}_{- σ , i}^{( + ) T} ) Δ {W}_{I , i > 1}^{( - )} {\overline{R}}_{v , i}^{( + ) T} \to Δ {W}_{I , i}^{( - )} , \qquad ( ii )$$

$$decrypt ( \frac{1}{{α}_{i}} {\overline{r}}_{C , i}^{( - )} {\overline{R}}_{- σ , i}^{( - ) T} ) Δ {b}_{I , i}^{( - )} \to Δ {b}_{I , i}^{( - )} , \qquad ( iii )$$

$$decrypt {h}_{Δ W , 1}^{( \frac{1}{{α}_{1}} {\overline{r}}_{C , 1}^{( + )} {R}_{- σ , 1}^{( + ) T} ) Δ {W}_{I , 1}^{( + )}} \to Δ {W}_{I , 1}^{( + )} , \qquad ( iv )$$

$$decrypt {\overline{h}}_{Δ W , i > 1}^{( \frac{1}{{α}_{i}} {\overline{r}}_{C , i}^{( + )} {R}_{- σ , i}^{( + ) T} ) Δ {W}_{I , i}^{( + )} {R}_{v , i}^{( + ) T}} \to Δ {W}_{I , i}^{( + )} , \qquad ( v )$$

$$decrypt {\overline{h}}_{Δ b , i}^{( \frac{1}{{α}_{i}} {\overline{r}}_{C , i}^{( + )} {R}_{- σ , i}^{( + ) T} ) Δ {b}_{I , i}^{( + )}} \to Δ {b}_{I , i}^{( + )} , \qquad ( vi )$$

$$calculate Δ {W}_{0 , I , i}^{( + )} - Δ {W}_{0 , I , i}^{( - )} , \qquad ( vii )$$

$$calculate Δ {b}_{0 , I , i}^{( + )} - Δ {b}_{0 , I , i}^{( - )} . \qquad ( viii )$$

Step 17: P₋ performs the following substeps:

$$decrypt {}_{}^{{v}_{I , n}^{( + )} {\overline{R}}_{- v , n}^{( - )}} {\overline{h}}_{- v , n}^{} \to {v}_{I , n}^{( - )} \qquad ( i )$$

$$decrypt {}_{}^{{v}_{I , n}^{( - )} {R}_{- v , n}^{( - )}} {\overline{h}}_{- v , n + 1}^{} \to {v}_{I , n}^{( + )} , \qquad ( ii )$$

$$calculate {v}_{0 , I , n}^{( - )} - {v}_{0 , I , n}^{( + )} . \qquad ( iii )$$

Step 18: If Step 16, substep (iii) equals zero, P₋ knows P₊ applied an equivalent set of neural net operations to the (+) copy, modulo the congruence class, and likewise for P₊ with Step 16, substeps (vii) and (viii).
Proof: Applying Theorem 1 and associated lemmas to Steps 1 through 18, as shown above, ensures appropriate R and R̅—with factorizations into R₍ᵢ₎, R̅₍ᵢ₎ and Q, Q̅ matrices, respectively, to preserve underlying unencrypted neural network operations via the exchange of block inverses (to produce block identity matrices where needed) and kernels (to produce block zero matrices where needed).
Furthermore, these exchanges are fair since both parties must do so for the encrypted matrices they exchange with the other party. Likewise for the exchange of complex scalars, k̅_{-σ,-v,i}, k̅_{σ,v,i}. k̅_{-C,-v,n}, and k̅_{C,v,n}, which respectively ensure (logₖ_{_{−v,i}}h̅_{-v,i})(logₖ_{_{−σ,i}}h̅−_{σ,i}), (logₖ_{_{σ,i}}h̅_{+σ,i})(logₖ_{_{W,i}}h̅_{W,i}), (logₖ_{_{−v,n}}h̅_{-v,n})(logₖ_{_{−C,n}}h̅_{-C,n}), and (logₖ_{_{v,n}}h̅_{v,n})(logₖ_{_{C,n}}h̅_{C,n}) are all identity matrices when applied to Steps 3 and 10. (Exchanging these scalars allows the other party to choose two logarithm bases that cancel without exchanging the two bases themselves.)
Therefore, Steps 1 through 18 preserve forward and back propagation operations on NN_{0,I}, modulo the respective matrix expansions.
When Step 16, substep (iii) equals zero, P₋ knows P₊ applied an equivalent set of neural net operations to the (+) copy, modulo the congruence class, and likewise for P₊ for Step 16, substeps (vii) and (viii) in the (−) copy.
This proves our claim. #
Lemma 2.1. The order of exponentials and logarithms may be reversed in Theorem 2, provided corresponding matrices are chosen to ensure these operations are defined.
Proof: No specific order of operations for exponentials and logarithms was required in Steps 1 through 18. Therefore, their order may be reversed. #
Lemma 2.2. Letting P₊=P₋ and eliminating exponentiations and logarithms in Theorem 2 preserves forward and back propagation operations on NN_{0,I}, modulo the respective matrix expansions, allowing a congruent encrypted neural network to be run by a single party.
Proof: This is a subcase of Theorem 2 above. #
Lemma 2.3. Either party may set all block matrices in their unexchanged copy of the neural network to zero matrices and all R matrices to the identity, save those multiplying the other party's where required block inverses and elements of kernels must be selected.
Proof: These choices are still congruent to the exchanged copy, saving computational resources at the risk of lower data-at-rest and data-in-motion security. #
Lemma 2.4. To avoid exponentials and logarithms of symbolic activation function and error function matrices in Step 5 (vii) and Step 6 (vi), Step 6 (xii) and Step 7 (iii), Step 12 (x) and Step 13 (iv), and Step (xi) and Step 14 (i) of Theorem 2, we may substitute the following for these paired steps, respectively:
Step 5 (viii) encrypt, exponentiate, right-multiply

$${\overline{σ}}_{- , I , i} \to {h}_{- σ , i}^{{\overline{R}}_{+ σ , i}^{( - )} {\overline{r}}_{- σ , i}^{( - )}} \times {\overline{r}}_{+ σ , i}^{( - )} {\overline{σ}}_{- , I , i} {\overline{R}}_{- b , i + 1}^{( - )} , where {k}_{- σ , i} = {e}^{\frac{{\overline{k}}_{- σ , - v , i}}{ln {\overline{k}}_{- v , i}}} ,$$

$${\overline{Q}}_{{r}_{- σ} , i}^{( - )} = {\overline{Q}}_{{r}_{σ} , i}^{( - ) - 1} , {\overline{r}}_{- σ , i , ( 1 )}^{( - )} = {\overline{r}}_{- σ , i , ( 1 )}^{( - ) - 1 , +} , {\overline{r}}_{- σ , i , ( 2 )}^{( - )} ∈ ker {\overline{r}}_{σ , i}^{( - )} ,$$

Step 6 (vi) take

$${log}_{{k}_{- σ , i}} of {\overline{h}}_{- σ , i}^{{\overline{R}}_{+ σ , i}^{( - )} {\overline{r}}_{- σ , i}^{( - )}} , multiply \to ( {log}_{{k}_{- σ , i}} {\overline{h}}_{- σ , i} ) {\overline{R}}_{+ σ , i}^{( - )} {\overline{r}}_{- σ , i}^{( - )} {\overline{r}}_{+ σ , i}^{( - )} {\overline{σ}}_{- , I , i} {\overline{R}}_{- b , i + 1}^{( - )} ,$$

$$where {k}_{- σ , i} = {e}^{\frac{{\overline{k}}_{- σ , - v , i}}{ln {k}_{- v , i}}} ,$$

Step 6 (xii) encrypt, exponentiate

$${\overline{σ}}_{+ , I , i} \to {\overline{R}}_{v , i + 1}^{( + )} {\overline{σ}}_{+ , I , i}^{( + )} {\overline{r}}_{- σ , i}^{( + )} {}_{}^{{\overline{r}}_{σ , i}^{( + )} {\overline{R}}_{- σ , i}^{( + )}} {\overline{h}}_{+ σ , i}^{} , {\overline{k}}_{σ , i} = {e}^{\frac{{\overline{k}}_{σ , W , i}}{ln {\overline{k}}_{W , i}}} , where {\overline{Q}}_{{r}_{- σ} , i}^{( + )} = {\overline{Q}}_{{r}_{σ} , i}^{( + ) - 1} ,$$

$${\overline{r}}_{- σ , i , ( 1 )}^{( + )} = {\overline{r}}_{σ , i , ( 1 )}^{( + ) - 1 , +} , {\overline{r}}_{- σ , i , ( 2 )}^{( + )} ∈ ker {\overline{r}}_{σ , i}^{( + )} ,$$

Step 7 (iii) take logₖ_{_{σ,i}} of

$${}_{}^{{\overline{r}}_{σ , i}^{( + )} {\overline{R}}_{- σ , i}^{( + )}} {\overline{h}}_{+ σ , i}^{} , multiply \to {\overline{R}}_{v , i + 1}^{( + )} {\overline{σ}}_{+ , I , i}^{( + )} {\overline{r}}_{- σ , i}^{( + )} {\overline{r}}_{+ σ , i}^{( + )} {\overline{R}}_{- σ , i}^{( + )} ( {log}_{{k}_{- σ , i}} {\overline{h}}_{- σ , i} ) , where$$

$${k}_{σ , i} = {e}^{\frac{{\overline{k}}_{σ , W , i}}{ln {k}_{W , i}}} ,$$

Step 12 (x) encrypt, exponentiate, right-multiply

$${\overline{C}}_{- , R , n} \to {\overline{h}}_{- C , n}^{{\overline{R}}_{+ C , n}^{( - )} {\overline{r}}_{- , n}^{( - )}} \times {\overline{r}}_{+ , n}^{( - )} {\overline{C}}_{- , I , n} {\overline{r}}_{- C , n}^{( - )} , where {\overline{k}}_{- C , n} = {e}^{\frac{{\overline{k}}_{- C , - v , n}}{ln {\overline{k}}_{- v , n}}} ,$$

$${\overline{Q}}_{- , i}^{( - )} = {\overline{Q}}_{+ , i}^{( - ) - 1} , {\overline{r}}_{- , i , ( 1 )}^{( - )} = {\overline{r}}_{+ , i , ( 1 )}^{( - ) - 1 , +} , {\overline{r}}_{- , i , ( 2 )}^{( - )} ∈ ker {\overline{r}}_{+ , i}^{( - )} ,$$

Step 13 (iv) take logₖ_{_{−Cn}} of

$${}_{}^{} {\overline{h}}_{- C , n}^{{\overline{R}}_{+ C , n}^{( - )} {\overline{r}}_{- , n}^{( - )}} , right - multiply \to ( {log}_{{k}_{- C , n}} {\overline{h}}_{- C , n} ) {\overline{R}}_{+ C , n}^{( - )} {\overline{r}}_{- , n}^{( - )} {\overline{r}}_{+ , n}^{( - )} {\overline{C}}_{- , I , n}^{} {\overline{r}}_{- C , n}^{( - )} ,$$

$$where {\overline{k}}_{- C , n} = {e}^{\frac{{\overline{k}}_{- C , - v , n}}{ln {k}_{- v , n}}} ,$$

Step 13 (xi) encrypt, exponentiate, left-multiply

$${\overline{C}}_{+ , I , i} \to {\overline{r}}_{C , i}^{( + )} {\overline{C}}_{W , I , i} {\overline{r}}_{- , i}^{( + )} {}_{}^{{\overline{r}}_{+ , i}^{( + )} {\overline{R}}_{- C , i}^{( + )}} {\overline{h}}_{C , i}^{} , where {\overline{k}}_{- C , n} = {e}^{\frac{{\overline{k}}_{- C , v , n}}{ln {\overline{k}}_{v , n}}} ,$$

$${\overline{Q}}_{- , i}^{( + )} = {\overline{Q}}_{+ , i}^{( + ) - 1} , {\overline{r}}_{- , i , ( 1 )}^{( + )} = {\overline{r}}_{+ , i , ( 1 )}^{( + ) - 1 , +} , {\overline{r}}_{- , i , ( 2 )}^{( - )} ∈ ker {\overline{r}}_{+ , i}^{( + )} ,$$

Step 14 (i) take logₖ_{_{C,n}} of

$${}^{{\overline{r}}_{+ , i}^{( + )} {\overline{R}}_{- C , i}^{( + )}} {\overline{h}}_{C , i} , left - multiply \to {\overline{r}}_{C , i}^{( + )} {\overline{r}}_{- , i}^{( + )} {\overline{r}}_{+ , i}^{( + )} {\overline{C}}_{W , I , i} {\overline{R}}_{- C , i}^{( + )} ( {log}_{{k}_{C , n}} {\overline{h}}_{C , n} ) , where {k}_{C , n} = {e}^{\frac{{\overline{k}}_{C , v , n}}{ln {k}_{v , n}}} .$$

Proof: These choices still produce the following products equal to 1,

$$( {log}_{{k}_{- v , i}} {\overline{h}}_{- v , i} ) ( {log}_{{k}_{- σ , i}} {\overline{h}}_{- σ , i} ) , ( {log}_{{k}_{σ , i}} {\overline{h}}_{+ σ , i} ) ( {log}_{{k}_{W , i}} {\overline{h}}_{W , i} ) , ( {log}_{{k}_{- v , n}} {\overline{h}}_{- v , n} ) ( {log}_{{k}_{- C , n}} {\overline{h}}_{- C , n} ) , and ( {log}_{{k}_{v , n}} {\overline{h}}_{v , n} ) ( {log}_{{k}_{C , n}} {\overline{h}}_{C , n} ) ,$$

### in Steps 8 and 9.

Furthermore, the pairs of new r matrices

$$( i . e . , {\overline{r}}_{- σ , i}^{( - )} , {\overline{r}}_{+ σ , i}^{( - )} ; {\overline{r}}_{- σ , i}^{( + )} , {\overline{r}}_{σ , i}^{( + )} ; {\overline{r}}_{- , n}^{( - )} , {\overline{r}}_{+ , n}^{( - )} ; {\overline{r}}_{- , i}^{( + )} {\overline{r}}_{+ , i}^{( + )} , respectively )$$

produce required inverse and zero block matrices to preserve underlying matrix operation on the unencrypted neural network. #
Lemma 2.5: Steps 1 through 18 of the two-party-plus “reshuffling” algorithm may be repeated where two parties work with a trusted third party, P₀, that (i) receives one-party encrypted data from both parties, (ii) performs all subsequent forward and backwards propagation neural network matrix operations, and (iii) passes final two-party encrypted outputs to each party for subsequent decryption.
Proof: This is a direct result of Theorem 2 and trivial mathematically. However, it is important both practically and computationally given input data owners may not have computational resources at their disposal. #
Lemma 2.6: Zero-trust reshuffling algorithms, with and without P₀, enable “Model-as-a-Service” (MaaS) and “Training-Data-as-a-Service” (TDaaS) paradigms while protecting input data.
Proof: This follows from repeating the steps listed above and noting that it does not matter whether P_{±} owns the training data. Thus, a party may make its model or training data available to another party as a service while ensuring privacy and protection. #

Though one party could encrypt its source and provide to another for augmented use, doing so via a trusted third party seems the more practical scenario. We now have a means to make neural network operations secure between one or more parties while verifying results without trust. This is what we aimed to achieve.

In summary, the reshuffling algorithm for encrypted neural network operations may involve non-linear transformation steps as exponentiation first and then logarithms and in other implementation examples may involve nonlinear transformation steps as logarithms first and then exponentiation. In some implementations, the data owner may themselves run the encrypted neural network operations. In other examples, a trusted third party may receive the one-party encryption keys from the data owner and neural network owner respectively and then perform the neural network encryption computation operations. The trusted third party may then share the two-party encrypted outputs to each of the two parties for decryption. In some examples, either party in the reshuffling algorithm may select their expansion block matrices to be identity and zero matrices to simplify computation of their own encryption steps, while accepting the trade-off of higher risk for data-at-rest and data-in-motion. In some examples, the reshuffling algorithm can be adjusted to handle activation functions and error functions that may be symbolic operations. Across these illustrative examples of the reshuffling algorithm, the neural network owner may offer a model-as-a-service implementation in a secure manner and in other examples, the data owner may offer a training-data-as-a-service implementation in a secure manner.

### Embodiment 1: Alternative Sub-Embodiments—Exemplary Implementation of Reshuffling Method Using Special Matrix Classes

In the previous reshuffling algorithm, matrix inversions, exponentiations, and logarithms are computationally expensive unless special matrix classes are chosen. Implementation approaches which novelly employ (i) skew symmetric and orthogonal matrices, (ii) circulant matrices, (iii) finite cyclic group generators, or (iv) representations of clifford algebras, reduce the computational complexity and enable the reshuffling algorithm to be implemented efficiently. The effect of the matrix classes is to select matrix classes for which inverses, exponentiations, and/or logarithms may be computed efficiently via mathematical simplifications. These are discussed in turn below.

(i) Exemplary Implementation of Reshuffling Method Using Skew Symmetric and Orthogonal Matrices (or, Equivalently. Hermitian and Unitary Matrices for Complex-Valued Matrices)

In the reshuffling algorithm, multiple steps generate matrices with random components where inverses, logarithms, and exponentials are subsequently taken. Such steps are computationally inefficient for generalized matrices. However, specific matrices may be selected that reduce the complexity, allowing the reshuffling algorithms to be more readily implemented.

Orthogonal matrices have a unique property: when transposed, they are their inverse, i.e., O^{T}×O=O×O^{T}=I. This property has advantages for matrix logarithms: the logarithm of such an orthogonal matrix, if it exists, will be skew-symmetric. This property again provides a predictability and structure that can be utilized to simplify and optimize the reshuffling algorithm.

Skew-symmetric matrices are matrices for which the transpose is the negative of the original matrix, i.e., A^{T}=−A. One of their properties is that their exponentials always result in orthogonal matrices. Efficient algorithms, like the Padé approximant and subsequent improvements to it, converge quickly for exponentials and logarithms when corresponding matrices are skew symmetric and orthogonal matrices, respectively.

Furthermore, this choice further simplifies the reshuffling algorithm and makes it computationally efficient since all required matrix inverses require inverting an orthogonal matrix, requiring a trivial transposition. Through the use of skew symmetric and orthogonal matrices for the linear and non-linear transformation for the encrypted neural network, the complexity of matrix inverse is reduced to O(n²) instead of O(n³) or worse. Similarly, the choice of skew symmetric and orthogonal matrices brings the complexity of matrix exponentials and matrix logarithms to O(n³) utilizing approximation methods with reduced complexity, and better approximations versus a general matrix.

(i)(a) Example Efficient Implementation of Forward Propagation Using the Reshuffling Method Using Using Skew Symmetric and Orthogonal Matrices

Recall, in the Reshuffling Method, the operations performed in the numbered step 3, step 4, step 5, step 6 and step 8. Step 3 involves the generation of respective generic invertible complex matrices (h matrices). Step 4 involves the generation of encryption keys in the form of left and right expansion block matrices and exchange of a select set of keys. Step 5 and Step 6 involve various encryption and exponentiation operations and Step 8 and 17 cover forward propagation operations of the encrypted neural network. In some implementation of the Reshuffling Method using Skew Symmetric and Orthogonal matrices, the block expansion matrices are specially chosen from a group of orthogonal matrices and called as R_{⊥}. In the implementation of non-linear transformation steps involving skew symmetric and orthogonal matrices, h matrices generated and exchanged in step 3 are constructed using R_{⊥} a non-zero real-valued scalar and a diagonal block diagonal matrices. In step 4, the various block expansion matrices—R, Q, r matrices—are all chosen to be elements of a group of orthogonal matrices of the same order n. In steps 5 and 6, the block expansion matrices are chosen such that the encrypted exponentiation of the state vectors are orthogonal matrices and the symbolic activation functions are encrypted by using left and right exponentials, instead of exponentiating the symbolic activation function. In steps 8 and 17, the choice of skew symmetric and orthogonal matrices present an alternate option for exchange of encrypted outputs for verification.

Adopting the convention that R_{⊥} indicates an orthogonal matrix belonging to the group O(n), λ indicates a non-zero real-valued scalar, and D indicates a block diagonal matrix, the following choices may be used for respective Steps and substeps in the Reshuffling Method, with the other steps unchanged:

$$Step 3 ( i ) {\overline{h}}_{W , i} = {\overline{h}}_{⊥ , W , i} = {e}^{{R}_{⊥ , {\overline{h}}_{W} , i} {D}_{i} ( {λ}_{{\overline{h}}_{W} , i , j} ( \begin{matrix}0 & + 1 \\ - 1 & 0\end{matrix} ) ) {R}_{⊥ , {\overline{h}}_{W} , i}^{T}} ∈ O ( n ) , {λ}_{{\overline{h}}_{W} , i , j} \neq 0 \\ Step 3 ( i ) {\overline{h}}_{+ σ , i} = {\overline{h}}_{⊥ , σ , i} = {\overline{k}}_{W , i}^{{R}_{⊥ , {\overline{h}}_{W} , i} {D}_{i} ( \frac{1}{{λ}_{{\overline{h}}_{W} , i , j}} ( \begin{matrix}0 & - 1 \\ + 1 & 0\end{matrix} ) ) {R}_{⊥ , {\overline{h}}_{W} , i}^{T}} ∈ O ( n ) , {\overline{k}}_{σ , i} = {e}^{\frac{{\overline{k}}_{σ , W , i}}{ln {\overline{k}}_{W , i}}} , \\ Step 3 ( ii ) {\overline{h}}_{- v , i} = {\overline{h}}_{⊥ , - v , i} = {\overline{k}}_{- v , i}^{{R}_{⊥ , {\overline{h}}_{- v} , i} {D}_{i} ( {λ}_{{\overline{h}}_{- v} , i , j} ( \begin{matrix}0 & + 1 \\ - 1 & 0\end{matrix} ) ) {R}_{⊥ , {\overline{h}}_{- v} , i}^{T}} ∈ O ( n ) , {λ}_{{\overline{h}}_{- v} , i , j} \neq 0 \\ Step 3 ( ii ) {\overline{h}}_{- σ , i} = {\overline{h}}_{⊥ , - σ , i} = {\overline{k}}_{- σ , i}^{{R}_{⊥ , {\overline{h}}_{- v} , i} {D}_{i} ( \frac{1}{{λ}_{{\overline{h}}_{- v} , i , j}} ( \begin{matrix}0 & - 1 \\ + 1 & 0\end{matrix} ) ) {R}_{⊥ , {\overline{h}}_{- v} , i}^{T}} ∈ O ( n ) , {\overline{k}}_{- σ , i} = {e}^{\frac{{\overline{k}}_{- σ , - v , i}}{ln {\overline{k}}_{- v , i}}} . \\ Step 4 {\overline{Q}}_{v , 1}^{( - )} = {\overline{Q}}_{⊥ , v , 1}^{( - )} ∈ O ( n ) , \\ Step 4 {Q}_{- W , 1}^{( - )} = {\overline{Q}}_{⊥ , v , 1}^{( - ) T} ∈ O ( n ) , \\ Step 4 {\overline{Q}}_{- v , i}^{( - )} = {\overline{Q}}_{⊥ , v , i}^{( - )} ∈ O ( n ) , \\ Step 4 {Q}_{- b , i}^{( - )} = {\overline{Q}}_{⊥ , v , i}^{( - ) T} ∈ O ( n ) , \\ Step 4 {\overline{Q}}_{{r}_{- v} , i + 1}^{( - ) - 1} = {\overline{Q}}_{⊥ , {r}_{- v} , i + 1}^{( - )} ∈ O ( n ) , \\ Step 4 {\overline{Q}}_{- b , i + 1}^{( - )} = {\overline{Q}}_{⊥ , {r}_{- v} , i + 1}^{( - ) T} ∈ O ( n ) , \\ Step 4 {\overline{r}}_{- v , i , ( 1 )}^{( - )} = {\overline{r}}_{⊥ , - v , i , ( 1 )}^{( - )} ∈ O ( n ) , \\ Step 4 {\overline{R}}_{- b , i , ( 1 )}^{( - )} = {\overline{Q}}_{⊥ , {r}_{- v} , i}^{( - ) T} {\overline{r}}_{⊥ , - v , i , ( 1 )}^{( - ) T} ∈ O ( n ) , \\ Step 4 {\overline{R}}_{- v , i , ( 1 )}^{( - )} = {\overline{R}}_{⊥ , - v , i , ( 1 )}^{( - )} ∈ O ( n ) , \\ Step 4 {\overline{R}}_{v , 1 , ( 1 )}^{( - )} = {\overline{R}}_{⊥ , v , 1 , ( 1 )}^{( - )} ∈ O ( n ) , \\ Step 4 {\overline{R}}_{W , i , ( 1 )}^{( + )} = {\overline{R}}_{⊥ , W , i , ( 1 )}^{( + ) - 1 , +} ∈ O ( n ) , \\ Step 4 {\overline{Q}}_{W , i}^{( + )} = {\overline{Q}}_{⊥ , W , i}^{( + )} ∈ O ( n ) , \\ Step 4 {\overline{Q}}_{v , i}^{( + )} = {\overline{Q}}_{⊥ , v , i}^{( + )} ∈ O ( n ) , \\ Step 4 {\overline{R}}_{v , i , ( 1 )}^{( + )} = {\overline{R}}_{⊥ , v , i , ( 1 )}^{( + )} ∈ O ( n ) , \\ Step 5 ( vi ) {\overline{R}}_{v , 1}^{( - )} = {R}_{⊥ , {\overline{h}}_{- v} , 1} {D}_{1} ( {λ}_{{\overline{h}}_{- v} , 1 j} ( \begin{matrix}0 & - 1 \\ + 1 & 0\end{matrix} ) ) {R}_{⊥ , {\overline{h}}_{- v} , 1}^{T} {\overline{R}}_{- v , 1}^{( - ) T} {\overline{v}}_{I , 1}^{T} {\overline{R}}_{⊥ , - v , 1} {\overline{D}}_{1} ( {\overline{λ}}_{- v , 1 , j} ( \begin{matrix}0 & + 1 \\ - 1 & 0\end{matrix} ) ) {\overline{R}}_{⊥ , - v , 1}^{T} \\ s . t . {}^{{\overline{R}}_{v , 1}^{( - )} {\overline{v}}_{I , 1} {\overline{R}}_{- v , 1}^{( - )}} {\overline{h}}_{- v , 1} ∈ O ( n ) , \\ Step 5 ( vii ) {\overline{r}}_{- v , i}^{( - )} = {R}_{⊥ , {\overline{h}}_{- v} , 1} {D}_{1} ( {λ}_{{\overline{h}}_{- v} , 1 , j} ( \begin{matrix}0 & - 1 \\ + 1 & 0\end{matrix} ) ) {R}_{⊥ , {\overline{h}}_{- v} , 1}^{T} {\overline{R}}_{- v , i}^{( - ) T} {\overline{R}}_{⊥ , - v , i} {\overline{D}}_{i} ( {\overline{λ}}_{- v , i , j} ( \begin{matrix}0 & + 1 \\ - 1 & 0\end{matrix} ) ) {\overline{R}}_{⊥ , - v , i}^{T} {\overline{R}}_{- v , i}^{( - )} \\ s . t . {}^{{\overline{r}}_{- v , i}^{( - )} {\overline{R}}_{- v , 1}^{( - )}} {\overline{h}}_{- v , i} ∈ O ( n ) , \\ Step 5 ( viii ) {\overline{r}}_{- σ , i}^{( - )} = {\overline{R}}_{⊥ , - σ , i} {\overline{D}}_{i} ( {\overline{λ}}_{- σ , i , j} ( \begin{matrix}0 & - 1 \\ + 1 & 0\end{matrix} ) ) {\overline{R}}_{⊥ , - σ , i}^{T} {\overline{R}}_{+ σ , i}^{( - ) T} {\overline{R}}_{⊥ , {\overline{h}}_{- v} , i} {\overline{D}}_{i} ( \frac{1}{{\overline{λ}}_{{\overline{h}}_{- v} , i , j}} ( \begin{matrix}0 & + 1 \\ - 1 & 0\end{matrix} ) ) {\overline{R}}_{⊥ , {\overline{h}}_{- v} , i}^{T} \\ s . t . {\overline{h}}_{- σ , i}^{{\overline{R}}_{+ σ , i}^{( - )} {\overline{r}}_{- σ , i}^{( - )}} ∈ O ( n ) , where {\overline{σ}}_{- , I , i} = {\overline{h}}_{- σ , i}^{{\overline{R}}_{+ σ , i}^{( - )} {\overline{r}}_{- σ , i}^{( - )}} \times {\overline{r}}_{+ σ , i}^{( - )} {\overline{σ}}_{- , I , i} {\overline{R}}_{- v , i + 1}^{( - )} , \\ Step 6 ( xi ) {\overline{R}}_{- W , i}^{( + )} = {\overline{R}}_{⊥ , W , i} {\overline{D}}_{i} ( {\overline{λ}}_{W , i , j} ( \begin{matrix}0 & + 1 \\ - 1 & 0\end{matrix} ) ) {\overline{R}}_{⊥ , W , i}^{T} {\overline{W}}_{I , i}^{T} {\overline{R}}_{W , i}^{( + ) T} {R}_{⊥ , {\overline{h}}_{W} , i} {D}_{i} ( {λ}_{{\overline{h}}_{W} , i , j} ( \begin{matrix}0 & - 1 \\ + 1 & 0\end{matrix} ) ) {R}_{⊥ , {\overline{h}}_{W} , i}^{T} = ( {\overline{R}}_{v , i , ( 1 )}^{( + ) - 1 , -} {\overline{Q}}_{v , i}^{( + ) - 1} , ∈ ker {\overline{Q}}_{v , i}^{( + )} {\overline{R}}_{v , i}^{( + )} ) \\ s . t . {\overline{h}}_{W , i}^{{\overline{R}}_{W , i}^{( + )} {\overline{W}}_{I , i} {\overline{R}}_{- W , i}^{( + )}} ∈ O ( n ) , \\ Step 6 ( xii ) {\overline{R}}_{- b , i}^{( + )} = {\overline{R}}_{⊥ , b , i} {\overline{D}}_{i} ( {\overline{λ}}_{b , i , j} ( \begin{matrix}0 & + 1 \\ - 1 & 0\end{matrix} ) ) {\overline{R}}_{⊥ , b , i}^{T} {\overline{b}}_{I , i}^{T} {\overline{R}}_{W , i}^{( + ) T} {R}_{⊥ , {\overline{h}}_{W} , i} {D}_{1} ( {λ}_{{\overline{h}}_{W} , i , j} ( \begin{matrix}0 & - 1 \\ + 1 & 0\end{matrix} ) ) {R}_{⊥ , {\overline{h}}_{W} , i}^{T} \\ s . t . {\overline{h}}_{W , i}^{{\overline{R}}_{W , i}^{( + )} {\overline{b}}_{I , i} {\overline{R}}_{- b , i}^{( + )}} ∈ O ( n ) , \\ Step 6 ( xiii ) {\overline{r}}_{σ , i}^{( + )} = {\overline{R}}_{⊥ , {\overline{h}}_{W} , i} {\overline{D}}_{i} ( \frac{1}{{\overline{λ}}_{{\overline{h}}_{W} , i , j}} ( \begin{matrix}0 & + 1 \\ - 1 & 0\end{matrix} ) ) {\overline{R}}_{⊥ , {\overline{h}}_{W} , i}^{T} {\overline{R}}_{- σ , i}^{( + ) T} {\overline{R}}_{⊥ , σ , i} {\overline{D}}_{i} ( {\overline{λ}}_{σ , i , j} ( \begin{matrix}0 & - 1 \\ + 1 & 0\end{matrix} ) ) {\overline{R}}_{⊥ , σ , i}^{T} \\ s . t . {}^{{\overline{r}}_{σ , i}^{( + )} {\overline{R}}_{- σ , i}^{( + )}} {\overline{h}}_{+ σ , i} ∈ O ( n ) , where {\overline{σ}}_{+ , I , i} = {\overline{R}}_{v , i + 1}^{( + )} {\overline{σ}}_{+ , I , i}^{( + )} {\overline{r}}_{- σ , i}^{( + )} {}^{{\overline{r}}_{σ , i}^{( + )} {\overline{R}}_{- σ , i}^{( + )}} {\overline{h}}_{+ σ , i} .$$

For forward propagation where no backpropagation is intended, Step 8 may be modified where P₋ retains possession of

$${}^{{\overline{R}}_{v , n}^{( + )} {v}_{I , n}^{( - )} {R}_{- v , n}^{( - )}} {\overline{h}}_{- v , n} ,$$

and Step 9, where P₊ exchanged

$${v}_{I , n}^{( + )} {\overline{R}}_{- v , n}^{( - )} and {\overline{R}}_{- v , n}^{( + )}$$

with P₋.

In Step 17, P₋ then decrypts

$${\overline{R}}_{v , n}^{( + )} {v}_{I , n}^{( - )} {R}_{- v , n}^{( - )} and {v}_{I , n}^{( + )} {\overline{R}}_{- v , n}^{( - )}$$

and verifies the congruence of the answers.

By making the previous choices for matrices for the Reshuffling Algorithm, we retain a high degree of generality: the choice of arbitrary complex invertible n×n matrix, with n² degrees of freedom, gets replaced by choosing n non-zero real-valued scalars and an orthogonal matrix, as derived from an exponentiated skew symmetric matrix, with

$$\frac{n ( n - 1 )}{2}$$

degrees of freedom, giving

$$\frac{n ( n + 1 )}{2}$$

total degrees of freedom. In addition to half as many degrees of freedom, skew symmetric and orthogonal matrices offer structural properties that make them better suited for matrix exponentials and matrix logarithms over a general matrix.

Matrix exponentials and logarithms can be computationally intensive for general matrices due to the necessity of series expansions. Commonly employed techniques like the scaling and squaring method for matrix exponentials and the inverse scaling and squaring for matrix logarithms are used in conjunction with Padé approximations. These methods are designed to reduce the computational complexity to a level akin to that of matrix multiplication. However, they introduce trade-offs between computational efficiency, accuracy, and convergence of the algorithm. Determining the appropriate number of scaling steps for the scaling and squaring method, and the correct number of square root operations for the inverse scaling and squaring method, can be challenging and critical for algorithmic success.

In contrast, when dealing with skew-symmetric and orthogonal matrices, more efficient and deterministic methods are available for computing matrix exponentials and logarithms. These methods leverage the structural properties of skew-symmetric and orthogonal matrices, which often allow for closed-form solutions that preserve the structure of matrices (e.g., J. R. Cardoso, F. S. Leite, Journal of Computational and Applied Mathematics 233 (2010) 2867-2875). In some implementations, for skew-symmetric matrices, the exponential can be computed directly through spectral decomposition, as these matrices have purely imaginary eigenvalues. Orthogonal matrices, having real eigenvalues of magnitude one, also facilitate more straightforward calculations for both exponentials and logarithms. These specialized methods circumvent the general challenges associated with convergence and computational overhead, providing more reliable and efficient outcomes for these specific classes of matrices of orthogonal and skew-symmetric matrices.

Backward propagation is conducted analogously by choosing all exponentiated matrices to be skew symmetric and all inverted matrices or matrix logarithms to be those of orthogonal matrices. Computational complexity is reduced in an analogous manner for exponentiations and logarithms as in forward propagation.

### (ii) Exemplary Implementation of Reshuffling Method Using Circulant Matrices

In some implementations of the reshuffling algorithm, circulant matrices may be used to perform the relevant matrix inverse, matrix exponentiation, and matrix logarithms in a computationally efficient manner. Circulant matrices are computationally efficient for inverse, exponentiation, and logarithm operations due to their unique structure and properties. The following section outlines the efficiency of circulant matrices for these operations:
1. Structure: A circulant matrix is a square matrix in which all row vectors are composed of the same elements, and each row vector is rotated one element to the right relative to the preceding row vector.
2. Diagonalization: Circulant matrices can be diagonalized using the discrete Fourier transform (DFT), which allows for efficient computation of their inverse, exponentiation, and logarithm. The DFT can be computed using the Fast Fourier Transform (FFT) algorithm, which has a complexity of O(n log n), where n is the dimension of the matrix.
   Below are exemplary steps for diagonalization of a circulant matrix C:
1. Construct Fourier Matrix: Generate the n×n Fourier matrix F whose (j, k)^{th} element is ω^{jk}, where

$$ω = {e}^{( - \frac{2 π i}{n} )}$$

is the generic n-th root of unity.

$${F}_{jk} = {ω}^{jk} where j , k = 0 , 1 , … , n - 1$$

2. Compute FFT of First Row: Apply FFT on the first row of C to get the diagonal elements d₀, d₁, . . . , dₙ₋₁ of the diagonal matrix D.

$$D = diag ( {d}_{0} , {d}_{1} , … , {d}_{n - 1} ) = F \times First row of C$$

3. Diagonalize C: Use D and F to express C as C=FDF⁻¹
   Now C is diagonalized and you can use D and F for efficient computations like inverse, exponentiation, etc. All of these steps, thanks to FFT, will have a time complexity of O(n log n). Thus circulant matrices are more efficient than similar operations that take O(n³) for generic matrices.
      Below we describe how circulant matrices perform matrix inverses, matrix exponentials, and matrix logarithms in an exemplary implementation of the reshuffling algorithm
1. For inverse computations:
   After diagonalizing the circulant matrix using the DFT, the inverse can be computed by taking the inverse of the diagonal matrix and applying the inverse DFT. This process has a complexity of O(n log n) due to the FFT algorithm.
   In the above example, where is C=FDF⁻¹, C⁻¹=FD⁻¹F⁻¹
2. For matrix exponentiation:
   The matrix exponential of a circulant matrix can be computed efficiently using the DFT and element-wise exponentiation of the diagonal matrix. This process has a complexity of O(n log n) due to the FFT algorithm.
   In the above example, where C=FDF⁻¹, e^{C}=Fe^{D}F⁻¹
3. For matrix logarithm:
   The matrix logarithm of a circulant matrix can be computed efficiently using the DFT and element-wise logarithm of the diagonal matrix. This process has a complexity of O(n log n) due to the FFT algorithm.
   In the above example, where C=FDF⁻¹, log(C)=F log(D)F⁻¹.

In summary, circulant matrices are computationally efficient for inverse computations, matrix exponentiation, and matrix logarithm due to their unique structure and the ability to diagonalize them using the DFT. This allows for the operations to be computed with a complexity of O(n log n), which is faster than the typical O(n³) complexity for generic matrix operations.

(iii) Exemplary Implementation of Reshuffling Method Using Finite Cyclic Group Generators

In some implementations of the reshuffling algorithm, finite cyclic group generator matrices may be used to perform the relevant matrix inverse, matrix exponentiation, matrix logarithms, and other matrix operations in a computationally efficient manner.

A finite cyclic group generator is an element in the finite cyclic group that generates all other elements in the group through repeated application of the group operation. In other words, a finite cyclic group G is generated by a single element g, such that every element in G can be expressed as a power of g (for multiplicative notation) with the identity matrix, or I, as the identity element. This element g is called the generator of the group. Generators of finite cyclic groups are efficient for inverse operations, exponentiation, and logarithms due to the unique properties and the structure of finite cyclic groups. The following section outlines the efficiency of finite cyclic group generator matrices for these operations:
1. Inverse operations: In a finite cyclic group of order n with generator g, the inverse of an element g^{k} can be computed as g^{(n-k)}, using algorithms like the square-and-multiply method.
2. Exponentiation: Exponentiation in finite cyclic groups can be computed efficiently because, as mentioned in (1), the power series of g will eventually yield the identity. For a finite cyclic group of order n, exponentiation of g^{k} takes this form:

$$exp ( {g}^{k} ) = {\sum }_{j = 0}^{∞} \frac{1}{j !} {g}^{kj} = {\sum }_{j = 0}^{n - 1} {g}^{kj ( modn )} {\sum }_{l = 0} \frac{1}{( ln + j ) !} ,$$

the first summation is finite and may be computed explicitly and the latter summation converges quickly due to the factorial in the denominator, yielding a computational complexity of O(n(n−1)).
3. Logarithms: Logarithmic calculations are similarly sped up to due to eigenvalues of matrix representations of finite cyclic groups being the n^{th} roots of unity, exp(2πik/n). This requires only the eigenvectors and inverse eigenvector matrix to calculate the logarithm. Because the choice of eigenvector matrix is restricted only to invertible matrices, it may be restricted to orthogonal, unitary, circulant, or other matrix classes with easily calculated inverses, simplify computation.

### (iv) Exemplary Implementation of Reshuffling Method Using Representations of Clifford Algebras

In some implementations of the reshuffling algorithm, specific representations of Clifford algebras may be used to perform the relevant matrix inverse, matrix exponentiation, matrix logarithms, and other matrix operations in a computationally efficient manner. Such exemplary representations of Clifford algebras may include those suitable for finite cyclic groups, which benefit from the efficient computations as described above.

### 9. Embodiment 2: Matrix and Term-Wise Operations

Embodiment 2 addresses a potential limitation of Embodiment 1 by extending privacy-preserving methods to support a wider range of non-linear activation functions. It introduces techniques for transforming activation functions to handle affine transformations of hidden layer inputs, overcoming the constraints of simpler activation functions. These transformed activation functions are represented using series expansions, such as Taylor series, to enhance privacy. The method in Embodiment 2 incorporates matrix-based expansions, row/column permutations and term-wise operations for scrambling matrix multiplications and exponentiations. Additionally, higher-dimensional terms in the series coefficients can be used to provide further data privacy and security.

Current industry practices rely on deploying pre-trained or open-source models within a customer's network, where models can be fine-tuned for specific needs. When neural network (NN) model owners aim to protect their model weights, these practices are often limited to legal agreements and license guarantees prohibiting unauthorized training with customer data. In contrast, Embodiment 2 enables data owners to use AI models without exposing sensitive data and allows NN model owners to protect their weights without relying on trust-based agreements. By ensuring secure and privacy-preserving collaboration, Embodiment 2 bridges critical gaps in data security and trust, expanding the scope of AI applications in enterprise environments.

Terminology from Embodiment 1 Used in Embodiment 2

The following statements apply to Embodiment 1 and are consistent with Embodiment 2:
1. Reshuffling refers to the “shuffling” of matrices representing neural network parameters and operations, as well as both input and output embeddings.
2. According to the disclosed reshuffling algorithm, the forward propagation and backward propagation are obscured through maintenance, matrix manipulations and adding dummy data. This ensures not only is the calculation being done correctly, but that it does it in a way that can be independently performed by every party.

### Embodiment 2: Updated Flow Sequence & Forward Propagation Example

The following is a use case for reshuffling to generate ‘shared/transformed data’ and reshuffled NN operations in a univariate example.

This embodiment describes an enclave acting as the neural network (NN) owner, with the NN stored in a data store linked to the enclave. In an alternate embodiment, an enclave can orchestrate a NN owner residing in one exclave and a data owner in another exclave. Such an architecture can be implemented within the IDMP framework, leveraging the multi-tenant enclaves outlined in U.S. provisional patent application No. 63/650,498 (Docket No. IST-05.001P), which is incorporated by reference in its entirety herein, as if fully set forth herein.

In this exemplary implementation, a user requests to run a prediction without divulging their private data to the neural network (NN). The IDMP allows the user to transform their private data into a reshuffled, shared form using a set of cryptographically generated passwords (or keys) specific to the session. These keys are securely shared with the NN owner, enabling both parties to reshuffle their respective inputs (data and NN) consistently.

This reshuffling process ensures the privacy of the user's original data, as the NN owner cannot reverse-engineer the private data from the reshuffled shared/transformed data. Likewise, the NN itself is reshuffled using the same shared cryptographic keys, ensuring that forward (and back propagation) calculations can still be correctly performed. Importantly, the operations—forward propagation (and back propagation)—proceed as if performed on the original private data and NN.

In this context, the term ‘NN owner’ refers to an agent responsible for executing the NN operations, including adjustments to the model architecture, hyperparameters, and data schemas. The system ensures that both the reshuffled data and reshuffled NN execute securely, preserving the zero-knowledge and zero-trust principles integral to the IDMP architecture.

Note that private data operates in untransformed space, whereas shared/transformed data operates in the shared, transformed space.

FIG. 25 shows the parties and steps involved in an exemplary forward propagation implementation, according to embodiments of the present invention. In the exemplary implementation of FIG. 25, a user requests to run a prediction without divulging their private data to the neural network (NN) owner. The flow sequence below is mirrored in FIG. 25:

### Setup in IDMP—to Build on Zero Trust, Zero Knowledge Security for Data in Customer Data Plane

1. Instantiate secure exclave (2536)
   a. The customer instantiates a pre-configured secure Exclave (2534).
   b. A system check is performed to validate that the Exclave is properly isolated, secured, and complies with Zero Knowledge and Zero Trust principles.
2. The user can initiate a session through the UX/UI interface client (2502), where a session-specific symmetric cryptographic keys (2506) are generated to encrypt data in a manner compliant with the latest cryptographic standards (e.g., FIPS). An exemplary symmetric key generation with secure storage (2504) for encryption of data at rest, data in transit encryption is described below.
   a. Key Generation compliant with latest security standards
      Typical examples for key generation for encrypting data involve two parties that establish a shared secret key over a public channel using the FIPS-203 Module-Lattice-Based Key-Encapsulation Mechanism (ML-KEM) protocol. If implementations of this protocol aren't available in a FIPS-compliant compute environment, fallback to the earlier federal standard for public shared establishment of a shared private secret, Elliptic Curve Diffie-Hellman (ECDH) will also work when computed over a FIPS-186 elliptic curve.
      ML-KEM and ECDH are both resistant to quantum cryptanalysis in different ways. ML-KEM is preferred for its lattice-based approach to quantum resistance, which can reinforce its security model in the event that an attacker to the system has access to a scalable quantum computer.
      Either key establishment and encapsulation mechanism ensures that neither the data owner nor the neural network (NN) owner has unilateral control over the key generation process, preserving the Zero Knowledge potential with Zero Trust assurances.
   b. Secure Key Distribution
      i. Both ML-KEM and ECDH approaches produce a shared secret that both parties have with strong referential integrity and non-repudiation security assurances. As such, the keys don't need to be distributed to parties for this approach to function.
      ii. If the Neural Network owner wants to share the network with a third party, that party will also need to know the shared secret initially developed between the first two parties. For this exchange of shared secret material to be safe, its transit over all networks must be encrypted in transit. Distribution is handled through an end-to-end encrypted and authenticated channel, ensuring secure delivery to the intended parties. This safe transit is ensured by a socket layer protocol such as TLS 1.2 when using FIPS-approved implementations of DISA-approved cryptographic algorithms: AES-256 for block ciphers, ECDSA for authentication, and SHA-2 for any message digest needs around safe transit of data.
   c. Secure Key Storage
      Both the data owner and the NN owner store their respective keys in a secure manner, using a key management service (KMS) running on a computing system equipped with a hardware security module (HSM) within their isolated environments.
   d. Key Validation
      Both the data owner and NN owner validate their keys using their respective systems, ensuring the keys meet the applicable cryptographic standards such as FIPS-203 or FIPS-186.
3. Initialize a copy of the baseline pre-trained NN (2524)
   a. E.g., a baseline classifier NN trained on metadata to predict task duration based on action logs
4. Data preparation (2552), performed by a separate data owner agent
   a. Provide pre-processed input data (pre-vectorized input data) in exclave or linked securely to exclave

### Share ‘Transformation Compatibility Data’ for Privacy Preserving Approach

5. Data owner agent (through client) exchanges details (2512) with the NN agent (in exclave), with all data exchange utilizing the shared cryptographic keys for encrypting data in transit.
   a. Dimensions of the expansion of the input data
   b. Location of the bias vector and unit vector
   c. Option for the true activation function (optional)
   d. Level for multi-variate activation at each layer (1 in the case of univariate)
The agreed upon details are shared back with the data owner agent from the client.
6. Data owner agent generates random matrices r, \tilde{r} (2528).
   a. Random matrices are the private passwords that the data owner uses to create shareable versions of their otherwise private data.
   b. The dimensions of the random matrices are based on the transformation compatibility data exchanged during setup—that depends on the dimensions of the input data and the dimensions of expansion agreed upon with the NN owner.
   c. The data owner may utilize a random number generator in order to create the individual data entries within the random matrices. In various embodiments, the data owner may utilize a secure user interface to provide a seed input to the random number generator which is used to generate the random matrices r, \tilde{r}.
7. The NN agent receives the transformation compatibility data (2518).

### Transformation of Input Data and NN Network to Create ‘Shared’ Versions

8. NN owner to expand their weights, biases, activation function and cost function (2520)
   a. NN owner uses the agreed upon dimensions for expansion, which are shared with the data owner, to transform their weights and biases into an expanded block format. (See example of Eqn. (B6) in the section “Embodiment 2: Proof of Matrix Operations,”.)
9. Setup NN agent in exclave with the ‘shared/transformed’ version of the neural net (Alternately, can be a separate exclave in NN data plane in a multi-tenancy example) (2538)
   a. The customer instantiates a copy of the reshuffled Istari Neural Network agent within a pre-configured secure Exclave.
   b. Securely transmit session-specific configurations of the reshuffled neural network, such as model architecture, hyperparameters, and data schemas, to the Exclave using encrypted communication channels.
10. In an alternate embodiment, a pre-trained NN in the NN agent is transformed using the transformation compatibility data (2540).
11. Data owner expands the input (2544) using (r, \tilde{r}) and generates v̌₁, σᵢ (the expanded transformed activation function and bottom component of v̌ᵢ (Refer to the description of Eqn. (B50)), then shares with the ‘transformed’ NN agent within the exclave. (See the example steps of Eqns. (B7), (B16) and (B17).) (All references to equation numbers herein refer to equation numbers in the section “Embodiment 2: Proof of Matrix Operations,” and are quoted here for convenience of the reader.)
   The input owner may do similarly:

$${\check{v}}_{i} = {e}^{{\hat{v}}_{i} {\hat{r}}_{i , v}} = {( \begin{matrix}{e}^{{v}_{i}} \\ {e}^{- {\tilde{r}}_{i , v}} \\ e\end{matrix} )}^{{\hat{r}}_{i , v}} , \qquad ( B16 )$$

where \hat{r}_{i,v}, is performing an element-wise exponential and \tilde{r}_{i,v} and e=e1 are both row vectors of dimension col dim(v̌₁).
   Like before, preserving normal row-column matrix multiplication requires a new operation:

$${( {W}_{i , A} {⊗}_{0}^{T} {\check{v}}_{i} )}_{j > row dim {W}_{i , A} , k} = ln {\check{ν}}_{i , col k}^{T} {⊗}_{0} {W}_{i , A , row j}^{T} ,$$

where we adopt the following notation:

$${r}_{i , z} = {r}_{i , v} , {\tilde{r}}_{i , z} = {\tilde{r}}_{i , v} . \qquad ( B17 )$$

12. NN agent with ‘transformed’ neural network propagates the ‘transformed’ input data to compute the

$${e}^{R ( {v}_{N} )}$$

in the final layer (2542), as shown in Eqn. (B50).
   The input owner then generates v̌₁, σ̌ᵢ, and the bottom component of v̌_{i>1} and provides them to the network owner. The network owner propagates to the final output

[symbol]

$${N - 1}_{} ( ( \begin{matrix}{w}_{N - 1} & I & {b}_{N - 1} \\ 0 & 0 & 1\end{matrix} ) ⊗ {( \begin{matrix}{e}^{{v}_{N - 1}} \\ {e}^{- {\tilde{r}}_{N - 1 , v}} \\ e\end{matrix} )}^{{\hat{r}}_{N - 1 , v}} ) = {e}^{ℛ ( {v}_{N} )} , \qquad ( B50 )$$

The transformed output is presented as a matrix data structure with floating point elements.
13. Once the transformed output is shared with the data owner agent (2546), the data owner agent applies R⁻¹ to obtain the untransformed (true) output v_{N,A}. The data owner may subsequently use this untransformed, private output for any purpose, including display, download, further computation. See example below:
   The neural network owner may then return this private output to the input owner, who may apply R⁻¹∘ ln to attain v_{N,A}, without any knowledge of the neural network weights and biases.

### Alternate Embodiment of Transformed Neural Network (NN Agent Exclave Operations)

An alternate sub-embodiment of Embodiment 2 involves the use of shared/transformed NN, where the NN owner generates their private transformation keys to transform their NN into the transformed space, so that the data owner may use their transformed input data to perform computations. In this sub-embodiment, the transformation step in 8 (2520) will be different and may include the following steps as the Neural network is reshuffled further to preserve its privacy:
a. NN owner expands the weights and biases using block matrices to create an expanded matrix, with block dimensions, consistent with the location of the bias vector and unit vector in the modified input. (See example in Eqns. (B8) and (B12).)
b. NN further exponentiates the modified block Weight matrix (See Eqn. (B14)).
c. Define a new transformation operator to consistently handle the exponentiated, expanded weight matrix (See Eqn. (B15)):
d. NN owner also creates the modified activation function using r, \tilde{r}, and σ̌. This step is central to the idea of building the privacy preserving method that begins with the non-linear activation functions. In some examples, the NN owner utilizes the true activation function pre-agreed with the data owner.
e. NN owner exponentiates the activation function \hat{σ} that accepts affine transformations further into the transformed activation function σ̌ (see Eqns. (B18) and (B19)):
f. NN owner creates a Taylor series of the transformed activation function. In other embodiments, other polynomial transformations can be utilized (e.g., Laplace transform, Fourier series expansion). NN can thus share the coefficients of the series without divulging the specific activation function or its modified form.
g. In an alternate embodiment with multivariate expansions, the Taylor series coefficients are themselves series functions such as Bell polynomials. The Bell polynomial coefficient shared can present an additional layer of privacy for the neural network's activation function and the modifications to the weights and biases.
h. The final layer activation function is additionally transformed in order to preserve privacy. (See Eqn. (B38)).
i. NN owner also performs corresponding operations on the cost function (similar to the activation function changes) so that the modified cost function can correctly compute using the modified.
j. NN owner defines a specific data operation for the modified weights and biases matrix, to operate on the modified shared version of the input data.

### Privacy-Preserving Function Transformation Measures (Activation Functions, Cost Functions, Loss Functions, Error Functions)

The various privacy preserving options in these embodiments are illustrated in 1908, within FIG. 19. As a summary, these can include:
1. Use of a selection of invertible matrices (e.g., left or right matrices) for operations such as expansion, row/column permutations, random matrix multiplication, and exponentiation
2. Use of modified activation functions that work on affine transformations in hidden layers
3. Using Taylor series and Bell polynomials in data privacy offers a method for approximating and securing complex functions in neural network computations.
   a. The Taylor series allows for efficient processing by simplifying non-linear functions, yet it lacks inherent data obscurity, making it vulnerable to pattern-based attacks since data relationships remain visible.
   b. Bell polynomials extend this to multivariate cases, capturing interactions between variables, but without added entropy, they still expose patterns that could be exploited.
4. For stronger privacy, introducing a reversible entropy component to either approach could better disguise data relationships, balancing computational efficiency with improved security.

Note that various series expansions are within the scope of the current invention. The Taylor series is one embodiment of a series expansion. Various series expansions are within the scope of the current invention. Similarly, various invertible entropy components and bounded entropy components and/or noise functions are within the scope of the current invention.

Tables 2 and 3 below detail some of the key steps carried out by the data owner and the NN owner for various alternatives of Embodiment 2.

### Sub-Embodiment 2A: Shared Data

In various embodiments involving the use of a neural network (NN), the data owner may wish to utilize their proprietary data as input or as part of a training dataset for the NN, while maintaining data sovereignty and privacy. Specifically, the data owner does not wish to share the true, untransformed data directly with the NN owner.

FIGS. 26-28 show some of the steps involved to maintain data sovereignty and privacy when the data owner uses their proprietary data as input, training, or context data for the neural network, according to one embodiment of the present invention. These figures outline a sub-embodiment focused on the use of “shared/transformed data.” Here, “shared/transformed data” refers to transformed input data that the data owner can securely share with the NN owner. This transformation ensures that the untransformed, original data remains confidential, while allowing the transformed NN to process the transformed inputs consistently.

### Correspondence Between Untransformed and Transformed Spaces (FIG. 26)

FIG. 26 shows some of the steps involved to maintain data sovereignty and privacy when the data owner uses their data as input, training, or context data for neural network computations, according to one embodiment of the present invention. Specifically, FIG. 26 illustrates the correspondence between the untransformed (true) space and the transformed space across various components of the NN. These include:
Input Data: The untransformed input vector (2602) is transformed into the transformed input vector (2604) through the sequential steps shown in 2608, which include:
   1. Expansion with a random matrix.
   2. Multiplication with another random matrix.
   3. Term-wise exponentiation of the result.
Alternatively, the term-wise exponentiation may be replaced by matrix exponentiation in other embodiments.
NN Parameters: The untransformed NN (2612) is transformed into the transformed NN (2614) using transformation setup data. The transformation includes expanding the NN's parameters to match the dimension of the transformed input data. This is achieved through identity block matrices (2616) that ensure compatibility with the expanded input dimensions.
Activation Functions: The untransformed non-linear activation functions (2618) are converted into transformed activation functions (2620) using steps such as 2622:
   1. Expanding the activation function in an exponential form.
   2. Adding terms to address singularities, ensuring the activation function remains continuously differentiable.
   3. Incorporating bounded, finite differentiable noise for additional privacy.
      The transformed activation function can then be represented as a Taylor series or a similar series, with options to include higher-order multivariate terms for the coefficients.

### NN Computations in Transformed Space (FIG. 26)

In the untransformed space, NN computations (2624) involve applying non-linear activation functions to each hidden layer node, where the function arguments are computed using affine matrix operations (2628) involving the hidden layer inputs, weights, and bias matrices.

To preserve the integrity of the original NN computations, a transformation operator (2632) is defined. This operator ensures that the computations performed in the transformed space (using the transformed NN and transformed input data) yield equivalent results to those performed in the untransformed space.

FIG. 25 shows additional steps involved to maintain data sovereignty and privacy when the data owner uses their data as input, training, or context data for neural network computations, according to one embodiment of the present invention. Specifically, FIG. 27 continues the sequence of steps outlined in FIG. 26, highlighting distinctions between operations in the untransformed (true) space and the transformed space. A key difference lies in how functions are computed in these spaces:
In the untransformed space, non-linear activation functions (2704) are shared directly with the data owner and applied term-wise to the hidden layer inputs during forward propagation.
In the transformed space, the transformed activation functions (2706) are shared as series coefficients and computed using polynomial series operations. These transformed activation functions may also include bounded, differentiable noise functions to enhance the privacy of the untransformed activation functions.

### Forward Propagation Operations

With the definitions of data, functions, and operations established, forward propagation in the untransformed space 2708 involves applying activation functions to the affine transformations of the hidden layer inputs (2712), proceeding sequentially through all layers until the output layer. At the final layer, the untransformed output is produced and can be used directly. The untransformed NN remains unchanged at the end of the forward propagation operation (2716).

Forward propagation in the transformed space (2720) uses the transformed activation functions acting on the transformed hidden layer inputs (2714). These inputs are computed from the transformed NN 2614 and transformed input data (2604) using the transformation operator 2626. At the final layer, the result is a transformed output, which is shared with the data owner. The data owner, holding the private transformation key, decrypts the transformed output to obtain the untransformed true output. Similar to the untransformed space, the transformed NN remains unchanged at the end of forward propagation (2718).

### Backpropagation Operations

FIG. 26 shows additional steps involved to maintain data sovereignty and privacy when the data owner uses their data as input, training, or context data for neural network computations, according to one embodiment of the present invention. Backpropagation in both spaces adjusts weights and biases based on training and target datasets. The process relies on the computation of a cost function and its gradient with respect to the error, which is propagated through the hidden layers to tune the NN. Backpropagation in the untransformed space (2720) adjusts the untransformed weights and biases of the NN using the untransformed training dataset and target dataset 2804. Backpropagation in the transformed space (2722) adjusts the transformed weights and biases based on the transformed training dataset and transformed target dataset 2806.
Cost Function:
   In the untransformed space, the cost function (2808) is shared directly with the data owner.
   In the transformed space, the transformed cost function (2810) is shared by the data owner as floating-point coefficients of a series function. These coefficients may include bounded differentiable noise functions to preserve the privacy of the untransformed cost function.
NN updates during backpropagation steps:
   Untransformed space backpropagation (2812) directly updates the NN weights and biases using the untransformed training dataset and target dataset.
   Transformed space backpropagation (2814) in the transformed space can involve locked training in certain embodiments and unlocked training in other embodiments:
      1. In locked cases, all transformed training data are used to update the transformed NN weights and biases.
      2. In other cases of unlocked training, the NN owner may restrict training of the transformed NN and, in a pre-agreed manner, exchange additional transformation keys to enable updates based on select transformed training data only.
   End state after backpropagation:
      At the end of backpropagation in the untransformed Space (2816), the trained NN and its untransformed true outputs are ready for immediate use.
      At the end of backpropagation in the transformed Space (2818), the transformed NN must be de-transformed by the NN owner. This involves reversing the exponentiation, permutation, and expansion steps to obtain the untransformed trained NN. Similarly, the transformed outputs must be de-transformed by the data owner to recover the untransformed true outputs.

Table 4 provides a detailed set of steps performed in the embodiment 2, sub-embodiment for shared/transformed data as described in FIG. 25. As shown below, there are a coordinated set of actions that the data owner and the NN owner must take at the setup, to ensure secure data transfers and for ensuring transformation compatibility. Further in the shared/transformed data sub-embodiment, the data owner takes additional steps to transform their input data so as to perform forward propagation and backward propagation operations in the transformed NN such that the data owner protects the privacy of their untransformed data, while the NN owner does not share any of their untransformed NN details.

TABLE 4
Sub-Embodiment 2A Process: Shared/Transformed Data

| Data Owner | NN Owner |
|---|---|
| Data owner setup steps | NN owner setup steps |
| 1. Initiate secure session in client for providing | 1. Pre-processing-Pre-trained private NN |
| ‘shared/transformed’ input or training data to | available in a secure database |
| private NN. A secure session includes secure | 2. Symmetric key generated by client, |
| internet connection protocols such as secure | distributed to NN owner in enclave |
| http, e.g., https://. | 3. Enclave sets up secure exclave for NN agent |
| 2. Symmetric key generation from client, | |
| distributed to data owner agent in customer | |
| data plane | |
| Data owner exchanges shared/transformed | NN owner exchanges shared/transformed data |
| data setup information | setup information |
| 3. Data owner agent exchanges | 1. NN agent in enclave receives |
| shared/transformed data sharing setup | shared/transformed data sharing information |
| information ( | from data owner agent |
| a. Dimension of expansion | 2. Initialize a copy of the baseline pre-trained |
| b. Location of bias and unit vector | NN from the secure database in the exclave |
| c. Multivariate activation at each layer | for the NN agent |
| d. Choice of true activation function) | 3. Based on exchanged information, expand the |
| 4. Prepare input data and training data | NN weights and bias matrices (Eqn. (B7)) |
| (pre-vectorized input data or training data) | |
| Data owner privacy preserving steps | (None) |
| 1. Data owner agent generates random matrices | |
| r, \tilde{r} (does not share with NN owner) | |
| 2. Data owner adds privacy protection to the | |
| input data through expansion, random | |
| multiple and exponentiation: | |
| a. Expansion, random multiple: Expand the | |
| columns of input vector υ_{1,A} with | |
| spurious data in block matrix υ_{1,B}, | |
| permute columns and multiply by | |
| random matrix r_{i,v} element-wise (Eqn. | |
| (B9)) (Note: column permutation and | |
| r_{1,v} preserve the augmented matrix | |
| form) | |
| b. No expansion, random multiple: In some | |
| embodiments, the column expansion and | |
| column permutation is not done and only | |
| the multiplication with random matrix is | |
| done (Simplified version of Eqn. (B13)) | |
| c. Exponentiation: The expanded data from | |
| step 6 (or 7) is augmented with rows for | |
| \tilde{r}_{i,v} and a row vector, then exponentiated | |
| term-wise as in (Eqn. (B16)) | |
| d. Preserve true matrix multiplication: | |
| Define special operator so true matrix | |
| multiplication is preserved in | |
| exponentiated input data (Eqn. (B17)) | |
| 3. Data owner adds privacy protection to hidden | |
| layer activation functions | |
| a. Define a transformed version of the true | |
| activation function (e.g., example of | |
| exponential form as shown in Eqn. (B18) | |
| chosen so that Taylor expansion is well | |
| defined) | |
| b. Expand using a Taylor series about a | |
| point z̆ᵢ | |
| i. Other polynomial series such as | |
| Fourier or Laplace are applicable, but | |
| may have the privacy measures may | |
| be less | |
| ii. Laurent series, Maclaurin series are | |
| also applicable | |
| c. Compute Taylor series coefficients | |
| utilizing Bell polynomials (Eqn. (B28)) | |
| d. Add further privacy measure by selecting | |
| a multivariate case of Bell polynomials | |
| to define the individual Taylor series | |
| coefficients | |
| e. Note: | |
| i. exponentials and logarithms for | |
| defining transformed activation | |
| functions in Eqn. (B18) are chosen | |
| for ease of computation, and other | |
| functions are applicable | |
| ii. Transformed activation function | |
| acting on affine transformation of | |
| input, same as true activation | |
| function acting on true hidden layer | |
| inputs | |
| 4. Data owner adds additional privacy to the | |
| transformed activation function through the | |
| use of bounded, infinitely differentiable noise | |
| functions | |
| 5. Partial Weierstrass function is a good | |
| example of such a noise function (Eqn. | |
| (B60)) | |
| 6. Data owner adds or multiplies σₛₘₒₒₜₕ (z) by | |
| functions such as Eqn. (B60) to introduce | |
| variability at arbitrarily small intervals | |
| without affecting macro-activation properties | |
| 7. Data owner selects the R function so the | |
| inverse aligns with r (Eqn. (B40)) where | |
| error transformation key \tilde{R} alone is | |
| exchanged with NN owner | |
| Data owner shared/transformed data sharing | Receive |
| steps | |
| 1. Forward propagation: Data owner shares | |
| three pieces of shared/transformed data with | |
| NN agent in exclave: transformed input data, | |
| transformed activation function and bottom | |
| components of transformed hidden layer | |
| inputs | |
| 2. Data owner generates expanded, | |
| exponentiated input ῠ₁, | |
| 3. Generates series-expanded transformed | |
| activation function and shares coefficients or | |
| Bell polynomials for σ̆ᵢ for all hidden layers | |
| 4. Shares the bottom component of ῠ_{i>1} | |
| Receive | NN owner performs data operations with |
| | shared/transformed data |
| | 1. NN agent in exclave receives the |
| | shared/transformed data, transformed |
| | activation function coefficients and the bottom |
| | component of ῠ_{i>1} |
| | 2. NN agent in exclave uses expanded |
| | weights,biases and special math operator to |
| | propagate transformed input data to generate a |
| | transformed version of output (Eqn. (50)) |
| | 3. NN agent in exclave shares transformed |
| | version of output with data owner agent [symbol] |
| Data owner output extraction | (None) |
| 1. Data owner receives transformed version of | |
| output from NN owner after propagation by | |
| NN agent (Data owner does not have access to | |
| these steps on LHS of Eqn. (B50)) | |
| 2. Data owner applies R⁻¹ to obtain private | |
| version of output from the transformed | |
| version shared by NN agent | |
| Additional steps for Back propagation | NN owner performs backpropagation data |
| 1. Share target data: | operations with shared transformed target data |
| Data owner shares transformed target data | 1. Transformed target data: NN owner uses |
| t̆^{< m>} = [symbol] , and shares with NN | t̆^{< m>} and their calculated output in the |
| owner in the exclave. | final layer to compute the error estimation |
| | at the last layer, instead of first computing |
| | the output and then separately doing the |
| | computation for error |
| Share transformed cost functions as floating point | Transformed cost functions as |
| coefficients: | series coefficients: |
| Input owner calculates Taylor series expansions of | NN owner agent receives the transformed cost |
| multivariate transformed cost functions with | functions as floating point coefficients, along |
| floating point coefficients | with the transformation operator to |
| | use element-wise products to treat vector |
| | elements from multivariate transformed |
| | functions as individual elements |
| | use a new element-wise product definition for |
| | components of multivariate transformed |
| | vector elements |
| | compute partial derivatives using the Taylor |
| | series expansions |
| | remove excess diagonalized or null tensor |
| | dimensions |
| (None) | Training of transformed neural network: |
| | Beginning with the final output layer, the |
| | gradient of the cost function with respect to |
| | the final weight and biases is calculated |
| | (Eqns. (B50-B52)) |
| | Unlocked training: |
| | When transformed NN is unlocked, the |
| | transformed target data set and transformed |
| | input training data from the data owner is used |
| | to propagate the gradients to the transformed |
| | weights and biases and update the transformed |
| | NN in the exclave. |
| | The NN owner performs no matrix expansions |
| | and the data input owner selects r matrices |
| | such that no obscuring elements need to be |
| | divided out. |
| | Business use case: |
| | Example deployment of Model as a service, where |
| | data owners have use of the model and in turn |
| | contribute training data in a privacy |
| | preserving manner |
| | Locked training: |
| | When the NN owner has performed matrix |
| | expansions and the data input owner also has |
| | r matrices to add obscuring elements in |
| | term-wise products, the transformed NN is |
| | locked for training. The NN owner can not |
| | update the transformed weights and biases and |
| | need to exchange additional transformation |
| | keys for decryption steps with the input data |
| | ownerBusiness use case: Example deployment |
| | of Model as a service, where the data owner |
| | may want to limit the amount of training data |
| | added to train the transformed NN |
| | When transformed NN is locked, the gradient of |
| | transformed cost function with respect to the |
| | weights and biases is calculated using the |
| | transformed target data set and transformed |
| | input training data from the data owner. The |
| | end result is an encrypted gradient (Eqn. |
| | (B52)) |
| 2. Partial decryption of Locked NN | 1. Exchange of encrypted (detransformation) |
| gradients: | Locked NN gradients: NN owner |
| Data owner receives Eqn. (B52) and right | exchanges encrypted gradients of |
| multiples with decryption keys (r | transformed weights and biases (Eqn. |
| matrices) for each hidden layer to | (B52)) for each hidden layer with the data |
| compute Eqn. (B53) | input owner |
| 3. Data owner sents Eqn. (B53) to send to | 2. Decryption of partially decrypted locked |
| NN owner | NN gradient: NN owner receives Eqn. |
| | (B53), then left multiplies by the inverse |
| | of error transformation key R matrix in |
| | each layer to obtain true gradients of the |
| | transformed NN |
| | Compute true updates to weights and biases of |
| | transformed NN: In both locked and unlocked |
| | cases, the NN owner assigns a learning rate |
| | for each hidden layer to then compute the true |
| | updates based on the gradients of cost |
| | function with respect to the weights and biases |
| | NN agent in the exclave performs the inverse |
| | steps to remove the extra expansions, |
| | permutations and recover the updated true |
| | trained NN weights and biases from the |
| | transformed NN weight and biases. The true |
| | updated weights and biases are walled off |
| | from the data owner, but shared back with the |
| | NN agent in the enclave and also stored as a |
| | secure copy in the true NN database. |

### Sub-Embodiment 2B: Shared NN

In this alternative of Embodiment 2, the data owner receives from the NN owner, or from a NN agent exclave, a transformed/shared NN, including a transformed weights and biases matrix, transformed activation and cost functions, as well as a transformation operator for both forward and back propagation.

FIGS. 29-31 show some of the steps involved to maintain data sovereignty and privacy when the model owner shares elements of their model, according to one embodiment of the present invention. These figures outline a sub-embodiment focused on the use of “shared/transformed NN.” Here, “shared/transformed NN” refers to transformed NN data that the NN owner can securely share with the data owner. This transformation ensures that the untransformed, original NN remains confidential, while allowing the transformed NN to process the transformed inputs consistently.

### Correspondence Between Untransformed and Transformed Spaces (FIG. 29)

FIG. 29 shows some of the steps involved to maintain data sovereignty and privacy when the neural network model owner shares elements of their model, according to one embodiment of the present invention. Specifically, FIG. 29 illustrates the correspondence between the untransformed (true) space and the transformed space across various components of the NN. These include:
Input Data: The untransformed input vector (2906) is transformed into the transformed input vector (2908) through the sequential steps shown in 29, which include:
   1. Expansion with an extra unity term
   2. Multiplication with another random matrix.
   3. Term-wise exponentiation of the result.
      Alternatively, the term-wise exponentiation may be replaced by matrix exponentiation in other embodiments.
NN Parameters: The untransformed NN (2914) is transformed into the transformed NN (2916) using through the sequential steps shown in 2718, which include:
   1. Combining the NN's parameters at each layer into a single block matrix, which will match the dimension of the transformed input data
   2. Expansion of the block matrix form further with row-only expansions using additional random matrices
   3. Row permutation of the resulting block matrix
   4. Left multiplication by a random block matrix.
   5. Exponentiation of the result
      Alternatively, the term-wise exponentiation may be replaced by matrix exponentiation in other embodiments.
Activation Functions: The untransformed non-linear activation functions (29) are converted into transformed activation functions (2922) using steps such as 29:
   1. Expanding the activation function in an exponential form.
   2. Adding terms to address singularities, ensuring the activation function remains continuously differentiable.
   3. Incorporating bounded, finite differentiable noise for additional privacy.
      The transformed activation function can then be represented as a Taylor series or a similar series, with options to include higher-order multivariate terms for the coefficients. In the shared/transformed NN use case, the NN owner computes the transformed NN parameters and shares with the data owner.

### NN Computations in Transformed Space (FIG. 29)

In the untransformed space, NN computations (2926) involve applying non-linear activation functions to each hidden layer node, where the function arguments are computed using affine matrix operations (29) involving the hidden layer inputs, weights, and bias matrices.

To preserve the integrity of the original NN computations, a transformation operator (2928) is defined. This operator ensures that the computations performed in the transformed space (using the transformed NN and transformed input data) yield equivalent results to those performed in the untransformed space, with an example shown in FIG. 29.

FIG. 30 shows additional steps involved to maintain data sovereignty and privacy when the neural network model owner shares elements of their model, according to one embodiment of the present invention. Specifically, FIG. 30 continues the sequence of steps outlined in FIG. 29, highlighting distinctions between operations in the untransformed (true) space and the transformed space. A key difference lies in how functions are computed in these spaces:
In the untransformed space, non-linear activation functions (3004) are shared directly with the data owner and applied term-wise to the hidden layer inputs during forward propagation.
In the transformed space, the transformed activation functions (3006) are shared as series coefficients and computed using polynomial series operations. These transformed activation functions may also include bounded, differentiable noise functions to enhance the privacy of the untransformed activation functions.

### Forward Propagation Operations

With the definitions of data, functions, and operations established, forward propagation in the untransformed space 3008 involves applying activation functions to the affine transformations of the hidden layer inputs (3012), proceeding sequentially through all layers until the output layer. At the final layer, the untransformed output is produced and can be used directly. The untransformed NN remains unchanged at the end of the forward propagation operation (3016).

Forward propagation in the transformed space (3010) uses the transformed activation functions acting on the transformed hidden layer inputs (3014). These inputs are computed from the transformed NN 2916 and transformed input data (2908) using the transformation operator 2928. At the final layer, the result is a transformed output, which is shared with the data owner. The data owner, holding the private transformation key, decrypts the transformed output to obtain the untransformed true output. Similar to the untransformed space, the transformed NN remains unchanged at the end of forward propagation (3018).

### Backpropagation Operations

FIG. 31 shows additional steps involved to maintain data sovereignty and privacy when the neural network model owner shares elements of their model, according to one embodiment of the present invention. Backpropagation in both spaces adjusts weights and biases based on training and target datasets. The process relies on the computation of a cost function and its gradient with respect to the error, which is propagated through the hidden layers to tune the NN. Backpropagation in the untransformed space (3020) adjusts the untransformed weights and biases of the NN using the untransformed training dataset and target dataset 3104. Backpropagation in the transformed space (3022) adjusts the transformed weights and biases based on the transformed training dataset and transformed target dataset 3106.
Cost Function:
   In the untransformed space, the cost function (3108) is shared directly with the data owner.
   In the transformed space, the transformed cost function (3110) is shared by the NN owner as floating-point coefficients of a series function. These coefficients may include bounded differentiable noise functions to preserve the privacy of the untransformed cost function.
NN updates during backpropagation steps:
   Untransformed space backpropagation (3112) directly updates the NN weights and biases using the untransformed training dataset and target dataset.
   Transformed space backpropagation (3114) in the transformed space can involve locked training in certain embodiments and unlocked training in other embodiments:
      1. In locked cases, all transformed training data are used to update the transformed NN weights and biases.
      2. In other cases of unlocked training, the data owner may restrict training of the transformed NN using their input data and, in a pre-agreed manner, exchange additional transformation keys to enable updates based on select transformed training data only.
End state after backpropagation:
   At the end of backpropagation in the untransformed Space (3116), the trained NN and its untransformed true outputs are ready for immediate use.
   At the end of backpropagation in the transformed Space (3118), the transformed NN must be de-transformed by the NN owner. This involves reversing the exponentiation, permutation, and expansion steps to obtain the untransformed trained NN. Similarly, the transformed outputs must be de-transformed by the data owner to recover the untransformed true outputs.

Table 5 provides a detailed set of steps performed in the embodiment 2, sub-embodiment for shared/transformed NN. As shown below, there is a coordinated set of actions that the NN owner and the data owner must take at the setup, to ensure secure data transfers and for ensuring transformation compatibility. Further in the shared/transformed NN sub-embodiment, the NN owner takes additional steps to transform their input NN so that the data owner is able to perform forward propagation and backward propagation operations in the transformed NN such that the NN owner protects the privacy of their untransformed NN details, while the data owner is able to perform the correct computations.

Exemplary embodiments of transformed neural network (NN) operations, such as the “Shared data” use case in Table 4 and the “Shared NN” use case in Table 5, demonstrate distinct examples of mutually invertible, ordered-pair transformation operators. In FIG. 26, corresponding to the shared data use case, transformation operators 2626 and 2632 illustrate how exponentiated input data is first transposed, then converted using a logarithm, and computed from the left. This preserves the integrity of the original NN operations in their untransformed state.

Similarly, in FIG. 29, which relates to the shared NN use case, transformation operators 2928 and 2932 demonstrate how exponentiated input data is converted via a logarithm applied on the right. These transformation operator examples highlight that the choice of operator depends on whether the data owner or the NN owner generates the shared, transformed versions of their proprietary data.

FIG. 34 illustrates exemplary forward propagation operations involving a transformed NN. Similarly, FIGS. 35, 36, and 37 illustrate exemplary backpropagation operations involving a transformed NN.

TABLE 5
Sub-Embodiment 2B Process: Shared/Transformed NN

| Data Owner | NN Owner |
|---|---|
| Data owner setup steps | NN owner setup steps |
| 1. Initiate secure session in client for | 1. Pre-processing-Pre-trained private NN |
| evaluating private input or training data | available in a secure database |
| using a shared/transformed NN. A secure | 2. Symmetric key generated by client, |
| session includes secure internet | distributed to NN owner in enclave |
| connection protocols such as secure http, | 3. Enclave sets up secure exclave for NN |
| e.g., https://. | agent |
| 2. Symmetric key generation from client, | |
| distributed to data owner agent in | |
| customer data plane | |
| Data owner exchanges shared/transformed | NN owner exchanges shared/transformed data |
| data setup information | setup information |
| 1. Data owner agent exchanges | 1. NN agent in enclave receives |
| shared/transformed data sharing setup | shared/transformed data sharing information |
| information ( | from data owner agent |
| i. Dimension of expansion | 2. Initialize a copy of the baseline pre-trained |
| ii. Location of bias | NN from the secure database in the exclave |
| iii. Multivariate activation at each layer | for the NN agent |
| iv. Choice of true activation function) | 3. Based on exchanged information, expand the |
| 2. Prepare input data and training data | NN weights and bias matrices (Eqn. (B7)) |
| (pre-vectorized input data or training data) | |
| (None) | NN owner privacy preserving steps |
| | 1. NN owner agent generates random matrices r |
| | and \tilde{r} (does not share with data owner) |
| | 2. NN owner adds privacy protection to the |
| | private NN through expansion, random |
| | multiple and exponentiation: |
| | a. Expansion, random multiple: Expand the |
| | rows of the transformed augmented |
| | weight matrix W_{i,A} with spurious data in |
| | block matrix W_{1,C}, permute rows and left |
| | multiply by random block matrix \hat{r}_{i,W} |
| | element-wise (Eqn. (B8)) (Note: row |
| | permutation and \hat{r}_{i,W} preserve the |
| | augmented matrix form of weights and |
| | biases, such that the transformed matrix |
| | operations can be correctly performed) |
| | b. No expansion, random multiple: In some |
| | embodiments, the row expansion and row |
| | permutation is not done and only the left |
| | multiplication with random block matrix |
| | is done (Simplified version of Eqn. (B13)) |
| | c. Exponentiation: The expanded weights |
| | and bias matrix from step 13, then |
| | exponentiated term-wise as in |
| | (Eqn. (B14)) |
| | d. Preserve true matrix multiplication: |
| | Define the specific transformation |
| | operator so true matrix multiplication is |
| | preserved in exponentiated NN weights |
| | and bias matrix (Eqn. (B15)) |
| | 3. NN owner adds privacy protection to hidden |
| | layer activation functions and cost functions |
| | a. Define a transformed version of the true |
| | activation function (e.g., example of |
| | exponential form as shown in Eqn. (B18) |
| | chosen so that Taylor expansion is well |
| | defined) |
| | b. Expand using a Taylor series about a |
| | point z̆i |
| | i. Other polynomial series such as |
| | Fourier or Laplace are applicable, but |
| | may have the privacy measures may be |
| | less |
| | ii. Laurent series, Maclaurin series are |
| | also applicable |
| | c. Compute Taylor series coefficients |
| | utilizing Bell polynomials (Eqn. (B28)) |
| | d. Add further privacy measure by selecting |
| | a multivariate case of Bell polynomials to |
| | define the individual Taylor series |
| | coefficients |
| | e. Note: |
| | i. exponentials and logarithms for |
| | defining transformed activation |
| | functions in Eqn. (B18) are chosen for |
| | ease of computation, and other |
| | functions are applicable |
| | ii. Transformed activation function acting |
| | on affine transformation of input, same |
| | as true activation function acting on |
| | true hidden layer inputs |
| | 4. NN owner adds additional privacy to the |
| | transformed activation |
| | function through the |
| | use of bounded, infinitely differentiable noise |
| | functions. |
| | 5. Partial Weierstrass function is a good |
| | example of such a noise function (Eqn. |
| | (B58)) |
| | 6. NN owner adds |
| | or multiplies σₛₘₒₒₜₕ (z) by |
| | functions as Eqn. (B60) to introduce |
| | variability at arbitrarily small intervals |
| | without affecting macro-activation properties |
| (Receive) | NN owner shared/transformed NN sharing |
| | steps |
| | Forward propagation: |
| | 1. NN owner in the exclave shares three pieces |
| | of shared/transformed NN with the data |
| | owner agent in a separate exclave: |
| | shared/transformed NN weights and bias |
| | matrix, transformed activation function and |
| | transformed cost functions |
| | a. NN owner generates expanded, |
| | exponentiated Weights and bias block |
| | matrix as the transformed NN Wᵢ |
| | b. Generates series-expanded transformed |
| | activation function and shares coefficients |
| | or Bell polynomials for σ̆ᵢ for all hidden |
| | layers |
| | c. Generates series-expanded transformed |
| | activation function and shares coefficients |
| | or Bell polynomials for σ̆ᵢ for all hidden |
| | layers |
| (Receive) | NN operations in transformed space |
| | As part of transformation compatibility data, the |
| | NN owner exchanges the form of the |
| | transformation operator (Eqn. (B15)) with the data |
| | owner so they can perform the computations in the |
| | transformed space. The transformation operator |
| | includes the pair-wise inverse operations so the |
| | computations in the untransformed space are |
| | preserved. In some embodiments, the floating |
| | point representation of computations means that |
| | the operations are preserved up to an error |
| | threshold. Operations preserved up to an error |
| | threshold are deemed equivalent herein. |
| Data owner privacy preserving steps | (None) |
| Data owner selects the R function so the inverse | |
| aligns with r (Eqn. (B40)) where error | |
| transformation key \tilde{R} alone is exchanged with NN | |
| owner. R function allows data owner to compute | |
| the true output from expanded output. | |
| Data owner performs data operations with | |
| shared/transformed NN | |
| 1. Data owner agent in their exclave receives the | |
| shared/transformed NN, transformed | |
| activation function coefficients and | |
| transformed cost function coefficients | |
| 2. Data owner agent in their exclave uses the | |
| transformed NN weights and biases matrix, | |
| the transformed activation function and the | |
| transformation operator (Eqn. (B15)) to | |
| propagate the expanded input data (Eqn. (B6)) | |
| to generate an expanded, exponentiated | |
| version of the output e\hat{^{r}}N,υ{circumflex over (_{^{υ}})}^{N} in the output | |
| layer (as shown in Eqg. B55). The \hat{r}_{N,υ} term | |
| is known only to the NN owner as it is | |
| generated in the hidden layers using the | |
| transformed hidden layer inputs and the | |
| transformed activation functions. The data | |
| owner is unable to use the transformed output | |
| as-is and needs to coordinate de-transform | |
| steps with the NN owner. | |
| Data owner output extraction | |
| 1. Data owner agent in their exclave applies a | |
| private output transformation key [symbol] ₒᵤₜ | |
| exponentiated from the right to the | |
| transformed output term and shares the | |
| resulting locked transformed output with the | |
| NN owner agent e\hat{^{r}}N,υ{circumflex over (_{^{υ}})}^{N} [symbol] ^{out} | |
| | NN owner partially unlocks transformed |
| | forward propagation output |
| | In order to unlock the locked transformed output, |
| | the NN owner applies |
| | (\hat{r}_{N,υ})⁻¹ o ln, first applying a logarithm from |
| | left and then left-multiplying the inverse of the |
| | private transformation key for the last layer. NN |
| | owner creates the locked output \hat{υ}_{N} [symbol] ₒᵤₜ that is |
| | now locked only with the data owner's private |
| | output transformation key and sends back to the |
| | data owner. |
| Data owner output extraction | |
| Data owner applies [symbol] ⁻¹ₒᵤₜ from the right to obtain | |
| private untransformed version of the output from | |
| the transformed version shared by NN agent | |
| Additional steps for back propagation | |
| | NN owner shared/transformed NN sharing |
| | steps |
| | Forward propagation: |
| | 2. NN owner in the exclave shares three pieces |
| | of shared/transformed NN with the data |
| | owner agent in a separate exclave: |
| | shared/transformed NN weights and bias |
| | matrix, transformed activation function and |
| | transformed cost functions |
| | a. NN owner generates expanded, |
| | exponentiated Weights and bias block |
| | matrix as the transformed NN W̌ᵢ |
| | b. Generates series-expanded transformed |
| | activation function and shares coefficients |
| | or Bell polynomials for σ̌ᵢ for all hidden |
| | layers |
| | c. Generates series-expanded transformed |
| | activation function and shares coefficients |
| | or Bell polynomials for σ̌ᵢ for all hidden |
| | layers |
| Data owner performs backpropagation data | |
| operations with shared transformed NN data | |
| 1. Prepare transformed target data: | |
| a. Data owner uses training data set of | |
| υ̌ₘ, to generate transformed target | |
| data t̆^{< m>}, which is expanded in | |
| form to perform the computations in | |
| the transformed space with the | |
| transformed NN weights and biases, | |
| transformed activation and cost | |
| functions received from the NN | |
| owner. | |
| b. Data owner uses t̆^{< m>} and their | |
| calculated output in the final layer to | |
| compute the error estimation at the | |
| last layer | |
| Receive | Transformed cost functions with transformation |
| | operator for training operations: |
| | 1. NN owner agent shares the transformed cost |
| | functions as floating point coefficients, along |
| | with the transformation operator for training to |
| | a. use element-wise products to treat vector |
| | elements from multivariate transformed |
| | functions as individual elements |
| | b. use a new element-wise product definition |
| | for components of multivariate |
| | transformed vector elements |
| | c. compute partial derivatives using the |
| | Taylor series expansions |
| | d. remove excess diagonalized or null tensor |
| | dimensions |
| Training of transformed neural network by data | (None) |
| owner: Beginning with the final output layer, | |
| the gradient of the cost function with respect | |
| to the final weight and biases is calculated | |
| (Eqn. (B57)) | |
| Unlocked training: | |
| When transformed NN is unlocked, the | |
| transformed target data set and transformed | |
| input training data from the data owner is used | |
| to propagate the gradients to the transformed | |
| weights and biases and update the transformed | |
| NN in the data owner agent's exclave. | |
| In this case, the transformed NN owner includes | |
| no matrix expansions and the data input owner | |
| selects r matrices such that no obscuring | |
| elements need to be divided out. | |
| Business use case: Example deployment of | |
| Model as a service, where data owners have | |
| use of the model for use in their own settings, | |
| but do not know the true neural network | |
| Locked training: | |
| When the transformed NN includes matrix | |
| expansions and the data input owner also has | |
| r matrices to add obscuring elements in | |
| term-wise products, the transformed NN is | |
| locked for training. The NN owner can not | |
| update the transformed weights and biases and | |
| need to exchange additional transformation | |
| keys for decryption steps with the input data | |
| ownerBusiness use case: Example deployment | |
| if the training data owner wishes to use or | |
| provide now-fine tuned neural network as a | |
| service (Trained Model as a service) to others | |
| When transformed NN is locked, the data owner | |
| agent computes the gradient of transformed | |
| cost function with respect to the weights and | |
| biases using the transformed target data set | |
| and transformed input data. The end result is | |
| an encrypted gradient (Eqn. (B57)) | |
| (None) | Locked NN case-additional steps for decryption |
| | of partially decrypted locked NN gradient: |
| | NN owner chooses the use of Eqn. (B58) to |
| | combine learning rate with a decryption key |
| Decryption of Locked NN gradients: | (None) |
| Data owner receives input from NN | |
| owner that they used Eqn. (B58), so the | |
| data owner can use Eqn. (B59) to update | |
| weights in the transformed space subject | |
| to a congruence relation | |
| Data owner shares the updated weights and biases | Compute true updates to weights and biases of |
| of the now-trained transformed NN with the NN | transformed NN: |
| owner agent in their exclave | In both locked and unlocked cases, the NN owner |
| | assigns a learning rate for each hidden layer to |
| | then compute the true updates based on the |
| | gradients of cost function with respect to the |
| | weights and biases |
| | In the locked case in addition, the NN owner |
| | assigns the learning rate consistent with Eqn. |
| | (B58) to correctly allow for training of the locked |
| | transformed NN |
| (None) | NN agent in the exclave performs the inverse |
| | steps to remove the extra expansions, |
| | permutations and recover the updated true |
| | trained NN weights and biases from the |
| | transformed NN weight and biases. The true |
| | updated weights and biases are walled off |
| | from the data owner, but shared back with the |
| | NN agent in the enclave and also stored as a |
| | secure copy in the true NN database. |

### Embodiment 2: Proof of Matrix Operations

Following are mathematical proofs supporting the steps of Embodiment 2. Embodiment 2 follows a process for creating “shared/transformed” neural networks and shared/transformed training sets that may be used by other parties while keeping underlying information private. Maintaining correct-but-obscured mathematical operations while forward propagating through the hidden layers places a strong constraint, as does backpropagating via gradient descents, on the allowed algorithms. We derived an explicit form for the algorithms where calculations may be done in closed form to minimize computation.

### An Introduction to Transformed Activation Functions

A small number of activation and cost functions have come into frequent use in neural networks. Activation functions typically inject non-linear behavior in between the affine transformations associated with each neuron, effectively turning on and off inputs. Cost functions are used to train neural networks by spreading error across weights and biases in a desirable way to minimize total error. Like activation function, they are also typically non-linear. Because hidden layers and outputs of neural network are not known a priori, this reduces options to use mathematical operations to protect private neural network and training data.

We introduce an affine transformation of the zi hidden layer inputs that is correlated to associated “transformed” activation functions as a kind of password for neural network data but not operations. This is sufficient to create a privacy schema where two parties may share learning without sharing underlying private data.

Let \hat{σ}ᵢ be the vector activation function of the ith layer, i<N, of an N-layer neural network such that

$${\hat{σ}}_{i} ( {r}_{i , in} ( {z}_{i} - {\tilde{r}}_{i , in} ) ) = {r}_{i , out} ( {σ}_{i} ( {z}_{i} ) - {\tilde{r}}_{i , out} ) , \qquad ( B1 )$$

$${\hat{σ}}_{N - 1} ( {r}_{N - 1 , in} ( {z}_{N - 1} - {\tilde{r}}_{N - 1 , in} ) ) = ℛ ( {σ}_{N - 1} ( {z}_{N - 1} ) ) = ℛ ( {v}_{N} ) ,$$

where σ_{1≤i<N} is the actual activation function, rᵢ and r_{i+1,v} are random non-zero matrices, \tilde{r}ᵢ and \tilde{r}_{i+1,v} are random matrices, [symbol] an invertible function over the domain of possible outputs, and all products are Hadamard products unless otherwise specified. We shall see later that neural network owners employ leftwards row-wise operations, and input or training data owners, rightwards column-wise operations. The context will be clear when creating private networks or data sets, so we may use the same notation to capture both cases.

If σᵢ(zᵢ) has a Taylor series expansion about the points \tilde{r}ᵢ, we may rewrite (B1) as

$${\hat{σ}}_{i} ( {r}_{i , in} ( {z}_{i} - {\tilde{r}}_{i , in} ) ) = {\sum }_{k = 0}^{∞} \frac{{r}_{i , out}}{{r}_{i , in}^{k} k !} {σ}_{i}^{( k )} ( {\tilde{r}}_{i , in} ) {( {r}_{i , in} ( {z}_{i} - {\tilde{r}}_{i , in} ) )}^{k} - {r}_{i , out} {\tilde{r}}_{i , out} , \qquad ( B2 )$$

$${\hat{σ}}_{N - 1} ( {r}_{N - 1 , in} ( {z}_{N - 1} - {\tilde{r}}_{N - 1 , in} ) ) =$$

$${\sum }_{k = 0}^{∞} \frac{{ℛ ( {σ}_{N - 1} ( {\tilde{r}}_{N - 1 , in} ) )}^{( k )}}{k ! {r}_{N - 1 , in}^{k}} {( {r}_{N - 1 , in} ( {z}_{N - 1} - {\tilde{r}}_{N - 1 , in} ) )}^{k}$$

$$where {ℛ ( {σ}_{N - 1} ( {\tilde{r}}_{N - 1 , in} ) )}^{( k )} =$$

$${\sum }_{n : {\sum }_{i = 1}^{k} {in}_{i} = k} \frac{k ! {ℛ}^{( {n}_{1} + … {n}_{k} )} ( {σ}_{N - 1} ( {\tilde{r}}_{N - 1 , in} ) )}{{n}_{1} ! 1 {!}^{{n}_{1}} … {n}_{k} ! {k !}^{{n}_{k}}} {\prod }_{j = 1}^{k} {( {σ}_{N - 1}^{( j )} ( {\tilde{r}}_{N - 1 , in} ) )}^{{n}_{j}} ,$$

where the final equation is the Faa di Bruno formula for derivatives of composite functions.

Any desired behavior of an activation function may be approximated arbitrarily closely by an everywhere infinitely differentiable function with infinitely many Taylor Series expansion terms at all points, using techniques such as smooth approximations (e.g., Softplus function for ReLU), mollifiers, or exponential functions approximation to ensure infinite differentiability and convergence of the Taylor series. Additionally, bounded infinitely differential noise functions may be applied to strength protections for Taylor Series expansion coefficients Appendix for more details.

Wishing to the keep the affine transformation of the hidden layers private, we may use (B2) to recast \hat{σ}ᵢ(zᵢ) as a series expansion with floating point coefficients:

$${\hat{σ}}_{i} ( {r}_{i , in} ( {z}_{i} - {\tilde{r}}_{i , in} ) ) = {\sum }_{k = 0}^{∞} \{ {c}_{i} \} {( {r}_{i , in} ( {z}_{i} - {\tilde{r}}_{i , in} ) )}^{k} , \qquad ( B3 )$$

$$\{ {c}_{i < N - 1} \} = \{ \frac{{r}_{i , out}}{{r}_{i , in}^{k} k !} {σ}_{i}^{( k )} ( {\tilde{r}}_{i , in} ) - {δ}_{k , 0} {r}_{i , out} {\tilde{r}}_{i , out} \} ,$$

$$\{ {c}_{N - 1} \} = \{ {\sum }_{n : {\sum }_{i = 1}^{k} {in}_{i} = k} \frac{{ℛ}^{( {n}_{1} + … {n}_{k} )} ( {σ}_{N - 1} ( {\tilde{r}}_{N - 1 , in} ) )}{{r}_{N - 1 , in}^{k} {n}_{1} ! 1 {!}^{{n}_{1}} … {n}_{k} ! {k !}^{{n}_{k}}} {\prod }_{j = 1}^{k} {( {σ}_{N - 1}^{( j )} ( {\tilde{r}}_{N - 1 , in} ) )}^{{n}_{j}} \} ,$$

where brackets indicate floating point numbers. Thus, if a neural network or its inputs are modified somehow to produce r_{i,in}(z_{i,in}−\tilde{r}ᵢ) rather than zᵢ in the hidden layers, the activation functions may be correspondingly modified according to (B3) to “escort” the hidden layer input through the non-linearity while keeping it private. The final activation has no constraints, other than infinite differentiability and invertibility over the output domain.

If the final output corresponds to a training set,

$${t}_{N}^{〈 m 〉} ,$$

indexed by m, then the final activation function may be modified to give the difference in outputs:

$${\hat{σ}}_{N - 1}^{〈 m 〉} ( {r}_{N - 1 , in} ( {z}_{N - 1} - {\tilde{r}}_{N - 1 , in} ) ) = {ℛ}^{〈 m 〉} ( {t}_{N}^{〈 m 〉} - {σ}_{N - 1} ( {z}_{N - 1} ) ) , \qquad ( B4 )$$

$${\hat{σ}}_{N - 1}^{〈 m 〉} ( {r}_{N - 1 , in} ( {z}_{N - 1} - {\tilde{r}}_{N - 1 , in} ) ) =$$

$${\sum }_{k = 0}^{∞} \frac{{{ℛ}^{〈 m 〉} ( {t}_{N}^{〈 m 〉} - {σ}_{N - 1} ( {\tilde{r}}_{N - 1 , in} ) )}^{( k )} {( {r}_{N - 1 , in} ( {z}_{N - 1} - {\tilde{r}}_{N - 1 , in} ) )}^{k}}{k ! {r}_{N - 1 , in}^{k}} ,$$

$$where {ℛ}^{〈 m 〉} {( {t}_{N}^{〈 m 〉} - {σ}_{N - 1} ( {\tilde{r}}_{N - 1 , in} ) )}^{( k )} =$$

$${\sum }_{n : {\sum }_{i = 1}^{k} {in}_{i} = k} \frac{k ! {ℛ}^{〈 m 〉 ( {n}_{1} + … {n}_{k} )} ( {t}_{N}^{〈 m 〉} - {σ}_{N - 1} ( {\tilde{r}}_{N - 1 , in} ) )}{{n}_{1} ! 1 {!}^{{n}_{1}} … {n}_{k} ! {k !}^{{n}_{k}}} {\prod }_{j = 1}^{k} {( - 1 )}^{{n}_{j}} {( {σ}_{N - 1}^{〈 m 〉 ( j )} ( {\tilde{r}}_{N - 1 , in} ) )}^{{n}_{j}} .$$

This will be important later.

We will begin by forward propagating through the neural network. Because the weights and biases are affine transformations, they cannot produce higher-than-linear terms for the hidden layers without knowing them a priori. Assuming hidden layer are not known a priori, then the only exception the final output layer since there are no further weights and biases to apply. We will assume hidden layers are not known a priori throughout this paper.

Thinking of these neural network modifications as “passwords” locking underlying data—but not forward and backwards propagation calculations themselves—the hidden layers have the greatest restriction because they must be consistent with matrix multiplication and addition. Thankfully, steps may be applied in addition to (B3) to make the passwords stronger.

### Step 1: Obscure the Weights and Biases or Input Data

Writing the first neural network input, v₁, and all weights, w_{1≤i<N}, and biases, bᵢ, in augmented matrix format,

$$\begin{matrix}{w}_{i} , {b}_{i} \to ( \begin{matrix}{w}_{i} & {b}_{i} \\ 0 & 1\end{matrix} ) , & {v}_{1} \to ( \begin{matrix}{v}_{1} \\ 1\end{matrix} )\end{matrix} , \qquad ( B5 )$$

let us assume the neural network and input vector are owned by different parties, each wishing to collaborate, but only if their information remains private. The bottom component “1” facilitates vector addition but does not other contribute to the neural network. If a private neural network owner is exchanging an intellectual-property-preserving “transformed” version of it with an input/data owner, they begin by including additional vectors, r_{i,b} and \tilde{r}_{i,b}, to obscure the biases:

$${W}_{i , A} = ( \begin{matrix}{w}_{i} & {b}_{i} - {\tilde{r}}_{i , b} \\ 0 & 1\end{matrix} ) \to {W}_{i , A} ( \begin{matrix}{v}_{i} \\ 1\end{matrix} ) = ( \begin{matrix}{z}_{1} - {\tilde{r}}_{i , b} \\ 1\end{matrix} ) , \qquad ( B6 )$$

where 0 is a row vector with equal column dimension to wᵢ. The reasons for this structure will be clear subsequently.

If, instead, the input owner is making a private input or exchanging data-as-a-Service, they may analogously obscure the bias by expanding the augmented matrix format:

$${v}_{i , A} = ( \begin{matrix}\begin{matrix}{v}_{i} \\ {\tilde{r}}_{i}\end{matrix} \\ 1\end{matrix} ) \to ( \begin{matrix}{w}_{i} & - I & {b}_{i} \\ 0 & 0 & 1\end{matrix} ) {v}_{i , A} = ( \begin{matrix}{z}_{i} - {\tilde{r}}_{i} \\ 1\end{matrix} ) . \qquad ( B7 )$$

Note that having \tilde{r}ᵢ exposed in v_{i,A} is problematic for maintaining privacy, so we will need additional steps to create the transformed input data.

### Step 2: Expand and Scramble the Augmented Weight or Input Data

Next, the network owner may (i) expand the rows of the transformed augmented weight matrix, W_{i,A}, with a block matrix, W_{i,C}, containing spurious data, (ii) scramble the rows, and (iii) multiply the result element-wise by an arbitrary matrix:

$${\hat{W}}_{i , r} = {\hat{r}}_{i , W} ( {R}_{i , row} \times ( \begin{matrix}{W}_{i , A} \\ {W}_{i , C}\end{matrix} ) ) = ( \begin{matrix}{r}_{i , w} & {r}_{i , b} \\ {0}_{row dim {w}_{i}} & 1\end{matrix} ) ( {R}_{i , row} \times ( \begin{matrix}{W}_{i , A} \\ {W}_{i , C}\end{matrix} ) ) , \qquad ( B8 )$$

where R_{i,row} is an partially invertible matrix that preserves the augmented matrix form, “X” is row-column matrix multiplication, \hat{r}_{i,W} is a matrix containing spurious data that preserves the augmented matrix, and 0_{row dim Ŵ}_{ᵢ} is a zero vector.

The input owner may do likewise for input data:

$${\hat{v}}_{1 , r} = ( ( \begin{matrix}{v}_{1 , A} & {v}_{1 , B}\end{matrix} ) \times {R}_{col} ) {\hat{r}}_{1 , v} = ( ( \begin{matrix}{v}_{1 , A} & {v}_{1 , B}\end{matrix} ) \times {R}_{col} ) ( \begin{matrix}{r}_{i , v} \\ 1\end{matrix} ) , \qquad ( B9 )$$

where R_{col} and r_{1,v} analogously preserve the augmented matrix form (i.e., \hat{v}_{1,v,row dim v}_{_{1,A}}, j=1, \hat{r}_{i,v,row dim v}_{_{1,A}}, j=1) and 1 is a row vector where all elements are 1. Because of the need to preserve row-column multiplication, (B8) may not expand nor permute columns. Likewise for rows in (B9). To understand why, consider the following expanded matrix, whose submatrices, S_{i,A} and S_{i,C}, are block matrices that multiply corresponding block matrices in Ŵ₁ and satisfy the following:

$${\hat{W}}_{i , r} = ( \begin{matrix}{\hat{W}}_{i , r , A} & {\hat{W}}_{i , r , B} \\ {\hat{W}}_{i , r , C} & {\hat{W}}_{i , r , D}\end{matrix} ) \times ( \begin{matrix}{S}_{i , A} \\ {S}_{i , C}\end{matrix} ) ⇒ {S}_{i , A} \times {S}_{i , A}^{- 1 ( right )} = I , \qquad ( B10 )$$

$${\hat{W}}_{i , r , B} \times {S}_{i , C} ∈ coker ( {S}_{i , A}^{- 1 ( right )} ) ⇒ {\hat{W}}_{i , r} \times {S}_{i , A}^{- 1 ( right )} ( \begin{matrix}{v}_{i , W} \\ 1\end{matrix} ) = ( \begin{matrix}{\hat{W}}_{i , r , A} \\ {\hat{W}}_{i , r , C}\end{matrix} ) \times ( \begin{matrix}{v}_{i , W} \\ 1\end{matrix} ) .$$

Equation (B10) would require that the neural network owner exchange

$${S}_{i , A}^{- 1 ( right )}$$

with the input owner to ensure correct multiplication, which collapses Ŵ_{i,r} to row expansions only.

The analogous result is true for transformed input data:

$${\hat{v}}_{1 , r} = ( \begin{matrix}{S}_{1 , A} & {S}_{1 , B}\end{matrix} ) \times ( \begin{matrix}{\hat{v}}_{i , r , A} & {\hat{v}}_{i , r , B} \\ {\hat{v}}_{i , r , C} & {\hat{v}}_{i , r , D}\end{matrix} ) , \qquad ( B11 )$$

$${S}_{1 , A}^{- 1 ( left )} \times {S}_{1 , A} = I , {S}_{1 , B} \times {\hat{v}}_{i , r , B} ∈ ker ( {S}_{1 , A}^{- 1 ( left )} ) ⇒$$

$$( \begin{matrix}{W}_{1} & I & {b}_{1}\end{matrix} ) \times {S}_{1 , A}^{- 1 ( left )} \times {\hat{v}}_{1 , r} = ( \begin{matrix}{W}_{1} & I & {b}_{1}\end{matrix} ) \times ( \begin{matrix}{\hat{v}}_{i , r , A} & {\hat{v}}_{i , r , B}\end{matrix} ) .$$

As before, the input owner must exchange

$${S}_{1 , A}^{- 1 ( left )}$$

with the neural network owner to get the correct row-column multiplication, which collapses \hat{v}₁ to column expansions and permutations.

Therefore, we may assume that (8) is the most general forms are the following:

$${\hat{W}}_{i , r} \times {\hat{r}}_{i , W} ( {R}_{in} \times ( \begin{matrix}{\hat{W}}_{i , A} \\ {\hat{W}}_{i , C}\end{matrix} ) ) = {\hat{r}}_{i , W} {\hat{W}}_{i} , \qquad ( B12 )$$

$${\hat{v}}_{1 , r} = ( ( {\hat{v}}_{1 , A} {\hat{v}}_{1 , B} ) \times {R}_{in} ) {\hat{r}}_{1 , v} = {\hat{v}}_{i} {\hat{r}}_{1 , v} ,$$

where we drop the “row” and “col” subscript and adopt the convention that parentheses precede Hadamard products that precede row-column products. For an arbitrary R, equation (B13) requires us to change the element-wise activation function into one involving row-column matrix multiplication, \hat{σ}_{i,R}, whose elements are series expansions over all input components:

$${\hat{σ}}_{i , R , W} ( \hat{z} ) = {r}_{i + 1 , out} \text{} ( \text{} {\sum }_{k = 0}^{∞} \frac{{σ}_{i , R , W}^{( k )} ( {\tilde{r}}_{i , in} )}{{r}_{i , in}^{k} k !} {\sum }_{l = 1}^{n} {( {R}_{i + 1 , out} )}_{l} {{\hat{z}}_{i , l}^{k} ( {D}_{\hat{r} , i , W} \times {R}_{i , in} )}_{l}^{- 1} - {\tilde{r}}_{i + 1 , out} ) , \qquad ( B13 )$$

$${\hat{σ}}_{i , R , v} ( \hat{z} ) = {r}_{i + 1 , out} ( {\sum }_{k = 0}^{∞} \frac{{σ}_{i , R , v}^{( k )} ( {\tilde{r}}_{i , in} )}{{r}_{i , in}^{k} k !} {\sum }_{l = 1}^{n} {( {R}_{i , in} \times {D}_{\hat{r} , i , v} )}_{l}^{- 1} {{\hat{z}}_{i , l}^{k} ( {R}_{i + 1 , out} )}_{l} - {\tilde{r}}_{i + 1 , out} ) ,$$

where σ̌_{i,R,W} multiplies from left for transformed neural networks, σ̌_{i,R,v} from the right for transformed training data, n is the column dimension of \hat{z}, and the diagonal matrices, D, replace the Hadamard multiplications for ease of notation.

### Step 3: Take a Hadamard Exponential and Change Matrix Operations

The network owner takes an element-wise exponential of W̌ᵢ.

$${i}_{} = {e}^{{\hat{W}}_{i , r}} . \qquad ( B14 )$$

Because of the exponentiation, normal row-column matrix multiplication changes to a new operation for 1≤n≤col dim Wᵢ,

$${( {i = 1}_{} {⊗}_{1} ( \begin{matrix}{v}_{i} \\ 1\end{matrix} ) )}_{j > row dim {W}_{i} , 1} = ( \begin{matrix}{\prod }_{l : [ {r}_{i , w , j , l} = {r}_{i , w , j , 1} ]} {e}^{{r}_{i , w , j , l} {\hat{W}}_{i , j , l} {v}_{i , l}} \\ {\prod }_{l : [ {r}_{i , w , j , l} = {r}_{i , w , j , 2} \neq {\overleftarrow{r}}_{i , w , j , 1} ]} {e}^{{r}_{i , w , j , l} {\hat{W}}_{i , j , l} {v}_{i , l}} \\ ⋮ \\ {\prod }_{l : [ {r}_{i , j , l} = {r}_{i , w , j , n - 1} \neq {\overleftarrow{r}}_{i , w , j , n - 2} ]} {e}^{{r}_{i , w , j , l} {\hat{W}}_{i , j , l} {v}_{i , l}} \\ {e}^{{r}_{i , b , j} ( {b}_{i , j} - {\tilde{r}}_{i , b , j} )}\end{matrix} ) , \qquad ( B15 )$$

$${i > 1}_{} ⊗ {i}_{} = {i > 1}_{} ⊗ ( \begin{matrix}{e}^{{r}_{i , v} {σ}_{i - 1} ( {z}_{i - 1} ) - {r}_{i , v} {\tilde{r}}_{i , v}} \\ e\end{matrix} ) = ( {i}_{} {⊗}_{1} ln {i}_{} ) ,$$

$$\begin{matrix}{r}_{1 , z} = {r}_{1 , W} & {r}_{1 , z} = {r}_{1 , W} ,\end{matrix}$$

$${r}_{i > 1 , z , j , l < n} = {r}_{i , w , j , l} {r}_{i , v , l} , {\tilde{r}}_{i > 1 , z , j , l < n} = {\tilde{r}}_{i , w , j , l} + {W}_{i , j , l} {\tilde{r}}_{i , v , l} ,$$

$${r}_{i , z , j , n + 1} = {r}_{i , b , j} , {\tilde{r}}_{i , z , j , n + 1} = {\tilde{r}}_{i , b , j} ,$$

where brackets are Iverson brackets and [symbol] _{i,w,j,l}={r_{i,w,j,l},r_{i,w,j,l-1}, . . . , r_{i,w,j,1}}.

The input owner may do similarly:

$${i}_{} = {e}^{{\hat{v}}_{i} {\hat{r}}_{i , v}} = {( \begin{matrix}\begin{matrix}{e}^{{v}_{i}} \\ {e}^{- {\tilde{r}}_{i , v}}\end{matrix} \\ e\end{matrix} )}^{{\hat{r}}_{i , v}} , \qquad ( B16 )$$

where \hat{r}_{i,v} is performing an element-wise exponential and \tilde{r}_{i,v} and e=e1 are both row vectors of dimension col dim(v̌₁).

Like before, preserving normal row-column matrix multiplication requires a new operation:

$${( {W}_{i , A} {⊗}_{0}^{T} {i}_{} )}_{j > row dim {W}_{i , A} , k} = ln {i , col k}_{T}^{} {⊗}_{0} {W}_{i , A , row j}^{T} ,$$

where we adopt the following notation:

$${r}_{i , z} = {r}_{i , v} , {\tilde{r}}_{i , z} = {\tilde{r}}_{i , v} . \qquad ( B17 )$$

Differences Between transformed Training Data Versus transformed Neural Networks: Introducing n dimensional vectors as the vector components in (B15) and (B17) allows to create multivariate activation functions in the next section for stronger privacy protection. One can see in (B15) and (B16) that 1≤n≤col dim Wᵢ for transformed neural networks but 1<n≤col dim Wᵢ for transformed training data. Otherwise, (B16) could be inverted. This is because v̌ᵢ may contain the term e^{r}^{_{i,v}}^{σ}^{_{i−1}}^{(z}^{_{i−1}}^{)-r}^{_{i,v}}^{\tilde{r}}^{_{i,v}} in (B15), whereas (B16) must break up e^{r}^{_{i,v}}^{σ}^{_{i−1}}^{(z}^{_{i−1}}⁾ and e^{-r}^{_{i,v}}^{\tilde{r}}^{_{i,v}} due to the training data owner not being able to create activation functions that depend on the weights and biases. Therefore, the bottom two components of (B16) must be generated for each layer of the neural network and exchanged to facilitate this privacy algorithm.

The n-indexed activation functions, where n>1 is determined by rᵢ, are the principle means of maintaining privacy during forward propagation as they introduce non-linearity in our privacy algorithm.

### Step 4: Generate Hidden Layer “Transformed” Activation Functions: Univariate

Equation (B3) is likely not ample protection for important information, like weights, biases, and training data. Therefore, we wish to create new transformed activation functions that are functions of žᵢ where σᵢ(zᵢ) is recoverable by the entity generating them. The constraint is that such transformed activation functions must also allow the subsequent weight multiplication and bias addition without knowing the output a priori. We also wish to minimize computation expense and maximize our ability to calculate coefficients explicitly for accuracy. Therefore, we will choose compositions of exponentials and logarithms. We will also set R_{i,in} and R_{i,out} equal to the identity since for clarity.

To begin, we Taylor expand the transformed activation function σ̌ᵢ(žᵢ)=e^{r}^{ᵢ₊₁}^{\hat{σ}}^{ᵢ}^{(r}^{_{i,σ}}^{(ln(ž}^{ᵢ}^{)-r}^{_{i,z}}^{\tilde{r}}^{_{i,σ}}^{))-r}^{ᵢ₊₁}^{\tilde{r}}^{ᵢ₊₁} about the vector e^{r}^{_{i,z}}^{\tilde{r}}^{_{i,σ}}, where the matrices are chosen such that the Taylor expansion is well-defined,

$${i}_{} ( {i}_{} ) = {\sum }_{k = 0}^{∞} \frac{{i}_{( k )}^{} ( {e}^{{r}_{i , z} {\tilde{r}}_{i , σ}} )}{k !} {( {i}_{} - {e}^{{\tilde{r}}_{i , σ} {r}_{i , z}} )}^{k} , \qquad ( B18 )$$

where r_{i,σ} and rᵢ₊₁ are non-zero random matrices, \tilde{r}_{i,σ} and \tilde{r}ᵢ₊₁ is a random matrix, and we have used the binomial series in (B18). Therefore, we must calculate the derivatives in (18) to compute the floating-point coefficients. The first derivative may be calculated via the chain rule:

$${i}_{( 1 )}^{} ( {i}_{} ) = {i}_{} ( {i}_{} ) \frac{{r}_{i + 1} {r}_{i , σ}}{{i}_{}} {B}_{1 , 1} ( {\hat{σ}}_{i}^{( 1 )} ( {r}_{i , σ} ( ln ( {i}_{} ) - {r}_{i , z} {\tilde{r}}_{i , σ} ) ) ) , \qquad ( B19 )$$

where B_{l,m} are the complete Bell polynomials. Now assume the kth derivative is

$${i}_{( k )}^{} ( {i}_{} ) = {i}_{} ( {i}_{} ) {\sum }_{l = 1}^{k} {\sum }_{m = 1}^{l} \frac{s ( k , l ) {r}_{i + 1}^{m} {r}_{i , σ}^{l}}{{i}_{k}^{}} {B}_{l , m} ( {\hat{σ}}_{i}^{( 1 )} , … , {\hat{σ}}_{i}^{( l - m + 1 )} ) , \qquad ( B20 )$$

where s(k,l) are Stirling numbers of the first kind. Taking another derivative yields

$${i}_{( k + 1 )}^{} ( {i}_{} ) = {i}_{} ( {i}_{} ) {\sum }_{l = 1}^{k} {\sum }_{m = 1}^{l} \frac{s ( k , l ) {r}_{i + 1}^{m} {r}_{i , σ}^{l}}{{i}_{k}^{}} ( \frac{{r}_{i + 1} {r}_{i , σ}}{{i}_{}} {\hat{σ}}_{i}^{( 1 )} - \frac{k}{{i}_{}} + \frac{d}{d {i}_{}} ) {B}_{l , m} ( {\hat{σ}}_{i}^{( 1 )} , … , {\hat{σ}}_{i}^{( l - m + 1 )} ) , \qquad ( B21 )$$

The derivative of partial Bell polynomials is known:

$$\frac{d}{d} {B}_{l , m} ( {\hat{σ}}_{i}^{( 1 )} , … , {\hat{σ}}_{i}^{( l - m + 1 )} ) = {\sum }_{n = 1}^{l - m + 1} ( \begin{matrix}l \\ n\end{matrix} ) \frac{{r}_{i , σ}}{{i}_{}} {\hat{σ}}_{i}^{( n + 1 )} {B}_{l - n , m - 1} ( {\hat{σ}}_{i}^{( 1 )} , … , {\hat{σ}}_{i}^{( l - m - n + 2 )} ) , \qquad ( B22 )$$

Therefore, we may rewrite

$${i}_{( k + 1 )}^{} ( {i}_{} )$$

as

$$\frac{1}{{i}_{} ( )} {i}_{( k + 1 )}^{} ( {i}_{} ) = {\sum }_{l = 1}^{k} {\sum }_{m = 1}^{l} {\sum }_{n = 0}^{l - m + 1} \frac{( \begin{matrix}l \\ n\end{matrix} ) s ( k , l ) {r}_{i + 1}^{m} {r}_{i , σ}^{l + 1}}{{i}_{k + 1}^{}} {\hat{σ}}_{i}^{( n + 1 )} {B}_{l - n , m - 1} ( {\hat{σ}}_{i}^{( 1 )} , … , {\hat{σ}}_{i}^{( l - m - n + 2 )} ) + {\sum }_{l = 1}^{k} \frac{s ( k , l ) {r}_{i + 1}^{l + 1} {r}_{i , σ}^{l}}{{i}_{k + 1}^{}} {B}_{l + 1 , l + 1} ( {\hat{σ}}_{i}^{( 1 )} ) - {\sum }_{l = 1}^{k} {\sum }_{m = 1}^{l} \frac{ks ( k , l ) {r}_{i + 1}^{m} {r}_{i , σ}^{l}}{{i}_{k + 1}^{}} {B}_{l , m} ( {\hat{σ}}_{i}^{( 1 )} , … , {\hat{σ}}_{i}^{( l - m + 1 )} ) . \qquad ( B23 )$$

Applying a recursive identity for Bell polynomials,

$${B}_{l + 1 , m} ( {\hat{σ}}_{i}^{( 1 )} , … , {\hat{σ}}_{i}^{( l - m + 1 )} ) = {\sum }_{n = 1}^{l - m + 1} ( \begin{matrix}l \\ n\end{matrix} ) {\hat{σ}}_{i}^{( n + 1 )} {B}_{l - n , m - 1} ( {\hat{σ}}_{i}^{( 1 )} , … , {\hat{σ}}_{i}^{( l - m - n + 2 )} ) , \qquad ( B24 )$$

allows us to reduce the summands:

$$\frac{1}{{\check{σ}}_{i} ( {\check{z}}_{i} )} {\check{σ}}_{i}^{( k + 1 )} ( {\check{z}}_{i} ) = {\sum }_{l = 1}^{k} {\sum }_{m = 1}^{l} \frac{s ( k , l ) {r}_{i + 1}^{m} {r}_{i , σ}^{l + 1}}{{\check{z}}_{i}^{k + 1}} {B}_{l + 1 , m} ( {\hat{σ}}_{i}^{( 1 )} , ⋯ , {\hat{σ}}_{i}^{( l - m + 1 )} ) + {\sum }_{l = 1}^{k} \frac{s ( k , l ) {r}_{i + 1}^{l + 1} {r}_{i , σ}^{l + 1}}{{\check{z}}_{i}^{k + 1}} {B}_{l + 1 , l + 1} ( {\hat{σ}}_{i}^{( 1 )} ) - {\sum }_{l = 1}^{k} {\sum }_{m = 1}^{l} \frac{ks ( k , l ) {r}_{i + 1}^{m} {r}_{i , σ}^{l}}{{\check{z}}_{i}^{k + 1}} {B}_{l , m} ( {\hat{σ}}_{i}^{( 1 )} , ⋯ , {\hat{σ}}_{i}^{( l - m + 1 )} ) = {\sum }_{l = 2}^{k} {\sum }_{m = 1}^{l} \frac{( s ( k , l - 1 ) - k \cdot s ( k , l ) ) {r}_{i + 1}^{m} {r}_{i , σ}^{l}}{{\check{z}}_{i}^{k + 1}} {B}_{l , m} ( {\hat{σ}}_{i}^{( 1 )} , ⋯ , {\hat{σ}}_{i}^{( l - m + 1 )} ) + \frac{k ! {r}_{i + 1} {r}_{i , σ}}{{( - 1 )}^{k} {\check{z}}_{i}^{k + 1}} {B}_{1 , 1} ( {\hat{σ}}_{i}^{( 1 )} , ⋯ , {\hat{σ}}_{i}^{( l - m + 1 )} ) + {\sum }_{m = 1}^{k + 1} \frac{{r}_{i + 1}^{m} {r}_{i , σ}^{k + 1}}{{\check{z}}_{i}^{k + 1}} {B}_{k + 1 , m} ( {\hat{σ}}_{i}^{( 1 )} , ⋯ , {\hat{σ}}_{i}^{( k - m + 2 )} ) , \qquad ( B25 )$$

where we have used the identities s(k, 1)=(−1)^{k-1}(k−1)! and s(k,k)=1
Additionally, applying a recurrence relationship for Stirling numbers of the first kind,

$$s ( k , l - 1 ) - ks ( k , l ) = s ( k + 1 , l ) , \qquad ( B26 )$$

proves our inductive assumption true for the (k+1)th derivative:

$${\check{σ}}_{i}^{( k + 1 )} ( {\check{z}}_{i} ) = {\check{σ}}_{i} ( \check{z} ) {\sum }_{l = 1}^{k + 1} {\sum }_{m = 1}^{l} \frac{s ( k + 1 , l ) {r}_{i + 1}^{m} {r}_{i , σ}^{l}}{{\check{z}}_{i}^{k + 1}} {B}_{l , m} ( {\hat{σ}}_{i}^{( 1 )} , ⋯ , {\hat{σ}}_{i}^{( l - m + 1 )} ) = \frac{{\check{σ}}_{i} ( {\check{z}}_{i} )}{{\check{z}}_{i}^{k + 1}} {\sum }_{l = 1}^{k + 1} s ( k + 1 , l ) {r}_{i , σ}^{l} {B}_{l} ( {r}_{i + 1} {\hat{σ}}_{i}^{( 1 )} , ⋯ , {r}_{i + 1} {\hat{σ}}_{i}^{( l - m + 1 )} ) . \qquad ( B27 )$$

This proves our assumption true in general.

Evaluating at the point ž=e^{r}^{_{i,z}}^{\tilde{r}}^{_{i,σ}} provides the derivatives for (18) explicitly:

$${\check{σ}}_{i}^{( k )} ( {e}^{{\tilde{r}}_{i , σ}} ) = \frac{{\check{σ}}_{i} ( {e}^{{r}_{i , z} {\tilde{r}}_{i , σ}} )}{{e}^{{kr}_{i , z} {\tilde{r}}_{i , σ}}} {\sum }_{l = 1}^{k} {\sum }_{m = 1}^{l} s ( k , l ) {r}_{i + 1}^{m} {r}_{i , σ}^{l} {B}_{l , m} ( {\hat{σ}}_{i}^{( 1 )} ( 0 ) , ⋯ , {\hat{σ}}_{i}^{( l - m + 1 )} ( 0 ) ) = \frac{{\check{σ}}_{i} ( {e}^{{r}_{i , z} {\tilde{r}}_{i , σ}} )}{{e}^{{kr}_{i , z} {\tilde{r}}_{i , σ}}} {\sum }_{l = 1}^{k} {\sum }_{m = 1}^{l} s ( k , l ) \frac{{r}_{i , out}^{m} {r}_{i + 1}^{m}}{{r}_{i , in}^{l}} {B}_{l , m} ( {σ}_{i}^{( 1 )} ( {\tilde{r}}_{i , z} + {\tilde{r}}_{i , σ} ) , ⋯ , {σ}_{i}^{( l - m + 1 )} ( {\tilde{r}}_{i , z} + {\tilde{r}}_{i , σ} ) ) = \frac{{\check{σ}}_{i} ( {e}^{{r}_{i , z} {\tilde{r}}_{i , σ}} )}{{e}^{{kr}_{i , z} {\tilde{r}}_{i , σ}}} {\sum }_{l = 1}^{k} \frac{s ( k , l )}{{r}_{i , in}^{l}} {B}_{l} ( {r}_{i , out} {r}_{i + 1} {σ}_{i}^{( 1 )} ( {\tilde{r}}_{i , z} + {\tilde{r}}_{i , σ} ) , ⋯ , {r}_{i + 1 , z} {r}_{i + 1 , σ} {σ}_{i}^{( l - m + 1 )} ( {\tilde{r}}_{i , z} + {\tilde{r}}_{i , σ} ) ) , \qquad ( B28 )$$

$$where$$

$${\check{σ}}_{i} ( {e}^{{r}_{i , z} {\tilde{r}}_{i , σ}} ) = {e}^{{r}_{i , out} {r}_{i + 1} ( {σ}_{i} ( {\tilde{r}}_{i , z} + {\tilde{r}}_{i , σ} ) - {\tilde{r}}_{i , out} - {\tilde{r}}_{i + 1} )} ,$$

$${r}_{i , in} = {r}_{i , z} {r}_{i , σ} , {\tilde{r}}_{i , in} = {r}_{i , z} + {r}_{i , σ} , {r}_{i + 1 , v} = {r}_{i + 1} {r}_{i , out} , {\tilde{r}}_{i + 1 , v} = {r}_{i + 1} + {r}_{i , out} .$$

Reviewing the last two sections, one need not choose exponentials and logarithms to create transformed activation functions, though they are appealing due to the ability to calculate Taylor series coefficients explicitly. What is unique is that (i) true activation functions acting on true hidden layer inputs are contained in a recoverable form inside different transformed activation functions acting on affine transformations of those inputs, with higher order terms not being possible without a priori knowledge; (ii) these activations may be scrambled up using R_{i,in} and R_{i,out}; and (iii) these transformed activation functions may then be made more secure by inserting them inside a composition of a function invertible over some domain containing the true input data and its partial (or full) inverse.

Note also that we may use (B28) and (B13.1) together, as the derivative

$${( {\check{σ}}_{i , R , W} ( \check{z} ) )}_{a , b} = {\sum }_{k = 0}^{∞} \frac{{\check{σ}}_{i}^{( k )} ( {e}^{{r}_{i , z} {\tilde{r}}_{i , σ}} )}{{r}_{i , in}^{k} k !} {\sum }_{l = 1}^{n} {( {e}^{{R}_{i , out}} )}_{a , l} {( {( \check{z} - {e}^{{r}_{i , z} {\tilde{r}}_{i , σ}} )}_{l}^{k} )}^{{( {D}_{\hat{r} , i , W} \times {R}_{i , in} )}_{l}^{- 1}} - {r}_{i , out} {\tilde{r}}_{i , out} , \qquad ( B13 \text{.1} )$$

$${( {\hat{σ}}_{i , R , v} ( \hat{z} ) )}_{a , b} = {\sum }_{k = 0}^{∞} \frac{{r}_{i , out} {\hat{σ}}_{i , R , v}^{( k )} ( {e}^{{r}_{i , z} {\tilde{r}}_{i , σ}} )}{{r}_{i , in}^{k} k !} {\sum }_{l = 1}^{n} {( {e}^{{R}_{i , in}^{- 1} {\check{r}}_{i , v}^{- 1}} )}_{a , l} {{\check{z}}_{l}^{k} ( {e}^{{R}_{i , out}} )}_{l , b} - {r}_{i , out} {\tilde{r}}_{i , out} ,$$

$${\hat{σ}}_{i , R , W} ( \hat{z} ) = {r}_{i + 1 , out} ( {\sum }_{k = 0}^{∞} \frac{{σ}_{i , R , W}^{( k )} ( {\tilde{r}}_{i , in} )}{{r}_{i , in}^{k} k !} {\sum }_{l = 1}^{n} {( {R}_{i + 1 , out} )}_{l} {{\hat{z}}_{i , l}^{k} ( {D}_{\hat{r} , i , W} \times {R}_{i , in} )}_{l}^{- 1} - {\tilde{r}}_{i + 1 , out} ) ,$$

$${\hat{σ}}_{i , R , v} ( \hat{z} ) = {r}_{i + 1 , out} ( {\sum }_{k = 0}^{∞} \frac{{σ}_{i , R , v}^{( k )} ( {\tilde{r}}_{i , in} )}{{r}_{i , in}^{k} k !} {\sum }_{l = 1}^{n} {( {R}_{i , in} \times {D}_{\hat{r} , i , v} )}_{l}^{- 1} {{\hat{z}}_{i , l}^{k} ( {R}_{i + 1 , out} )}_{l} - {\tilde{r}}_{i + 1 , out} ) ,$$

Because of the growing size of neural networks and associated monetary costs for training them, secure but computationally efficient transformed activation and cost functions will be the most desired.

### Step 5: Generate Hidden Layer Transformed Activation Functions: Multivariate

For transformed input and training data, there will be a need for multivariate transformed activation functions of multiple indexes to maintain privacy. To create them, we expand a multivariate activation function

$${\check{σ}}_{i} ( {\check{z}}_{i , 1} , … , {\check{z}}_{i , n} ) = {e}^{{r}_{i + 1} {\hat{σ}}_{i} ( {r}_{i , σ} ( ln ( {\check{z}}_{i , 1}^{\frac{{r}_{i , 0}}{{r}_{i , z , 1}}} {\check{z}}_{i , 2}^{\frac{{r}_{i , 0}}{{r}_{i , z , 2}}} ⋯ {\check{z}}_{i , n}^{\frac{{r}_{i , 0}}{{r}_{i , n}}} ) - {r}_{i , 0} {\tilde{r}}_{i , σ} ) ) - {\tilde{r}}_{i + 1}} \qquad ( B29 )$$

$$about$$

$${\check{z}}_{i} = {e}^{{\tilde{r}}_{i , σ} {r}_{i , z}} \text{:} {\check{σ}}_{i} ( {\check{z}}_{i , 1} , … , {\check{z}}_{i , n} ) = {\sum }_{\vert k \vert = 0}^{∞} \frac{{( {\check{z}}_{i , n} - 1 )}^{{k}_{n}} {⋯ ( {\check{z}}_{i , 1} - 1 )}^{{k}_{1}}}{{k}_{n} ! ⋯ {k}_{1} !} \frac{{\partial }^{( \vert k \vert )} {\hat{σ}}_{i} ( {e}^{{\tilde{r}}_{i , σ}} )}{\partial {\check{z}}_{i , n}^{{k}_{n}} ⋯ \partial {\check{z}}_{i , 1}^{{k}_{1}}} ,$$

where |k|=k₁+ . . . +kₙ. Here, ž_{i,j} are the components of the vector indices in (B15) or (B17), where

$${\check{z}}_{i , 1}^{\frac{{r}_{i , 0}}{{r}_{i , z , 1}}} {\check{z}}_{i , 2}^{\frac{{r}_{i , 0}}{{r}_{i , z , 2}}} ⋯ {\check{z}}_{i , n}^{\frac{{r}_{i , 0}}{{r}_{i , n}}} = {\check{z}}_{i} .$$

Using the commutativity of the partial derivatives to order them reverse lexicographically, we take a derivative of σ̌ᵢ with respect to ž_{i,1}:

$$\frac{\partial }{\partial {\check{z}}_{i , 1}} {\check{σ}}_{i} ( {\check{z}}_{i} ) = \frac{{r}_{i}}{{r}_{i , 1}} ( \frac{{\check{z}}_{i}}{{\check{z}}_{i , 1}} ) \frac{\partial }{\partial {\check{z}}_{i}} {\check{σ}}_{i} ( {\check{z}}_{i} ) = {\check{σ}}_{i , j} ( {\check{z}}_{i} ) ( \frac{{r}_{i + 1} {r}_{i , σ} {r}_{i , 0}}{{\check{z}}_{i , 1} {r}_{i , z , 1}} ) {B}_{1 , 1} ( {\hat{σ}}_{i}^{( 1 )} ) . \qquad ( B30 )$$

Now assume the following for the k₁th derivative:

$$( B31 )$$

$$\frac{{\partial }^{{k}_{1}}}{\partial {\check{z}}_{i , 1}^{{k}_{1}}} {\check{σ}}_{i} ( {\check{z}}_{i , 1} , … , {\check{z}}_{i , n} ) = {\check{σ}}_{i} ( {\check{z}}_{i} ) {\sum }_{l = 1}^{{k}_{1}} {\sum }_{m = 1}^{l} \frac{{r}_{i + 1}^{m} {r}_{i , σ}^{l} {r}_{i , 0}^{l}}{{\check{z}}_{i , 1}^{{k}_{1}} {r}_{i , z , 1}^{l}} {B}_{l , m} ( {\hat{σ}}_{i}^{( 1 )} , ⋯ , {\hat{σ}}_{i}^{( l - m + 1 )} ) .$$

Taking another derivative with respect to ž_{i,1} gives

$$\frac{{\partial }^{{k}_{1} + 1}}{\partial {\check{z}}_{i , 1}^{{k}_{1} + 1}} {\check{σ}}_{i} ( {\check{z}}_{i} ) = {\check{σ}}_{i} ( {\check{z}}_{i} ) {\sum }_{l = 2}^{{k}_{1}} {\sum }_{m = 1}^{l} \frac{( s ( {k}_{1} , l - 1 ) - {k}_{1} s ( {k}_{1} , l ) ) {r}_{i + 1}^{m} {r}_{i , σ}^{l} {r}_{i , 0}^{l}}{{\check{z}}_{i , 1}^{{k}_{1} + 1} {r}_{i , z , 1}^{l}} {B}_{l , m} ( {\hat{σ}}_{i}^{( 1 )} , ⋯ , {\hat{σ}}_{i}^{( l - m + 1 )} ) + {\check{σ}}_{i} ( {\check{z}}_{i} ) \frac{{( - 1 )}^{{k}_{1}} {k}_{1} ! {r}_{i + 1} {r}_{i , σ} {r}_{i , 0}}{{\check{z}}_{i , 1}^{{k}_{1} + 1} {r}_{i , z , 1}} {B}_{1 , 1} ( {\hat{σ}}_{i}^{( 1 )} , ⋯ , {\hat{σ}}_{i}^{( l - m + 1 )} ) + {\check{σ}}_{i} ( {\check{z}}_{i} ) {\sum }_{l = 1}^{{k}_{1}} \frac{{r}_{i + 1}^{l + 1} {r}_{i , σ}^{l + 1} {r}_{i , 0}^{l + 1}}{{\check{z}}_{i , 1}^{{k}_{1} + 1} {r}_{i , z , 1}^{l + 1}} {B}_{l + 1 , l + 1} ( {\hat{σ}}_{i}^{( 1 )} ) , \qquad ( B32 )$$

where (B32) is derived following analogous steps in (B21) through (B25), which consolidates to

$$\frac{{\partial }^{{k}_{1} + 1}}{\partial {\check{z}}_{i , 1}^{{k}_{1} + 1}} {\check{σ}}_{i} ( {\check{z}}_{i} ) = {\check{σ}}_{i} ( {\check{z}}_{i} ) {\sum }_{l = 2}^{{k}_{1} + 1} {\sum }_{m = 1}^{l} \frac{s ( k + 1 , l ) {r}_{i + 1}^{m} {r}_{i , σ}^{l} {r}_{i , 0}^{l}}{{\check{z}}_{i , 1}^{{k}_{1} + 1} {r}_{i , z , 1}^{l}} {B}_{l , m} ( {\hat{σ}}_{i}^{( 1 )} , ⋯ , {\hat{σ}}_{i}^{( l - m + 1 )} ) , \qquad ( B33 )$$

using the Stirling number of the first kind identities that were applied in (B26). ▪

Now assume the following:

$$\frac{{\partial }^{{k}_{1} + ⋯ + {k}_{n}}}{\partial {\check{z}}_{i , n}^{{k}_{n}} ⋯ \partial {\check{z}}_{i , 1}^{{k}_{1}}} {\check{σ}}_{i} ( {\check{z}}_{i , 1} , … , {\check{z}}_{i , n} ) = {\check{σ}}_{i} ( {\check{z}}_{i} ) {\sum }_{\vert l \vert = 1}^{\vert k \vert} {\sum }_{l ∈ p ( \vert l \vert )} {\sum }_{m = 1}^{\vert l \vert} \frac{{τ}^{l} s ( k , l ) {r}_{i + 1}^{m} {r}_{i , σ}^{\vert l \vert} {r}_{i , 0}^{\vert l \vert}}{{\check{z}}_{i}^{k} {r}_{i , z}^{l}} {B}_{\vert l \vert , m} ( {\hat{σ}}_{i}^{( 1 )} , ⋯ , {\hat{σ}}_{i}^{( l - m + 1 )} ) = {\check{σ}}_{i} ( {\check{z}}_{i} ) {\sum }_{\vert l \vert = 1}^{\vert k \vert} {r}_{i , σ}^{\vert l \vert} {r}_{i , 0}^{\vert l \vert} {B}_{\vert l \vert} ( {r}_{i + 1} {\hat{σ}}_{i}^{( 1 )} , ⋯ , {r}_{i + 1} {\hat{σ}}_{i}^{( \vert l \vert - m + 1 )} ) {\sum }_{l ∈ p ( \vert l \vert )} \frac{s ( k , l )}{{r}_{i , z}^{l}} . \qquad ( B34 )$$

where |a|=Σᵢaᵢ,

$${a}^{b} = {\prod }_{i} {a}_{i}^{{b}_{i}} ,$$

a!=Πᵢaᵢ!, and s(k,l)=Πᵢs(kᵢ,lᵢ). Taking another derivative with respect to xₙ gives

$$\frac{1}{{\check{σ}}_{i} ( {\check{z}}_{i} )} \frac{{\partial }^{\vert k \vert + 1}}{\partial {\check{z}}_{i}^{k + {e}_{n}}} {\check{σ}}_{i} ( {\check{z}}_{i , 1} , … , {\check{z}}_{i , n} ) = {\sum }_{\vert l \vert = 1}^{{k}_{1} + ⋯ + {k}_{n}} {\sum }_{l ∈ p ( \vert l \vert )} {\sum }_{m = 1}^{{l}_{1} + ⋯ + {l}_{n}} \frac{- {k}_{n} s ( {k}_{1} , {l}_{1} ) ⋯ s ( {k}_{n} , {l}_{n} ) {{r}_{i + 1}^{m} ( {r}_{i , σ} {r}_{i , 0} )}^{{l}_{1} + ⋯ + {l}_{n}}}{{\check{z}}_{i , n} {\check{z}}_{i , 1}^{{k}_{1}} ⋯ {\check{z}}_{i , n}^{{k}_{n}} {r}_{i , z , 1}^{{l}_{1}} ⋯ {r}_{i , z , n}^{{l}_{n}}} {B}_{{l}_{1} + ⋯ + {l}_{n} , m} ( {\hat{σ}}_{i}^{( 1 )} , ⋯ , {\hat{σ}}_{i}^{( l - m + 1 )} ) + {\sum }_{\vert l \vert = 1}^{\vert k \vert} {\sum }_{l ∈ p ( \vert l \vert )} {\sum }_{m = 1}^{\vert l \vert} \frac{s ( {k}_{1} , {l}_{1} ) ⋯ s ( {k}_{n} , {l}_{n} ) {{r}_{i + 1}^{m} ( {r}_{i , σ} {r}_{i , 0} )}^{{l}_{1} + ⋯ + {l}_{n} + 1}}{{\check{z}}_{i , 1}^{{k}_{1}} ⋯ {\check{z}}_{i , n}^{{k}_{n} + 1} {r}_{i , z , 1}^{{l}_{1}} ⋯ {r}_{i , z , n}^{{l}_{n} + 1}} {B}_{\vert l \vert + 1 , m} ( {\hat{σ}}_{i}^{( 1 )} , ⋯ , {\hat{σ}}_{i}^{( l - m + 1 )} ) == {\sum }_{\vert l \vert = 1}^{\vert k + {e}_{n} \vert} {\sum }_{l ∈ p ( \vert l \vert )} {\sum }_{m = 1}^{\vert l \vert} \frac{s ( k + {e}_{n} , l ) {r}_{i + 1}^{m} {r}_{i , σ}^{\vert l \vert} {r}_{i , 0}^{\vert l \vert}}{{\check{z}}_{i}^{k + {e}_{n}} {r}_{i , z}^{l}} {B}_{\vert l \vert , m} ( {\hat{σ}}_{i}^{( 1 )} , ⋯ , {\hat{σ}}_{i}^{( l - m + 1 )} ) = \frac{1}{{\check{z}}_{i}^{k + {e}_{n}}} {\sum }_{\vert l \vert = 1}^{\vert k + {e}_{n} \vert} {r}_{i , σ}^{\vert l \vert} {r}_{i , 0}^{\vert l \vert} {B}_{\vert l \vert} ( {r}_{i + 1} {\hat{σ}}_{i}^{( 1 )} , ⋯ , {r}_{i + 1} {\hat{σ}}_{i}^{( l - m + 1 )} ) {\sum }_{l ∈ p ( \vert l \vert )} \frac{s ( k + {e}_{n} , l )}{{r}_{i , z}^{l}} , \qquad ( B35 )$$

where (B36) is derived following analogous steps in (B19) through (B24) and p(|l|) is the partition function. This proves our inductive assumption holds in general. ▪

Letting žᵢ=e^{\tilde{r}}^{_{i,σ}}^{r}^{_{i,z}} we may calculate the coefficients of the multivariate transformed activation functions:

$${σ}_{i}^{( k )} ( {e}^{{\tilde{r}}_{i , σ} {r}_{i , z}} ) = \frac{{\check{σ}}_{i} ( {e}^{{\tilde{r}}_{i , σ} {r}_{i , z}} )}{{e}^{k {\tilde{r}}_{i , σ} {r}_{i , z}} k !} {\sum }_{\vert l \vert = 1}^{\vert k \vert} {\sum }_{l ∈ p ( \vert l \vert )} {\sum }_{m = 1}^{\vert l \vert} \frac{s ( k , l ) {r}_{i + 1}^{m} {r}_{i , out}^{m}}{{r}_{i , in}^{l}} {B}_{\vert l \vert , m} ( {σ}_{i}^{( 1 )} ( {\tilde{r}}_{i , z} + {\tilde{r}}_{i , σ} ) , ⋯ , {σ}_{i}^{( \vert l \vert - m + 1 )} ( {\tilde{r}}_{i , z} + {\tilde{r}}_{i , σ} ) ) = \frac{{\check{σ}}_{i} ( {e}^{{\tilde{r}}_{i , σ} {r}_{i , z}} )}{{e}^{k {\tilde{r}}_{i , σ} {r}_{i , z}} k !} {\sum }_{\vert l \vert = 1}^{\vert k \vert} {B}_{\vert l \vert} ( {r }_{i + 1} {r}_{i , out} {σ}_{i}^{( 1 )} ( {\tilde{r}}_{i , z} + {\tilde{r}}_{i , σ} ) , ⋯ , {r}_{i + 1} {r}_{i + 1 , out} {σ}_{i}^{( \vert l \vert - m + 1 )} ( {\tilde{r}}_{i , z} + {\tilde{r}}_{i , σ} ) ) {\sum }_{l ∈ p ( \vert l \vert )} \frac{s ( k , l )}{{r}_{i , z}^{l}} \qquad ( B36 )$$

$$where$$

$${\check{σ}}_{i} ( {e}^{{\tilde{r}}_{i , σ} {r}_{i , z}} ) = {e}^{{r}_{i + 1} {r}_{i , out} {σ}_{i} ( {\tilde{r}}_{i , z} + {\tilde{r}}_{i , σ} ) - {\tilde{r}}_{i + 1} - {\tilde{r}}_{i , out}} ,$$

$${r}_{i , in} = {r}_{i , z} {r}_{i , σ} , {\tilde{r}}_{i , in} = {r}_{i , z} + {r}_{i , σ} , {r}_{i + 1 , v} = {r}_{i + 1} {r}_{i , out} , {\tilde{r}}_{i + 1 , v} = {r}_{i + 1} + {r}_{i , out} .$$

Note that mapping

$$( {r}_{i , 0} , {\check{z}}_{i}^{{r}_{i , 0}} , l ) \to ( {r}_{i , z} , {\check{z}}_{i} , l )$$

restores univariate activation functions.

The multivariate transformed activation functions allow stronger element-wise non-linearity to be introduced at the cost of computation. The simplest we are required to use corresponds to n=2 with the following manageable coefficients:

$$\frac{1}{k !} {σ}_{i}^{( k )} ( {e}^{{\tilde{r}}_{i , σ} {r}_{i , z}} ) = \frac{{\check{σ}}_{i} ( {e}^{{\tilde{r}}_{i , σ} {r}_{i , z}} )}{{e}^{k {\tilde{r}}_{i , σ} {r}_{i , z}} k !} {\sum }_{\vert l \vert = 1}^{\vert k \vert} {B}_{\vert l \vert} ( {r}_{i + 1 , σ} {r}_{i + 1 , v} {\hat{σ}}_{i}^{( i )} ( {\tilde{r}}_{i , z} + {\tilde{r}}_{i , σ} ) , 1 \leq i \leq \vert l \vert - m + 1 ) {\sum }_{{l}_{2} = 0}^{\vert l \vert} \frac{s ( {k}_{1} , \vert l \vert - {l}_{2} ) s ( {k}_{2} , {l}_{2} )}{{r}_{i , 1}^{\vert l \vert - {l}_{2}} {r}_{i , 2}^{{l}_{2}}} . \qquad ( B37 )$$

### Step 6: Generate Final Activation Functions and Transformed Cost Functions

As first introduced in (B1) through (B3), the final layer is different. The transformed activation function for the final output may be any infinitely differentiable function of the true activation function that is invertible over the domain of the output. For a few forward propagations, the computational expense of [symbol] may be of little concern, but for many, it likely would be. For back propagation only, the final transformed activation function,

$${\hat{σ}}_{N - 1}^{〈 m 〉} ,$$

and associated privacy function, [symbol] may be modified to output the error of the final layer to save a computational step:

$$\begin{matrix}{\check{σ}}_{N - 1}^{〈 m 〉} ( {\check{z}}_{N - 1} ) = {ℛ}^{〈 m 〉} ( {\hat{σ}}_{N - 1}^{〈 m 〉} ( ln ( {\check{z}}_{N - 1} ) ) ) \\ = {ℛ}^{〈 m 〉} ( {E}_{T} ( {t}_{N}^{〈 m 〉} - {σ}_{N - 1} ( {z}_{N - 1} ) ) ) \\ = {\check{E}}_{T} ( {r}_{N - 1 , i n} ( {z}_{N - 1} - {\tilde{r}}_{N - 1 , i n} ) ) , where\end{matrix} \qquad ( B38 )$$

$${\check{E}}_{T} ( \hat{z} ) = {\sum }_{\vert k \vert = 0}^{∞} \frac{{( {\hat{z}}_{n} - {\tilde{r}}_{E , n} )}^{{k}_{n}} ⋯ {( {\hat{z}}_{1} - {\tilde{r}}_{E , 1} )}^{{k}_{1}}}{{k}_{n} ! ⋯ {k}_{1} !} \frac{{\partial }^{( \vert k \vert )} {\hat{E}}_{T} ( {\tilde{r}}_{E} )}{\partial {\hat{z}}_{n}^{{k}_{n}} ⋯ \partial {\hat{z}}_{1}^{{k}_{1}}} .$$

Here, the multivariate derivative requires application of the multivariate form of di Bruno's formula from by Constantine and Savits successively. (See G. M. Constantine and T. H. Savits, “A Multivariate Faa Di Bruno Formula with Applications”, in Transactions of the American Mathematical Society, Volume 348, Number 2, February 1996, available at www.ams.org/journals/tran/1996-348-02/S0002-9947-96-01501-2/S0002-9947-96-01501-2.pdf.)

To recover the true changes to the weights and biases, we must be able to calculate its associated partial derivative in the transformed neural network,

$$\frac{\partial {E}_{T}}{\partial {W}_{N - i , j , k}} = \frac{\partial {E}_{T}}{\partial {\check{E}}_{T}} \frac{\partial {\check{E}}_{T}}{\partial {\check{z}}_{N - i}} \frac{\partial {\check{z}}_{N - i}}{\partial {W}_{N - i , j , k}} = {( {ℛ}^{- 1 ′} ( {\check{E}}_{T} ) ( \frac{\partial {\check{E}}_{T}}{\partial {\check{z}}_{N - i}} \check{∘} ln {\check{v}}_{N - i}^{T} ) )}_{{Π}^{- 1} , j , k} . \qquad ( B39 )$$

Here, “∘̌” is a new element-wise product where a∘̌b=abₖ for

$$\frac{\partial {b}_{k}}{\partial a} \neq 0 ,$$

where k indexes components of multivariate transformed vector elements. Additionally, Π⁻¹ indicates the corresponding column permutation or row permutations that been inverted and false columns and rows, respectively, removed.

The right-hand term in the parenthesis may be found recursively, but [symbol] ⁻¹′(Ě_{T}) requires knowledge from both parties: [symbol] ⁻¹ is known only to the private data owner, and Ě_{T}, to the opposite party. To invert this term, an exchange of private data in either direction would undermine the privacy scheme. This motivates a choosing [symbol] such that

$${ℛ}^{- 1 ′} ( {\check{E}}_{T} ) = {r}^{- 1} \tilde{ℛ} ( {\check{E}}_{T} ) ⇒ ℛ = {r ( \int \tilde{ℛ} ( {\check{E}}_{T} ) )}^{- 1} - r \tilde{r} , \qquad ( B40 )$$

where r and \tilde{r} are vectors known only by the private data owner (the former, strictly non-zero) and [symbol] is a strictly non-zero function known to both parties so that no exchange of Ê_{T} is required. The choice of the inverse is so that r aligns with [symbol] .

If r and \tilde{r} is the Hadamard identity and zero vectors, respectively, and no column or row expansion(s) are taken, the neural network may be considered “unlocked” with no additional data exchanges needed. If the private data owner wishes the gradient to be “locked,” i.e., require additional data exchanges to use the results, additional steps are needed. A reason for this might be restricting the amount of training data for fine-tuning a shared/transformed neural network.

For a locked network, should the private data owner wish to invert r, then reverse the permutation(s), then collapse the expansion, and then return the output to the other party, that party would simply compare each expansion copy in the original gradient tensor to find the one that is proportional to the returned gradient matrix. To prevent this, we must generalize the error function for each weight and bias component:

$$\frac{\partial {E}_{T}}{\partial {W}_{N - i , j , k}} = {( {( {r}^{[ N - i ]} \int \tilde{ℛ} ( {\check{E}}_{T , j , k}^{[ N - i ]} ) )}^{- 1} ( \frac{\partial {\check{E}}_{T , j , k}^{[ N - i ]}}{\partial {\check{z}}_{N - i}} \check{∘} ln {\check{v}}_{N - i}^{T} ) )}_{{Π}^{- 1} , j , k} , \qquad ( B41 )$$

which multiplies the augmented weight-bias tensor gradients by an associated non-zero private tensor via a modified error function for every element. Note the importance of having a different r^{[N-i]} for each neural network layer, which we denote in brackets to avoid confusion with exponents, derivatives, or training data labeling. Because the gradients are element-wise calculations, this is not a too significant a computational burden. Because the scalar multiplication and permutation(s) in (B41) will be inverted at the same time to unlock the answer for the transformed data user, that user cannot determine the expansion copy to which it belonged, providing the expansion dimension is greater than one.

Equations (B40) and (B41) tell us that the privacy mechanism for the gradients is the element-wise multiplication; the function of the final error may be considered a convention, as it is known to both parties. Our convention should now be a familiar one. Let our choice pf error functions obey the following:

$${\hat{E}}_{T}^{[ N - i ]} ( {r}_{N , v} ( x - {\tilde{r}}_{N , v} - {\tilde{r}}_{N , t} ) ) = {r}_{N , out}^{[ N - i ]} ( {E}_{T} ( x ) - {\tilde{r}}_{N , out}^{[ N - i ]} ) , \qquad ( B42 )$$

$${\check{E}}_{T}^{[ N - i ]} ( \check{x} ) = ℛ ( {\hat{E}}_{T}^{[ N - i ]} ) = {e}^{{r}_{T}^{[ N - i ]} {\hat{E}}_{T}^{[ N - i ]}} ( {r}_{E}^{[ N - i ]} ( ln ( \tilde{x} ) - {r}_{N , v} {\tilde{r}}_{E , i n}^{[ N - i ]} ) ) - {\tilde{r}}_{T}^{[ N - i ]} .$$

Here, x̌ is the input vector based on the exponentiated final outputs and target data

$$( e . g . , \frac{{\check{t}}_{N}}{{\check{v}}_{N}} ) ,$$

and x is its lowered form (i.e., tₙ−vₙ), analogous to the hidden layer inputs to the activation functions. Additionally,

$${r}_{T}^{[ N - i ]} , {\tilde{r}}_{T}^{[ N - i ]} , {r}_{N , out}^{[ N - i ]} and {\tilde{r}}_{N , out}^{[ N - i ]}$$

are matrices of the same dimensions as the associated weight-bias matrix of layer N−i (the first and third being strictly non-zero) that have different forms for the unlocked and locked cases mentioned above.

Unlike the multivariate transformed activation functions, we may not make any simplifying assumptions about the multiple indexes so that a general cost function could be used. However, we still require them to have a multivariate Taylor Series expansion about the vector

$$\check{x} = {e}^{{r}_{N , v} {\tilde{r}}_{E}^{[ N - i ]}} :$$

$${\check{E}}_{T}^{[ N - i ]} ( \check{x} ) = {\sum }_{\vert k \vert = 0}^{∞} \frac{{( {\check{z}}_{n} - {e}^{{r}_{N , v , n} {\tilde{r}}_{E}^{[ N - i ]}} )}^{{k}_{n}} ⋯ {( {\check{z}}_{1} - {e}^{{r}_{N , v , 1} {\tilde{r}}_{E}^{[ N - i ]}} )}^{{k}_{1}}}{{k}_{n} ! ⋯ {k}_{1} !} \frac{{\partial }^{( \vert k \vert )} {\check{E}}_{T}^{[ N - i ]} ( {e}^{{r}_{N , v} {\tilde{r}}_{E}^{[ N - i ]}} )}{\partial {\check{x}}_{n}^{{k}_{n}} ⋯ \partial {\check{x}}_{1}^{{k}_{1}}} , \qquad ( B43 )$$

where |k|=k₁+ . . . +kₙ. Note we will drop the level superscript [N−i] until the end of this derivation to avoid confusion with the exponents.

We may apply (B18) successively to calculate the following derivative:

$$\frac{{\partial }^{{k}_{1}}}{\partial {\check{x}}_{1}^{{k}_{1}}} {\check{E}}_{T} ( \check{x} ) = {\check{E}}_{T} ( \check{x} ) {\sum }_{l = 1}^{{k}_{1}} {\sum }_{m = 1}^{l} \frac{s ( {k}_{1} , l ) {r}_{T}^{m} {r}_{E}^{l}}{{\check{x}}_{1}^{{k}_{1}}} {B}_{l , m} ( \frac{\partial {\hat{E}}_{T}}{\partial {\check{x}}_{1}} , … , \frac{{\partial }^{l - m + 1} {\hat{E}}_{T}}{\partial {\check{x}}_{1}^{l - m + 1}} ) , \qquad ( B44 )$$

which we will assume holds if extended to a potentially multivariate vector notation, ordering vectors lexicographically from left to right, with e₁ as the first unit vector:

$$\frac{{\partial }^{k}}{\partial {\check{x}}^{k}} {\check{E}}_{T} ( \check{x} ) = {\sum }_{l = 1}^{k} {\sum }_{m = 1}^{\vert l \vert} \frac{s ( k , l ) {r}_{T}^{m} {r}_{E}^{l}}{{\check{x}}^{k}} {B}_{l , m} ( {\hat{E}}_{T}^{( {e}_{1} )} , ⋯ , {\hat{E}}_{T}^{( m i n ( {l}_{dim ( l )} , \vert l \vert - m + 1 ) {e}_{dim ( l )}} ) . \qquad ( B45 )$$

This vector extension of Bell polynomials is also combinatorial: coefficients in [symbol] are the number of ways of partitioning n sets of lᵢ unique elements, i∈[1, n], into one combined, non-empty subset of m elements.

Assuming (B31) holds for all partial derivatives corresponding to whole-number-valued vectors, k, when dim(k)=i. Consider the next partial derivative, ∂ₓⱼ, where j∈{i, i+1}:

$$\frac{\partial }{\partial {\check{x}}_{j}} {\check{E}}_{T}^{( k )} ( \check{x} ) = {\check{E}}_{T} ( \check{x} ) {\sum }_{l = 1}^{k} {\sum }_{m = 1}^{\vert l \vert} \frac{s ( k , l ) {r}_{T}^{m} {r}_{E}^{l}}{{\check{x}}^{k}} ( \frac{{r}_{T} {r}_{E} \partial {\hat{E}}_{T}}{{\check{x}}_{j} \partial {\check{x}}_{j}} - {δ}_{i , j} \frac{{k}_{i}}{{\check{x}}_{i}} + \frac{\partial }{\partial {\check{x}}_{j}} ) {B}_{l , m} . \qquad ( B46 )$$

The partial derivative may be calculated as before:

$$\frac{\partial }{\partial {\check{x}}_{j}} {B}_{l , m} = \frac{{r}_{E}}{{\check{x}}_{j}} {\sum }_{n = 1}^{\vert l \vert - m + 1} ( \begin{matrix}\vert l \vert \\ n\end{matrix} ) \frac{\partial {\hat{E}}_{T}^{( {d}_{n} )}}{\partial {\check{x}}_{j}} {B}_{l - {d}_{n} , m - 1} , \qquad ( B47 )$$

where dₙ is the vector corresponding to the partial derivative associated with the nth argument of B_{l,m}.

This consolidates (B46):

$$\frac{\partial }{\partial {\check{x}}_{j}} {\check{E}}_{T}^{( k )} ( \check{x} ) = - {δ}_{i , j} {\check{E}}_{T} ( \check{x} ) {\sum }_{l = 1}^{k} {\sum }_{m = 1}^{\vert l \vert} \frac{{k}_{j} s ( k , l ) {r}_{T}^{m} {r}_{E}^{l}}{{\check{x}}^{k} {\check{x}}_{j}} {B}_{l , m} + {\check{E}}_{T} ( \check{x} ) {\sum }_{l = 1}^{k} {\sum }_{m = 1}^{\vert l \vert} {\sum }_{n = 0}^{\vert l \vert - m + 1} \frac{( \begin{matrix}\vert l \vert \\ n\end{matrix} ) s ( k , l ) {r}_{T}^{m} {r}_{E}^{l}}{{\check{x}}^{k} {\check{x}}_{j}} \frac{\partial {\hat{E}}_{T}^{( {d}_{n} )}}{\partial {\check{x}}_{j}} {B}_{l - {d}_{n} , m - 1} = {\check{E}}_{T} ( \check{x} ) ( {δ}_{i , j} {\sum }_{l = 1}^{k + {e}_{i}} {\sum }_{m = 1}^{\vert l \vert} \frac{( s ( k , l - {e}_{i} ) - {k}_{i} s ( k , l ) ) {r}_{T}^{m} {r}_{E}^{l}}{{\check{x}}^{k} {\check{x}}_{j}} {B}_{l , m} + {δ}_{i + 1 , j} {\sum }_{l = 1}^{k} {\sum }_{m = 1}^{\vert l \vert} \frac{s ( k , l ) {r}_{T}^{m} {r}_{E}^{l}}{{\check{x}}^{k} {\check{x}}_{j}} {B}_{l + {e}_{j} , m} ) = {\check{E}}_{T} ( \check{x} ) ( {δ}_{i , j} {\sum }_{l = 1}^{k + {e}_{i}} {\sum }_{m = 1}^{\vert l \vert} \frac{s ( k + {e}_{j} , l ) {r}_{T}^{m} {r}_{E}^{l}}{{\check{x}}^{k + {e}_{j}}} {B}_{l , m} + {δ}_{i + 1 , j} {\sum }_{l = 1}^{k + {e}_{i + 1}} {\sum }_{m = 1}^{\vert l \vert} \frac{s ( k + {e}_{j} , l ) {r}_{T}^{m} {r}_{E}^{l}}{{\check{x}}^{k + {e}_{j}}} {B}_{l , m} ) . \qquad ( B48 )$$

This proves our claim by induction. ▪

Like before, we can evaluate the Taylor expansion at the vector e^{r}^{_{N,v}}^{\tilde{r}}^{_{E}} to calculate the coefficients:

$$\frac{{\partial }^{k}}{\partial {\check{x}}^{k}} {E}_{T}^{[ N - i ]} ( {e}^{{r}_{N , v} {\tilde{r}}_{E}^{[ N - i ]}} ) = \frac{{\check{E}}_{T}^{[ N - i ]} ( {e}^{{r}_{N , v} {\tilde{r}}_{E}^{[ N - i ]}} )}{{e}^{k {r}_{N , v} {\tilde{r}}_{E}^{[ N - i ]}} k !} \times {\sum }_{l = 1}^{k} {\sum }_{m = 1}^{\vert l \vert} \frac{s ( k , l ) {( {r}_{T}^{[ N - i ]} {r}_{N , out}^{[ N - i ]} )}^{m}}{{r}_{N , i n}^{l}} {B}_{l , m} ( {E}_{T}^{( {e}_{1} )} ( {\tilde{r}}_{N , v} + {\tilde{r}}_{E}^{[ N - i ]} ) , ⋯ , {E}_{T}^{( m i n ( {l}_{dim ( l )} , \vert l \vert - m + 1 ) {e}_{dim ( l )} )} ( {\tilde{r}}_{N , v} + {\tilde{r}}_{E}^{[ N - i ]} ) ) = \frac{{\check{E}}_{T}^{[ N - i ]} ( {e}^{{r}_{N , v} {\tilde{r}}_{E}^{[ N - i ]}} )}{{e}^{k {r}_{N , v} {\tilde{r}}_{E}^{[ N - i ]}} k !} {\sum }_{l = 1}^{k} \frac{s ( k , l )}{{r}_{N , i n}^{l}} {B}_{l} ( {r}_{T}^{[ N - i ]} {r}_{N , out}^{[ N - i ]} {E}_{T}^{[ N - i ] ( y )} ( {\tilde{r}}_{N , v} + {\tilde{r}}_{E}^{[ N - i ]} ) ; ∀ y ∈ [ {e}_{1} , min ( {l}_{d i m ( l )} , \vert l \vert - m + 1 ) {e}_{d i m ( l )} ] ) , \qquad ( B49 )$$

where we have restored the neural network level superscripts and lexicographically ordered the multivariate-indexed derivatives. It is worth noting that for many widely used error functions, the multivariate Bell polynomials may be further simplified due to symmetries between the input arguments, which we exploited with the multivariate transformed activation functions to avoid vectorized Bell polynomials.
Shared/Transformed Input Data: Forward and Backward Propagation with Privacy

With these tools, we can create a scheme where two parties get correct forward and backward propagation outputs without sharing inputs, weights, or biases. We start with the case where an input owner provides use of their data—but not the data itself—to a neural network owner. The two parties must agree on (i) the dimensions of the expansion, (ii) the location of the bias vector and unit vector in the augmented matrix, and (iii) the level of club-sandwiching at each layer.

The input owner then generates v̌₁, σ̌₁, and the bottom component of v̌_{i>1} and provides them to the network owner. The network owner propagates to the final output [symbol] .

$${\check{σ}}_{N - 1} ( ( \begin{matrix}{w}_{N - 1} & I & {b}_{N - 1} \\ 0 & 0 & 1\end{matrix} ) ⊗ {( \begin{matrix}{e}^{{v}_{N - 1}} \\ {e}^{- {\tilde{r}}_{N - 1 , v}} \\ e\end{matrix} )}^{{\hat{r}}_{N - 1 , v}} ) = {e}^{ℛ ( {v}_{N} )} , \qquad ( B50 )$$

The neural network owner may then return this private output to the input owner, who may apply [symbol] ⁻¹∘ ln to attain v_{N,A}, without any knowledge of the neural network weights and biases.

If [symbol] is part of training set, the transformed target data, [symbol] = [symbol] , may also be exchanged with the neural network owner for backpropagation. To backpropagate with transformed data, the input owner calculates the Taylor expansions of the multivariate transformed cost functions with floating point coefficients and exchanges them with the neural network owner. Beginning with the final output layer, the gradient of the cost function with respect to the final weight and biases is calculated:

$$\begin{matrix}( unlocked ) \frac{\partial {E}_{T}}{\partial {W}_{N - 1 , k , l}} = \frac{\partial {E}_{T}}{\partial {\check{E}}_{T}^{[ N - 1 ]}} \frac{\partial {\check{E}}_{T}^{[ N - 1 ]}}{\partial {\check{v}}_{N}} \frac{\partial \check{v}}{\partial {\check{z}}_{N - 1}} \frac{\partial {\check{z}}_{N - 1}}{\partial {W}_{N - 1 , k , l}} ⇒ \\ \frac{\partial {E}_{T}}{\partial {W}_{N - 1}} = \{ \frac{\partial ln {\check{E}}_{T}^{[ N - 1 ]}}{\partial ln ( {\check{z}}_{N - 1} )} \} \check{∘} ln {\check{v}}_{N - 1}^{T}\end{matrix} \qquad ( B50 \text{.1} )$$

$$\begin{matrix}( locked ) \frac{\partial {E}_{T}}{\partial {W}_{N - 1 , k , l}} = \frac{\partial {E}_{T}}{\partial {\check{E}}_{T , k , l}^{[ N ]}} \frac{\partial {\check{E}}_{T , k , l}^{[ N ]}}{\partial {\check{v}}_{N}} \frac{\partial \check{v}}{\partial {\check{z}}_{N - 1}} \frac{\partial {\check{z}}_{N - 1}}{\partial {W}_{N - 1 , k , l}} ⇒ \\ \frac{\partial {E}_{T}}{\partial {W}_{N - 1}} = {( ( \{ \frac{\partial ln {\check{E}}_{T}^{[ N ]}}{\partial ln ( {\check{z}}_{N - 1} )} \} \check{∘} ln {\check{v}}_{N - 1}^{T} ) {( {r}_{N , out} {r}_{T}^{[ N ]} )}^{- 1} )}_{{π}_{col} ( 1 )} \\ = {{R}_{{π}_{col} ( 1 )}^{[ N ]} ( {r}_{N , out} {r}_{T}^{[ N ]} )}_{{π}_{col} ( 1 )}^{- 1} ,\end{matrix}$$

$$where \{ \frac{\partial ln {\check{E}}_{T}^{[ j ]}}{\partial ln ( {\check{z}}_{N - 1} )} \} = \frac{{\check{z}}_{N - 1}}{{\check{E}}_{T}^{[ j ]}} \{ \frac{\partial {\check{E}}_{T}^{[ j ]}}{\partial {\check{v}}_{N}} \} \{ \frac{\partial {\check{v}}_{N}}{\partial {\check{z}}_{N - 1}} \} .$$

Here, (i) element-wise products now treat vector elements arising from multivariate transformed functions as individual elements (This allows three types of element-wise products: scalar times scalar, scalar times vector, and vector times vector.); (ii) partial derivatives in parentheses are calculated using exchanged Taylor Series expansions with floating point coefficients; (iii) “∘̌” is a new element-wise product where a∘̌b=abₖ when

$$\frac{\partial {b}_{k}}{\partial a} \neq 0 ,$$

where k indexes components of multivariate transformed vector elements; and (iv) trivial diagonalized or null tensor dimensions are removed.

In the unlocked case, no matrix expansion is undertaken, and

$${r}_{N , out}^{[ N ]} {r}_{T}^{[ N ]} = {1}_{hadamard}$$

so that no obscuring element-wise multiplication need be divided out. For the locked case, an additional exchange with the neural network owner will be required.

For both cases, the hidden layers, N−i<N may be calculated using

$$( a ) \frac{\partial ln ( {\check{E}}_{T}^{[ N - i ]} )}{\partial ln ( {\check{v}}_{N - i} )} = {W}_{N - i}^{T} \check{\times } \frac{\partial ln ( {\check{E}}_{T}^{[ N - i ]} )}{\partial ln ( {\check{z}}_{N - i} )} , \qquad ( B51 )$$

$$( b ) \frac{\partial ln ( {\check{E}}_{T}^{[ N - i ]} )}{\partial ln ( {\check{z}}_{N - i} )} = \frac{\partial ln ( {\check{E}}_{T}^{[ N - i ]} )}{\partial ln ( {\check{v}}_{N - i + 1} )} \{ \frac{\partial ln ( {\check{v}}_{N - i + 1} )}{\partial ln ( {\check{z}}_{N - i} )} \} ,$$

$$( c ) \frac{\partial ln ( {\check{E}}_{T}^{[ N - i ]} )}{\partial ln ( {\check{z}}_{N - i} )} = ( {W}_{N - i + 1}^{T} \check{\times } \frac{\partial ln ( {\check{E}}_{T}^{[ N - i + 1 ]} )}{\partial ln ( {\check{z}}_{N - i + 1} )} ) \{ \frac{\partial ln ( {\check{v}}_{N - i + 1} )}{\partial ln ( {\check{z}}_{N - i} )} \} ,$$

$$( unlocked ) \frac{\partial {E}_{T}}{\partial {W}_{N - i}} = \{ \frac{\partial ln {\check{E}}_{T}^{[ N - i ]}}{\partial ln ( {\check{z}}_{N - i} )} \} \check{∘} ln {\check{v}}_{N - i}^{T} ,$$

$$\begin{matrix}( locked ) \frac{\partial {E}_{T}}{\partial {W}_{N - i}} = {( ( \{ \frac{\partial ln {\check{E}}_{T}^{[ N - i ]}}{\partial ln ( {\check{z}}_{N - i} )} \} \check{∘} ln {\check{v}}_{N - i}^{T} ) {( {r}_{N , out} {r}_{T}^{[ N - i ]} )}^{- 1} )}_{{π}_{col} ( 1 )} \\ = {{R}_{{π}_{col} ( 1 )}^{[ N - i ]} ( {r}_{N , out} {r}_{T}^{[ N - i ]} )}_{{π}_{col} ( 1 )}^{- 1} .\end{matrix}$$

where ×̌ is a row-column multiplication: (a×̌b)_{i,j}=Σa_{i,l}b_{l,j,k} when

$$\frac{\partial {b}_{l , j , k}}{\partial {a}_{i , l}} \neq 0 .$$

For the locked case, the neural network owner then sends the following to the input owner:

$${\tilde{R}}^{[ N - i ]} \cdot ( {{R}^{[ N - i ]} ( {r}_{N , out} {r}_{T}^{[ N - i ]} )}^{- 1} ) . \qquad ( B52 )$$

where \tilde{R}^{[N-i]} is a rank 2 matrix and “⋅” is a column-wise outer product in the dimension of the expansion.

The input owner then calculates the following row matrix,

$${\tilde{R}}^{[ N - i ]} \cdot {R}_{{π}_{col} ( 1 )}^{[ N - i ]} \qquad ( B53 )$$

and returns it to the neural network owner. After assigning a learning rate, η^{[N-i]}, the network owner inverts \tilde{R}^{[N-i]} and discovers the true updates to the weights and biases:

$$Δ {W}_{N - i} = {η}^{[ N - i ]} {R}_{{π}_{col} ( 1 )}^{[ N - i ]} . \qquad ( B54 )$$

Shared/Transformed Neural Networks: Forward and Backward Propagation with Privacy

The case of shared/transformed neural networks is similar to that of shared/transformed training data with a few exceptions. After the neural network owner generates and exchanges (B13), activation functions, and cost functions, the input owner calculates the outputs,

$${\check{σ}}_{i} ( {\check{W}}_{i} ⊗ ( \begin{matrix}{e}^{{r}_{i , v} {σ}_{i - 1} ( {z}_{i - 1} ) - {r}_{i , v} {\tilde{r}}_{i - 1}} \\ e\end{matrix} ) ) = {e}^{{\hat{r}}_{i + 1 , v} {\hat{v}}_{i + 1}} , \qquad ( B55 )$$

up to the final layer, N. Equation (B50) applies after substituting π_{col}(1)→π_{rows,[N-i]}(1), where

$${π}_{rows , [ N - i ]} = {π}_{N - i , row} ( {π}_{N - i - 1 , row} ( ⋯ ( {π}_{1 , row} ( 1 , … , row rank {W}_{N - i} ) ) ) ) . \qquad ( B56 )$$

With this, we can compute the private gradients in the transformed neural network:

$$\begin{matrix}( a ) & \\ \frac{\partial ln ( {T}_{[ N - i ]}^{} )}{\partial ln ( {N - i}_{} )} = ln ( {N - i}_{T}^{} ) \check{\times } \frac{\partial ln ( {T}_{[ N - i ]}^{} )}{\partial ln ( {N - i}_{} )} & ( B57 )\end{matrix}$$

$$\frac{\partial ln ( {T}_{[ N - i ]}^{} )}{\partial ln ( {N - i}_{} )} = \frac{\partial ln ( {T}_{[ N - i ]}^{} )}{\partial ln ( {N - i + 1}_{} )} \{ \frac{\partial ln ( {N - i + 1}_{} )}{\partial ln ( {N - i}_{} )} \} , \qquad ( b )$$

$$\frac{\partial ln ( {T}_{[ N - i ]}^{} )}{\partial ln ( {N - i}_{} )} = ( ln ( {N - i}_{T}^{} ) \check{\times } \frac{\partial ln ( {T}_{[ N - i ]}^{} )}{\partial ln ( {N - i + 1}_{} )} ) \{ \frac{\partial ln ( {N - i + 1}_{} )}{\partial ln ( {N - i}_{} )} \} \qquad ( c )$$

$$( unlocked ) \frac{\partial {E}_{T}}{\partial {W}_{N - i}} = \{ \frac{\partial ln {T}_{[ N - i ]}^{}}{\partial ln ( {N - i}_{} )} \} \check{∘} ln {N - i}_{T}^{} ,$$

$$( locked ) \frac{\partial {E}_{T}}{\partial {W}_{N - i}} = {( {r}_{T , {π}_{rows , [ N - i ]}}^{[ N - i ]} )}^{- 1} {( \{ \frac{\partial ln {T}_{[ N - i ]}^{}}{\partial ln ( {N - i}_{} )} \} ln {N - i}_{T}^{} )}_{{π}_{rows , [ N - i ]}} = {( {r}_{T , {π}_{rows , [ N - i ]}}^{[ N - i ]} )}^{- 1} {R}_{{π}_{rows , [ N - i ]}}^{[ N - i ]} , where \{ \frac{\partial ln {T}_{[ j ]}^{}}{\partial ln ( {N - i}_{} )} \} = \frac{{N - i}_{}}{{T}_{[ j ]}^{}} \{ \frac{\partial {T}_{[ j ]}^{}}{\partial {N}_{}} \} \{ \frac{\partial {N}_{}}{\partial {N - 1}_{}} \} .$$

If the training data owner wishes to use or provide their now fine-tuned neural network as-a-Service others, then

$${( {r}_{T , {π}_{rows , [ N - i ]}}^{[ N - i ]} )}^{- 1} {R}_{{π}_{rows , [ N - i ]}}^{[ N - i ]}$$

may not be exchanged with the private neural network owner without giving away private information. Likewise, if a Hadamard multiple is exchanged, then the neural network owner cannot subtract from the weights to update it. The only option would be the neural network exchanging

$${( {r}_{T}^{[ N - i ]} )}^{- 1} {\hat{W}}_{N - i}$$

with the input owner.

Instead, then neural network owner may choose the following:

$${r}_{T , {π}_{rows , [ N - i ]}}^{[ N - i ]} = - {η}_{N - i} {r}_{N - 1 , {π}_{rows , [ N - i ]}^{- 1}} , \qquad ( B58 )$$

$$so that$$

$$Δ {N - i}_{} ≅ \frac{{N - i , new}_{}}{{N - i , old}_{}} = exp ( {R}^{( N - i )} ) , \qquad ( B59 )$$

where the congruence is modulo the expansion of the augmented matrix with dummy data.

Independent verification: Because transformed neural networks and transformed inputs and outputs and/or training data may arrive at the same answers for forward and backwards propagation performed separately by the two parties, the provide a means of independent verification.

For forward propagation, in Equations (B47) and (B55) with i=N−1, either the neural network owner or input owner may respectively perform the outer product (in the direction of the column expansion) associated with their corresponding transformed neural network or input data. After exchanging with the other party, the receiving party may invert the Hadamard and column permutation transformations associated with their own corresponding transformed data and subtract the two answers. If the result is zero, it is strong evidence, though not proof, the two parties performed forward propagation in accordance with this algorithm.

The preceding is true for backwards propagation in Equations (B51) and (B57) after substituting “column expansion” with “row expansion” and “column permutation” with “row permutation.”

Shared/Transformed Neural Networks with Shared/Transformed Training Data: Forward and Backward Propagation with Privacy

As should be clear from the previous sections, this case is not possible while protecting private data because none of the two parties could build the transformed activation and cost function. However, a trusted third party could do if desired.

### Smooth Approximations of Activation and Cost Functions

Many commonly used activation functions, e.g., ReLu, do not have Taylor Series expansions due to the lack of differentiability at the origin. However, we may use

$${σ}_{smooth} ( z ) = \frac{z}{( 1 - {e}^{- az} )} ,$$

for z≠0, and

$${σ}_{smooth} ( 0 ) = \frac{1}{a} ,$$

which is a close approximation of ReLu for a>>1. FIG. 30 shows a comparison for a=1000 (solid line) versus ReLu (dashed line).

Additionally, we may strength the security of activation and cost functions themselves, making it harder for attackers to use the analytic forms for commonly used functions (e.g., ReLu, sigmoid) to attempt to unlock private data.

One method is using bounded infinitely differentiable noise functions. To introduce variations are arbitrarily small intervals. For example, consider a partial Weierstrass function:

$${f}_{W , a , b , N} ( x ) = {\sum }_{n = 0}^{N} {a}^{n} cos ( {b}^{n} π x ) , where \frac{b + 1}{2} ∈ ℤ , ab > 1 + \frac{3 π}{2} . \qquad ( B60 )$$

As N→∞, this series remains continuous while being differentiable nowhere, but for finite series, (B60) is infinitely differentiable. By adding and/or multiplying σₛₘₒₒₜₕ(z) by functions like those in (B60), we may introduce variability at arbitrarily small intervals without affecting the macro-level activation properties.

In the example in FIG. 33, the solid curve shows

$${σ}_{smooth} ( z ) = \frac{z}{( 1 - {e}^{- 100 z} )} + \frac{{f}_{W , 0.9 , 7 , 40} ( z ) - 1}{2} ,$$

for z≠0, and

$${σ}_{smooth} ( 0 ) = \frac{1}{100} + \frac{{f}_{W , 0.9 , 7 , N} ( 0 ) - 1}{2} ,$$

and the dashed curve shows

$${σ}_{smooth} ( z ) = \frac{{zf}_{W , 0.9 , 7 , 40} ( 0 )}{( 1 - {e}^{- 100 z} )} .$$

for z≠0, and

$${σ}_{smooth} ( 0 ) = \frac{{f}_{W , 0.9 , 7 , N} ( 0 )}{100} .$$

Both methods introduce a bounded variability to the smooth surrogate for the ReLu activation function.

### Some Examples

To illustrate the privacy algorithms—one with transformed inputs, the other with transformed neural networks—we will work through some examples. A private neural network with private training data is shown in FIG. 34 in augmented matrix form.

Here, we have chosen

$$σ ( z ) = \frac{1}{( 1 + exp ( - z ) )}$$

for all elements. Choosing

$${E}_{T} = \frac{1}{2} {( {v}_{1}^{[ 3 ]} - {t}_{1} )}^{2} + \frac{1}{2} {( {v}_{2}^{[ 3 ]} - {t}_{2} )}^{2} ,$$

the final error is E_{T}=0.229.

Assigning a learning rate of 1 for all elements above, we can backpropagate to find the changes to the weights and biases in the output layer, as shown in FIG. 35. The weights and biases matrix for the output layer W₂ shows the changes to weights and biases due to training in dotted boxes.

With more partial derivatives, we find the weight and bias adjustments for the hidden layer, as shown in FIG. 36.

We will start with the case of transformed training data. To make the example easier to follow, we will not include any dummy data or permutations to focus on the exponentiation and transformed activation and cost functions.

To maintain a private input, the transformed input must necessarily be larger dimensionally, with corresponding adjustments to the augmented weight and bias matrices, as shown in FIG. 35.

Here, solid numbers without boxes (e.g. the first 3 columns) indicates private information, numbers in dotted line boxes is transformed data, and the multivariate transformed activation functions are the following Taylor Series expansions:

$$( {i , 1}_{} , {i , 2}_{} ) = {e}^{\frac{1}{2} {{( 1 + {e}^{- 0.22} {\check{z}}_{i , 1}^{- \frac{1}{3}} , {\check{z}}_{i , 1}^{- \frac{1}{2.7} ,} )}^{- 1}}^{- 1}} {\hat{σ}}_{i} ( ln ( {\check{z}}_{i , 1}^{\frac{2}{3}} {\check{z}}_{i , 2}^{\frac{2}{2.7}} ) ) = 4 σ ( z ) - 12 = \frac{4}{( 1 + exp ( z ) )} - 12 \qquad ( B61 )$$

$$( {i , 1}_{} , , {i , n}_{} ) = {e}^{\frac{4}{( 1 + {\check{z}}_{i , 1}^{1.5} {\check{z}}_{i , 2}^{1.35} )} - 12}$$

$${\hat{σ}}_{i} ( {r}_{i} ( {z}_{i} - {r}_{i} ) ) = 4 ( {σ}_{i} ( \frac{1}{2} ln ( {\check{z}}_{i , 1}^{\frac{2}{3}} {\check{z}}_{i , 2}^{\frac{2}{2.7}} ) + 0.22 ) - 3 ) = 4 {( 1 + {e}^{- 0.22} {\check{z}}_{i , 1}^{\frac{2}{3}} {\check{z}}_{i , 2}^{\frac{2}{2.7}} )}^{- 1} - 12 ,$$

$${\check{σ}}_{2}^{( 1 )} = 2.51319 + 1.94656 \cdot ( {\check{z}}_{1 , 2} - 1 ) + 0.0124432 \cdot {( {\check{z}}_{1 , 2} - 1 )}^{2} - 0.272646 \cdot {( {\check{z}}_{1 , 2} - 1 )}^{3} + 0.121284 \cdot {( {\check{z}}_{1 , 2} - 1 )}^{4} + ⋯ ,$$

$${\check{σ}}_{2}^{( 1 )} = 13.2841 + 7.81063 \cdot ( {\check{z}}_{2 , 1} - 1 ) + 0.302974 \cdot {( {\check{z}}_{2 , 1} - 1 )}^{2} - 0.704381 \cdot {( {\check{z}}_{2 , 1} - 1 )}^{3} + 0.24461 \cdot {( {\check{z}}_{2 , 1} - 1 )}^{4} + ⋯ ,$$

$${\check{σ}}_{2}^{( 1 )} = 8.731 + 5.6283 \cdot ( {\check{z}}_{2 , 2} - 1 ) + 0.166496 \cdot {( {\check{z}}_{2 , 2} - 1 )}^{2} - 0.171502 \cdot {( {\check{z}}_{2 , 2} - 1 )}^{3} + 0.0366469 \cdot {( {\check{z}}_{2 , 2} - 1 )}^{4} + ⋯ ,$$

We choose the following transformed error functions,

$${T , j , k}_{( i )}^{} ( {N}_{} ) = {( \frac{ijk}{10} )}^{\frac{jk}{2 i} {{Σ}_{l} ( {log}_{2} ( \frac{{{t}^{⌣}}_{l}}{{\check{v}}_{3 , l}} ) )}^{2} + \frac{i}{jk}} \qquad ( B62 )$$

### Sub-Embodiment 2.1: Uniform Matrix-Led Operations

The sub-embodiment described here (which is henceforth termed “Embodiment 2.1”) extends the methods of Embodiment 2 by adopting matrix-led operations uniformly more steps, including for transformed activation functions, enhancing privacy while maintaining computational consistency. In Embodiment 2, matrix expansions and row/column permutations were combined with optional term-wise operations for random scrambling or exponentiation, whereas. In Embodiment 2.1, all operations are matrix-led (see Table 1). Multiplications are performed as row-column operations, exponentials are represented as matrix exponentials (including diagonal matrices for Hadamard-like exponentials), and transformed activation functions are defined through power series represented by partially-invertible matrices. This approach further transforms cost and error functions into matrices, where indices correspond to power functions. Contrasting with Embodiment 2 sub-embodiment on shared data as described in FIGS. 26, 27 and 28, Embodiment 2.1 will include matrix-led multiplication instead in 2608 (as in Eqns. (B9) and (B12)), matrix terms with indices for power functions for the transformed activation function instead in 2706 (as in Eqn. (B13)) and forward or backpropagation operations are row-column matrix multiplications instead of term-wise operations as in 2714. Contrasting with Embodiment 2 sub-embodiment on ‘Shared NN’ as described in FIGS. 29, 30 and 31, Embodiment 2.1 will include matrix-led multiplication instead in 2918 (as in Eqns. (B8) and (B12)), matrix terms with indices for power functions for the transformed activation function instead in 3006 (as in Eqn. (B13)) and forward or backpropagation operations are row-column matrix multiplications instead of term-wise operations as in 2932.

Embodiment 2.1 closely follows the methods of Embodiment 2 while introducing a suite of privacy tools that can be selectively applied or stacked for greater privacy. These tools, including matrix-led operations such as row-column multiplications, matrix exponentials, and power series transformations, allow for scalable privacy enhancements with tradeoffs in computational load. Overall, by using matrix-led operations, Embodiment 2.1 maintains the matrix-led conceptual approach of Embodiment 1 while maintaining compatibility with the broader range of non-linear activation functions introduced in Embodiment 2.

A key advancement in Embodiment 2.1 is the balanced privacy protection it offers to both the data owner and the neural network (NN) owner. The data owner applies matrix multiplications from the right, while the NN owner applies them from the left, with each party preserving the privacy of their respective inputs. Unlike Embodiment 2, which applied security sequentially in a manner that may favor the NN owner, Embodiment 2.1 ensures equal protection by structuring operations into consecutive steps for both parties.

### 10. Embodiment 3: Trusted Third Party Embodiments

In Embodiment 3, a trusted third party generates the (transformed/shared) activation and cost functions. An attribute of Embodiments 2 and 2.1 is that one party—either the data owner or the NN owner—provides a transformed version of their untransformed data (the input data or the NN parameters, respectively) to the other party. This is accompanied by transformation compatibility data, transformed functions, and transformed operators, enabling computations to be performed in the transformed space while preserving data privacy. A necessary requirement for this approach is that one party must supply the transformed activation functions, depending on the use case. For example, in a shared data use case, the data owner provides the transformed functions, while in a shared NN use case, the NN owner provides the transformed functions.

However, a challenge arises when the NN owner offers their model as a service and escrows their transformed NN with a trusted third party (3DP) but cannot share the transformed NN directly with the data owner. In such cases, the data owner must rely on the trusted 3DP to perform computations in the transformed space.

Embodiment 3 addresses this challenge by introducing a trusted 3DP to facilitate secure, privacy-preserving computations. The 3DP generates and shares transformed activation and cost functions while preserving privacy for both parties. To achieve this, the 3DP generates two separate sets of random matrices: one for the data owner to transform their input data and another for the NN owner to transform their parameters. Using these matrices, the 3DP creates the transformed activation and cost functions, ensuring consistent transformations for computations in the transformed space. Neither party has access to the other's transformations, as the random matrices remain confidential.

In practical implementations, the 3DP can be realized using the IDMP enclave, which provides session-specific secure data storage, separate from the data owner's and NN owner's data planes. All computations occur within the secure enclave, and session data is securely deleted or archived afterward.

Sub-Embodiments of Embodiment 3 include the following:
1. Shared Data Use Case (Sub-Embodiment 3.1): The 3DP shares random matrices with the data owner for transforming their input data, using the same matrices to generate transformed functions shared with the NN owner.
2. Shared NN Use Case (Sub-Embodiment 3.2): The 3DP shares random matrices with the NN owner to transform their parameters, using the same matrices to generate transformed functions shared with the data owner.

Embodiment 3 ensures privacy for both parties, enabling secure and scalable neural network operations while addressing challenges in trust and data security.

### 11. Process Flows of Various Embodiments

Various methods, processes, non-transitory storage media, devices, servers, and systems for data sovereignty preserving processes are disclosed. The processes allow for collaborative use of a neural network (NN) between a data owner having private untransformed data and a NN owner having a private NN.

As discussed above, two major sub-embodiments of Embodiments 1 and 2 are discussed in the present disclosure. In a “shared data” sub-embodiment of the invention, the data owner shares a transformed representation of their data with the NN owner, and the NN owner carries out the NN operation in the transformed space. Conversely, in a “shared NN” sub-embodiment of the invention, the NN owner shares a transformed representation of their NN with the data owner, and the data owner carries out the NN operation in the transformed space.

Various processes are all within the scope of the present invention, and some illustrative examples of embodiments of processes are disclosed below. These examples are not meant to be exhaustive nor limiting the scope of the present invention, but are provided for illustrative purposes only. These processes may be implemented by one or more processors, executing program code from one or more memories and/or from one or more non-transitory storage media.

Anywhere a process is described as being executed by a processor, it is understood that one or more processors may be used to execute the process steps. Where a process is described as being executed from program code from a non-transitory storage medium, one or more non-transitory storage media may be used to store program code corresponding to one or more of the process sub-steps. Where a process is described as being executed from program code from a non-transitory storage medium, the program code may be equally executed from one or more memories, and/or from one or more non-transitory storage media, as would be apparent to one of ordinary skill in the art. Anywhere a process is described, it is understood it may be executed by a hardware processor, a device, a server, a system, and so on.

To assist the reader, the descriptions below of various embodiments of the invention are listed in the same order as the claims on these embodiments.

### Shared Data Methods

### Process at the Data Owner

### Preparing for Propagation: Transforming and Sending Data

A first aspect, or one embodiment of the present invention, is a computer-implemented method for neural network (NN) propagation, through a NN owned by a NN owner, of confidential data owned by a data owner.

The method may include generating a data owner private transformation key, where the data owner private transformation key is kept confidential by the data owner. The method may also include transforming the confidential data from a true space into transformed data in a transformed space using the data owner private transformation key. The method may also include generating a shared transformation key, where the shared transformation key is necessary for the NN owner to propagate the transformed data through a transformed NN in the transformed space. Finally, the method may also include transmitting, to the NN owner, the transformed data and the shared transformation key.

### Forward Propagation

In some embodiments, the confidential data may include input data for forward propagation through the NN. The method may also include receiving, from the NN owner, a transformed output in the transformed space, where the transformed output was generated by forward-propagating the input data through the transformed NN. The method may also include de-transforming the transformed output using the data owner private transformation key, to generate de-transformed output data in the true space, where the de-transformed output data is equivalent to a true space output generated by forward-propagating the input data through the NN in the true space.

### Transformation Setup Data

In some embodiments, the method may further include exchanging, with the NN owner, transformation setup data, where the transformation setup data is based at least on pre-agreed upon dimensionality data, where the transformation setup data provides information required for neural network operations in the transformed space, and where neural network operations performed in the transformed space are transformed operations that preserve corresponding neural network operations performed in the true space up to a predetermined error threshold.

### Transformation Operator

In some embodiments, the method may further include sending, to the NN owner, a transformation operator based at least on the transformation setup data, where the transformation operator is configured to perform transformed NN operations in the transformed space.

### Activation Function

In some embodiments, the method may further include exchanging, with the NN owner, an activation function, where the activation function is based at least on the transformation setup data, and where the activation function is required to perform transformed NN operations in the transformed space.

### Cost Function

In some embodiments, the transformation setup data may include a class of cost functions required to perform transformed NN operations in the transformed space, and the method may further include generating a cost function based on the class of cost functions of the transformation setup data.

### Secure Connection

In some embodiments, the method may further include initiating a secure connection between the data owner and the NN owner.

### Process at the NN Owner

### Propagation: Transforming the NN and Propagating the Transformed Data

A second aspect, or another embodiment of the present invention, is a computer-implemented method for neural network (NN) propagation, through a NN owned by a NN owner, of confidential data owned by a data owner.

The method may include receiving, from the data owner, transformed data in a transformed space, where the transformed data corresponds to the confidential data in a true space. The method may also include receiving, from the data owner, a shared transformation key necessary for the NN owner to propagate the transformed data through a transformed NN in the transformed space. The method may also include transforming a true NN from a true space into the transformed NN in the transformed space using information within the shared transformation key. Finally, the method may also include propagating the transformed data through the transformed NN in the transformed space, where the NN owner cannot access a transformed output in the transformed space generated by propagating the transformed data through the transformed NN.

### Forward Propagation

In some embodiments, the confidential data may include true input data for forward propagation through the NN, the transformed data may include transformed input data, and propagating the transformed data through the transformed NN may include forward-propagating the transformed input data through the transformed NN to generate the transformed output in the transformed space. The method may further include sending, to the data owner, the transformed output in the transformed space.

### Backpropagation

In some embodiments, the confidential data may include true training data and true target data for training the NN, the transformed data may include transformed training data and transformed target data for training the transformed NN, and propagating the transformed data through the transformed NN may include backpropagating one or more data points of the transformed training data and the transformed target data through the transformed NN in the transformed space, to generate one or more transformed error gradients in the transformed space. The method may further include training the NN using the one or more transformed error gradients in the transformed space to generate a transformed trained NN. Finally, the method may further include de-transforming the transformed NN by reversing the transforming of the true NN using information within the shared transformation key received from the data owner, to generate a trained NN in the true space.

### Shared NN Methods

### Process at the Data Owner

Propagation through the NN

A third aspect, or another embodiment of the present invention, is a computer-implemented method for neural network (NN) propagation, through a NN owned by a NN owner, of confidential data owned by a data owner.

The method may include receiving, from the NN owner, a transformed NN in a transformed space, where the transformed NN corresponds to a true NN in a true space. The method may also include transforming the confidential data from a true space into transformed data in the transformed space. Finally, the method may also include propagating the transformed data through the transformed NN in the transformed space, where the data owner cannot access a transformed output in the transformed space generated by propagating the transformed data through the transformed NN.

### Forward Propagation

In some embodiments, the confidential data may include true input data for forward propagation through the NN, the transformed data may include transformed input data, and propagating the transformed data through the transformed NN may include forward-propagating the transformed input data through the transformed NN to generate the transformed output in the transformed space. The method may further include generating a data owner private output transformation key, where the data owner private output transformation key is kept confidential by the data owner. The method may also include locking, using the data owner private output transformation key, the transformed output, to generate a locked transformed output, where a de-transformation of the locked transformed output from the transformed space to the true space preserves the locking in the true space and does not prevent a subsequent unlocking in the true space. The method may also include transmitting, to the NN owner, the locked transformed output. The method may also include receiving, from the NN owner, a locked de-transformed output. Finally, the method may also include unlocking the locked de-transformed output, using the data owner private output transformation key, to generate a de-transformed output data, where the de-transformed output data is equivalent to a true space output generated by forward-propagating the true input data through the NN in the true space.

### Backpropagation

In some embodiments, the confidential data may include true training data and true target data for training the NN, the transformed data may include transformed training data and transformed target data for training the transformed NN, and propagating the transformed data through the transformed NN may include backpropagating one or more data points of the transformed training data and the transformed target data through the transformed NN in the transformed space, to generate one or more transformed error gradients in the transformed space. The method may further include training the transformed NN using the one or more transformed error gradients in the transformed space to generate a trained transformed NN, where the data owner cannot de-transform the transformed NN or access a transformed output of the trained transformed NN in the transformed space without a NN owner private transformation key. Finally, the method may further include transmitting the trained transformed NN to the NN owner.

### Process at the NN Owner

### Transforming and Sharing the AN

A fourth aspect, or another embodiment of the present invention, is a computer-implemented method for neural network (NN) propagation, through a NN owned by a NN owner, of confidential data owned by a data owner. The method may include generating a NN owner private transformation key, where the NN owner private transformation key is kept confidential by the NN owner. The method may also include transforming a true NN from a true space, using the NN owner private transformation key, to generate a transformed NN in a transformed space. Finally, the method may also include transmitting, to the data owner, the transformed NN.

### Forward Propagation: Receiving and De-Transforming a Locked Transformed Output

In some embodiments, the confidential data may include true input data for forward propagation through the NN. The method may further include receiving, from the data owner, a locked transformed output of the transformed NN in the transformed space. The method may also include de-transforming, using the NN owner private transformation key, the locked transformed output, to generate a locked de-transformed output in the true space, where the NN owner cannot access the locked de-transformed output without a data owner private output transformation key. Finally, the method may also include transmitting, to the data owner, the locked de-transformed output.

### Backpropagation

In some embodiments, the confidential data may include true training data and true target data for training the NN, and the true training data and true target data were transformed by the data owner, to generate transformed training data and transformed target data. The method may further include receiving, from the data owner, a trained transformed NN, where the trained transformed NN was trained by the data owner in the transformed space using the transformed training data and transformed target data, and where the NN owner has no access to the transformed training data and the transformed target data used for training the trained transformed NN. Finally, the method may also include de-transforming the trained transformed NN using the NN owner private transformation key, to generate a trained NN in the true space.

### Program Code Executing Shared Data Process

### Process at the Data Owner

### Preparing for Propagation: Transforming and Sending Data

A fifth aspect, or another embodiment of the present invention, is one or more non-transitory physical storage media storing program code. The program code may be executable by a hardware processor. The hardware processor when executing the program code may cause the hardware processor to execute a computer-implemented privacy-preserving process for utilizing a neural network (NN) between a data owner having untransformed data and a NN owner having a private NN.

The program code may include code to initiate a secure connection between the data owner and the NN owner. The program code may also include code to exchange, with the NN owner, transformation compatibility data, where the transformation compatibility data is based at least on pre-agreed upon dimensionality data, where the transformation compatibility data provides information required for neural network operations in a transformed space, and where neural network operations performed in the transformed space are transformed operations that preserve corresponding neural network operations performed in an untransformed space up to a predetermined error threshold. The program code may also include code to exchange, with the NN owner, an activation function, where the activation function is based at least on the transformation compatibility data. The program code may also include code to generate a data owner private transformation key based at least on the transformation compatibility data, where the data owner private transformation key is configured to transform the untransformed data from the untransformed space into transformed data in the transformed space, and where the data owner private transformation key is kept confidential by the data owner. The program code may also include code to transform the untransformed data utilizing at least the data owner private transformation key to generate the transformed data in the transformed space. The program code may also include code to generate a shared transformation key, where the shared transformation key is necessary for the NN owner to propagate the transformed data through the transformed NN in the transformed space. Finally, the program code may also include code to send, to the NN owner, the transformed data and the shared transformation key necessary for the NN owner to propagate the transformed data through the transformed NN in the transformed space.

### Transformed Data

In some embodiments, the transformed data is generated using the transformation compatibility data and the data owner private transformation key.

### Shared Transformation Key

In some embodiments, the shared transformation key may include shared hidden layer transformation data generated based at least on the transformation compatibility data and the data owner private transformation key.

### Private Transformation Key

In some embodiments, the data owner private transformation key may include a set of random matrices, and where at least one individual data entry within the set of random matrices is a non-zero entry generated by the data owner using a random number generator.

### Forward Propagation: Receiving and De-Transforming the Transformed Output

In some embodiments, the untransformed data is untransformed input data for forward propagation through the transformed NN, where the transformed data is transformed input data. The program code may further include code to receive, from the NN owner, transformed output data, where the transformed output data may include output from a transformed NN in the transformed space in response at least to the transformed input data. Finally, the program code may also include code to generate a de-transformed output in the untransformed space from the transformed output data by de-transforming the untransformed data using the data owner private transformation key.

### Transformation Operator

In some embodiments, the program code may include code to send, to the NN owner, a transformation operator based at least on the transformation compatibility data, where the transformation operator is configured to perform transformed NN operations in the transformed space.

### NN Transformation

In some embodiments, the transformed NN may have been transformed using the transformation compatibility data, the activation function, the shared transformation key, and the transformation operator.

### Transformed Activation Function, According to Embodiment 2

In some embodiments, the activation function is a transformed activation function. The program code may further include code to generate the transformed activation function from an untransformed activation function through a series expansion using the transformation compatibility data and the data owner private transformation key.

### Transformation Compatibility Data: Multivariate Activation Functions

In some embodiments, the transformation compatibility data may include one or more multivariate terms within the transformed activation function to define a transformation of the untransformed activation function.

### Transformed Activation Function: Adding Noise

In some embodiments, a noise component is embedded within the transformed activation function by adding it to the untransformed activation function prior to the series expansion.

### Transformed Activation Function: Added Noise Features

In some embodiments, the noise component is a bounded differentiable noise function.

### Transformation Compatibility Data: Further Details

In some embodiments, the transformation compatibility data may include at least dimensions of the untransformed data, a location of a bias vector within the private NN, one or more dimensions of the private NN, a class of activation functions, and an error transformation key.

### Transformation: Configuration Details

In some embodiments, transforming the untransformed data to generate the transformed data may include one or more of a matrix expansion, a matrix right-multiplication, and a matrix exponentiation.

### Transformation: Further Configuration Details

In some embodiments, transforming the untransformed data to generate the transformed data may include expanding an untransformed data matrix using an expansion matrix associated with the data owner private transformation key to generate an expanded untransformed data matrix, right-multiplying the expanded untransformed data matrix using a multiplication matrix associated with the data owner private transformation key to generate a multiplied untransformed data matrix, and exponentiating the multiplied untransformed data matrix using an exponentiation matrix associated with the data owner private transformation key to generate a transformed data matrix.

### Transformation: Configuration Details Specific to Embodiment 1

In some embodiments, the exponentiating the multiplied untransformed data matrix uses an element-wise matrix exponentiation.

### Transformation: Configuration Details Specific to Embodiment 2

In some embodiments, the exponentiating the multiplied untransformed data matrix uses a row-column matrix-wise matrix exponentiation.

### Backpropagation: Cost Function Class

In some embodiments, the transformation compatibility data may include a class of cost functions.

### Backpropagation: Cost Function Generation

In some embodiments, the program code may further include code to generate a cost function based on the class of cost functions of the transformation compatibility data.

### Backpropagation: Cost Function Transformation

In some embodiments, the untransformed data may include target data and a training data set, and the transformed data may include a transformed target data and a transformed training data set. The program code may further include code to transform the cost function through a series expansion using the transformation compatibility data and the data owner private transformation key. The program code may also include code to generate a transformed cost function. Finally, the program code may also include code to send, to the NN owner, the transformed cost function.

### Backpropagation: Locked Training Data

In some embodiments, the program code may further include code to identify, through an exchange with the NN owner, at least one locked data point of the transformed target data and the transformed training data set. The program code may also include code to receive, from the NN owner, a locked gradient associated with the at least one locked data point. The program code may also include code to generate a partially unlocked gradient from the locked gradient, using at least the data owner private transformation key. Finally, program code may also include code to send, to the NN owner, the partially unlocked gradient to enable the unlocking of the gradient associated with the at least one locked data point for backpropagation.

### Process at the NN Owner

### Transforming the NN

A sixth aspect, or another embodiment of the present invention, is one or more non-transitory physical storage media storing program code. The program code may be executable by a hardware processor. The hardware processor when executing the program code may cause the hardware processor to execute a computer-implemented privacy-preserving process for utilizing a neural network (NN) between a data owner having untransformed data and a NN owner having a private NN.

The program code may include code to initiate a secure connection between the data owner and the NN owner. The program code may also include code to exchange, with the data owner, transformation compatibility data, where the transformation compatibility data is based at least on pre-agreed upon dimensionality data, where the transformation compatibility data provides information required for neural network operations in a transformed space, and where neural network operations performed in the transformed space are transformed operations that preserve corresponding neural network operations performed in an untransformed space up to a predetermined error threshold. The program code may also include code to exchange, with the data owner, an activation function, where the activation function is based at least on the transformation compatibility data. The program code may also include code to receive, from the data owner, transformed data and a shared transformation key necessary for the NN owner to propagate the transformed data through a transformed NN in the transformed space. Finally, the program code may also include code to transform the private NN using the transformation compatibility data to generate a transformed NN.

### Transformation Operator

In some embodiments, the program code may include code to receive, from the data owner, a transformation operator based at least on the transformation compatibility data, where the transformation operator is configured to perform transformed NN operations in the transformed space.

### NN Transformation

In some embodiments, the transformed NN may have been transformed using the transformation compatibility data, the activation function, the shared transformation key, and the transformation operator.

### Transformed Activation Function, According to Embodiment 2

In some embodiments, the activation function is a transformed activation function generated from an untransformed activation function through a series expansion using the transformation compatibility data and a private transformation key generated by the data owner.

### Transformation Compatibility Data: Multivariate Activation Functions

In some embodiments, the transformation compatibility data may include one or more multivariate terms within the transformed activation function to define a transformation of the untransformed activation function.

### Forward Propagation: Generating and Sending the Transformed Output

In some embodiments, the transformed data is transformed input data for forward propagation through the transformed NN. The program code may further include code to generate transformed output data from the transformed input data using the transformed NN, the shared transformation key and the transformation operator, where the transformed output data may include output from a transformed NN in the transformed space in response at least to the transformed input data. Finally, the program code may also include code to send, to the data owner, the transformed output data.

### Transformation Compatibility Data

In some embodiments, the transformation compatibility data may include at least dimensions of the untransformed data, a location of a bias vector within the private NN, one or more dimensions of the private NN, a class of activation functions, and an error transformation key.

### Checking the Consistency of Dimensionality Data

In some embodiments, the program code may further include code to verify, upon receiving the transformation compatibility data and the transformation operator, that the transformation operator is consistent with the dimensions of the untransformed data included within the transformation compatibility data.

### Transforming the NN

In some embodiments, transforming the private NN may include generating an expanded weights and biases matrix through a matrix expansion, where the matrix expansion may include expanding an untransformed weights and biases matrix associated with the private NN using the dimensions of the untransformed data from the transformation compatibility data.

### Transformation Operations

In some embodiments, transforming the private NN may further include generating transformed weights and biases through a matrix permutation and a matrix multiplication of the expanded weights and biases matrix, where the matrix permutation may include a rearrangement of rows of a matrix according to a specific permutation sequence, and where the matrix multiplication is one of term-wise multiplication and row-column matrix multiplication.

### Backpropagation: Cost Function

In some embodiments, the transformed data may include transformed target data and a transformed training data set. The program code may further include code to receive, from the data owner, a transformed cost function required to train the transformed NN in the transformed space.

### Backpropagation Using Unlocked Training Data

In some embodiments, the program code may further include code to perform backpropagation through the transformed NN using a plurality of data points of the transformed target data and the transformed training data set, the transformed cost function, the shared transformation key, and the transformation operator, to generate a plurality of error terms in the transformed space corresponding to the plurality of data points. The program code may also include code to generate a plurality of unlocked gradients using the plurality of error terms, where the plurality of unlocked gradients are unlocked based on a generation of a private transformation key by the data owner. The program code may also include code to update the transformed weights and biases using the plurality of unlocked gradients. Finally, the program code may also include code to generate a trained transformed NN using the updated transformed weights and biases.

### Backpropagation Using Locked Training Data

In some embodiments, the program code may further include code to identify, through an exchange with the data owner, at least one locked data point of the transformed target data and the transformed training data set. The program code may also include code to perform backpropagation through the transformed NN using the at least one locked data point, the transformed cost function, the shared transformation key, and the transformation operator, to generate at least one error term corresponding to the at least one locked data point in the transformed space. The program code may also include code to generate at least one locked gradient based on the at least one error term, where the at least one locked gradient is locked based on a generation of a private transformation key by the data owner. The program code may also include code to send, to the data owner, the at least one locked gradient associated with the at least one locked data point. The program code may also include code to receive, from the data owner, at least one partially unlocked gradient associated with the at least one locked data point. The program code may also include code to generate at least one unlocked gradient from the at least one locked gradient using at least the error transformation key. The program code may also include code to update the transformed weights and biases using the at least one unlocked gradient. Finally, the program code may also include code to generate a trained transformed NN using the updated transformed weights and biases.

### NN Agent Exclave

In some embodiments, the transformed NN may be generated by the NN owner within a NN agent exclave accessible from a data owner's network, where the NN agent exclave is a secure data storage configured to host the transformed NN and accessible on a permissioned-basis for data exchange.

### NN Agent Exclave: Receiving NN Configuration Information

In some embodiments, the program code to transform the private NN may include program code to securely transmit session-specific configuration information of the transformed NN to the NN agent exclave using a dedicated secure connection.

### NN Agent Exclave: Receiving Specific NN Configuration Information

In some embodiments, the session-specific configuration information of the transformed NN may include one of a NN model architecture, a NN hyperparameter, and a NN data schema.

### De-Transforming the NN Back to Untransformed Space: Unlocked Training Data Case

In some embodiments, the program code may include code to generate a de-transformed weights and biases matrix by reversing the matrix expansion, the matrix permutation, and/or a matrix exponentiation performed during the transforming of the private NN, and using at least the transformation compatibility data. Finally, the program code may also include code to generate a de-transformed trained NN in the untransformed space based on the de-transformed weights and biases matrix.

### New Transformed Trained NN in a New Transformed Space: Unlocked Training Data Case

In some embodiments, the program code may include code to initiate a new secure connection between a new data owner and the NN owner. The program code may also include code to receive, from the new data owner, new transformation compatibility data, where the new transformation compatibility data provides information required for neural network operations in a new transformed space. The program code may also include code to receive, from the new data owner, a new activation function, where the new activation function is based at least on the new transformation compatibility data. The program code may also include code to receive, from the new data owner, new transformed data and a new shared transformation key necessary for the NN owner to propagate the new transformed data through a new transformed trained NN in the new transformed space. Finally, the program code may also include code to transform the de-transformed trained NN from the untransformed space to the new transformed space using the new transformation compatibility data to generate the new transformed trained NN.

### Program Code Executing Shared NN Process

### Process at the NN Owner

### Transforming the NN

A seventh aspect, or another embodiment of the present invention, is one or more non-transitory physical storage media storing program code. The program code may be executable by a hardware processor. The hardware processor when executing the program code may cause the hardware processor to execute a computer-implemented privacy-preserving process for utilizing a neural network (NN) between a data owner having untransformed data and a NN owner having a private NN.

The program code may include code to initiate a secure connection between the NN owner and the data owner. The program code may also include code to exchange, with the data owner, transformation compatibility data, where the transformation compatibility data is based at least on pre-agreed upon dimensionality data, where the transformation compatibility data provides information required for neural network operations in a transformed space, and where neural network operations performed in the transformed space are transformed operations that preserve corresponding neural network operations performed in an untransformed space up to a predetermined error threshold. The program code may also include code to exchange, with the data owner, an activation function, where the activation function is based at least on the transformation compatibility data. The program code may also include code to generate a NN owner private transformation key based at least on the transformation compatibility data, where the NN owner private transformation key is configured to transform the untransformed NN from the untransformed space into a transformed NN in the transformed space, and where the NN owner private transformation key is kept confidential by the NN owner. The program code may also include code to transform the private NN utilizing the transformation compatibility data and the NN owner private transformation key to generate the transformed NN in the transformed space. Finally, the program code may also include code to send, to the data owner, the transformed NN.

### Private Transformation Key

In some embodiments, the NN owner private transformation key may include a set of random matrices, where at least one individual data entry within the set of random matrices is a non-zero entry generated by the data owner using a random number generator.

### Transformed Activation Function, According to Embodiment 2

In some embodiments, the activation function may be a transformed activation function. The program code may further include code to generate the transformed activation function from an untransformed activation function through a series expansion using the transformation compatibility data and the NN owner private transformation key.

### Transformation of Weights and Biases: Matrix Operations

In some embodiments, the transformed NN may include transformed weights and biases generated through one or more transformation steps using the transformation compatibility data, where the one or more transformation steps include one of a matrix expansion, a matrix multiplication, and a matrix exponentiation.

### Transformation Operator

In some embodiments, the program code may include code to send, to the data owner, a transformation operator based at least on the transformation compatibility data, where the transformation operator is configured to perform transformed NN operations in the transformed space.

### Process at the Data Owner

### Receiving the Transformed NN

An eighth aspect, or another embodiment of the present invention, is one or more non-transitory physical storage media storing program code. The program code may be executable by a hardware processor. The hardware processor when executing the program code may cause the hardware processor to execute a computer-implemented privacy-preserving process for utilizing a neural network (NN) between a data owner having untransformed data and a NN owner having a private NN.

The program code may include code to initiate a secure connection between the data owner and the NN owner. The program code may also include code to exchange, with the NN owner, transformation compatibility data, where the transformation compatibility data is based at least on pre-agreed upon dimensionality data, where the transformation compatibility data provides information required for neural network operations in a transformed space, and where neural network operations performed in the transformed space are transformed operations that preserve corresponding neural network operations performed in an untransformed space up to a predetermined error threshold. The program code may also include code to exchange, with the NN owner, an activation function, where the activation function is based at least on the transformation compatibility data. Finally, the program code may also include code to receive, from the NN owner, a transformed NN, where the transformed NN was generated in the transformed space by transforming the private NN from the untransformed space using the transformation compatibility data and a NN owner private transformation key generated by the NN owner.

### Transformed Activation Function, According to Embodiment 2

In some embodiments, the activation function is a transformed activation function generated by the NN owner.

### Transformation Operator

In some embodiments, the program code may include code to receive, from the NN owner, a transformation operator based at least on the transformation compatibility data, where the transformation operator is configured to perform transformed NN operations in the transformed space.

### Forward Propagation Operations

In some embodiments, the untransformed data is untransformed input data for forward propagation through the transformed NN. The program code may further include code to transform the untransformed input data by applying a set of matrix operations using the transformation compatibility data, to generate transformed input data in the transformed space. The program code may also include code to generate transformed output data from the transformed input data using the transformed NN, the activation function, and the transformation operator, where the transformed output data may include output from the transformed NN in the transformed space in response at least to the transformed input data. The program code may also include code to generate locked transformed output data from the transformed output data using a private output transformation key. The program code may also include code to send the locked transformed output data to the NN owner. The program code may also include code to receive, from the NN owner, locked untransformed output data, where the locked untransformed output data was generated by the NN owner from the locked transformed output data by reversing the transforming of the untransformed input data using the NN owner private transformation key. Finally, the program code may also include code to generate untransformed output data in the untransformed space from the locked untransformed output data using the private output transformation key.

### Transforming the Input Data

In some embodiments, the set of matrix operations may include generating an expanded untransformed input data matrix through a matrix expansion, where the matrix expansion may include expanding an untransformed input data matrix using one or more dimensions of the private NN from the transformation compatibility data.

### Transformation Operations

In some embodiments, the set of matrix operations may further include generating the transformed output data through a matrix permutation and a matrix multiplication of the expanded untransformed input data matrix, where a matrix permutation may include a rearrangement of columns of a matrix according to a specific permutation sequence, and where a matrix multiplication generates a product matrix, a product vector, or a product scalar, by multiplying elements of a first matrix with elements of a second matrix in a specific pattern.

### 12. System Architectures

### Exemplary System Architecture

An exemplary embodiment of the present disclosure may include one or more servers (management computing entities), one or more networks, and one or more clients (user computing entities). Each of these components, entities, devices, and systems (similar terms used herein interchangeably) may be cloud-based, and in direct or indirect communication with, for example, one another over the same or different wired or wireless networks. All of these devices, including servers, clients, and other computing entities or nodes may be run internally by a customer (in various architecture configurations including private cloud), internally by the provider of the IDMP (in various architecture configurations including private cloud), and/or on the public cloud.

FIG. 38 provides illustrative schematics of a server (management computing entity) 3810 connected via a network 3820 to a client (user computing entity) 3830 used within an IDMP, according to some embodiments of the present invention. While FIG. 38 illustrates the various system entities as separate, standalone entities, the various embodiments are not limited to this particular architecture. Additionally, the terms “client device”, “client computing entity”, “edge device”, and “edge computing system” are equivalent and are used interchangeably herein.

### Exemplary Management Computing Entity

An illustrative schematic is provided in FIG. 38 for a server or management computing entity 3810. In general, the terms computing entity, computer, entity, device, system, and/or similar words used herein interchangeably may refer to, for example, one or more cloud servers, computers, computing entities, desktop computers, mobile phones, tablets, phablets, notebooks, laptops, distributed systems, gaming consoles, watches, glasses, iBeacons, proximity beacons, key fobs, radio frequency identification (RFID) tags, earpieces, scanners, televisions, dongles, cameras, wristbands, wearable items/devices, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, crawling, displaying, storing, determining, creating/generating, monitoring, evaluating, and/or comparing (similar terms used herein interchangeably). In one embodiment, these functions, operations, and/or processes can be performed on data, content, and/or information (similar terms used herein interchangeably), as they are used in a digital engineering process.

In one embodiment, management computing entity 3810 may be equipped with one or more communication interfaces 3812 for communicating with various computing entities, such as by exchanging data, content, and/or information (similar terms used herein interchangeably) that can be transmitted, received, operated on, processed, displayed, stored, and/or the like. For instance, management computing entity 3810 may communicate with one or more client computing devices such as 3830 and/or a variety of other computing entities. Network or communications interface 3812 may support various wired data transmission protocols including, but not limited to, Fiber Distributed Data Interface (FDDI), Digital Subscriber Line (DSL), Ethernet, Asynchronous Transfer Mode (ATM), frame relay, and data over cable service interface specification (DOCSIS). In addition, management computing entity 3810 may be capable of wireless communication with external networks, employing any of a range of standards and protocols, including but not limited to, general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High-Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

As shown in FIG. 38, in one embodiment, management computing entity 3810 may include or be in communication with one or more processors 3814 (also referred to as processors and/or processing circuitry, processing elements, and/or similar terms used herein interchangeably) that communicate with other elements within management computing entity 3810, for example, via a bus. As will be understood, processor 3814 may be embodied in a number of different ways. For example, processor 3814 may be embodied as one or more complex programmable logic devices (CPLDs), microprocessors, multi-core processors, co-processing entities, application-specific instruction-set processors (ASIPs), graphical processing units (GPUs), microcontrollers, and/or controllers. The term circuitry may refer to an entire hardware embodiment or a combination of hardware and computer program products. Thus, processor 3814 may be embodied as integrated circuits (ICs), application-specific integrated circuits (ASICs), field-programmable gate arrays (FPGAs), programmable logic arrays (PLAs), hardware accelerators, other circuitry, and/or the like. As will therefore be understood, processor 3814 may be configured for a particular use or configured to execute instructions stored in volatile or non-volatile (or non-transitory) media 3816 and 3818, or otherwise accessible to processor 3814. As such, whether configured by hardware or computer program products, or by a combination thereof, processor 3814 may be capable of performing steps or operations according to embodiments of the present disclosure when configured accordingly.

In one embodiment, management computing entity 3810 may further include or be in communication with non-transitory memory 3818 (also referred to as non-volatile media, non-volatile storage, non-transitory storage, physical storage media, memory, memory storage, and/or memory circuitry—similar terms used herein interchangeably). In one embodiment, the non-transitory memory or storage may include one or more non-transitory memory or storage media, including but not limited to hard disks, ROM, PROM, EPROM, EEPROM, flash memory, MMCs, SD memory cards, Memory Sticks, CBRAM, PRAM, FeRAM, NVRAM, MRAM, RRAM, SONOS, FIG RAM, Millipede memory, racetrack memory, and/or the like. As will be recognized, the non-volatile (or non-transitory) storage or memory media may store cloud storage buckets, databases, database instances, database management systems, data, applications, programs, program modules, scripts, source code, object code, byte code, compiled code, interpreted code, machine code, executable instructions, and/or the like. The term database, database instance, and/or database management system (similar terms used herein interchangeably) may refer to a collection of records or data that is stored in a computer-readable storage medium using one or more database models, such as a hierarchical database model, network model, relational model, entity-relationship model, object model, document model, semantic model, graph model, and/or the like.

In one embodiment, management computing entity 3810 may further include or be in communication with volatile memory 3816 (also referred to as volatile storage, memory, memory storage, memory and/or circuitry—similar terms used herein interchangeably). In one embodiment, the volatile storage or memory may also include one or more volatile storage or memory media, including but not limited to RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. As will be recognized, the volatile storage or memory media may be used to store at least portions of the databases, database instances, database management systems, data, applications, programs, program modules, scripts, source code, object code, byte code, compiled code, interpreted code, machine code, executable instructions, and/or the like being executed by, for example, processor 3814. Thus, the cloud storage buckets, databases, database instances, database management systems, data, applications, programs, program modules, scripts, source code, object code, byte code, compiled code, interpreted code, machine code, executable instructions, and/or the like may be used to control certain aspects of the operation of management computing entity 3810 with the assistance of processor 3814 and an operating system.

Although not shown, management computing entity 3810 may include or be in communication with one or more input elements, such as a keyboard input, a mouse input, a touch screen/display input, motion input, movement input, audio input, pointing device input, joystick input, keypad input, and/or the like. Management computing entity 3810 may also include or be in communication with one or more output elements, also not shown, such as audio output, visual output, screen/display output, motion output, movement output, spatial computing output (e.g., virtual reality or augmented reality), and/or the like.

As will be appreciated, one or more of the components of management computing entity 3810 may be located remotely from other management computing entity components, such as in a distributed system. Furthermore, one or more of the components may be combined and additional components performing functions described herein may be included in management computing entity 3810. Thus, management computing entity 3810 can be adapted to accommodate a variety of needs and circumstances. As will be recognized, these architectures and descriptions are provided for exemplary purposes only and are not limited to the various embodiments.

### Exemplary User Computing Entity

A user may be a human individual, a company, an organization, an entity, a department within an organization, a representative of an organization and/or person, an artificial user such as algorithms, artificial intelligence, or other software that interfaces, and/or the like. FIG. 38 further provides an illustrative schematic representation of a client user computing entity 3830 that may be used in conjunction with embodiments of the present disclosure. In various embodiments, computing device 3830 may be a general-purpose computing device with dedicated modules for performing digital engineering-related tasks. It may alternatively be implemented in the cloud, with logically and/or physically distributed architectures.

As shown in FIG. 38, user computing entity 3830 may include a power source 3831, an antenna 3870, a radio transceiver 3832, a network and communication interface 3834, and a processor unit 3840 that provides signals to and receives signals from the network and communication interface. The signals provided to and received may include signaling information in accordance with air interface standards of applicable wireless systems. In this regard, user computing entity 3830 may be capable of operating with one or more air interface standards, communication protocols, modulation types, and access types. More particularly, user computing entity 3830 may operate in accordance with any of a number of wireless communication standards and protocols, such as those described above with regard to management computing entity 3810. Similarly, user computing entity 3830 may operate in accordance with multiple wired communication standards and protocols, such as those described above with regard to management computing entity 3810.

Via these communication standards and protocols, user computing entity 3830 may communicate with various other entities using concepts such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). User computing entity 3830 may also download changes, add-ons, and updates, for instance, to its firmware, software (e.g., including executable instructions, applications, program modules), and operating system.

In some implementations, processing unit 3840 may be embodied in several different ways. For example, processing unit 3840 may be embodied as one or more complex programmable logic devices (CPLDs), microprocessors, multi-core processors, co-processing entities, application-specific instruction-set processors (ASIPs), graphical processing units (GPUs), microcontrollers, and/or controllers. Further, processing unit 3840 may be embodied as one or more other processing devices or circuitry. The term circuitry may refer to an entirely hardware embodiment or a combination of hardware and computer program products. Thus, processing unit 3840 may be embodied as integrated circuits, application specific integrated circuits (ASICs), field programmable gate arrays (FPGAs), programmable logic arrays (PLAs), hardware accelerators, other circuitry, and/or the like. As will therefore be understood, processing unit 3840 may be configured for a particular use or configured to execute instructions stored in volatile or non-volatile media or otherwise accessible to the processing unit. As such, whether configured by hardware or computer program products, or by a combination thereof, processing unit 3840 may be capable of performing steps or operations according to embodiments of the present invention when configured accordingly.

In some embodiments, processing unit 3840 may comprise a control unit 3842 and a dedicated arithmetic logic unit (ALU) 3844 to perform arithmetic and logic operations. In some embodiments, user computing entity 3830 may comprise a graphics processing unit (GPU) 3846 for specialized parallel processing tasks, and/or an artificial intelligence (AI) module or accelerator 3848, also specialized for applications including artificial neural networks and machine learning. In some embodiments, processing unit 3840 may be coupled with GPU 3846 and/or AI accelerator 3848 to distribute and coordinate digital engineering related tasks.

In some embodiments, computing entity 3830 may include a user interface, including an input interface 3850 and an output interface 3852, each coupled to processing unit 3840. User input interface 3850 may comprise any of a number of devices or interfaces allowing computing entity 3830 to receive data, such as a keypad (hard or soft), a touch display, a mic/speaker for voice/speech/conversation, a camera for motion or posture interfaces, and appropriate sensors for spatial computing interfaces. User output interface 3852 may comprise any of a number of devices or interfaces allowing computing entity 3830 to provide information to a user, such as through the touch display, or a speaker for audio outputs. In some embodiments, output interface 3852 may connect computing entity 3830 to an external loudspeaker or projector, for audio and/or visual output. In some embodiments, user interfaces 3850 and 3852 integrate multimodal data in an interface that caters to human users. Some examples of human interfaces include a dashboard-style interface, a workflow-based interface, conversational interfaces, and spatial-computing interfaces. As shown in FIG. 7, computing entity 3830 may also support bot/algorithmic interfaces such as code interfaces, text-based API interfaces, and the like.

User computing entity 3830 can also include volatile and/or non-volatile storage or memory 3860, which can be embedded and/or may be removable. For example, the non-volatile or non-transitory memory may be ROM, PROM, EPROM, EEPROM, flash memory, MMCs, SD memory cards, Memory Sticks, CBRAM, PRAM, FeRAM, NVRAM, MRAM, RRAM, SONOS, FIG RAM, Millipede memory, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The volatile and non-volatile (or non-transitory) storage or memory 3860 may store an operating system 3862, application software 3864, data 3866, databases, database instances, database management systems, data, applications, programs, program modules, scripts, source code, object code, byte code, compiled code, interpreted code, machine code, executable instructions, and/or the like to implement functions of user computing entity 3830. As indicated, this may include a user application that is resident on the entity or accessible through a browser or other user interface for communicating with management computing entity 3810 and/or various other computing entities.

In some embodiments, user computing entity 3830 may include one or more components or functionalities that are the same or similar to those of management computing entity 3810, as described in greater detail above. As will be recognized, these architectures and descriptions are provided for exemplary purposes only and are not limited to the various embodiments.

In some embodiments, computing entities 3810 and/or 3830 may communicate to external devices like other computing devices and/or access points to receive information such as software or firmware, or to send information from the memory of the computing entity to external systems or devices such as servers, computers, smartphones, and the like.

In some embodiments, two or more computing entities such as 3810 and/or 3830 may establish connections using a network such as 3820 utilizing any of the networking protocols listed previously. In some embodiments, the computing entities may use network interfaces such as 3812 and 3834 to communicate with each other, such as by communicating data, content, information, and/or similar terms used herein interchangeably that can be transmitted, received, operated on, processed, displayed, stored, and/or the like.

### Additional Hardware & Software Implementation Details

Although an example processing system has been described above, implementations of the subject matter and the functional operations described herein can be implemented in other types of digital electronic circuitry, or in computer software, firmware, or hardware, including the structures disclosed in this specification and their structural equivalents, or in combinations of one or more of them.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described herein can be implemented as one or more computer programs, i.e., one or more modules of computer program instructions, encoded on computer storage medium for execution by, or to control the operation of, information/data processing apparatus. Alternatively, or in addition, the program instructions can be encoded on an artificially generated propagated signal, e.g., a machine-generated electrical, optical, or electromagnetic signal, which is generated to encode information/data for transmission to suitable receiver apparatus for execution by an information/data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The operations described herein can be implemented as operations performed by an information/data processing apparatus on information/data stored on one or more computer-readable storage devices or received from other sources.

The terms “processor”, “computer,” “data processing apparatus”, and the like encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing, and grid computing infrastructures.

A computer program (also known as a program, software, software application, script, code, program code, and the like) can be written in any form of programming language, including compiled or interpreted languages, declarative or procedural languages, and it can be deployed in any form, including as a standalone program or as a module, component, subroutine, object, or other unit suitable for use in a computing environment. A computer program may, but need not, correspond to a file in a file system. A program can be stored in a portion of a file that holds other programs or information/data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described herein can be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read only memory or a random-access memory or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, e.g., magnetic, magneto optical disks, or optical disks. However, a computer need not have such devices. Devices suitable for storing computer program instructions and information/data include all forms of non-volatile memory, media, and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described herein can be implemented on a computer having a display device, e.g., a CRT (cathode ray tube) or LCD (liquid crystal display) monitor, for displaying information/data to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described herein can be implemented in a computing system that includes a backend component, e.g., as an information/data server, or that includes a middleware component, e.g., an application server, or that includes a frontend component, e.g., a client computer having a graphical user interface or a web browser through which a user can interact with an implementation of the subject matter described herein, or any combination of one or more such back end, middleware, or front end components. The components of the system may be interconnected by any form or medium of digital information/data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship with each other. In some embodiments, a server transmits information/data (e.g., an HTML page) to a client device (e.g., for purposes of displaying information/data to and receiving user input from a user interacting with the client device). Information/data generated at the client device (e.g., a result of the user interaction) can be received from the client device at the server.

While this specification contains many specific implementation details, these should not be construed as limitations on the scope of any embodiment or of what may be claimed, but rather as descriptions of features specific to particular embodiments. Certain features that are described herein in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

In some embodiments of the present invention, the entire system can be implemented and offered to the end-users and operators over the Internet, in a so-called cloud implementation. No local installation of software or hardware would be needed, and the end-users and operators would be allowed access to the systems of the present invention directly over the Internet, using either a web browser or similar software on a client, which client could be a desktop, laptop, mobile device, and so on. This eliminates any need for custom software installation on the client side and increases the flexibility of delivery of the service (software-as-a-service), and increases user satisfaction and ease of use. Various business models, revenue models, and delivery mechanisms for the present invention are envisioned, and are all to be considered within the scope of the present invention.

In general, the method executed to implement the embodiments of the invention, may be implemented as part of an operating system or a specific application, component, program, object, module, or sequence of instructions referred to as “program code,” “computer program(s)”, “computer code(s),” and the like. The computer programs typically comprise one or more instructions set at various times in various memory and storage devices in a computer, and that, when read and executed by one or more processors in a computer, cause the computer to perform operations necessary to execute elements involving the various aspects of the invention. Moreover, while the invention has been described in the context of fully functioning computers and computer systems, those skilled in the art will appreciate that the various embodiments of the invention are capable of being distributed as a program product in a variety of forms, and that the invention applies equally regardless of the particular type of machine or computer-readable media used to actually affect the distribution. Examples of computer-readable media include but are not limited to recordable type media such as volatile and non-volatile (or non-transitory) memory devices, floppy and other removable disks, hard disk drives, optical disks, which include Compact Disk Read-Only Memory (CD ROMS), Digital Versatile Disks (DVDs), etc., as well as digital and analog communication media.

### 13. IDMP Terminology

Some illustrative terminologies used with the IDMP are provided below to assist in understanding the present invention, but these are not to be read as restricting the scope of the present invention. The terms may be used in the form of nouns, verbs, or adjectives, within the scope of the definition.

### Digital Engineering

Digital engineering (DE): According to the Defense Acquisition University (DAU) and the Department of Defense (DOD) Digital Engineering Strategy published in 2018, digital engineering is “an integrated digital approach to systems engineering, using authoritative sources of systems' data and models as a continuum across disciplines to support lifecycle activities from concept through disposal.” Digital engineering incorporates digital technological innovations into an integrated, model-based approach that empowers a paradigm shift from the traditional design-build-test methodology of systems engineering to a new model-analyze-build methodology, thus enabling systems design, prototyping, and testing all in a virtual environment.
DE data: Digital engineering (DE) data includes project management, program management, product management, design review, and/or engineering data.
DE data field: A data field for DE data, for example, in a DE document template.
Phases: The stages within a DE product lifecycle, including but not limited to, stakeholder analysis, concept studies, requirements definition, preliminary design and technology review, system modeling, final design, implementation, system assembly and integration, prototyping, verification and validation on system, sub-system, and component levels, and operations and maintenance.
DE model: A computer-generated model that represents characteristics or behaviors of a complex product, system, or process. A DE model can be created or modified using a DE tool, and a DE model may be represented by one or more DE model files. A DE model file is the computer model file created or modified using the DE tool. In the present disclosure, the terms “digital model”, “DE model” and “DE model file” may be used interchangeably, as the context requires. A DE model within the IDEP as disclosed herein refers to any digital file uploaded onto the platform, including documents that are appropriately interpreted, as defined below. For example, a computer-aided design (CAD) file, a Systems Modeling Language (SysML) file, a Systems Requirements Document (SDR) text file, and a Neural Network Model JSON file may each be considered a DE model, in various embodiments of the present invention. A DE model may be machine-readable only, may be human-readable as well but written in programming codes, or may be human-readable and written in natural language-based texts. For example, a word-processing document comprising a technical specification of a product, or a spreadsheet file comprising technical data about a product, may also be considered a DE model. A DE model is a type of digital model, defined below. In general, any reference to a DE model in the specification and drawings may be considered equivalent to a reference to a digital model, and vice versa.
Digital Model: A computer-generated model that represents characteristics or behaviors of a complex product, system, or process. Digital models include DE models but are not limited to the field of digital engineering. For example, digital models include medical model files used to build digital twins of patients (e.g., digital patients), such as clinical documentation, laboratory results, physiological test results, psychological test results, patient communications and reports, patient medical data, health records, remote monitoring data, and the like. Digital models also include the financial models used to build digital twins of financial assets, such as enterprise data, business financial data, process data (e.g., manufacturing, logistics, sales, supply chain), research results, etc. Other examples of digital models are also within the scope of the present invention, for example, scientific models, geophysical models, climate models, biological models, biochemical models, chemical models, drug models, petrochemical models, oceanographic models, business process models, management science models, economic models, econometric models, sociological models, population dynamics models, socioeconomic models, planetary science models, mining models, mineral models, metallurgical models, supply chain logistics models, manufacturing models, and so on. Digital models include one or more digital artifacts, where each digital artifact is accessible with a security network. A model file can be created or modified using a software tool. A model file within the Interconnected Digital Model Platform (IDMP) as disclosed herein refers to any digital file uploaded onto the platform. All the terms and concepts defined above and included herein, including model splicing, model splices, and software-defined digital threads, apply in the context of the digital model and within the context of the IDMP.
Verification: According to the DAU, verification “confirms that a system element meets design-to or build-to specifications. Through the system's life cycle, design solutions at all levels of the physical architecture are verified through a cost-effective combination of analysis, examination, demonstration, and testing.” Verification refers to evaluating whether a product, service, or system meets specified requirements and is fit for its intended purpose, checking externally against customer or stakeholder needs. For example, in the aerospace industry, a verification process may include testing an aircraft component to ensure it can withstand the forces and conditions it will encounter during flight.
Validation: According to the DAU, validation is “1) the review and approval of capability requirement documents by a designated validation authority. 2) The process by which the contractor (or as otherwise directed by the DoD component procuring activity) tests a publication/technical manual for technical accuracy and adequacy. 3) The process of evaluating a system or software component during, or at the end of, the development process to determine whether it satisfies specified requirements.” Thus, validation refers to evaluating whether the overall performance of a product, service, or system is suitable for its intended use, including its compliance with regulatory requirements, and its ability to meet the needs of its intended users, checking internally against specifications and regulations. For example, for an industrial product manufacturing, a validation process may include consumer surveys that inform product design, modeling and simulations for validating the design, prototype testing for failure limits and feedback surveys from buyers.
Common Verification & Validation (V&V) products: Regulatory and certification standards, compliances, calculations, and tests (e.g., for the development, testing, and certification of products and/or solutions) are referred to herein as “common V&V products.”
DE tool: A tool or DE tool is a DE application software (e.g., a CAD software), computer program, and/or script that creates or manipulates a DE model during at least one stage or phase of a product lifecycle. A DE tool may comprise multiple functions or methods.

### IDMP/IDEP

Interconnected Digital Engineering Platform (IDEP), also referred to as a “Digital Engineering and Certification Ecosystem”: According to the DAU, a “DE ecosystem” is the “interconnected infrastructure, environment, and methodology (process, methods, and tools) used to store, access, analyze, and visualize evolving systems' data and models to address the needs of the stakeholders.” Embodiments of the IDEP as disclosed herein comprise software platforms running on hardware to realize the aforementioned capabilities under zero-trust principles. Specifically, an embodiment of the IDEP is a software platform that interconnects a plurality of spliced DE model files through one or more software-defined digital threads (see FIGS. 3-6). A DE and certification ecosystem performs verification and validation tasks, defined next. An IDEP may be considered a type of Interconnected Digital Model Platform (IDMP) when one or more of the digital models are engineering or science related, the IDMP being defined below. In general, any reference to an IDEP in the specification and drawings can be considered equivalent to a reference to an IDMP, and vice versa, and any feature, embodiment, or description in relation to one applies analogously to the other. The terms “Interconnected” and “Integrated” are used interchangeably herein.
Interconnected Digital Model Platform (IDMP): Embodiments of the IDMP as disclosed herein include interconnected infrastructure, environment, and methodology (process, methods, and tools) used to store, access, analyze, visualize, and modify data and digital models associated with a product or system. In some embodiments, IDMPs include software platforms running on hardware to realize the aforementioned capabilities under zero-trust principles. Specifically, an embodiment of the IDMP is a software platform that interconnects a plurality of spliced model files through one or more software-defined digital threads.
Hyperscale capabilities: The ability of a system architecture to scale adequately when faced with massive demand.
IDEP enclave or DE platform enclave: A central command hub responsible for the management and functioning of DE platform operations. An enclave is an independent set of cloud resources that are partitioned to be accessed by a single customer (i.e., single-tenant) or market (i.e., multi-tenant) that does not take dependencies on resources in other enclaves.
IDEP exclave or DE platform exclave: A secondary hub situated within a customer environment to assist with customer DE tasks and operations. An exclave is a set of cloud resources outside enclaves managed by the IDEP, to perform work for individual customers. Examples of exclaves include virtual machines (VMs) and/or servers that the IDEP maintains to run DE tools for customers who may need such services.
Admins or Administrators: Project managers or other authorized users. Admins may create templates in the documentation system and have high-level permissions to manage settings in the IDEP.
Requesters: Users who use the platform for the implementation of the modeling and simulations towards certification and other purposes, and who may generate documentation in the digital documentation system, but do not have admin privileges to alter the required templates, document formats, or other system settings.
Reviewers/Approvers: Users who review and/or approve templates, documents, or other system data.
Contributors: Users who provide comments or otherwise contribute to the IDEP.
AI Agent or Tool Agent: a software entity or module that takes instructions from the enclave and acts on behalf of a user or another program to perform specific tasks or operations related to an AI model or a DE tool. An AI agent or a tool agent may be designed as part of the IDMP but deployed by a customer within a secured customer environment to interface in-between the IDMP, AI models, and/or proprietary tools the customer is licensed for. Inside the customer environment, modular agents interact directly with the domain-specific tools and models to allow for bi-directional data flow across distributed tools.
Resource-capability mapping: A framework for identifying and linking available resources with the capabilities they enable or support. An exemplary resource-capability mapping is the IDMP API, or platform API, where the resource refers to third-party tools and functions integrated into and accessible via the IDMP, and where the exemplary capability refers to IDMP functions written in scripts for completing certain tasks using the available resource. Such resource-capability mappings may be used to identify how tool-specific resources such as tool functions, access and control capabilities, human-machine interfaces, processes, and objects can be allocated, invoked, and utilized efficiently and effectively to achieve specific IDMP platform functions or tasks. Resource capability mapping also assists with zero-knowledge implementations where the capability details are available to a user while the specific digital tool resource or its functions are only mapped within the customer environment. Another example of the resource-capability mapping framework is the variable mapping table disclosed herein.
User intent: The goal, objective, or desired outcome that a user aims to achieve when interacting with the IDMP/IDEP. User intent may be expressed through various forms of input, such as user actions, natural language prompts, commands, or selections within the platform interface.
User actions: Specific interactions, inputs, or operations performed by a user within the IDMP/IDEP. User actions may include, but are not limited to, mouse clicks, keyboard inputs, voice commands, or any other form of interaction with the platform's interface or components.

### Model Splicing on IDMP/IDEP

Application Programming Interface (API): A software interface that provides programmatic access to services by a software program, thus allowing application software to exchange data and communicate with each other using standardized requests and responses. It allows different programs to work together without revealing the internal details of how each works. A DE tool is typically provided with an API library for code-interface access.
Script: A computer-executable sequence of instructions that is interpreted and run within or carried out by another program, without compilation into a binary file to be run by itself through a computer processor without the support of other programs.
API scripts: Scripts that implement particular functions available via the IDEP as disclosed herein. An API script may be an API function script encapsulated in a model splice, or an “orchestration script” or “platform script” that orchestrates a workflow through a digital thread built upon interconnected model splices.
Platform API or IDMP/IDEP API: A library of API scripts available on the IDEP/IDMP as disclosed herein.
API function scripts, “splice functions,” “splice methods,” “ISTARI functions,” or “function nodes”: A type of API scripts. When executed, an API function script inputs into or outputs from a DE model or DE model splice. An “input” function, input method, or “input node” allows updates or modifications to an input DE model. An “output” function, output method, or “output node” allows data extraction or derivation from an input DE model via its model splice. An API function script may invoke native API function calls of native DE tools, where the terms “native” and “primal” may refer to existing DE model files, functions, and API libraries associated with specific third-party DE tools, including both proprietary and open-source ones.
Endpoints: an endpoint in the context of software and networking is a specific digital location or destination where different software systems communicate with each other. It enables external systems to access the features or data of an application, operating system, or other services. An API endpoint is the point of interaction where APIs receive requests and return data in response. A software development kit (SDK) endpoint or SDK-defined endpoint similarly provides a service handle for use with an SDK. References to API endpoints in the present disclosure are equally applicable to SDK endpoints.
Artifact: According to the DAU, a digital artifact is “an artifact produced within, or generated from, a DE ecosystem” to “provide data for alternative views to visualize, communicate, and deliver data, information, and knowledge to stakeholders.” In the present disclosure, a “digital artifact” or “artifact” is an execution result from an output API function script within a model splice. Multiple artifacts may be generated from a single DE model or DE model splice. In some embodiments, as a matter of design choice, a digital artifact is atomic and indivisible in terms of security levels, so that permissions for users to access and/or modify the digital artifact apply to the digital artifact as a whole, and may not apply to segments of the digital artifact. In other embodiments, a digital artifact includes segments that may have different access (e.g., viewing) and modification (e.g., updating) security levels. Consequently, for a given user, an “authorized artifact” for access is an artifact for which all segments fall under an access security level that allows the given user to access (e.g., view) it. Similarly, for a given user, an “authorized artifact” for modification is an artifact for which all segments fall under a modification security level that allows the given user to modify (e.g., update) it.
Model splice: Within the present disclosure, a “model splice”, “model wrapper”, or “model graft” of a given DE model file comprises locators to or copies of (1) DE model data or digital artifacts extracted or derived from the DE model file, including model metadata, and (2) splice functions (e.g., API function scripts) that can be applied to the DE model data. The splice functions provide unified and standardized input and output API endpoints for accessing and manipulating the DE model data. The DE model data are model-type-specific, and a model splice is associated with model-type-specific input and output schemas. One or more different model splices may be generated from the same input DE model file(s), based on the particular user application under consideration, and depending on data access restrictions. In some contexts, the shorter terms “splice”, “wrapper”, and/or “graft” are used to refer to spliced, wrapped, and/or grafted DE models.
Model representation: Within the present disclosure, “model representation” of a given DE model includes any embodiment of the engineering model in the form of DE model file(s), model splices, or collections of digital artifacts derived from the DE model. In some embodiments, a DE model representation comprises model-type-specific locators to DE model data and metadata, potentially including standardized input and output API endpoints for accessing and manipulating the DE model data. Discussions related to the usage of model splices in the present disclosure are applicable to any other forms of model representation as well.
Model splicing or DE model splicing: A process for generating a model splice from a DE model file. DE model splicing encompasses human-readable document model splicing, where the DE model being spliced is a human-readable text-based document.
Model splicer: Program code or script (uncompiled) that performs model splicing of DE models.

A DE model splicer for a given DE model type, when applied to a specific DE model file of the DE model type, retrieves, extracts, or derives DE model data associated with the DE model file, generates and/or encapsulates splice functions and instantiates API endpoints according to input/output schemas.

### Digital Thread

Model splice linking: Generally, model splice linking refers to jointly accessing two or more DE model splices via API endpoints or splice functions. For example, data may be retrieved from one splice to update another splice (e.g., an input splice function of a first model splice calls upon an output splice function of a second model splice); data may be retrieved from both splices to generate a new output (e.g., output splice functions from both model splices are called upon); data from a third splice may be used to update both a first and a second splice (e.g., input splice functions from both model splices are called upon). In the present disclosure, “model linking” and “model splice linking” may be used interchangeably, as linked model splices map to correspondingly linked DE models.
Digital thread, Software-defined digital thread, Software-code-defined digital thread, or Software digital thread: According to the DAU, a digital thread is “an extensive, configurable and component enterprise-level analytical framework that seamlessly expedites the controlled interplay of authoritative technical data, software, information, and knowledge in the enterprise data-information-knowledge systems, based on the digital system model template, to inform decision makers throughout a system's lifecycle by providing the capability to access, integrate, and transform disparate data into actionable information.” Within the IDEP as disclosed herein, a digital thread is a platform script that calls upon the platform API to facilitate, manage, or orchestrate a workflow through linked model splices to provide the aforementioned capabilities. That is, a digital thread within the IDEP is a computer-executable script that connects data from one or more DE models, data sources, or physical artifacts to accomplish a specific mission or business objective, and may be termed a “software-defined digital thread” or “software digital thread” that implements a communication framework or data-driven architecture that connects traditionally siloed DE models to enable seamless information flow among the DE models via model splices. In various embodiments, a digital thread associated with a digital twin is configured to execute a scripted workflow associated with the digital twin.
Tool linking: Similar to model splice linking, tool linking generally refers to jointly accessing two or more DE tools via model splices, where model splice functions that encapsulate disparate DE tool functions are called upon jointly to perform a DE task.
Workflow: A workflow typically representing an entire process or sequence of operations that achieves a specific goal or outcome. It encompasses the complete set of activities, from initiation to completion, that are required to fulfill a business process or software function. Workflows often involve multiple participants, systems, or departments and can be complex, involving branching paths, decision points, and parallel processes.
Digital Workflow: A digital workflow refers to a series of digital tasks and process steps that are carried out electronically to achieve a specific outcome. Digital workflows involve the use of digital tools, software applications, and technologies to streamline and manage various activities within an organization or project. They often enable full or partial automation, and typically include elements such as data input, information processing, task assignment, approval processes, and document management, all conducted in a digital environment.
Tasks and Process Steps: A task is usually a subset of a workflow and represents a discrete unit of work that needs to be completed as part of the larger process. Tasks are more specific and focused than workflows and are often assigned to individual agents. They have defined inputs, outputs, and objectives. Multiple tasks typically make up a workflow, and each task contributes to the overall goal of the workflow. A process step, or simply “step”, in turn, is the smallest unit of work within this hierarchy. Process steps are the individual actions or operations that, when combined, form a task. They are highly specific, often atomic actions that represent the most granular level of detail in a workflow. Multiple process steps are usually required to complete a single task, and the successful execution of all steps results in the completion of the task. In the context of digital workflows, the terms “digital task”, “digital workflow task”, and “digital engineering task” are used interchangeably herein.
Digital Task Implementation: An orchestration script, or a platform script, may be generated over the IDMP to implement a digital task including one or more process steps, where the “implementation” of the digital task through an orchestration script means that the orchestration script includes instructions carrying out each process step required to complete the digital task.

### Digital Twin

Digital twin: According to the DAU, a digital twin is “a virtual replica of a physical entity that is synchronized across time. Digital twins exist to replicate configuration, performance, or history of a system. Two primary sub-categories of digital twin are digital instance and digital prototype.” A digital instance is “a virtual replica of the physical configuration of an existing entity; a digital instance typically exists to replicate each individual configuration of a product as-built or as-maintained.” A digital prototype is “an integrated multi-physical, multiscale, probabilistic model of a system design; a digital prototype may use sensor information and input data to simulate the performance of its corresponding physical twin; a digital prototype may exist prior to realization of its physical counterpart.” Thus, a digital twin is a real-time virtual replica of a physical object or system, with bi-directional information flow between the virtual and physical domains. In some embodiments, a digital twin is a digital replica configured to run in a virtual environment and instantiated through a scripted digital thread, where the digital thread accesses data (e.g., digital artifacts) from a set of digital models through splicing. A digital twin may be instantiated, run, or executed, through a digital thread. Updating a digital twin may include the actions of modifying, deleting, and/or adding data to its twin configuration, to an associated digital thread, or to an associated digital model associated with the updated digital twin. In one embodiment, digital twins may be ephemeral and may have in-built time and space restrictions (see “twin configuration” definition below). In various embodiments, a physical twin is a physical object instantiated in a physical environment based on a set of model files through an MBSE manufacturing and/or prototyping process. In various embodiments, digital twins can be created for both physical products and physical processes. They are not limited to tangible items like machinery or vehicles; they can also simulate complex physical processes, such as manufacturing workflows or supply chain logistics, to improve efficiency and predict outcomes. This flexibility allows digital twins to be applied across various industries and scenarios.
Authoritative twin: A reference design configuration at a given stage of a product life cycle. At the design stage, an authoritative twin is the twin configuration that represents the best design target. At the operational stage, an authoritative twin is the twin configuration that best responds to the actual conditions on the ground or “ground-truths”.
External Feedback: In various embodiments, external feedback comprises feedback data from at least one source external to a given digital twin, including digital twin performance data as received, analyzed or processed by the IDMP. External feedback may also include physical twin performance data, data from a virtual sensor, data from a physical sensor, user input (e.g., a user prompt, or a user response over a GUI), data from a simulation, a product certification file, or a product requirements file. In some embodiments, external feedback may also include feedback from control algorithms or processes in the IDMP that track digital twin performance (e.g., tracking error levels and/or tolerance between digital and corresponding physical twin data). External feedback data can also include feedback data that is external to the IDMP.
Twin Configuration: A twin configuration includes data specifying the configuration of a digital or a physical twin. Twin configurations may include a twin version identifier identifying the digital twin, one or more digital thread identifiers identifying the digital threads responsible for instantiating and running a twin, one or more model representation identifiers (e.g., URIs) identifying the model representations that are used by the twin, and an authoritative twin indicator (e.g., a boolean or binary variable) indicating whether the twin is an authoritative twin. The various twin configurations associated with the various physical and digital twins of a given product may be stored in a twin configuration set of the IDMP. In some embodiments, the twin configuration set acts as a specification database for the various digital and physical twins for one or more products or systems. In some embodiments, the twin configuration of a digital twin may include time and space restrictions on the associated digital twin, such as a validity time frame, a validity cutoff time, a validity space, or a validity geographical area (e.g., geofencing, proximity to another twin configuration).

### Security

Zero-trust security: An information security principle based on the assumption of no implicit trust between any elements, agents, or users. Zero trust may be carried out by implementing systematic mutual authentication and least privileged access, typically through strict access control, algorithmic impartiality, and data isolation. Within the IDEP as disclosed herein, least privileged access through strict access control and data isolation may be implemented via model splicing and the IDEP system architecture.
Zero-knowledge approach: A zero-knowledge approach in data operations refers to a method where computational processes and data analyses are conducted such that the underlying data remains completely confidential and undisclosed to the parties performing the operations. This technique enables the validation, aggregation, and processing of data without exposing the actual data content, thereby preserving privacy and confidentiality.
Security Network: Information security networks are security networks that are configured to maintain the confidentiality, integrity, and availability of digital information (e.g., digital model data) through cybersecurity measures such as encryption, firewalls, intrusion detection systems, and access controls. A “security network” is a set of networked resources having identical access control restrictions, where each networked resource provides access to one or more digital model files. In various embodiments, the networked resources of a security network may be determined by one or a combination of the following factors: (1) having a minimum security access level, (2) belonging to a given physical network, (3) belonging to a given customer organization, and (4) belonging to a given business division.
Information Security (Infosec) Levels: Also referred to as “security levels” or “security access levels”, information security (Infosec) levels designate classifications assigned to data and operations based on sensitivity and security requisites, dictating access control and data handling procedures across networks. In some embodiments, an infosec level may define a security network.

### Testing

Testing: The process of evaluating and verifying the functionality, performance, and reliability of software components, digital workflows, or systems within a software platform such as the IDMP/IDEP. Testing may include assessing various aspects such as quality assurance (QA), quality control (QC), usability, and end-to-end functionality of the platform, its components, or the digital tasks executed on it.
Human-readable test scenarios: Descriptions of test cases or testing situations written in natural language that are easily understandable by human users or testers. These scenarios may outline the steps, conditions, and expected outcomes of a particular test. The test scenarios usually include a sequence of human-readable testing steps that are carried out on the software platform. In some embodiments, the testing steps are configured to evaluate the performance of the software platform in accomplishing the user intent. In other embodiments, they are configured to verify the ability of the software platform to accomplish the user intent.
Test script: A set of instructions, typically in the form of computer code or a structured sequence of commands, designed to automate the execution of a specific test scenario within the IDMP/IDEP. Test scripts may be generated based on human-readable test scenarios and may be used to perform automated testing of various platform components, digital workflows, or system functionalities.

### 14. Conclusions

One of ordinary skill in the art knows that the use cases, structures, schematics, flow diagrams, and steps may be performed in any order or sub-combination, while the inventive concept of the present invention remains without departing from the broader scope of the invention. Every embodiment may be unique, and step(s) of method(s) may be either shortened or lengthened, overlapped with other activities, postponed, delayed, and/or continued after a time gap, such that every active user and running application program is accommodated by the server(s) to practice the methods of the present invention.

For simplicity of explanation, the embodiments of the methods of this disclosure are depicted and described as a series of acts or steps. However, acts or steps in accordance with this disclosure can occur in various orders and/or concurrently, and with other acts or steps not presented and described herein. Furthermore, not all illustrated acts or steps may be required to implement the methods in accordance with the disclosed subject matter. In addition, those skilled in the art will understand and appreciate that the methods could alternatively be represented as a series of interrelated states via a state diagram or events or their equivalent.

As used herein, the singular forms “a,” “an,” and “the” include plural references unless the context clearly indicates otherwise. Thus, for example, reference to “a cable” includes a single cable as well as a bundle of two or more different cables, and the like.

The terms “comprise,” “comprising,” “includes,” “including,” “have,” “having,” and the like, used in the specification and claims are meant to be open-ended and not restrictive, meaning “including but not limited to.”

In the foregoing description, numerous specific details are set forth, such as specific structures, dimensions, processes, parameters, etc., to provide a thorough understanding of the present invention. The particular features, structures, materials, or characteristics may be combined in any suitable manner in one or more embodiments. The words “example”, “exemplary”, “illustrative” and the like, are used herein to mean serving as an example, instance, or illustration. Any aspect or design described herein as “example” or its equivalents is not necessarily to be construed as preferred or advantageous over other aspects or designs. Rather, use of the words “example” or equivalents is intended to present concepts in a concrete fashion.

As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A, X includes B, or X includes both A and B, then “X includes A or B” is satisfied under any of the foregoing instances.

Reference throughout this specification to “an embodiment,” “certain embodiments,” or “one embodiment” means that a particular feature, structure, or characteristic described in connection with the embodiment is included in at least one embodiment. Thus, the appearances of the phrase “an embodiment,” “certain embodiments,” or “one embodiment” throughout this specification are not necessarily all referring to the same embodiment.

As used herein, the term “about” in connection with a measured quantity, refers to the normal variations in that measured quantity, as expected by one of ordinary skill in the art in making the measurement and exercising a level of care commensurate with the objective of measurement and the precision of the measuring equipment. For example, in some exemplary embodiments, the term “about” may include the recited number ±10%, such that “about 10” would include from 9 to 11. In other exemplary embodiments, the term “about” may include the recited number ±X %, where X is considered the normal variation in said measurement by one of ordinary skill in the art.

Features which are described in the context of separate embodiments may also be provided in combination in a single embodiment. Conversely, various features which are, for brevity, described in the context of a single embodiment, may also be provided separately or in any suitable sub-combination. The applicant hereby gives notice that new claims may be formulated to such features and/or combinations of such features during the prosecution of the present application or of any further application derived therefrom. Features of the transitory physical storage medium described may be incorporated into/used in a corresponding method, digital documentation system and/or system, and vice versa.

Although the present invention has been described with reference to specific exemplary embodiments, it will be evident that the various modifications and changes can be made to these embodiments without departing from the broader scope of the invention. Accordingly, the specification and drawings are to be regarded in an illustrative sense rather than in a restrictive sense. It will also be apparent to the skilled artisan that the embodiments described above are specific examples of a single broader invention which may have greater scope than any of the singular descriptions taught. There may be many alterations made in the descriptions without departing from the scope of the present invention, as defined by the claims.

What is claimed is:

1. A method for sharing transformed data owned by a data owner with a neural network (NN) owner, the transformed data for propagation, by the NN owner, through a transformed NN owned by the NN owner, the method executable by the data owner, the method comprising:
exchanging, with the NN owner, shared transformation compatibility data, wherein the shared transformation compatibility data is based at least on pre-agreed upon dimensionality data comprising dimensions of expansion of confidential data, wherein the shared transformation compatibility data provides information required for neural network operations in a transformed space, wherein neural network operations performed in the transformed space are transformed operations that preserve corresponding neural network operations performed in an untransformed space up to a predetermined error threshold;
generating a confidential data owner private transformation key, wherein the confidential data owner private transformation key is kept confidential by the data owner;
transforming the confidential data from a true space into the transformed data in the transformed space using the confidential data owner private transformation key and the shared transformation compatibility data;
generating a shared transformation key corresponding to the confidential data owner private transformation key, wherein the shared transformation key is necessary for the NN owner to propagate the transformed data through the transformed NN in the transformed space; and
transmitting, to the NN owner, the transformed data and the shared transformation key.

2. The method of claim 1, wherein the confidential data comprises input data for transformation and forward propagation through the transformed NN, wherein the transformed data comprises transformed input data, and wherein the method further comprises:
receiving, from the NN owner, a transformed output in the transformed space, wherein the transformed output was generated by forward-propagating the transformed input data through the transformed NN; and
de-transforming the transformed output using the confidential data owner private transformation key, to generate de-transformed output data in the true space, wherein the de-transformed output data is equivalent to a true space output generated by forward-propagating the input data through the NN in the true space.

3. The method of claim 1, further comprising:
exchanging, with the NN owner, transformation setup data, wherein the transformation setup data is based at least on the pre-agreed upon dimensionality data, wherein the transformation setup data provides information required for neural network operations in the transformed space, wherein neural network operations performed in the transformed space are transformed operations that preserve corresponding neural network operations performed in the true space up to a predetermined error threshold.

4. The method of claim 3, further comprising:
sending, to the NN owner, a transformation operator based at least on the transformation setup data, wherein the transformation operator is configured to perform transformed NN operations in the transformed space.

5. The method of claim 3, further comprising:
exchanging, with the NN owner, an activation function, wherein the activation function is based at least on the transformation setup data, and wherein the activation function is required to perform transformed NN operations in the transformed space.

6. The method of claim 3,
wherein the transformation setup data comprises a class of cost functions required to perform transformed NN operations in the transformed space, and
wherein the method further comprises generating a cost function based on the class of cost functions of the transformation setup data.

7. The method of claim 1, further comprising:
initiating a secure connection between the data owner and the NN owner.

8. A method for neural network (NN) propagation, through a transformed NN owned by a NN owner, of transformed data owned by a data owner, the method executable by the NN owner, the method comprising:
exchanging, with the data owner, shared transformation compatibility data, wherein the shared transformation compatibility data is based at least on pre-agreed upon dimensionality data comprising dimensions of expansion of confidential data, wherein the shared transformation compatibility data provides information required for neural network operations in a transformed space, wherein neural network operations performed in the transformed space are transformed operations that preserve corresponding neural network operations performed in an untransformed space up to a predetermined error threshold;
receiving, from the data owner, the transformed data in the transformed space, wherein the transformed data corresponds to the confidential data in a true space;
receiving, from the data owner, a shared transformation key necessary for the NN owner to propagate the transformed data through the transformed NN in the transformed space;
transforming a true NN from the true space into the transformed NN in the transformed space using information within the shared transformation key and the shared transformation compatibility data; and
propagating the transformed data through the transformed NN in the transformed space, wherein the NN owner cannot de-transform a transformed output in the transformed space generated by propagating the transformed data through the transformed NN.

9. The method of claim 8,
wherein the confidential data comprises true input data for transformation and forward propagation through the transformed NN,
wherein the transformed data comprises transformed input data,
wherein propagating the transformed data through the transformed NN comprises forward-propagating the transformed input data through the transformed NN to generate the transformed output in the transformed space, and
wherein the method further comprises sending, to the data owner, the transformed output in the transformed space.

10. The method of claim 8,
wherein the confidential data comprises true training data and true target data for transformation and training the transformed NN,
wherein the transformed data comprises transformed training data and transformed target data for training the transformed NN,
wherein propagating the transformed data through the transformed NN comprises backpropagating one or more data points of the transformed training data and the transformed target data through the transformed NN in the transformed space, to generate one or more transformed error gradients in the transformed space, and
wherein the method further comprises:
training the NN using the one or more transformed error gradients in the transformed space to generate a transformed trained NN; and
de-transforming the transformed NN by reversing the transforming of the true NN using information within the shared transformation key received from the data owner, to generate a trained NN in the true space.

11. A method for neural network (NN) propagation, through a transformed NN owned by a NN owner, of confidential data owned by a data owner, the method executable by the data owner, the method comprising:
exchanging, with the NN owner, shared transformation compatibility data, wherein the shared transformation compatibility data is based at least on pre-agreed upon dimensionality data comprising dimensions of expansion of the confidential data, wherein the shared transformation compatibility data provides information required for neural network operations in a transformed space, wherein neural network operations performed in the transformed space are transformed operations that preserve corresponding neural network operations performed in an untransformed space up to a predetermined error threshold;
receiving, from the NN owner, the transformed NN in the transformed space, wherein the transformed NN corresponds to a true NN in a true space;
transforming the confidential data from the true space into transformed data in the transformed space using the shared transformation compatibility data; and
propagating the transformed data through the transformed NN in the transformed space, wherein the data owner cannot de-transform a transformed output in the transformed space generated by propagating the transformed data through the transformed NN.

12. The method of claim 11,
wherein the confidential data comprises true input data for transformation and forward propagation through the transformed NN,
wherein the transformed data comprises transformed input data,
wherein propagating the transformed data through the transformed NN comprises forward-propagating the transformed input data through the transformed NN to generate the transformed output in the transformed space, and
wherein the method further comprises:
generating a data owner private output transformation key, wherein the data owner private output transformation key is kept confidential by the data owner;
locking, using the data owner private output transformation key, the transformed output, to generate a locked transformed output, wherein a de-transformation of the locked transformed output from the transformed space to the true space preserves the locking in the true space and does not prevent a subsequent unlocking in the true space;
transmitting, to the NN owner, the locked transformed output;
receiving, from the NN owner, a locked de-transformed output; and
unlocking the locked de-transformed output, using the data owner private output transformation key, to generate a de-transformed output data, wherein the de-transformed output data is equivalent to a true space output generated by forward-propagating the true input data through the NN in the true space.

13. The method of claim 11,
wherein the confidential data comprises true training data and true target data for transformation and training the transformed NN,
wherein the transformed data comprises transformed training data and transformed target data for training the transformed NN,
wherein propagating the transformed data through the transformed NN comprises backpropagating one or more data points of the transformed training data and the transformed target data through the transformed NN in the transformed space, to generate one or more transformed error gradients in the transformed space, and
wherein the method further comprises:
training the transformed NN using the one or more transformed error gradients in the transformed space to generate a trained transformed NN, wherein the data owner cannot de-transform the transformed NN or de-transform a transformed output of the trained transformed NN in the transformed space without a NN owner private transformation key; and
transmitting the trained transformed NN to the NN owner.

14. A method for sharing a transformed neural network (NN), the transformed NN owned by a NN owner, for NN propagation through the transformed NN of confidential data owned by a data owner, the method executable by the NN owner, the method comprising:
exchanging, with the data owner, shared transformation compatibility data, wherein the shared transformation compatibility data is based at least on pre-agreed upon dimensionality data comprising dimensions of expansion of the confidential data, wherein the shared transformation compatibility data provides information required for neural network operations in a transformed space, wherein neural network operations performed in the transformed space are transformed operations that preserve corresponding neural network operations performed in an untransformed space up to a predetermined error threshold;
generating a confidential NN owner private transformation key, where the confidential NN owner private transformation key is kept confidential by the NN owner;
transforming a true NN from a true space, using the confidential NN owner private transformation key and the shared transformation compatibility data, to generate the transformed NN in the transformed space; and
transmitting, to the data owner, the transformed NN.

15. The method of claim 14, wherein the method further comprises:
receiving, from the data owner, a locked transformed output of the transformed NN in the transformed space;
de-transforming, using the confidential NN owner private transformation key, the locked transformed output, to generate a locked de-transformed output in the true space, wherein the NN owner cannot unlock the locked de-transformed output without a data owner private output transformation key; and
transmitting, to the data owner, the locked de-transformed output.

16. The method of claim 14,
wherein the confidential data comprises true training data and true target data for transformation and training the transformed NN,
wherein the true training data and the true target data were transformed by the data owner, to generate transformed training data and transformed target data, and
wherein the method further comprises:
receiving, from the data owner, a trained transformed NN, wherein the trained transformed NN was trained by the data owner in the transformed space using the transformed training data and the transformed target data, and wherein the NN owner has no access to the transformed training data and the transformed target data used for training the trained transformed NN; and
de-transforming the trained transformed NN using the confidential NN owner private transformation key, to generate a trained NN in the true space.

17. One or more non-transitory storage media having computer-executable program code, the program code executable by a hardware processor, the program code when executed, causing the hardware processor to execute a process for utilizing a neural network (NN) between a data owner having untransformed data and a NN owner having a private NN, the program code comprising code to:
initiate a secure connection between the data owner and the NN owner;
exchange, with the NN owner, transformation compatibility data, wherein the transformation compatibility data is based at least on pre-agreed upon dimensionality data, wherein the transformation compatibility data provides information required for neural network operations in a transformed space, wherein neural network operations performed in the transformed space are transformed operations that preserve corresponding neural network operations performed in an untransformed space up to a predetermined error threshold;
exchange, with the NN owner, an activation function, wherein the activation function is based at least on the transformation compatibility data;
generate a data owner private transformation key based at least on the transformation compatibility data, wherein the data owner private transformation key is configured to transform the untransformed data from the untransformed space into transformed data in the transformed space, and wherein the data owner private transformation key is kept confidential by the data owner;
transform the untransformed data utilizing at least the data owner private transformation key to generate the transformed data in the transformed space;
generate a shared transformation key, wherein the shared transformation key is necessary for the NN owner to propagate the transformed data through the transformed NN in the transformed space; and
send, to the NN owner, the transformed data and the shared transformation key necessary for the NN owner to propagate the transformed data through the transformed NN in the transformed space.

18. The one or more non-transitory storage media of claim 17, wherein the transformed data is generated using the transformation compatibility data and the data owner private transformation key.

19. The one or more non-transitory storage media of claim 17, wherein the shared transformation key comprises shared hidden layer transformation data generated based at least on the transformation compatibility data and the data owner private transformation key.

20. The one or more non-transitory storage media of claim 17, wherein the data owner private transformation key comprises a set of random matrices, and wherein at least one individual data entry within the set of random matrices is a non-zero entry generated by the data owner using a random number generator.

21. The one or more non-transitory storage media of claim 17, wherein the untransformed data is untransformed input data for forward propagation through the transformed NN, wherein the transformed data is transformed input data, and wherein the program code comprises code to:
receive, from the NN owner, transformed output data, wherein the transformed output data comprises output from a transformed NN in the transformed space in response at least to the transformed input data; and
generate a de-transformed output in the untransformed space from the transformed output data by de-transforming the untransformed data using the data owner private transformation key.

22. The one or more non-transitory storage media of claim 17, wherein the program code comprises code to:
send, to the NN owner, a transformation operator based at least on the transformation compatibility data, wherein the transformation operator is configured to perform transformed NN operations in the transformed space.

23. The one or more non-transitory storage media of claim 22, wherein the transformed NN has been transformed using the transformation compatibility data, the activation function, the shared transformation key, and the transformation operator.

24. The one or more non-transitory storage media of claim 17, wherein the activation function is a transformed activation function, and wherein the program code further comprises code to:
generate the transformed activation function from an untransformed activation function through a series expansion using the transformation compatibility data and the data owner private transformation key.

25. The one or more non-transitory storage media of claim 24, wherein the transformation compatibility data comprises one or more multivariate terms within the transformed activation function to define a transformation of the untransformed activation function.

26. The one or more non-transitory storage media of claim 24, wherein a noise component is embedded within the transformed activation function by adding it to the untransformed activation function prior to the series expansion.

27. The one or more non-transitory storage media of claim 26, wherein the noise component is a bounded differentiable noise function.

28. The one or more non-transitory storage media of claim 17, wherein the transformation compatibility data comprises at least dimensions of the untransformed data, a location of a bias vector within the private NN, one or more dimensions of the private NN, a class of activation functions, and an error transformation key.

29. The one or more non-transitory storage media of claim 17, wherein transforming the untransformed data to generate the transformed data comprises one or more of a matrix expansion, a matrix right-multiplication, and a matrix exponentiation.

30. The one or more non-transitory storage media of claim 17, wherein transforming the untransformed data to generate the transformed data comprises:
expanding an untransformed data matrix using an expansion matrix associated with the data owner private transformation key to generate an expanded untransformed data matrix;
right-multiplying the expanded untransformed data matrix using a multiplication matrix associated with the data owner private transformation key to generate a multiplied untransformed data matrix; and
exponentiating the multiplied untransformed data matrix using an exponentiation matrix associated with the data owner private transformation key to generate a transformed data matrix.

31. The one or more non-transitory storage media of claim 30, wherein the exponentiating the multiplied untransformed data matrix uses an element-wise matrix exponentiation.

32. The one or more non-transitory storage media of claim 30, wherein the exponentiating the multiplied untransformed data matrix uses a row-column matrix-wise matrix exponentiation.

33. The one or more non-transitory storage media of claim 17, wherein the transformation compatibility data comprises a class of cost functions.

34. The one or more non-transitory storage media of claim 33, wherein the program code further comprises code to generate a cost function based on the class of cost functions of the transformation compatibility data.

35. The one or more non-transitory storage media of claim 34,
wherein the untransformed data comprises target data and a training data set,
wherein the transformed data comprises a transformed target data and a transformed training data set, and
wherein the program code further comprises code to:
transform the cost function through a series expansion using the transformation compatibility data and the data owner private transformation key, to generate a transformed cost function; and
send, to the NN owner, the transformed cost function.

36. The one or more non-transitory storage media of claim 35, wherein the program code further comprises code to:
identify, through an exchange with the NN owner, at least one locked data point of the transformed target data and the transformed training data set;
receive, from the NN owner, a locked gradient associated with the at least one locked data point;
generate a partially unlocked gradient from the locked gradient, using at least the data owner private transformation key; and
send, to the NN owner, the partially unlocked gradient to enable the unlocking of the gradient associated with the at least one locked data point for backpropagation.

37. One or more non-transitory storage media having computer-executable program code, the program code executable by a hardware processor, the program code when executed, causing the hardware processor to execute a process for utilizing a neural network (NN) between a data owner having untransformed data and a NN owner having a private NN, the program code comprising code to:
initiate a secure connection between the data owner and the NN owner;
exchange, with the data owner, transformation compatibility data, wherein the transformation compatibility data is based at least on pre-agreed upon dimensionality data, wherein the transformation compatibility data provides information required for neural network operations in a transformed space, wherein neural network operations performed in the transformed space are transformed operations that preserve corresponding neural network operations performed in an untransformed space up to a predetermined error threshold;
exchange, with the data owner, an activation function, wherein the activation function is based at least on the transformation compatibility data;
receive, from the data owner, transformed data and a shared transformation key necessary for the NN owner to propagate the transformed data through a transformed NN in the transformed space; and
transform the private NN using the transformation compatibility data to generate a transformed NN.

38. The one or more non-transitory storage media of claim 37, wherein the program code comprises code to:
receive, from the data owner, a transformation operator based at least on the transformation compatibility data, wherein the transformation operator is configured to perform transformed NN operations in the transformed space.

39. The one or more non-transitory storage media of claim 38, wherein the transformed NN has been transformed using the transformation compatibility data, the activation function, the shared transformation key, and the transformation operator.

40. The one or more non-transitory storage media of claim 37, wherein the activation function is a transformed activation function generated from an untransformed activation function through a series expansion using the transformation compatibility data and a private transformation key generated by the data owner.

41. The one or more non-transitory storage media of claim 40, wherein the transformation compatibility data comprises one or more multivariate terms within the transformed activation function to define a transformation of the untransformed activation function.

42. The one or more non-transitory storage media of claim 38, wherein the transformed data is transformed input data for forward propagation through the transformed NN, and wherein the program code comprises code to:
generate transformed output data from the transformed input data using the transformed NN, the shared transformation key and the transformation operator, wherein the transformed output data comprises output from the transformed NN in the transformed space in response at least to the transformed input data; and
send, to the data owner, the transformed output data.

43. The one or more non-transitory storage media of claim 38, wherein the transformation compatibility data comprises at least dimensions of the untransformed data, a location of a bias vector within the private NN, one or more dimensions of the private NN, a class of activation functions, and an error transformation key.

44. The one or more non-transitory storage media of claim 43, wherein the program code further comprises code to:
verify, upon receiving the transformation compatibility data and the transformation operator, that the transformation operator is consistent with the dimensions of the untransformed data comprised within the transformation compatibility data.

45. The one or more non-transitory storage media of claim 43, wherein transforming the private NN comprises generating an expanded weights and biases matrix through a matrix expansion, wherein the matrix expansion comprises expanding an untransformed weights and biases matrix associated with the private NN using the dimensions of the untransformed data from the transformation compatibility data.

46. The one or more non-transitory storage media of claim 45,
wherein transforming the private NN further comprises generating transformed weights and biases through a matrix permutation and a matrix multiplication of the expanded weights and biases matrix,
wherein the matrix permutation comprises a rearrangement of rows of a matrix according to a specific permutation sequence, and
wherein the matrix multiplication is one of term-wise multiplication and row-column matrix multiplication.

47. The one or more non-transitory storage media of claim 46,
wherein the transformed data comprises transformed target data and a transformed training data set, and
wherein the program code further comprises code to:
receive, from the data owner, a transformed cost function required to train the transformed NN in the transformed space.

48. The one or more non-transitory storage media of claim 47, wherein the program code further comprises code to:
perform backpropagation through the transformed NN using a plurality of data points of the transformed target data and the transformed training data set, the transformed cost function, the shared transformation key, and the transformation operator, to generate a plurality of error terms in the transformed space corresponding to the plurality of data points;
generate a plurality of unlocked gradients using the plurality of error terms, wherein the plurality of unlocked gradients are unlocked based on a generation of a private transformation key by the data owner;
update the transformed weights and biases using the plurality of unlocked gradients; and
generate a trained transformed NN using the updated transformed weights and biases.

49. The one or more non-transitory storage media of claim 47, wherein the program code further comprises code to:
identify, through an exchange with the data owner, at least one locked data point of the transformed target data and the transformed training data set;
perform backpropagation through the transformed NN using the at least one locked data point, the transformed cost function, the shared transformation key, and the transformation operator, to generate at least one error term corresponding to the at least one locked data point in the transformed space;
generate at least one locked gradient based on the at least one error term, wherein the at least one locked gradient is locked based on a generation of a private transformation key by the data owner;
send, to the data owner, the at least one locked gradient associated with the at least one locked data point;
receive, from the data owner, at least one partially unlocked gradient associated with the at least one locked data point;
generate at least one unlocked gradient from the at least one locked gradient using at least the error transformation key;
update the transformed weights and biases using the at least one unlocked gradient; and
generate a trained transformed NN using the updated transformed weights and biases.

50. The one or more non-transitory storage media of claim 37, wherein the transformed NN is generated by the NN owner within a NN agent exclave accessible from a data owner's network, and wherein the NN agent exclave is a secure data storage configured to host the transformed NN and accessible on a permissioned-basis for data exchange.

51. The one or more non-transitory storage media of claim 50, wherein the program code to transform the private NN comprises program code to securely transmit session-specific configuration information of the transformed NN to the NN agent exclave using a dedicated secure connection.

52. The one or more non-transitory storage media of claim 51, wherein the session-specific configuration information of the transformed NN comprises one of a NN model architecture, a NN hyperparameter, and a NN data schema.

53. The one or more non-transitory storage media of claim 48, wherein the program code comprises code to:
generate a de-transformed weights and biases matrix by reversing the matrix expansion, the matrix permutation, and/or a matrix exponentiation performed during the transforming of the private NN, and using at least the transformation compatibility data, and
generate a de-transformed trained NN in the untransformed space based on the de-transformed weights and biases matrix.

54. The one or more non-transitory storage media of claim 53, wherein the program code comprises code to:
initiate a new secure connection between a new data owner and the NN owner;
receive, from the new data owner, new transformation compatibility data, wherein the new transformation compatibility data provides information required for neural network operations in a new transformed space;
receive, from the new data owner, a new activation function, wherein the new activation function is based at least on the new transformation compatibility data;
receive, from the new data owner, new transformed data and a new shared transformation key necessary for the NN owner to propagate the new transformed data through a new transformed trained NN in the new transformed space; and
transform the de-transformed trained NN from the untransformed space to the new transformed space using the new transformation compatibility data to generate the new transformed trained NN.

55. One or more non-transitory storage media having computer-executable program code, the program code executable by a hardware processor, the program code when executed, causing the hardware processor to execute a process for utilizing a neural network (NN) between a data owner having untransformed data and a NN owner having a private NN, the program code comprising code to:
initiate a secure connection between the NN owner and the data owner;
exchange, with the data owner, transformation compatibility data, wherein the transformation compatibility data is based at least on pre-agreed upon dimensionality data, wherein the transformation compatibility data provides information required for neural network operations in a transformed space, wherein neural network operations performed in the transformed space are transformed operations that preserve corresponding neural network operations performed in an untransformed space up to a predetermined error threshold;
exchange, with the data owner, an activation function, wherein the activation function is based at least on the transformation compatibility data;
generate a NN owner private transformation key based at least on the transformation compatibility data, wherein the NN owner private transformation key is configured to transform the untransformed NN from the untransformed space into a transformed NN in the transformed space, and wherein the NN owner private transformation key is kept confidential by the NN owner;
transform the private NN utilizing the transformation compatibility data and the NN owner private transformation key to generate the transformed NN in the transformed space; and
send, to the data owner, the transformed NN.

56. The one or more non-transitory storage media of claim 55, wherein the NN owner private transformation key comprises a set of random matrices, and wherein at least one individual data entry within the set of random matrices is a non-zero entry generated by the data owner using a random number generator.

57. The one or more non-transitory storage media of claim 55, wherein the activation function is a transformed activation function, and wherein the program code further comprises code to:
generate the transformed activation function from an untransformed activation function through a series expansion using the transformation compatibility data and the NN owner private transformation key.

58. The one or more non-transitory storage media of claim 55, wherein the transformed NN comprises transformed weights and biases generated through one or more transformation steps using the transformation compatibility data, wherein the one or more transformation steps comprise one of a matrix expansion, a matrix multiplication, and a matrix exponentiation.

59. The one or more non-transitory storage media of claim 55, wherein the program code comprises code to:
send, to the data owner, a transformation operator based at least on the transformation compatibility data, wherein the transformation operator is configured to perform transformed NN operations in the transformed space.

60. One or more non-transitory storage media having computer-executable program code, the program code executable by a hardware processor, the program code when executed, causing the hardware processor to execute a process for utilizing a neural network (NN) between a data owner having untransformed data and a NN owner having a private NN, the program code comprising code to:
initiate a secure connection between the data owner and the NN owner;
exchange, with the NN owner, transformation compatibility data, wherein the transformation compatibility data is based at least on pre-agreed upon dimensionality data, wherein the transformation compatibility data provides information required for neural network operations in a transformed space, and wherein neural network operations performed in the transformed space are transformed operations that preserve corresponding neural network operations performed in an untransformed space up to a predetermined error threshold;
exchange, with the NN owner, an activation function, wherein the activation function is based at least on the transformation compatibility data; and
receive, from the NN owner, a transformed NN, wherein the transformed NN was generated in the transformed space by transforming the private NN from the untransformed space using the transformation compatibility data and a NN owner private transformation key generated by the NN owner.

61. The one or more non-transitory storage media of claim 60, wherein the activation function is a transformed activation function generated by the NN owner.

62. The one or more non-transitory storage media of claim 60, wherein the program code comprises code to:
receive, from the NN owner, a transformation operator based at least on the transformation compatibility data, wherein the transformation operator is configured to perform transformed NN operations in the transformed space.

63. The one or more non-transitory storage media of claim 62, wherein the untransformed data is untransformed input data for forward propagation through the transformed NN, and wherein the program code comprises code to:
transform the untransformed input data by applying a set of matrix operations using the transformation compatibility data, to generate transformed input data in the transformed space;
generate transformed output data from the transformed input data using the transformed NN, the activation function, and the transformation operator, wherein the transformed output data comprises output from the transformed NN in the transformed space in response at least to the transformed input data;
generate locked transformed output data from the transformed output data using a private output transformation key;
send the locked transformed output data to the NN owner;
receive, from the NN owner, locked untransformed output data, wherein the locked untransformed output data was generated by the NN owner from the locked transformed output data by reversing the transforming of the untransformed input data using the NN owner private transformation key; and
generate untransformed output data in the untransformed space from the locked untransformed output data using the private output transformation key.

64. The one or more non-transitory storage media of claim 63, wherein the set of matrix operations comprise generating an expanded untransformed input data matrix through a matrix expansion, wherein the matrix expansion comprises expanding an untransformed input data matrix using one or more dimensions of the private NN from the transformation compatibility data.

65. The one or more non-transitory storage media of claim 64, wherein the set of matrix operations further comprise generating the transformed output data through a matrix permutation and a matrix multiplication of the expanded untransformed input data matrix, wherein a matrix permutation comprises a rearrangement of columns of a matrix according to a specific permutation sequence, and wherein a matrix multiplication generates a product matrix, a product vector, or a product scalar, by multiplying elements of a first matrix with elements of a second matrix in a specific pattern.
